(19) United States
(12) Patent Application Publication
(10) Pub. No.: US 2024/0025058 A1
(43) Pub. Date: Jan. 25, 2024

(54) ROBOTIC APPARATUSES, SYSTEMS, AND METHODS FOR MOVING OBJECTS

(71) Applicant: THE RUBIC TECHNOLOGIES INC., Calgary (CA)

(72) Inventors: Tim JOHNSON, Calgary (CA); Masoud KALANTARI, Calgary (CA)

(21) Appl. No.: 18/253,552

(22) PCT Filed: Nov. 18, 2021
(86) PCT No.: PCT/CA2021/051632

§ 371 Date: May 18, 2023

Related U.S. Application Data
(60) Provisional application No. 63/115,367, filed on Nov. 18, 2020.
(60) Provisional application No. 63/142,326, filed on Jan. 27, 2021.

(51) Int. Cl. B25J 18/02; B25J 9/16; B25J 5/00; B65G 1/137

(52) U.S. Cl. CPC B25J 18/025; B25J 9/1694; B25J 5/007; B65G 1/1375

(57) ABSTRACT

Disclosed herein is a robot of a robotic system for moving objects such as packages, containers, totes, cases, bins, and/or boxes in a site, such as a warehouse, for fulfillment automation. The robot includes a base, a lift mechanism, and an object transitioning apparatus. The lift mechanism is coupled to the base. The lift mechanism is configured to vertically displace the object transitioning apparatus, relative to the base. The object transitioning apparatus includes an object manipulator for grasping an object. The object manipulator includes an extendible arm and an end effector for grasping the object. Lateral displacement of the end effector is effected by extension and retraction of the extendible arm. The extendible arm is laterally extendible, relative to the base, in a first direction, and also in a second direction that is opposite the first direction.

### FIELD

This disclosure generally relates to robotic apparatuses, systems, and methods, particularly robotic apparatuses, systems, and methods for moving objects such as packages, containers, totes, cases, bins, and/or boxes in a site, such as a warehouse, for fulfillment automation.

### BACKGROUND

Objects, such as packages, containers, totes, cases, bins, and/or boxes, can be stored in a site, for example, in a warehouse. The objects are placed on object supporters, which defines a surface on which the object is supportable, for example, a shelf of a rack, a platform, or a pallet. It is desirable to use the storage space of the warehouse efficiently. In this respect, it is desirable for: (i) the racks to be tall and have a plurality of object supporters, (ii) the object supporters to have increased depth, (iii) the space between the objects that are supported on the object supporter to be reduced, and (iv) the width of the aisle defined between racks to be reduced.

Existing automated storage and retrieval systems are able to emplace an object on an object supporter for storage, and also to retrieve the object from the object supporter. Unfortunately, such existing systems have limited vertical extension and lateral reach, which reduces the available space in a warehouse that is usable for object storage. In addition, while using existing systems, objects on the object supporter need to be spaced further apart, which reduces the number of objects that can be supported on the object supporter. Further, existing systems require increased aisle width for operation, which also reduces the available space in the warehouse that is usable for object storage.

### SUMMARY

In one aspect, there is provided a robot, comprising: a base; an object manipulator, comprising: an extendible arm; an end effector that is coupled to the extendible arm; wherein: the end effector is configured for grasping an object, such that a grasped object is established; and the extendible arm is extendible and retractable for displacing the grasped object relative to the base; the extendible arm is configurable in a first extendible arm extended configuration and a second extendible arm extended configuration; in the first extendible arm extended configuration, the extendible arm is extended, in a first direction; in the second extendible arm extended configuration, the extendible arm is extended, in a second direction that is opposite the first direction.

In another aspect, there is provided a robot, configured for: (i) displacing a first object relative to a first object supporter, the first object supporter being configured to support the first object, and (ii) displacing a second object relative to a second object supporter, the second object supporter is configured to support the second object, wherein the first object supporter is disposed opposite the second object supporter in a spaced-apart relationship such that an aisle is defined, comprising: a base; an object manipulator, comprising: an extendible arm; an end effector that is coupled to the extendible arm; wherein: the end effector, wherein, for each one of the first and second objects, independently, the end effector is configured for grasping a respective one of the first and second objects, such that a grasped object is established; and the extendible arm is extendible and retractable for displacing the grasped object relative to the base; the extendible arm is configurable in a first extendible arm extended configuration and a second extendible arm extended configuration; in the first extendible arm extended configuration, the telescoping arm is extended, such that the end effector is disposed for grasping the first object; in the second extendible arm extended configuration, the extendible arm is extended, such that the end effector is disposed for grasping the second object.

In another aspect, there is provided a robot, comprising: a base; an object manipulator, comprising: an extendible arm, extendible from a extendible arm retracted configuration to a first extendible arm extended configuration, and also extendible from the extendible arm retracted configuration to a second extendible arm extended configuration; an end effector that is coupled to the extendible arm; wherein: the end effector is configured for grasping an object, such that a grasped object is established; and the extendible arm is extendible and retractable for displacing he grasped object relative to the base; in transitioning from the extendible arm retracted configuration to the first extendible arm extended configuration, the extendible arm is extended in a first direction; and in transitioning from the extendible arm retracted configuration to the second extendible arm extended configuration, the extendible arm is extended in a second direction that is opposite the first direction.

In another aspect, there is provided a robot comprising: a base supportable by a reaction surface; an object manipulator, supported by the base, including: an end effector for grasping an object, wherein the end effector is displaceable relative to the base such that, while the end effector is grasping the object, the object is displaceable by the end effector; an anchor configuration; wherein: the base and the anchor configuration are co-operatively configured such that, while the base is supported on the reaction surface: the anchor configuration is emplaceable in an anchoring-effective state, with effect that the robot becomes anchored to the reaction surface.

In another aspect, there is provided a robot comprising: a base supportable by a reaction surface; an object manipulator, supported on the base, and including: an end effector for grasping an object, such that a grasped object is established; wherein: the object manipulator is displaceable, relative to the base, along a travel axis, between a lower vertical position and a higher vertical position, for effecting a change in elevation of the object manipulator; and the base and the object manipulator co-operate such that, while the base is supported on a reaction surface, such that the displaceability of the object manipulator is along a travel axis that is disposed at angle relative to the vertical, the base and the object manipulator are configurable into a modified travel axis-establishing state, with effect that the travel axis is modified to become a vertical axis.

In another aspect, there is provided a robot comprising: a base; an object manipulator configured for grasping an object; and a lift mechanism configured for vertically displacing the object manipulator, relative to the base, including: a prime mover for generating a force for urging the vertical displacement of the object manipulator relative to the base; and a counterweight configuration, coupled to the object manipulator, with effect that an opposing counterweight-based force is applied by the counterweight configuration to the object manipulator such that the weight of the object manipulator is opposed by the counterweight configuration, and such that the counterweight configuration is effective for assisting the prime mover with the urging of the vertical displacement of the object manipulator relative to the base.

In another aspect, there is provided a robot configured to displace an object relative to an object supporter, the robot comprising: a base; an object manipulator including: an object emplacement/removal tool; and an end effector configured for grasping an object; wherein: the object emplacement/removal tool and the end effector are co-operatively configured with effect that: the object emplacement/removal tool is displaceable, relative to the base, independently of the end effector, and along a first axis; the end effector is displaceable, with the object emplacement/removal tool, along a second axis; and the second axis is disposed parallel to an axis that is transverse to the first axis.

In another aspect, there is provided a robot configured to displace an object relative to an object supporter, the robot comprising: a base; an object manipulator including: an object emplacement/removal tool; and an end effector configured for grasping an object; wherein: the object emplacement/removal tool and the end effector are co-operatively configurable with effect that the object emplacement/removal tool is displaceable, relative to the base, independently of the end effector, and along a first axis, such that displacement of the object emplacement/removal tool, relative to the base, and along a first axis, is obtainable, and the displacement of the object emplacement/removal tool, relative to the base, and along a first axis, is obtainable in absence of displacement of the end effector, relative to the base, and along the first axis, such that positioning of the end effector, relative to the base, remains unchanged, with effect that the object manipulator is transitionable between an alignment ineffective configuration and an alignment effective configuration in response to the displacement of the object emplacement tool, relative to the end effector, and along the first axis, obtained in absence of displacement of the end effector, relative to the base, along the first axis; the object emplacement/removal tool and the end effector are co-operatively configurable with effect that the end effector is displaceable, with the object emplacement/removal tool, relative to the base, along a second axis, and in response to extension or retraction of the object emplacement/removal tool, such that displacement of the end effector, with the object emplacement/removal tool, relative to the base, along the second axis, and in response to extension or retraction of the object emplacement/removal tool, is obtainable, such that the object manipulator is transitionable between the alignment effective configuration and an object emplacement/removal effective configuration in response to the displacement of the end effector, relative to the base, along the second axis, and in response to the extension or the retraction of the object emplacement/removal tool; and the second axis is disposed parallel to an axis that is transverse to the first axis.

In another aspect, there is provided a robot, comprising: a base; an object manipulator, comprising: an extendible arm configured for extension and retraction; an end effector configured for grasping an object; wherein: the end effector is coupled to the extendible arm such that: the end effector is displaceable laterally, relative to the base, in response to extension or retraction of the extendible arm; and the end effector is displaceable laterally, relative to the extendible arm.

In another aspect, there is provided a robot, comprising: a base; an object manipulator, comprising: an end effector, the end effector comprising: a first grasping configuration disposed on a first side of the end effector; and a second grasping configuration disposed on a second side of the end effector that is opposite the first side; a robot-defined object supporter configured to support the object, such that, while the object is supported on the robot-defined object supporter, a supported object is established; wherein: each one of the first grasping configuration and the second configuration, independently, is configured for grasping an object, such that a grasped object is established; and while the object is supported by the robot-defined object supporter: the object manipulator is configurable in a first configuration, a second configuration, a third configuration, and a fourth configuration; in the first configuration: a first side of the supported object is grasped by the first grasping configuration, such that the end effector is coupled to the first side of the supported object; in the second configuration: there is an absence of coupling between the end effector and the supported object, and the first grasping configuration and the first side of the supported object are disposed in opposing relationship; in the third configuration: there is an absence of coupling between the end effector and the supported object, and the second grasping configuration and a second side of the supported object are disposed in opposing relationship, wherein, relative to the first side, the second side of the supported object is disposed on an opposite side of the supported object; in the fourth configuration: the second side of the supported object is grasped by the second grasping configuration, such that the end effector is coupled to the second side of the supported object; the object manipulator is: transitionable from the first configuration to the second configuration; transitionable from the second configuration to the third configuration; and transitionable from the third configuration to the fourth configuration.

In another aspect, there is provided a robot, comprising: a base; an object manipulator, comprising: a first end effector configured for grasping an object; a robot-defined object supporter configured to support the object, such that, while the object is supported on the robot-defined object supporter, a supported object is established; a second end effector, configured for grasping the object; wherein: the first end effector is displaceable laterally, relative to the base; and the second end effector is displaceable longitudinally, relative to the base.

In another aspect, there is provided a robot, comprising: a base; an object manipulator configured for: grasping an object, such that a grasped object is established; and moving the grasped object; a lift mechanism, for vertically displacing the object manipulator relative to the base, and including a frame mounted to the base, wherein the frame includes: a first frame section; a second frame section; and an intermediate frame section disposed between the first frame section and the second frame section; wherein: the first frame section and the second frame section are disposed in opposing relationship; the first frame section, the second frame section, and the intermediate frame section co-operatively configured such that a torque-receiving frame portion is defined; the object manipulator is coupled to the frame, such that the object manipulator is moveable relative to the frame for effectuating the vertical displacement, and such that, while the object manipulator is moving the grasped object, a force is transmitted from the object manipulator to the frame, with effect that a torque is applied to the torque-receiving frame portion; the torque-receiving frame portion is configured to resist the torque applied to the frame.

In another aspect, there is provided a robot, comprising: a base; an object manipulator, comprising: a telescoping arm; an end effector coupled to the telescoping arm; wherein: the end effector is configured for grasping an object, such that a grasped object is established; and the telescoping arm is extendible and retractable for moving the grasped object; the telescoping arm includes a plurality of arm segments; at least one of the plurality of arm segments has a C-shaped cross-section, such that the telescoping arm includes at least one C-shaped cross-section defined arm segment.

In another aspect, there is provided a robot, comprising: a base; an object manipulator including: an end effector for grasping an object; wherein: the end effector is displaceable relative to the base; and a temperature sensor, displaceable with the end effector; wherein: the end effector and the temperature sensor are co-operatively configured such that, while the end effector is being displaced relative to the base, the temperature sensor is effective for collecting a plurality of temperature data, wherein each one of the temperature data, independently, is representative of a temperature.

Other aspects will be apparent from the description and drawings provided herein.

### BRIEF DESCRIPTION OF DRAWINGS

In the figures, which illustrate example embodiments,

FIG. 1 is a schematic diagram of a robotic system;

FIG. 2 is a schematic diagram showing the software structure of the robotic system of FIG. 1;

FIG. 3 is a schematic of an image captured by an optical sensor of a robot of the robotic system of FIG. 1, with objects identified with bounding boxes;

FIG. 4 is a schematic of an image captured by an optical sensor of a robot of the robotic system of FIG. 1, with objects and spaces identified with bounding boxes;

FIG. 5 is a perspective view of a robot of the robotic system of FIG. 1, with the lift mechanism in a retracted configuration;

FIG. 6 is a perspective view of the robot of FIG. 5, with the lift mechanism in an extended configuration;

FIG. 7 is a perspective view of the robot of FIG. 5, with the lift mechanism in the extended configuration, and the extendible arm in a first extendible arm extended configuration;

FIG. 8 is a perspective view of the robot of FIG. 5, with the lift mechanism in the extended configuration, and the extendible arm in a second extendible arm extended configuration;

FIG. 9 is a top perspective view of the base configuration of the robot of FIG. 5;

FIG. 10 is a top perspective view of the base configuration of FIG. 9, depicting components disposed within the base configuration;

FIG. 11 is a bottom perspective view of the base configuration of FIG. 9, with the anchor configuration disposed in an anchor-effective state;

FIG. 12 is a bottom perspective view of the base configuration of FIG. 9, with the anchor configuration disposed in an anchor-ineffective state;

FIG. 13 is a perspective view of an anchor configuration displacement actuator of the base configuration of FIG. 9, with anchor subconfiguration connectors disposed in an extended position;

FIG. 14 is a perspective view of an anchor configuration displacement actuator of the base configuration of FIG. 9, with anchor subconfiguration connectors disposed in retracted position;

FIG. 15 is a front perspective view of the lift mechanism of the robot of FIG. 5, the lift mechanism disposed in a retracted configuration, and side and rear access doors open;

FIG. 16 is a rear perspective view of the lift mechanism of FIG. 15;

FIG. 17 is a front perspective view of the lift mechanism of FIG. 15, the lift mechanism disposed in an extended configuration;

FIG. 18 is a rear perspective view of the lift mechanism of FIG. 17;

FIG. 19 is a front perspective view of a frame of the lift mechanism of the robot of FIG. 15, with side and rear access doors open;

FIG. 20 is a rear perspective view of the frame of FIG. 19, with side and rear access doors open;

FIG. 21 is another front perspective view of the frame of FIG. 19, with side and rear access doors open;

FIG. 22 is a rear elevation view of the lift mechanism of FIG. 15, with side and rear access doors open, the lift mechanism disposed in the retracted configuration;

FIG. 23 is a rear elevation view of the lift mechanism of FIG. 15, with side and rear access doors open, the lift mechanism disposed in the extended configuration;

FIG. 24 is a front elevation view of the lift mechanism of FIG. 15;

FIG. 25 is a cross-sectional view of the lift mechanism of FIG. 24, along line 25-25 shown in FIG. 24;

FIG. 26 is a cross-sectional view of the lift mechanism of FIG. 24, along line 26-26 shown in FIG. 24;

FIG. 27 is a cross-sectional view of the lift mechanism of FIG. 24, along line 27-27 shown in FIG. 24;

FIG. 28 is a cross-sectional view of the lift mechanism of FIG. 24, along line 28-28 shown in FIG. 24;

FIG. 29 is a cross-sectional view of the lift mechanism of FIG. 24, along line 29-29 shown in FIG. 24;

FIG. 30 is a top elevation view of the lift mechanism of the robot of FIG. 5;

FIG. 31 is a cross-sectional view of the lift mechanism of FIG. 30, along line 31-31 shown in FIG. 30;

FIG. 32 is an enlarged view of the portion of the lift mechanism of FIG. 31, the portion identified by window A shown in FIG. 31;

FIG. 33 is a perspective view of an inner carrier of the lift mechanism of the robot of FIG. 5, with a connector plate disposed at a top end of the inner carrier;

FIG. 34 is a front elevation view of the inner carrier of FIG. 33;

FIG. 35 is a cross-sectional view of the inner carrier of FIG. 33, along line 35-35 shown in FIG. 34;

FIG. 36 is a perspective view of the inner carrier of FIG. 33, with the connector plate disposed at a bottom end of the inner carrier;

FIG. 37 is a perspective view of a counterweight configuration of the lift mechanism of the robot of FIG. 5, while the connector plate is disposed at a bottom end of the inner carrier;

FIG. 38 is a perspective view of the inner carrier of FIG. 33, with the connector plate disposed at a top end of the inner carrier;

FIG. 39 is a perspective view of a counterweight configuration of the lift mechanism of the robot of FIG. 5, while the connector plate is disposed at a top end of the inner carrier;

FIG. 40 is a front perspective view of an object transitioning apparatus of the robot of FIG. 5;

FIG. 41 is a rear perspective view of the object transitioning apparatus of FIG. 40;

FIG. 42 is a rear elevation view of an object manipulator of the object transitioning apparatus of FIG. 40;

FIG. 43 is a cross-sectional view of the object manipulator of FIG. 42, along line 43-43 shown in FIG. 42;

FIG. 44 is a front elevation of the object manipulator of FIG. 42, wherein an extendible arm of the object manipulator is disposed in an extendible arm retracted configuration;

FIG. 45 is a cross-sectional view of the object manipulator of FIG. 42, along line 45-45 shown in FIG. 44;

FIG. 46 is a cross-sectional view of the object manipulator of FIG. 42, along line 46-46 shown in FIG. 44;

FIG. 47 is a front elevation of the object manipulator of FIG. 42, wherein the extendible arm of the object manipulator is disposed in a first extendible arm extended configuration;

FIG. 48 is a front elevation of the object manipulator of FIG. 47;

FIG. 49 is a cross-sectional view of the object manipulator of FIG. 47, along line 49-49 shown in FIG. 47;

FIG. 50 is a cross-sectional view of the object manipulator of FIG. 47, along line 50-50 shown in FIG. 47;

FIG. 51 is a front elevation of the object manipulator of FIG. 42, wherein the extendible arm of the object manipulator is disposed in a second extendible arm extended configuration;

FIG. 52 is a front elevation of the object manipulator of FIG. 51;

FIG. 53 is a cross-sectional view of the object manipulator of FIG. 51, along line 53-53 shown in FIG. 51;

FIG. 54 is a cross-sectional view of the object manipulator of FIG. 51, along line 53-53 shown in FIG. 51;

FIG. 55 is a perspective view of a base arm segment of the extendible arm of the object manipulator of FIG. 42;

FIG. 56 is a perspective view of the base arm segment of FIG. 55, depicting components disposed within the base arm segment;

FIG. 57 is a front perspective view of a driver of the object manipulator of FIG. 42, with the grasping configurations disposed in a first longitudinal position;

FIG. 58 is a rear perspective view of the driver of FIG. 57;

FIG. 59 is a front perspective view of the driver of the object manipulator of FIG. 42, with the grasping configurations disposed in a second longitudinal position;

FIG. 60 is a rear perspective view of the driver of FIG. 59;

FIG. 61 is a front perspective view of the driver of the object manipulator of FIG. 42, depicting components of the driver;

FIG. 62 is a front elevation view of a grasping configuration of the object manipulator of FIG. 42, disposed in a first vertical position;

FIG. 63 is a cross-sectional view of the grasping configuration of FIG. 62, along line 63-63 shown in FIG. 62;

FIG. 64 is a front elevation view of the grasping configuration of the object manipulator of FIG. 42, disposed in a second vertical position;

FIG. 65 is a cross-sectional view of the grasping configuration of FIG. 64, along line shown in FIG. 64;

FIG. 66 is a side elevation of the driver of the object manipulator of FIG. 42, with a first grasping configuration pivoted relative to the driver;

FIG. 67 is a top elevation of the object transitioning apparatus of FIG. 40, with the robot defined object supporter disposed in a supporter retracted configuration;

FIG. 68 is a cross-sectional view of the object transitioning apparatus of FIG. 67, along line 68-68 shown in FIG. 67;

FIG. 69 is a perspective of the object transitioning apparatus of FIG. 40, with the robot defined object supporter disposed in a first supporter extended configuration;

FIG. 70 is a top elevation of the object transitioning apparatus of FIG. 69;

FIG. 71 is a cross-sectional view of the object transitioning apparatus of FIG. 69, along line 71-71 shown in FIG. 70;

FIG. 72 is a perspective of the object transitioning apparatus of FIG. 40, with the robot defined object supporter disposed in a second supporter extended configuration;

FIG. 73 is a top elevation of the object transitioning apparatus of FIG. 72;

FIG. 74 is a cross-sectional view of the object transitioning apparatus of FIG. 72, along line 74-74 shown in FIG. 73;

FIG. 75 is a perspective view of the object manipulator of the object transitioning apparatus of FIG. 40, wherein the driver is disposed at a first lateral position, relative to the terminal arm segment of the extendible arm;

FIG. 76 is a perspective view of the object manipulator of the object transitioning apparatus of FIG. 40, wherein the driver is disposed at a second lateral position, relative to the terminal arm segment of the extendible arm;

FIG. 77 is a right side elevation view of the object transitioning apparatus of FIG. 40, wherein the object manipulator is disposed in the alignment ineffective configuration;

FIG. 78 is a right side elevation view of the object transitioning apparatus of FIG. 40, wherein the object manipulator is disposed in the alignment effective configuration;

FIG. 79 is a top elevation of the object transitioning apparatus of FIG. 40, with an object supporter disposed on a first side of the object transitioning apparatus, an object supported on the robot-defined object supporter, and the object manipulator disposed in an object distribution ready configuration;

FIG. 80 is a top elevation of the object transitioning apparatus of FIG. 79, wherein the object manipulator is disposed in an alignment ineffective configuration, and the object is supported by the object supporter;

FIG. 81 is a top elevation of the object transitioning apparatus of FIG. 79, wherein the object manipulator is disposed in an alignment effective configuration;

FIG. 82 is a top elevation of the object transitioning apparatus of FIG. 79, wherein the object manipulator is disposed in a object emplacement/removal effective configuration, and the object is supported by the object supporter;

FIG. 83 is a perspective view of the housing and base of the object transitioning apparatus of FIG. 40, wherein the blocks are disposed in a retracted configuration;

FIG. 84 is a perspective view of the housing and base of the object transitioning apparatus of FIG. 40, wherein the blocks are disposed in an extended configuration;

FIG. 85 is a top elevation of the housing and base of the object transitioning apparatus of FIG. 83;

FIG. 86 is a cross-sectional view of the housing and base of FIG. 83, along line 86-86 shown in FIG. 85

FIG. 87 is a top elevation of the housing and base of the object transitioning apparatus of FIG. 84;

FIG. 88 is a cross-sectional view of the housing and base of FIG. 83, along line 88-88 shown in FIG. 87;

FIG. 89 is a perspective view of the object transitioning apparatus of FIG. 40 and objects supported on an object supporter, the object supporter disposed laterally of the object transitioning apparatus, the object manipulator of the object transitioning apparatus disposed in a object distribution ready configuration;

FIG. 90 is a top elevation view of the object transitioning apparatus and objects of FIG. 89;

FIG. 91 is a left side elevation view of the object transitioning apparatus and objects of FIG. 89;

FIG. 92 is a perspective view of the object transitioning apparatus of FIG. 40 and objects supported on an object supporter, the object supporter disposed laterally of the object transitioning apparatus, the object manipulator of the object transitioning apparatus disposed in an alignment ineffective configuration;

FIG. 93 is a top elevation view of the object transitioning apparatus and objects of FIG. 92;

FIG. 94 is a left side elevation view of the object transitioning apparatus and objects of FIG. 92;

FIG. 95 is a perspective view of the object transitioning apparatus of FIG. 40 and objects supported on an object supporter, the object supporter disposed laterally of the object transitioning apparatus, the object manipulator of the object transitioning apparatus disposed in an alignment effective configuration;

FIG. 96 is a top elevation view of the object transitioning apparatus and objects of FIG. 95;

FIG. 97 is a left side elevation view of the object transitioning apparatus and objects of FIG. 95;

FIG. 98 is a perspective view of the object transitioning apparatus of FIG. 40 and objects supported on an object supporter, the object supporter disposed laterally of the object transitioning apparatus, the object manipulator of the object transitioning apparatus disposed in an alignment effective configuration, and the extendible arm extended in a first direction towards an object;

FIG. 99 is a top elevation view of the object transitioning apparatus and objects of FIG. 98;

FIG. 100 is a left side elevation view of the object transitioning apparatus and objects of FIG. 98;

FIG. 101 is a perspective view of the object transitioning apparatus of Figure and objects supported on an object supporter, the object supporter disposed laterally of the object transitioning apparatus, the object manipulator of the object transitioning apparatus disposed in an object emplacement/removal effective;

FIG. 102 is a top elevation view of the object transitioning apparatus and objects of FIG. 101;

FIG. 103 is a left side elevation view of the object transitioning apparatus and objects of FIG. 101;

FIG. 104 is a perspective view of the object transitioning apparatus of Figure and objects supported on an object supporter, the object supporter disposed laterally of the object transitioning apparatus, wherein an object is grasped by the object manipulator and the object manipulator is disposed in the alignment effective configuration;

FIG. 105 is a top elevation view of the object transitioning apparatus and objects of FIG. 104;

FIG. 106 is a left side elevation view of the object transitioning apparatus and objects of FIG. 104;

FIG. 107 is a perspective view of the object transitioning apparatus of Figure and objects supported on an object supporter, the object supporter disposed laterally of the object transitioning apparatus, wherein an object is grasped by the object manipulator, and the object manipulator is disposed in the alignment ineffective configuration;

FIG. 108 is a top elevation view of the object transitioning apparatus and objects of FIG. 107;

FIG. 109 is a left side elevation view of the object transitioning apparatus and objects of FIG. 107;

FIG. 110 is a perspective view of the object transitioning apparatus of Figure and objects supported on an object supporter, the object supporter disposed laterally of the object transitioning apparatus, wherein an object is grasped by the object manipulator and emplaced on the robot defined object supporter, and the object manipulator is disposed in the object distribution ready configuration;

FIG. 111 is a top elevation view of the object transitioning apparatus and objects of FIG. 110;

FIG. 112 is a left side elevation view of the object transitioning apparatus and objects of FIG. 110;

FIG. 113 is a front perspective view of the object transitioning apparatus of FIG. 40, with the object manipulator disposed at a second vertical position;

FIG. 114 is a rear perspective view of the object transitioning apparatus of FIG. 113;

FIG. 115A is a perspective view of the object transitioning apparatus of Figure and an object disposed on a first object supporter, the first object supporter disposed on a first side of the object transitioning apparatus;

FIG. 115B is a front elevation view of the object transitioning apparatus and object of FIG. 115A;

FIG. 116A is a perspective view of the object transitioning apparatus of Figure and an object disposed on a first object supporter, the first object supporter disposed on a first side of the object transitioning apparatus, the object grasped by the object manipulator;

FIG. 116B is a front elevation view of the object transitioning apparatus and object of FIG. 116A;

FIG. 117A is a perspective view of the object transitioning apparatus of Figure and an object supported by the robot-defined object supporter, the object manipulator disposed in a first configuration;

FIG. 117B is a front elevation view of the object transitioning apparatus and object of FIG. 117A;

FIG. 118A is a perspective view of the object transitioning apparatus of Figure and an object supported by the robot-defined object supporter, the object manipulator disposed in a second configuration;

FIG. 118B is a front elevation view of the object transitioning apparatus and object of FIG. 118A;

FIG. 119A is a perspective view of the object transitioning apparatus of Figure and an object supported by the robot-defined object supporter, the object manipulator disposed in a fifth configuration;

FIG. 119B is a front elevation view of the object transitioning apparatus and object of FIG. 119A;

FIG. 120A is a perspective view of the object transitioning apparatus of Figure and an object supported by the robot-defined object supporter, the object manipulator disposed in a sixth configuration;

FIG. 120B is a front elevation view of the object transitioning apparatus and object of FIG. 120A;

FIG. 121A is a perspective view of the object transitioning apparatus of Figure and an object supported by the robot-defined object supporter, the object manipulator disposed in a third configuration;

FIG. 121B is a front elevation view of the object transitioning apparatus and object of FIG. 121A;

FIG. 122A is a perspective view of the object transitioning apparatus of Figure and an object supported by the robot-defined object supporter, the object manipulator disposed in a fourth configuration;

FIG. 122B is a front elevation view of the object transitioning apparatus and object of FIG. 122A;

FIG. 123A is a perspective view of the object transitioning apparatus of Figure and an object disposed on a second object supporter, the second object supporter disposed on a second side of the object transitioning apparatus, the object grasped by the object manipulator;

FIG. 123B is a front elevation view of the object transitioning apparatus and object of FIG. 123A;

FIG. 124 is a perspective view of a vertical displacement mechanism of the object transitioning apparatus of FIG. 40, the vertical displacement mechanism disposed in a retracted configuration;

FIG. 125 is a front elevation view of the vertical displacement mechanism of FIG. 124;

FIG. 126 is a right side elevation view of the vertical displacement mechanism of FIG. 124;

FIG. 127 is a cross-sectional view of the vertical displacement mechanism of FIG. 124, along line 127-127 shown in FIG. 126;

FIG. 128 is a perspective view of the vertical displacement mechanism of FIG. 124, the vertical displacement mechanism disposed in an extended configuration;

FIG. 129 is a front elevation view of the vertical displacement mechanism of FIG. 128;

FIG. 130 is a right side elevation view of the vertical displacement mechanism of FIG. 128;

FIG. 131 is a cross-sectional view of the vertical displacement mechanism of FIG. 128, along line 131-131 shown in FIG. 130;

FIG. 132 is a perspective view of the object transitioning apparatus of FIG. 40, depicting a second object manipulator;

FIG. 133 is a perspective view of a displacement mechanism of the second object manipulator of FIG. 132, the displacement mechanism disposed in a retracted configuration;

FIG. 134 is a perspective view of the displacement mechanism of the second object manipulator of FIG. 132, the displacement mechanism disposed in an intermediate forward configuration;

FIG. 135 is a perspective view of a displacement mechanism of the second object manipulator of FIG. 132, the displacement mechanism disposed in an extended configuration;

FIG. 136 is a perspective view of a displacement mechanism of the second object manipulator of FIG. 132, the displacement mechanism disposed in an intermediate rearward configuration;

FIG. 137 is a rear perspective view of the second object manipulator of FIG. 132 grasping an object disposed longitudinally forward of the object transitioning apparatus;

FIG. 138 is a front perspective view of the object manipulator and the object of FIG. 137;

FIG. 139 is a rear perspective view of the second object manipulator of FIG. 132 grasping an object that is emplaced on the robot-defined object supporter;

FIG. 140 is a front perspective view of the object manipulator and the object of FIG. 137;

FIG. 141 is a rear perspective view of the second object manipulator of FIG. 132 and the object, the object emplaced on the robot-defined object supporter, and the end effector of the second object manipulator disposed in a retracted configuration;

FIG. 142 is a front perspective view of the object manipulator and the object of FIG. 141;

FIG. 143 is a schematic of a temperature map;

FIG. 144 is a front perspective view of the robot of FIG. 5 and a pallet of objects disposed laterally of the robot;

FIG. 145 is a front perspective view of a driver of an object transitioning apparatus, wherein the grasping configurations include upward-facing hooks;

FIG. 146 is a bottom perspective view of the driver of FIG. 145, with a hook disposed in alignment with a handle of an object;

FIG. 147 is a front perspective view of a driver of an object transitioning apparatus, wherein the grasping configurations include downward-facing hooks, wherein a portion of a front-surface defining wall of an object is received in a downward facing hook;

FIG. 148 is a perspective view of a rail-coupling structure of the robot of FIG. 5;

FIG. 149 is a front elevation of the rail-coupling structure of FIG. 148 coupled to a rail;

### DETAILED DESCRIPTION

Embodiments herein relate to robotic apparatuses, systems, and methods for moving objects such as packages, containers, totes, cases, bins, and/or boxes in a site for fulfillment automation. The robotic system disclosed herein is suitable for operation in warehouses to reduce operation cost and increase the warehouse's overall throughput, such as the pick rate.

The robotic system disclosed herein utilizes robotic automation to effect dense picking operation capability and flexibility and without interference to other warehouse operations.

In some embodiments, for example, the robotic system disclosed herein uses one or more robots 110, for example, autonomous mobile robots, for operating in dense warehouses and logistic sites with packed objects placed beside each other in side by side relationship and/or above each other.

In some embodiments, for example, the robot 110 uses electrical and pneumatic actuators and motors with Al-based motion-planning software to move in a site such as a warehouse and to move objects from or to warehouse racks for warehouse order fulfillment.

In some embodiments, for example, the robotic system disclosed herein is designed from mechanical, electrical, and software standpoints to become a plug-and-play robotic system for easy integration with various warehouse types and environments.

In some embodiments, the robotic system disclosed herein may be integrated with various management systems such as warehouse management software (WMS) systems, cloud-based AMR fleet management systems, and the like.

In some embodiments, for example, the robot 110 comprises one or more proximity switches and sensors for collision avoidance and obstacle detection during movement of the robot 110 about the site.

In some embodiments, for example, the robot 110 includes one or more optical sensors such as a stereo camera, 3D camera, or light detection and ranging (LIDAR) sensors, displacement transducers, and Al-based computer vision technologies for navigation and object identification. In some embodiments, for example, the robot 110 comprises an Al engine using computer vision for decision making. In some embodiments, for example, the Al engine is a computer-vision-based Al engine.

The computer-vision-based Al engine of the robot 110 is trained using deep learning algorithms to expand its capabilities and improve its performance. To this end, in some embodiments, for example, the data collected by the optical sensors and displacement transducers are used to train the Al engine. In some embodiments, the robot 110 uses a feedback control subsystem combined with the Al engine to provide strong capability and reliability. In some embodiments, for example, the robot 110 uses shelf height information from actual shelf heights to facilitate the computer-vision-based Al engine in the position control of the object transitioning apparatus.

In some embodiments, for example, the robot 110 incudes sensors such as optical sensors (e.g. stereo cameras, 3D cameras, LIDAR sensors) and/or suitable ranging/positioning devices to facilitate computer vision, object detection, and collision detection. In some embodiments, for example, the robot 110 uses non-Al technologies for improving the reliability of the outputs and decisions of the Al engine in computer vision, object detection, and collision detection.

In some embodiments, the robot 110 comprises one or more lighting components such as one or more light-emitting diode (LED) lights, which may be turned on for illuminating the field of view (FOV) of the sensors (e.g. proximity sensors, optical sensors, etc.) of the robot 110 to facilitate collection of data by the sensors.

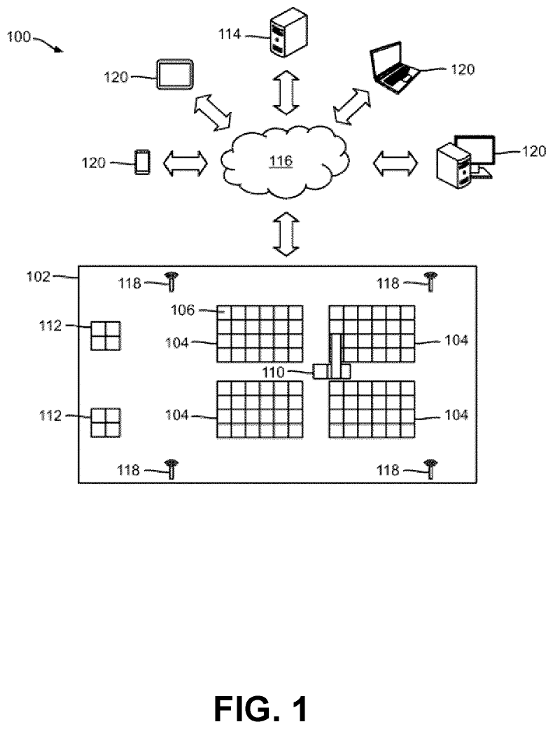

FIG. 1 depicts a robotic system 100. In some embodiments, for example, the robotic system 100 is configured for automating manual tasks in a site 102 such as a warehouse, a distribution center, a port, a cargo, a retail, and/or the like.

In some embodiments, for example, the site 102 comprises one or more racks 104 defining one or more object supporters, wherein an object supporter defines a surface on which the object is supportable, for example, a shelf of a rack, a platform, or a pallet, for accommodating a plurality of objects 106 such as packages, containers, bins, boxes, totes, and/or the like. One or more autonomous mobile robots 110 are deployed in the site 102 for moving objects from one or more loading zones 112 to the racks 104, from the racks 104 to the loading zones 112, or between the racks 104.

Each one of the robots 110, independently, are disposed in operable communication, for example, data communication, with one or more server computers 114 via a network 116 such as the Internet, a local area network (LAN), a wide area network (WAN), a metropolitan area network (MAN), and/or the like, preferably via suitable wireless communication technologies such as such as WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G networks, and/or the like. In some embodiments, the network 116 may also comprise one or more communication nodes 118, such as routers, switches, wireless access points, and/or the like, deployed in the site 102 for facilitating access of the network 116 by the robots 110.

In some embodiments, for example, the robots 110 are disposed in operable communication with the server 114 and/or the network 116 using suitable wired communication technologies such as Ethernet, USB cables, serial cables, parallel cables, and/or the like, if needed.

In some embodiments, for example, the robotic system 100 comprises one or more client computing devices 120 used by one or more users to communicate with the server computer 114 via the network 116 for performing various tasks such as placing an object-moving order, querying the status of a package-moving order, querying the status of the robots 110, querying the locations of objects 106, receiving notifications of package-moving orders, and the like. In some embodiments, for example, the client computing devices 120 are any suitable portable or non-portable computing devices such as desktop computers, laptop computers, tablets, smartphones, Personal Digital Assistants (PDAs), and/or the like.

In some embodiments, for example, the server computer 114 and client computing device 120 have similar hardware architecture and comprise a plurality of components including, e.g., a processor (also called a processing structure), system memory (volatile and/or non-volatile memory, e.g., RAM, ROM, EEPROM, and/or the like), non-removable or removable memory (e.g., hard disk drives, CD-ROMs, DVDs, solid-state memory, flash memory, and/or the like), networking components for connecting to the network 116, a display, one or more input devices such as a keyboard and a computer mouse, other input/output devices such as a microphone, a speaker, a printer, a scanner, and/or the like, and a system bus coupling the various computer components to the processor.

In some embodiments, for example, the processor is one or more single-core or multiple-core computing processors such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like.

In some embodiments, for example, the processor is one or more real-time processors, programmable logic controllers (PLCs), microcontroller units (MCUs), p-controllers (UCs), specialized or customized processors or controllers using e.g., field-programmable gate array (FPGA) or application-specific integrated circuit (ASIC) technologies, and/or the like.

In some embodiments, for example the robot 110 comprises a plurality of components including, e.g., a processor, system memory (volatile and/or non-volatile memory, e.g., RAM, ROM, EEPROM, and/or the like), non-removable or removable memory (e.g., hard disk drives, CD-ROMs, DVDs, solid-state memory, flash memory, and/or the like), networking components for connecting to the network 116, a plurality of sensors such as one or more optical sensors and displacement transducers, a plurality of action components including a lift mechanism, an object transitioning apparatus, and a base including a motive power assembly, and a system bus coupling the various components to the processor.

In some embodiments, for example the robot 110 comprises a display, one or more input devices such as a keyboard and a computer mouse, other input/output devices such as a microphone, a speaker, a printer, a scanner, and/or the like.

In some embodiments, for example the processor of the robot 110 is one or more real-time processors, PLCs, MCUs, UCs, specialized or customized processors or controllers using e.g., FPGA or ASIC technologies, and/or the like. In some embodiments, for example, the processor of the robot 110 is one or more single-core or multiple-core computing processors such as INTEL® microprocessors, AMD® microprocessors, ARM® microprocessors, and/or the like.

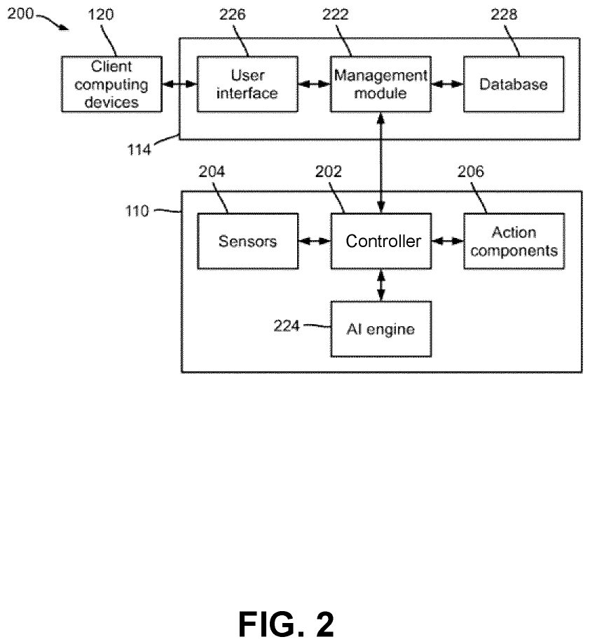

FIG. 2 is a schematic diagram showing the software structure 200 of the robotic system 100 in some embodiments. In some embodiments, for example, the robot 110 comprises a control module or a controller 202 coupled to an artificial intelligence (AI) engine 224 and in operable communication with sensors 204, for example, optical sensors, displacement transducers, vacuum sensors, and proximity sensors, as described in greater detail below, and action components 208, for example, the base 302, the lift mechanism 340, and the object transitioning apparatus 420, as described in greater detail below.

The control module 202 receives data collected by the sensors 206 and uses the Al engine 224 to make a plurality of decisions such as the exact location of an object, robot navigation (e.g., the path from the current location of the robot 110 to an object), an empty space in an object supporter of a rack, and/or the like, based on the received sensor data and the received user instructions. The controller 202 then instructs the action components 208 to perform an object-moving action.

The server computer 114 comprises a management module 222 coupled to a user interface 226 and a database 228 thereof. The management module 222 communicates with the client computing devices 120 via the user interface 226 to receive user instructions such as instructions of moving one or more packages 106. The management module 222 then processes the user instructions and sends the processed instructions to the controller 202 of the robot 110 for execution. After receiving execution reports from the controller 202 of the robot 110, the management module 222 of the server computer 114 reports the execution reports and various information such as the package-moving results, status of the robot 110, the status of the site 102, the status of racks 104, and/or the like, to the user via the user interface 226. In some embodiments, for example, the management module 222 stores the execution reports and various information into the database 228.

The robotic system 100 disclosed herein uses suitable deep learning algorithms to train the Al engine 224 for expanded capabilities and improved performances in, e.g., pathfinding and object recognition during an object-moving process or object-interacting process, based on computer vision and other suitable technologies.

In some embodiments, for example, the robot 110 is configured for autonomous navigation, for example, via the Al engine 224.

In some embodiments, for example, the robot 110 includes the necessary integrated circuits (ICs) to implement an Al engine 224 thereon rather than relying on an Al engine on a server computer that usually requires wireless communications, thereby eliminating the risk of poor wireless network connections may be present in the warehouse environment.

In some embodiments, for example, the robot 110 includes optical sensors such as stereo camera, 3D camera, and light detection and ranging (LIDAR) sensors and Al-based computer vision technologies for navigation and object identification. In some embodiments, for example, the robot 110 comprises an Al engine 224 using computer vision for decision making.

The computer-vision-based Al engine of the robot 110 is trained using deep learning algorithms to expand its capabilities and improve its performance. In some embodiments, as the sensors of the robot 110 collect data, the data is provided to the Al engine 224 to scale the training faster. In some embodiments, the robot 110 uses a feedback control subsystem combined with the Al engine 224 to provide strong capability and reliability. In some embodiments, for example, the Al engine uses shelf height information from actual shelf heights to facilitate the computer-vision-based Al engine 224 in the vertical displacement of the object transitioning apparatus 420, relative to the base 302.

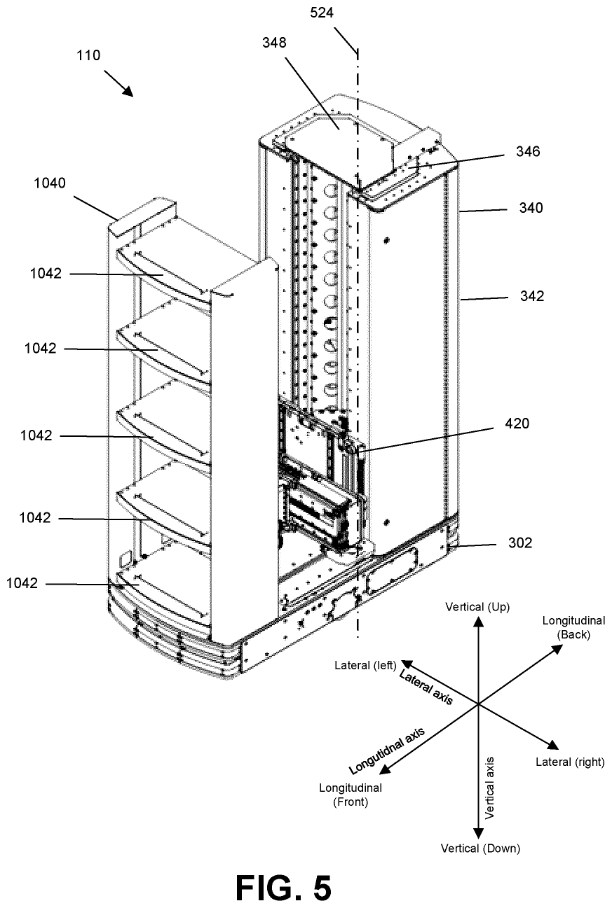

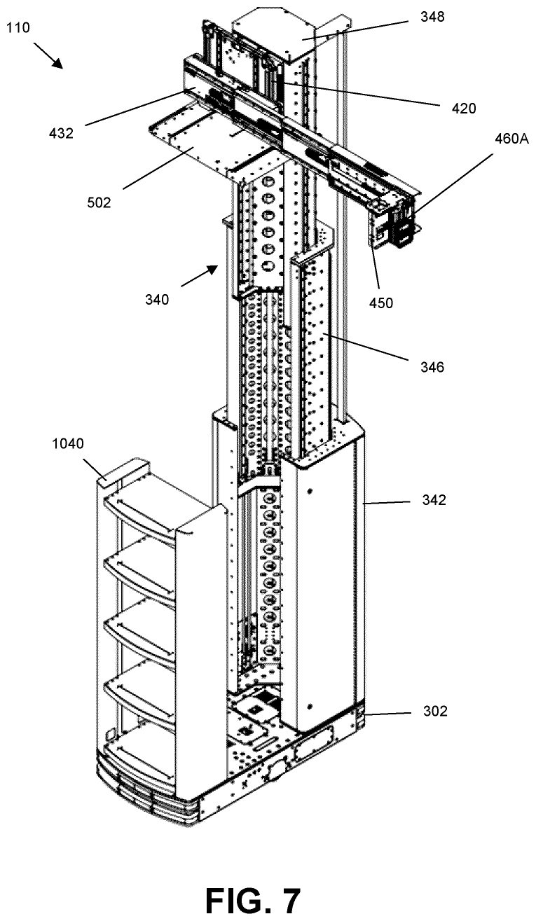

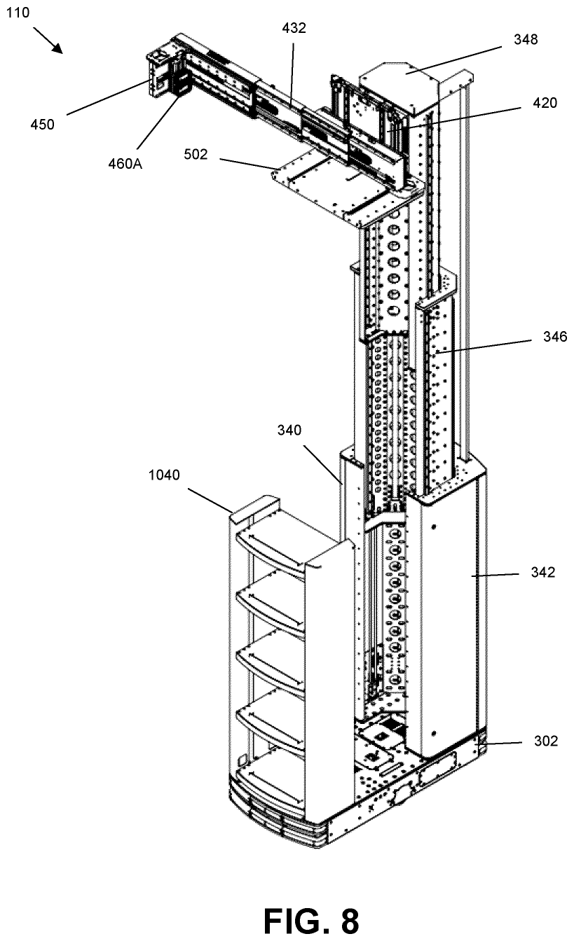

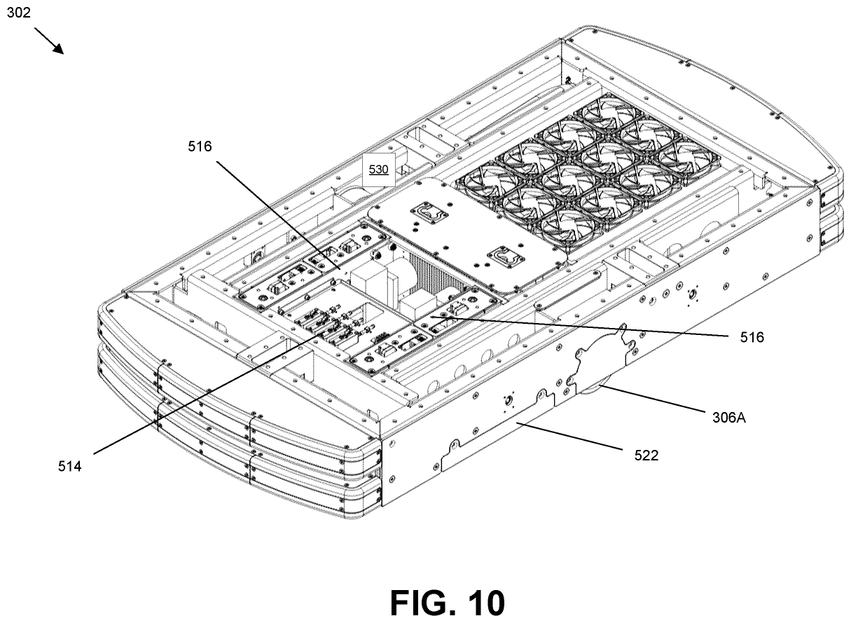

In some embodiments, for example, as depicted in FIG. 5 to FIG. 14, the robot 110 includes a base or a base configuration 302. In some embodiments, for example, the base configuration 302 is a mobile base configuration 302.

The base configuration 302 includes a motive power configuration including an engine structure, such as electronic motors, gas motor, and/or internal-combustion engines, a power source for the engine structure, such as a battery, fuel cell, or a fuel tank, operably coupled to the engine structure, a power source for the robot 110, such as a battery, a mobility platform 304, such as a plurality of wheels 306 including a pair of driving wheels 306A and a plurality of driven wheels 306B, configured for becoming co-operatively disposed in contact engagement with a reaction surface, such as the floor of the warehouse, for facilitating movement of the robot across the reaction surface, and a transmission configuration coupling the mobility platform and motive power configuration for moving the robot 110. In some embodiments, for example, the power source for the robot 110 is also the power source of the engine structure.

In some embodiments, for example, the mobility platform is configured for becoming co-operatively disposed in contact engagement with the reaction surface for facilitating movement of the mobile robot across the reaction surface within an aisle, which is defined by a first object supporter and second object supporter, the first object supporter is disposed opposite the second object supporter in a spaced-apart relationship.

In some embodiments, for example, the base configuration 302 comprises an autonomous navigation system having one or more optical sensors such as one or more cameras and/or one or more LIDAR sensors to control the motive power configuration and navigate the robot 110 to move in the site 102 using a suitable navigation technology such as LIDAR-based ranging and navigation, Visual Simultaneous Localization and Mapping (Visual SLAM), navigation technologies based on Ultra-Wide Band (UWB) communications, and Beacon technologies.

In some embodiments, for example, the controller 202 of the robot 110 is disposed in the base configuration 302.

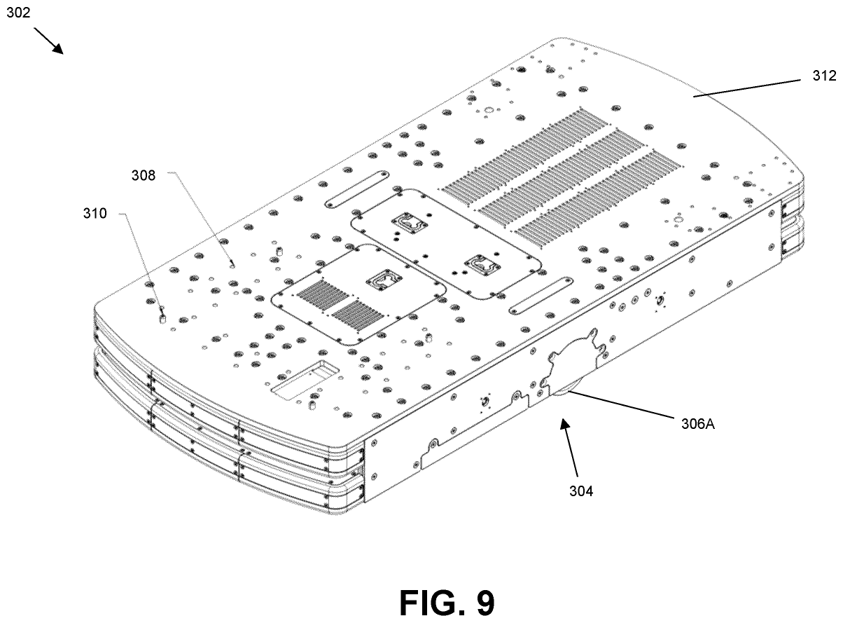

In some embodiments, for example, as depicted in FIG. 9, an upper surface 312 of the base configuration 302 includes a plurality of bolt holes 308 and a plurality of guide pins 310 for connection of the lift mechanism 340 to the base configuration 302. In some embodiments, for example, the lift mechanism 340, for example, a frame 342 of the lift mechanism 340, is bolted to the base configuration 302 via the bolt holes 308. In some embodiments, for example, the frame 342 includes corresponding bolt holes for securing the frame 342 to the base configuration 302 via mechanical fasteners, such as nuts and bolts, screws, and the like. In some embodiments, for example, the connection of the lift mechanism 340 to the base configuration 302 is aligned via the guide pins 310. In some embodiments, for example, the frame 342 includes corresponding guide ports for receiving the guide pins 310 to align the connection between the frame 342 and the base configuration 302.

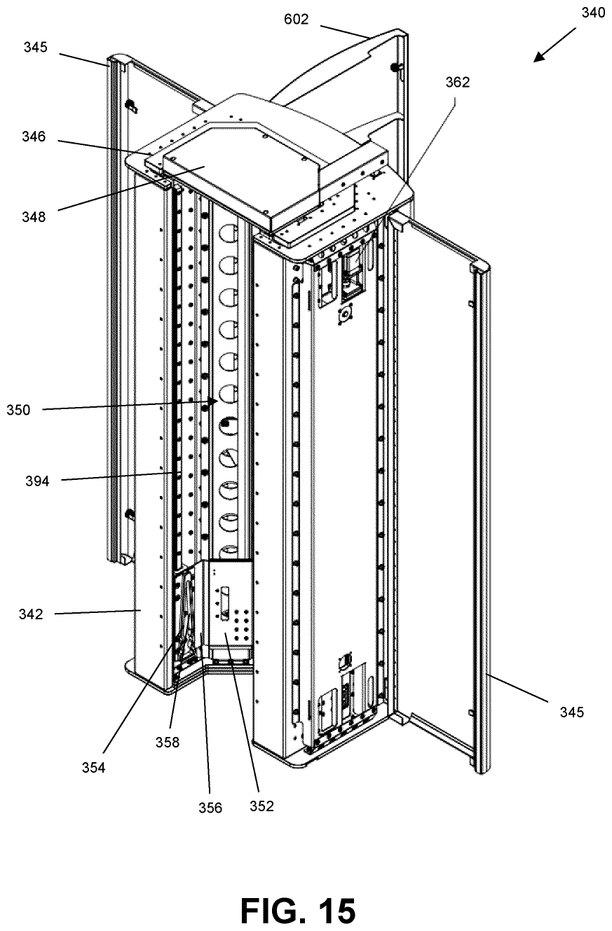

In some embodiments, for example, as depicted in FIG. 5 to FIG. 8, and FIG. 15 to FIG. 18, the robot 110 includes a lift mechanism 340. The lift mechanism 340 is connected to the base configuration 302 via mechanical fasteners. In some embodiments, for example, while the lift mechanism 340 is connected to the base configuration 302, the central longitudinal axis of the lift mechanism 340 is perpendicular to the upper surface 312 of the base configuration 302.

The lift mechanism 340 is configured to be coupled to an object transitioning apparatus 420, and, while the lift mechanism 340 is coupled to the object transitioning apparatus 420, the lift mechanism 340 is further configured to vertically displace the object transitioning apparatus 420. In some embodiments, for example, while the lift mechanism 340 is coupled to the base 302, the vertical displacement of the object transitioning apparatus 420 is relative to the base 302. In some embodiments, for example, the vertical displacement of the object transitioning apparatus 420, relative to the base 302, is for disposition of a platform or a robot-defined object supporter 502 of the object transitioning apparatus 420 at the same elevation as an object supporter, such as a shelf of a rack, a platform, or a pallet disposed in a site 102 such as a warehouse, such that an object on the robot-defined object supporter 502 is laterally (e.g. left or right of the robot 110) or longitudinally (e.g. front of the robot 110) displaceable from the platform to the object supporter, for example, to emplace the object onto the object supporter for storage, or such that an object that is supported on the object supporter is laterally displaceable from the object supporter to the robot-defined object supporter 502, for example, to retrieve the object and move the object to another location in the site.

In some embodiments, for example, while the object transitioning apparatus 420 is coupled to the lift mechanism 340, and the lift mechanism 340 is connected to the base 320, the object transitioning apparatus 420 is supported on the base 320.

In some embodiments, for example, the lift mechanism 340 includes a frame 342 an intermediate carrier 346, and an inner carrier 348. The frame 342 is connected to the base configuration 302, such that the connection of the lift mechanism 340 to the base configuration 302 is effected by the connection of the frame 342 to the base configuration 302.

The intermediate carrier 346 is coupled to the frame 342 such that the intermediate carrier 346 is vertically displaceable relative to the frame 342. While the frame 342 is connected to the base configuration 302, the vertical displaceability of the intermediate carrier 346, relative to the frame 342, is also relative to the base configuration 302.

The inner carrier 348 is coupled to the intermediate carrier 346 such that the inner carrier 348 is vertically displaceable relative to the frame 342. While the frame 342 is connected to the base configuration 302, the vertical displaceability of the inner carrier 348, relative to the frame 342, is also relative to the base configuration 302.

As described in greater detail below, the inner carrier 348 is coupled to the intermediate carrier 346 such that the inner carrier 348 is vertically displaceable relative to the intermediate carrier 346. While the frame 342 is connected to the base configuration 302, the vertical displaceability of the inner carrier 348, relative to the intermediate carrier 346, is also relative to the base configuration 302.

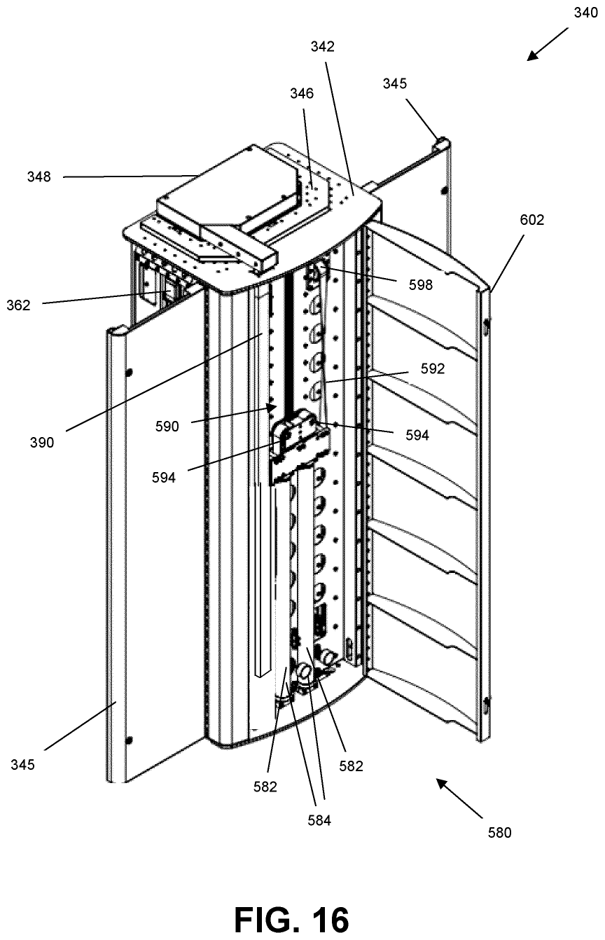

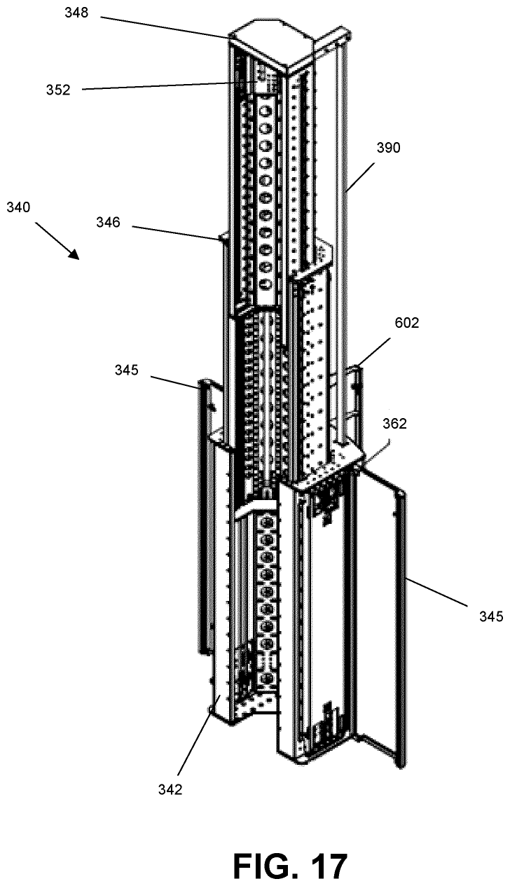

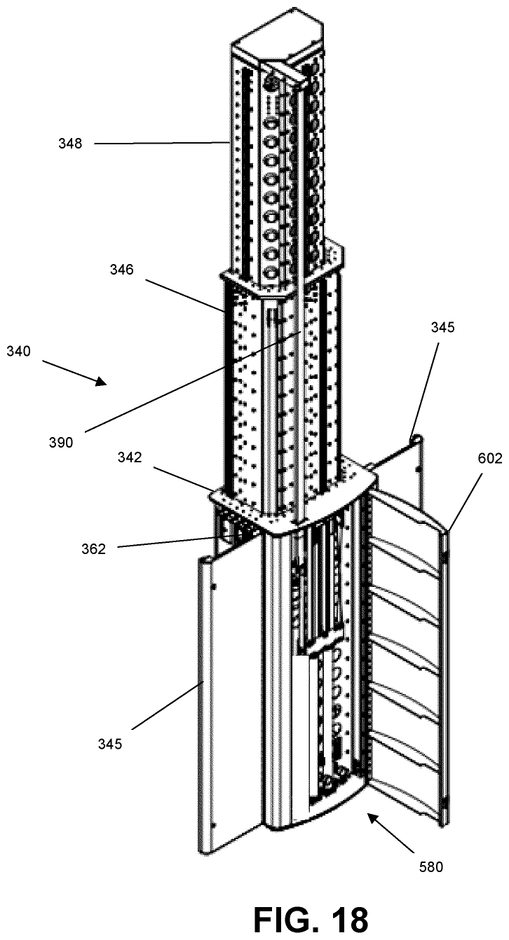

In some embodiments, for example, the vertical displaceability of the intermediate carrier 346 and the inner carrier 348 is such that the lift mechanism 340 is transitionable between a retracted configuration, as depicted in FIG. 15 and FIG. 16, and an extended configuration, as depicted in FIG. 17 and FIG. 18. In some embodiments, for example, while the lift mechanism 340 is disposed in the retracted configuration, the intermediate carrier 346 is disposed within the frame 342, for example, within a cavity 350 defined by the frame 342, and the inner carrier 348 is disposed within the intermediate carrier 346, for example, within a cavity 351 defined by the intermediate carrier 346. In some embodiments, for example, while the lift mechanism 340 is disposed in the extended configuration, at least a portion of the intermediate carrier 346 is disposed above the frame 342, and at least a portion of the inner carrier 348 is disposed above the intermediate carrier 346.

In some embodiments, for example, the vertical displaceability of the intermediate carrier 346, relative to the base 302, is such that the intermediate carrier 346 is vertically displaceable, relative to the base 302, between a lower vertical position, as depicted in FIG. 15 and FIG. 16, and a higher vertical position, as depicted by FIG. 17 and FIG. 18, wherein the higher vertical position is elevated relative to the lower vertical position.

In some embodiments, for example, the vertical displaceability of the inner carrier 348, relative to the base 302, is such that the inner carrier 348 is vertically displaceable, relative to the base 302, between a lower vertical position, as depicted in FIG. 15 and FIG. 16, and a higher vertical position, as depicted by FIG. 17 and FIG. 18, wherein the higher vertical position is elevated relative to the lower vertical position.

In some embodiments, for example, the lift mechanism 340 is a telescoping lift mechanism. In some embodiments, for example, while the lift mechanism 340 is disposed in the retracted configuration, the intermediate carrier 346 and the inner carrier 348 are nested in the frame 342, wherein the intermediate carrier 346 is disposed within the frame 342, and the inner carrier 348 is disposed within the intermediate carrier 346. In some embodiments, for example, while the lift mechanism 340 is disposed in the extended configuration, the intermediate carrier 346 and the inner carrier 348 are de-nested from the frame 342, wherein at least a portion of the intermediate carrier 346 is disposed above the frame 342, and at least a portion of the inner carrier 348 is disposed above the intermediate carrier 346. In some embodiments, for example, wherein the lift mechanism 340 is a telescoping lift mechanism, vertical displacement of the intermediate carrier 346 and the inner carrier 348, relative to the frame 342, includes vertical extension and vertical retraction of the intermediate carrier 346 and the inner carrier 348, relative to the frame 342.

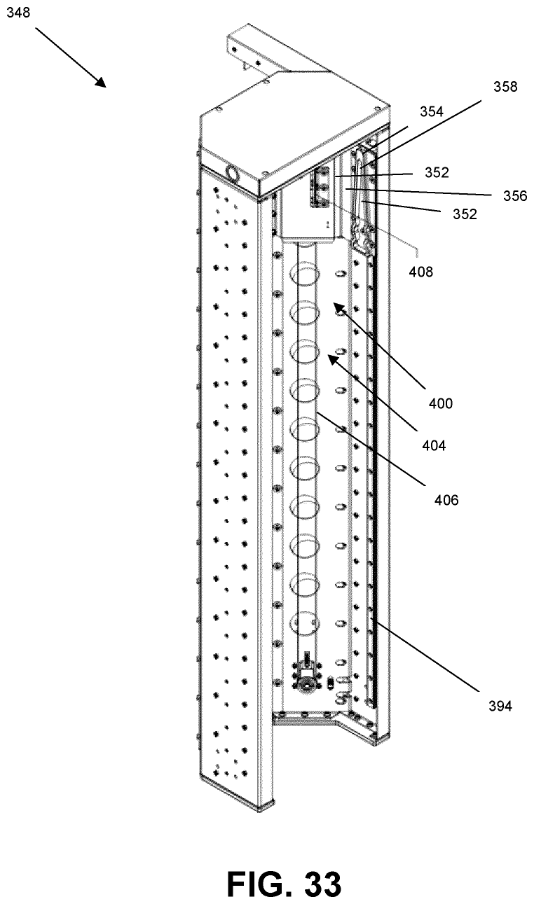

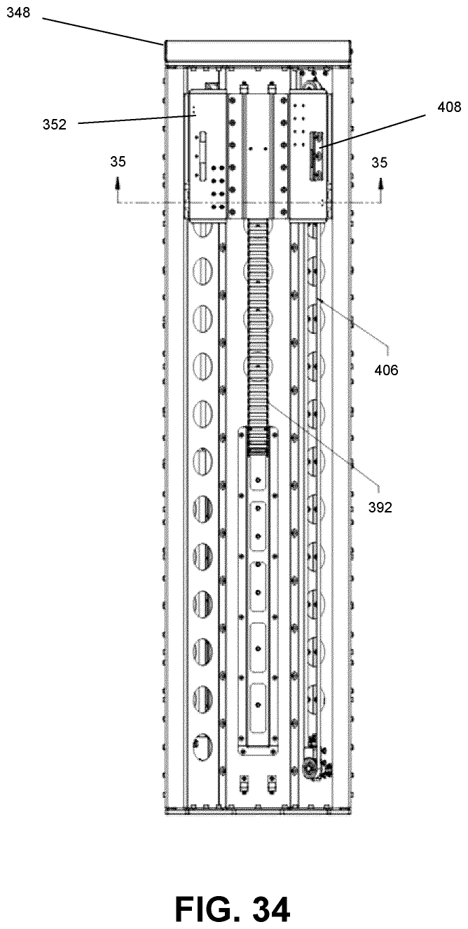

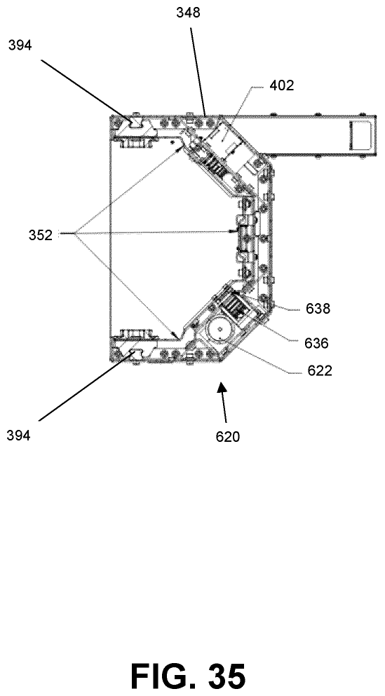

In some embodiments, for example, the lift mechanism 340 includes a connector plate 352 that is configured to operably couple with the object transitioning apparatus 420. In some embodiments, for example, coupling of the object transitioning apparatus 420 to the lift mechanism 340 is effected by coupling of the object transitioning apparatus 420 to the connector plate 352. The connector plate 352 defines one or more first connection system counterparts 354, wherein each one of the one or more first connection system counterparts 354, independently, co-operates with a respective second connection system counterpart 424 of the object transitioning apparatus 420, for coupling the connector plate 352 and the object transitioning apparatus 420. In some embodiments, for example, as depicted in FIG. 33, the connector plate 352 defines a pair of first connection system counterparts 354 disposed on opposite ends of the connector plate 350, such that the first connection system counterparts 354 are disposed in opposing relationship. Each one of the first connection system counterparts 354, independently, defines a connector 358 that extends from an inner surface 356 of the connector plate 352 in a direction towards the other first connection system counterpart 354. As depicted, each one of the connectors 358 of the first connection system counterparts 354, independently, has a triangular shape pointing vertically upwards. In some embodiments, for example, each one of the connectors 358, independently, has a circular shape, an oval shape, a quadrilateral shape such as a square or a rectangle, or a shape with more than four sides. In some embodiments, for example, each one of the second connection system counterparts 424 of the object transitioning apparatus 420, independently, defines a recess 426 to receive the connector 358 of the respective first connection system counterpart 354.

In some embodiments, for example, the coupling of the connector plate 352 and the object transitioning apparatus 420 is a releasable coupling. In such embodiments, for example, a first object transitioning apparatus 420, having a first object manipulator 430, that is coupled to the connector plate 352, can be decoupled from the connector plate 352, and a second object transitioning apparatus 420, having a second object manipulator 430 that is different from the first object manipulator 430 of the first object transitioning apparatus 420, can be coupled to the connector plate 352. In this respect, in some embodiments, for example, the object transitioning apparatus 420 having the appropriate object manipulator 430 for grasping a particular object can be coupled to the connector plate 352 for transitioning the object.

In some embodiments, for example, the connector plate 352 is vertically displaceable, relative to the base 302. In some embodiments, for example, the connector plate 352 is coupled to the inner carrier 348, such that the connector plate 352 is vertically displaced, relative to the base 302, in response to vertical displacement of the inner carrier 348, relative to the base 302.

In some embodiments, for example, while the object transitioning apparatus 420 is coupled to the connector plate 352, the object transitioning apparatus 420 is coupled to the lift mechanism 340, such that the object transitioning apparatus 420 is vertically displaceable, relative to the base 302, by the lift mechanism 340. In some embodiments, for example, while the object transitioning apparatus 420 is coupled to the connector plate 352, the object transitioning apparatus 420 is coupled to the inner carrier 348, such that the object transitioning apparatus 420 is vertically displaced, relative to the base 302, in response to vertical displacement of the inner carrier 348, relative to the base 302.

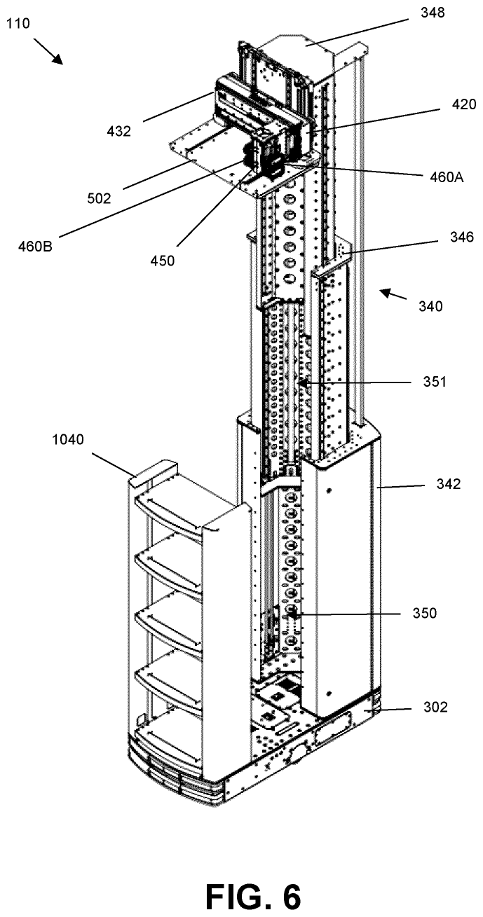

In some embodiments, for example, the vertical displaceability of the object transitioning apparatus 420, relative to the base 302, is such that the object transitioning apparatus 420 is vertically displaceable, relative to the base 302, between a lower vertical position, as depicted in FIG. 5, and a higher vertical position, as depicted by FIG. 6, wherein the higher vertical position is elevated relative to the lower vertical position.

In some embodiments, for example, the vertical length of the frame 342 is at least 6 feet, for example, 8 feet, for example, 10 feet. In some embodiments, for example, the vertical length of the inner carrier 346 is at least 6 feet, for example, 8 feet, for example, 10 feet. In some embodiments, for example, the vertical length of the inner carrier 348 is at least 6 feet, for example, 8 feet, for example, 10 feet.

In some embodiments, for example, the frame 342 is manufactured using sheet metal. In some embodiments, for example, the intermediate carrier 346 is manufactured using sheet metal. In some embodiments, for example, the inner carrier 348 is manufactured using sheet metal.

In some embodiments, for example, the lift mechanism 340 includes an actuator configuration 360 to effect the vertical displacement of the intermediate carrier 346 and inner carrier 348, relative to the base 302. In some embodiments, for example, the actuator configuration 360 includes a prime mover 362, for example, a motor, for example, an electric motor, that is disposed in operable communication with the intermediate carrier 346. In some embodiments, for example, the prime mover 362 is mounted to the frame 342. In some embodiments, for example, the mounting of the prime mover 362 to the frame 342 is such that the prime mover 362 is accessible via a side panel 345 of the frame 342, for example, for maintenance or replacement of the prime mover 362. The prime mover 362 is configured to generate a displacement force that is applicable to the intermediate carrier 346 and the inner carrier 348 for vertically displacing the intermediate carrier 346 and the inner carrier 348, relative to the base 302. In response to application of the displacement force from the prime mover 362 to the intermediate carrier 346 and the inner carrier 348, the intermediate carrier 346 and the inner carrier 348 are vertically displaced, relative to the base 302.

In some embodiments, for example, the prime mover 362 is configurable in an upward displacement drive state and a downward displacement drive state. In some embodiments, for example, while the prime mover 362 is disposed in the upward displacement drive state, the displacement force applied to the intermediate carrier 346 and the inner carrier 348 has an upward direction, such that the intermediate carrier 346 and the inner carrier 348 are displaced in the upward direction, relative to the base 302, in response to application of the displacement force to the intermediate carrier 346 and the inner carrier 348. In some embodiments, for example, while the prime mover 362 is disposed in the downward displacement drive state, the displacement force applied to the intermediate carrier 346 and the inner carrier 348 has a downward direction, such that the intermediate carrier 346 and the inner carrier 348 are displaced in the downward direction, relative to the base 302, in response to application of the displacement force to the intermediate carrier 346 and the inner carrier 348.

In some embodiments, for example, the prime mover 362 is disposed in data communication with the controller 202 and further disposed in electrical communication with the battery, for actuation of the prime mover 362 in the upward displacement drive state and the downward displacement drive state, via control commands from the controller 202.

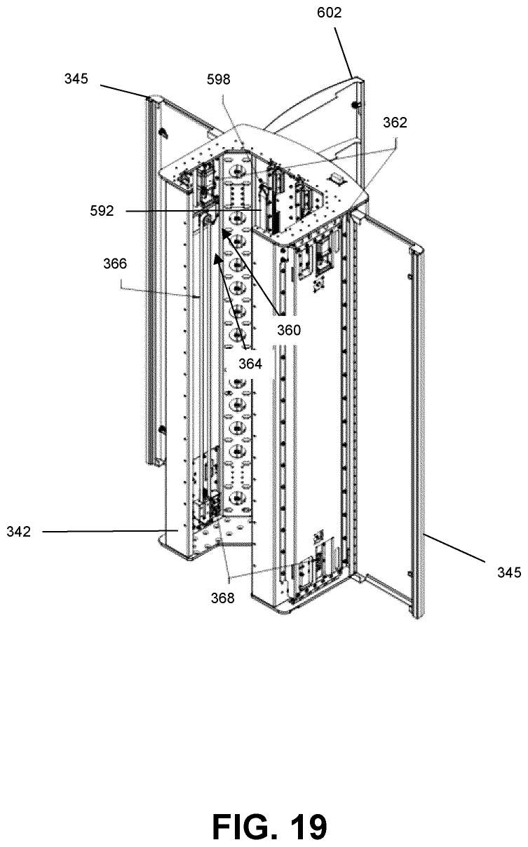

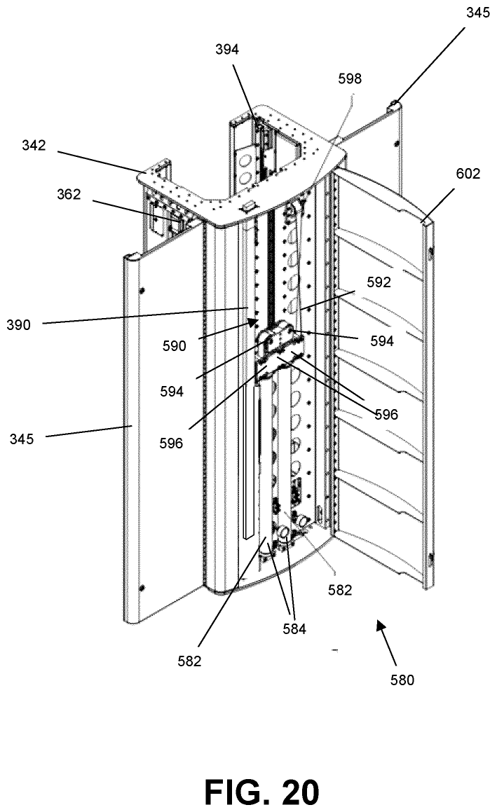

In some embodiments, for example, the actuator configuration 360 includes a transmission configuration 364 to effect the operable communication between the prime mover 362 and the intermediate carrier 346 and the inner carrier 348, in particular, between the prime mover 362 and the intermediate carrier 346. In some embodiments, for example, the transmission configuration 364 includes a transmission component 366, for example, a drive belt, a chain, a cable and the like, and an intermediate carrier connector 368, such as a plate or a block. As depicted in FIG. 19, the transmission component 366 connects the prime mover 362 and the intermediate carrier connector 368, which is connected to the intermediate carrier 346, such that the displacement force generated by the prime mover 362 is applied to the intermediate carrier 346 via the transmission component 366 and the intermediate carrier connector 368. In this respect, the displacement force generated by the prime mover 362 is an intermediate carrier displacement force. The intermediate carrier displacement force generated by the prime mover 362 is not directly applied to the inner module 348. In response to application of the intermediate carrier displacement force from the prime mover 362 to the intermediate carrier 346, the intermediate carrier 346 is vertically displaced, relative to the base 302.

In some embodiments, for example, to vertically displace the inner module 348, relative to the intermediate module 346, the lift mechanism 340 includes a transmission configuration 370. The base configuration 302, the intermediate carrier 346, the inner carrier 348, the transmission configuration 370 and the actuator configuration 360 are co-operatively configured such that, in response to application of the intermediate carrier displacement force to the intermediate carrier 346 by the actuator configuration 360 to effect the vertical displacement of the intermediate carrier 346, relative to the base configuration 302, an inner carrier displacement force is applied by the transmission configuration 370 to the inner carrier 348, to effect vertical displacement of the inner carrier 348, relative to the intermediate inner 346. In this respect, in some embodiments, for example, the displacement force generated by the prime mover 362 is applied directly to the intermediate carrier 346, and applied indirectly to the inner carrier 348 via the transmission configuration 370.

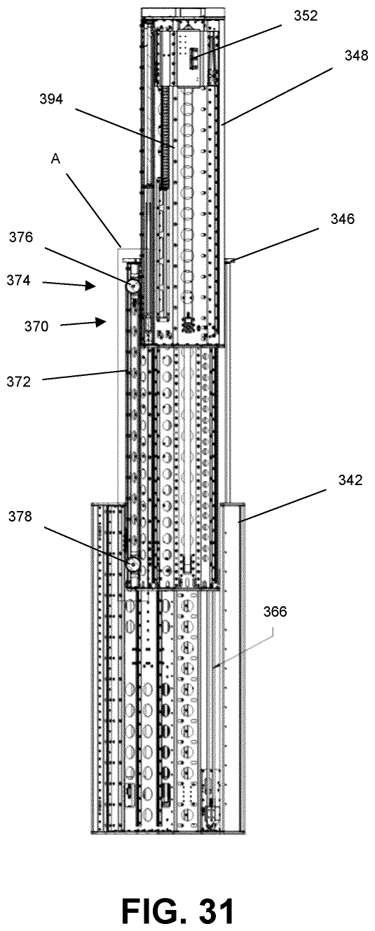

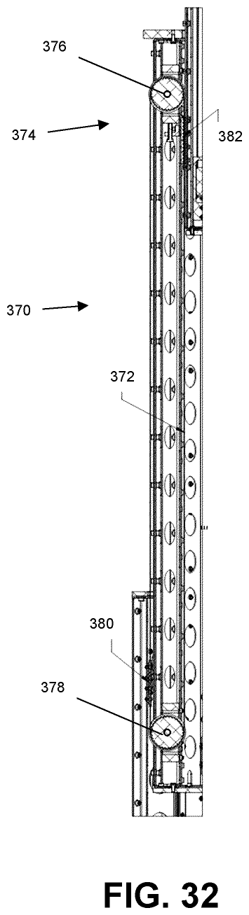

As depicted in FIG. 31 and FIG. 32, in some embodiments, for example, the transmission configuration 370 includes a transmission component 372, for example, a drive belt, a chain, a cable, and the like, and a pulley configuration 374, wherein the pulley configuration 374 includes two pulleys 376 and 378. The pulleys 376 and 378 are mounted to the intermediate carrier 346 with the pulley 376 positioned above the pulley 378, and the transmission component 372 is looped around the pulleys 376 and 378 and extend between the pulleys 376 and 378 and disposed in tension, with a first portion 380 of the transmission component 372 connected to the frame 342, and a second portion 382 of the transmission component connected to the inner carrier 348.

In response to upward vertical displacement of the intermediate carrier 346, for example, in response to application of the intermediate carrier displacement force having an upward vertical direction from the prime mover 362, the pulleys 376 and 378 are displaced upwards. As the pulley 376 is displaced upwards, the pulley 376 exerts a force on the transmission component 372, with effect that the transmission component 372 becomes further disposed in tension. Due to the connection of the transmission component to: (i) the frame 342, which is connected to the base 302 such that there is an absence of vertical displacement of the frame 342 relative to the base 302, and (ii) the inner carrier 348, which is displaceable relative to the intermediate carrier 346, as the transmission component becomes further disposed in tension, the tension in the transmission component 372 is transferred to the inner carrier 348 as an inner carrier displacement force, having an upward direction. In this respect, as the intermediate carrier 346 is displaced vertically upwards, the transmission component 372 applies the inner carrier displacement force to the inner carrier 348. In response to application of the inner carrier displacement force to the inner carrier 348, the inner carrier 348 is displaced, relative to the intermediate carrier 346, in the upward direction.

Similarly, in response to downward vertical displacement of the intermediate carrier 346, for example, in response to application of the intermediate carrier displacement force having a downward vertical direction from the prime mover 362, the pulleys 376 and 378 are displaced downwards. As the pulley 378 is displaced downwards, the pulley 378 exerts a force on the transmission component 372, with effect that the transmission component 372 becomes further disposed in tension. Due to the connection of the transmission component to: (i) the frame 342, which is connected to the base 302 such that there is an absence of vertical displacement of the frame 342 relative to the base 302, and (ii) the inner carrier 348, which is displaceable relative to the intermediate carrier 346, as the transmission component becomes further disposed in tension, the tension in the transmission component 372 is transferred to the inner carrier 348 as an inner carrier displacement force, having a downward direction. In this respect, as the intermediate carrier 346 is displaced vertically downwards, the transmission component 372 applies the inner carrier displacement force to the inner carrier 348. In response to application of the inner carrier displacement force to the inner carrier 348, the inner carrier 348 is displaced, relative to the intermediate carrier 346, in the downward direction.

In some embodiments, for example, the lift mechanism 340 includes more than one actuator configuration 360, for example, two actuator configurations 360. In some embodiments, for example, the two actuator configurations 360 are disposed, relative to the intermediate carrier 346, such that the intermediate carrier displacement forces applied to the intermediate carrier 346 by the actuator configurations 360 are balanced about a central longitudinal axis of the intermediate carrier 346. In some embodiments, for example, the two actuator configurations 360 are disposed in opposing relationship.

In some embodiments, for example, the lift mechanism 340 includes more than one transmission configuration 370, for example, a transmission configuration 370 for each actuator configuration 360 of the robot 110, for example, two transmission configurations 370. In some embodiments, for example, the two transmission configurations 370 are disposed, relative to the inner carrier 348, such that the inner carrier displacement forces applied to the inner carrier 348 by the transmission configurations 370 are balanced about a central longitudinal axis of the inner carrier 348. In some embodiments, for example, the two transmission configurations 370 are disposed in opposing relationship.

As noted above, in some embodiments, for example, the connector plate 352 is coupled to the inner carrier 348, such that the connector plate 352 is vertically displaceable, relative to the base 302, in response to vertical displacement of the inner carrier 348, relative to the base 302.

In some embodiments, for example, the coupling of the connector plate 352 to the inner carrier 348 is also such that the connector plate 352 is vertically displaceable, relative to the inner carrier 348. In some embodiments, for example, the vertical displacement of the connector plate 352, effected via vertical displacement of the inner carrier 348, relative to the base 302, is independent of the vertical displacement of the connector plate 352, relative to the inner carrier 348. In this respect, in some embodiments, for example: (i) while the lift mechanism 340 is disposed in the retracted configuration, the connector plate 352 is vertically displaceable relative to the inner carrier 348, (ii) while the lift mechanism 340 is disposed in the extended configuration, the connector plate 352 is also vertically displaceable relative to the inner carrier 348, and (iii) while the lift mechanism 340 is transitioning between the retracted configuration and the extended configuration, the connector plate 352 is also vertically displaceable relative to the inner carrier 348.

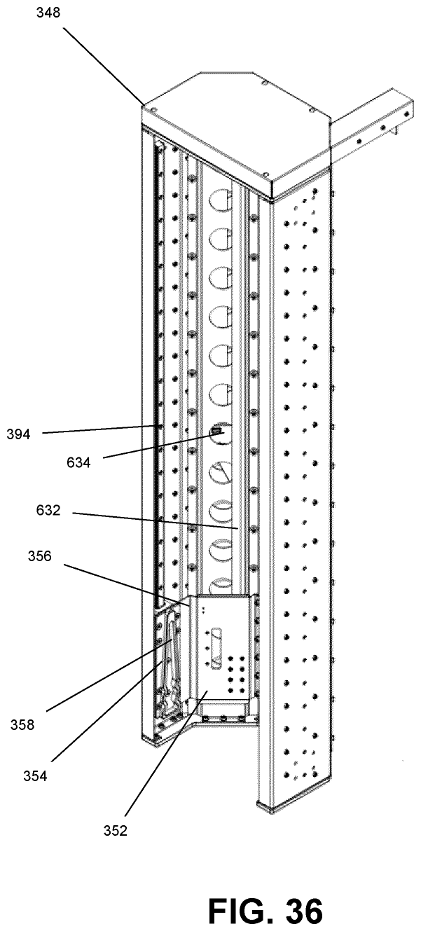

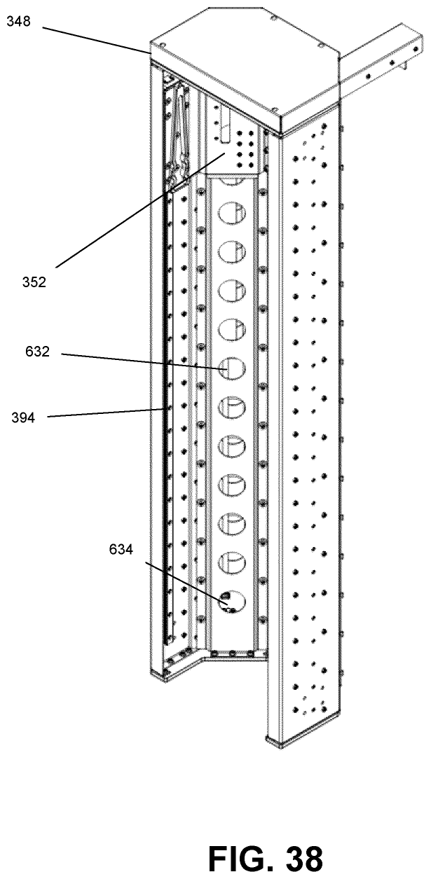

In some embodiments, for example, the vertical displaceability of the connector plate 352, relative to the inner carrier 348, is such that the connector plate 352 is displaceable, relative to the inner carrier 348, between a lower vertical position, as depicted in FIG. 36, and a higher vertical position, as depicted by FIG. 38, wherein the higher vertical position is elevated relative to the lower vertical position.

In some embodiments, for example, while the object transitioning apparatus 420 is coupled to the connector plate 352, the object transitioning apparatus 420 is vertically displaced, relative to the inner carrier 348, in response to vertical displacement of the connector plate 352, relative to the inner carrier 348. In some embodiments, for example, while the object transitioning apparatus 420 is coupled to the connector plate 352, the object transitioning apparatus 420 is vertically displaced, relative to the base 302, in response to vertical displacement of the connector plate 352, relative to the inner carrier 348.

In some embodiments, for example, the vertical displaceability of the connector plate 352, relative to the inner carrier 348, is such that, while the object transitioning apparatus 420 is coupled to the connector plate 352, the object transitioning apparatus 420 is displaceable, relative to the inner carrier 348, between a lower vertical position, as depicted in FIG. 36, and a higher vertical position, as depicted by FIG. 38, wherein the higher vertical position is elevated relative to the lower vertical position.

In some embodiments, for example, if the object transitioning apparatus 420 is to be vertically displaced a relatively shortly distance, for example, less than the vertical height of the frame 342, said vertical displacement can be effected only by the vertical displacement of the connector plate 352, relative to the inner carrier 348, without also having to vertically displace the intermediate carrier 346 and inner carrier 348, relative to the frame 342.

In some embodiments, for example, the connector plate 352 is vertically displaceable, relative to the base 302, in at least two ways, including: (i) the vertical displacement of the connector plate 352, effected via vertical displacement of the intermediate carrier 346 and inner carrier 348, relative to the base 302, and (ii) the vertical displacement of the connector plate 352, relative to the inner carrier 348.

In some embodiments, for example, while the object transitioning apparatus 420 is connected to the connector plate 352, the object transitioning apparatus 420 is vertically displaceable, relative to the base 302, in at least two ways, including: (i) the vertical displacement of the connector plate 352, effected via vertical displacement of the intermediate carrier 346 and inner carrier 348, relative to the base 302, and (ii) the vertical displacement of the connector plate 352, relative to the inner carrier 348.

In some embodiments, for example, by having at least the two ways of vertically displacing the object transitioning apparatus 420, relative to the base 302, the vertical displacement of the object transitioning apparatus 420, relative to the base 302, can be effected more quickly, than if there were only one of the two ways of vertically displacing the object transitioning apparatus 420, relative to the base 302.

In some embodiments, for example, the lift mechanism 340 includes an actuator configuration 400 to effect the vertical displacement of the connector plate 352, relative to the inner carrier 348. In some embodiments, for example, the actuator configuration 400 includes a prime mover 402, for example, a motor, for example, an electric motor, that is disposed in operable communication with the connector plate 352. In some embodiments, for example, the prime mover 402 is mounted to the inner carrier 348. The prime mover 402 is configured to generate a displacement force that is applicable to the connector plate 352 for vertically displacing the connector plate 352, relative to the inner carrier 348. In response to application of the displacement force from the prime mover 402 to the connector plate 352, the connector plate 352 is vertically displaced, relative to the inner carrier 348.

In some embodiments, for example, the prime mover 402 is configurable in an upward displacement drive state and a downward displacement drive state. In some embodiments, for example, while the prime mover 402 is disposed in the upward displacement drive state, the displacement force applied to the connector plate 352 has an upward direction, such that the connector plate 352 is displaced in the upward direction, relative to the inner carrier 348, in response to application of the displacement force to the connector plate 352. In some embodiments, for example, while the prime mover 402 is disposed in the downward displacement drive state, the displacement force applied to the connector plate 352 has a downward direction, such that the connector plate 352 is displaced in the downward direction, relative to the inner carrier 348, in response to application of the displacement force to the connector plate 352.

In some embodiments, for example, the prime mover 402 is disposed in data communication with the controller 202, for example, and further disposed in electrical communication with the battery of the robot 110, for example, via electrical and data cable 390, for actuation of the prime mover 402 in the upward displacement drive state and the downward displacement drive state, via control commands from the controller 202.

In some embodiments, for example, the actuator configuration 400 includes a transmission configuration 404 to effect the operable communication between the prime mover 402 and the connector plate 352. In some embodiments, for example, the transmission configuration 404 includes a transmission component 406, for example, a drive belt, a chain, a cable and the like, and a connector plate connector 408. As depicted in FIG. 33, the transmission component 406 connects the prime mover 402 and the connector plate connector 408, which is connected to the connector plate 352, for example, via mechanical fasteners, such that the displacement force generated by the prime mover 402 is applied to the connector plate 352 via the transmission component 406 and the connector plate connector 408. In this respect, the displacement force generated by the prime mover 402 is a connector plate displacement force. In response to application of the connector plate displacement force from the prime mover 402 to the connector plate 352, the connector plate 352 is vertically displaced, relative to the inner carrier 348.

In some embodiments, for example, the lift mechanism 340 includes more than one actuator configuration 400, for example, two actuator configurations 400. In some embodiments, for example, the two actuator configurations 400 are disposed, relative to the connector plate 352, such that the connector plate displacement forces applied to the connector plate 352 by the actuator configurations 400 are balanced about a central longitudinal axis of the connector plate 352. In some embodiments, for example, the two actuator configurations 400 are disposed in opposing relationship.

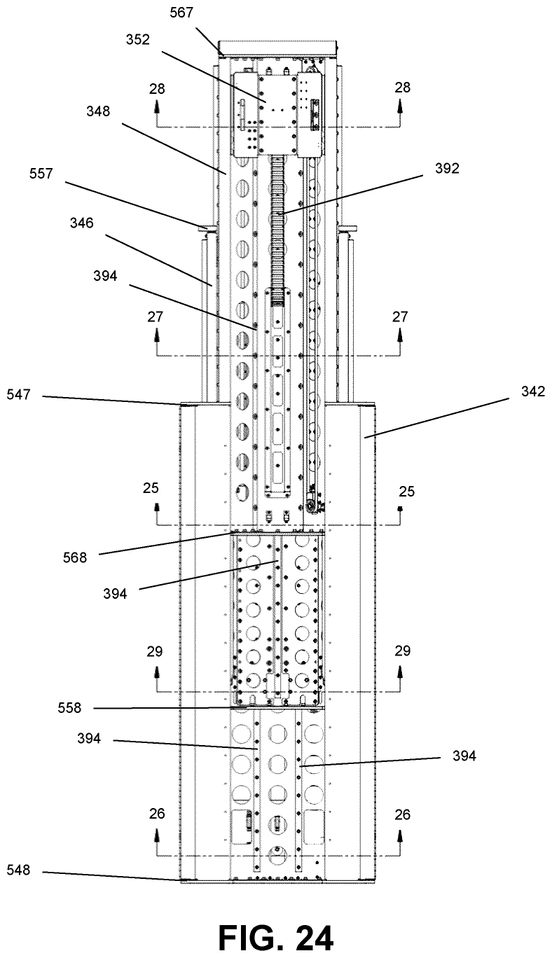

In some embodiments, for example, as depicted in FIG. 24 to FIG. 29, the lift mechanism 340 includes guides 394, for example, guide tracks, for guiding: (i) the vertical displacement of the intermediate carrier 346, relative to the frame 342, (ii) the vertical displacement of the inner carrier 348, relative to the intermediate carrier 346, and (iii) the vertical displacement of the connector plate 352, relative to the inner carrier 348.

In some embodiments, for example, the robot 110 includes an object transitioning apparatus 420 to effect transitioning of an object between an object supporter and a robot-defined object supporter 502 of the robot 110. The object transitioning apparatus 420 is connected to the lift mechanism 340 via the connector plate 352. In some embodiments, for example, the object transitioning apparatus 420 is configured to transition the object. In some embodiments, for example, the transitioning of the object includes moving the object, from the robot 110 to the object supporter, such as a shelf of a rack, a platform, or a pallet disposed in a site such as a warehouse, to emplace the object on the object supporter, for storage of the object in the warehouse. In some embodiments, for example, the transitioning includes retrieving an object from an object supporter by moving the object from the object supporter to the robot-defined object supporter 502. With the object retrieved, the robot 110 can move the object to another location of the site and emplace the object at the another location.

The object transitioning apparatus 420 includes a housing 422. The housing 422 defines the one or more second connection system counterparts 424, wherein each one of the one or more second connection system counterparts 424, co-operates with a respective first connection system counterpart 354 of the connector plate 352, to couple the connector plate 352 and the object transitioning apparatus 420. In some embodiments, for example, each one of the second connection system counterparts 424 of the object transitioning apparatus 420, independently, defines the recess 426 to receive the connector 358 of the respective first connection system counterpart 354 to effect the coupling of the connector plate 352 and the object transitioning apparatus 420.

In some embodiments, for example, electrical and data connectors 428 are connected to the housing 422. The electrical and data connectors 428 are disposed in electrical and data communication with the electrical and data components (e.g. actuators such as prime movers and pumps, controllers, sensors, etc.) of the object transitioning apparatus 420. In some embodiments, for example, the electrical and data components become disposed in electrical and data communication with the controller 202 and the battery in response to disposition of the electrical and data connectors 428 in electrical and data communication with the electrical and data cables 390 and 392. In some embodiments, for example, the cable 392 is disposed in electrical and data communication with the cable 390, and the disposition of the electrical and data connectors 428 in electrical and data communication with the electrical and data cables 390 and 392 is effected by connection of the electrical and data cable 392 to the electrical and data connectors 428.

In some embodiments, for example, the object transitioning apparatus 420 includes an object manipulator 430. The object manipulator 430 is configured to grasp an object, such that a grasped object is established, and move the grasped object. In some embodiments, for example, said lateral movement of the grasped object is in a lateral direction, relative to the base 302 (e.g. left direction or right direction relative to the base 302).

The object manipulator 430 is coupled to the housing 422. As described in greater detail below, the coupling of the object manipulator 430, relative to the housing 422, is such that the object manipulator 430 is vertically displaceable, relative to the housing 422, and also longitudinally displaceable, relative to the housing 422.

In some embodiments, for example, the object manipulator 430 includes an object emplacement/removal tool 421. In some embodiments, for example, the emplacement/removal tool 421 includes an extendible arm 432. The extendible arm 432 is actuatable for extension and retraction in a lateral direction, relative to the base 302. In some embodiments, for example, the extension and retraction is within a horizontal plane. In some embodiments, for example, the extension and retraction in the lateral direction is within the horizontal plane. As described in greater detail below, in some embodiments, for example, the extendible arm 432 is extendible in a first direction, for example, to the right side of the robot 110, and also extendible in a second direction that is opposite the first direction, for example, the left side of the robot 110.

In some embodiments, for example, the extendible arm 432 is a telescoping arm, and includes a plurality of arm segments, including a base arm segment 434, at least one intermediate segment 436, for example, two intermediate arm segments 436A and 436B, and a terminal arm segment 438.

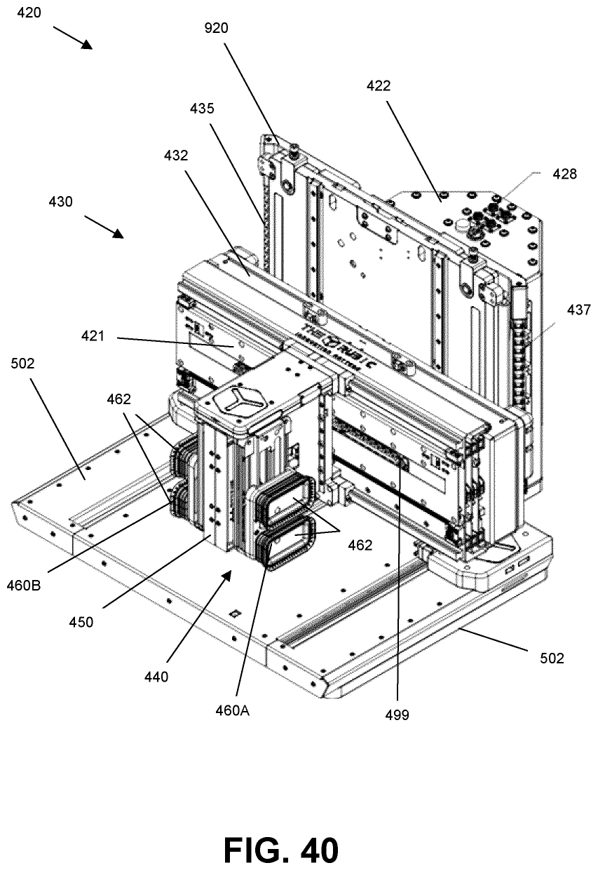

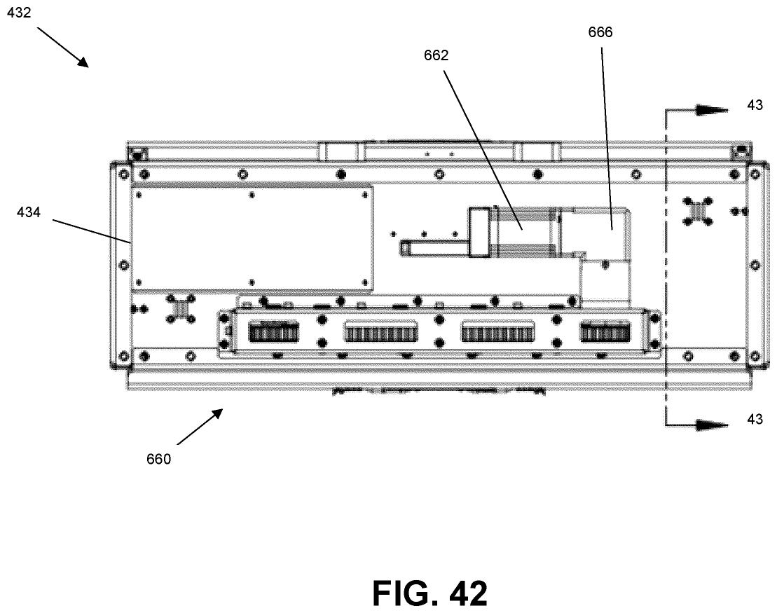

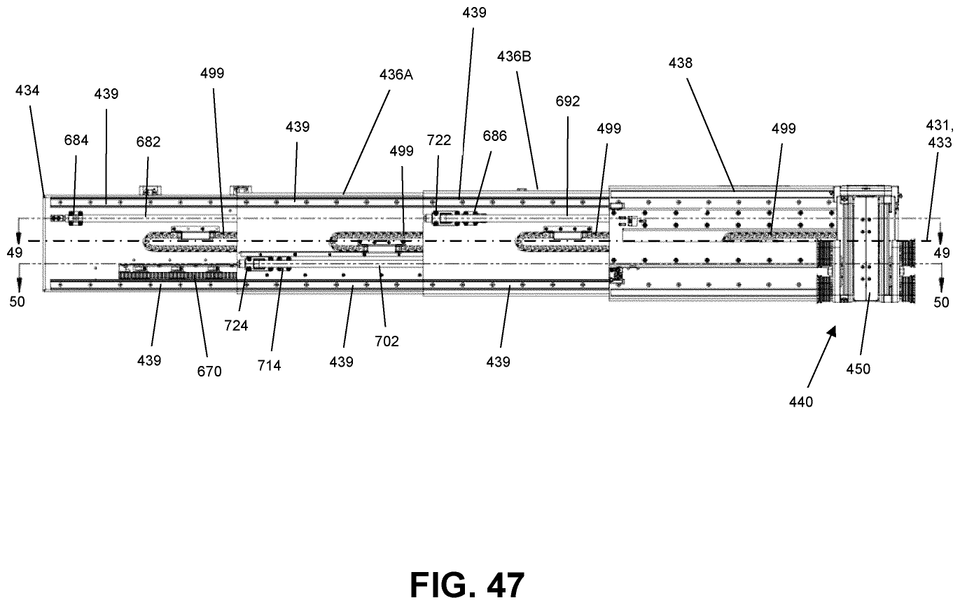

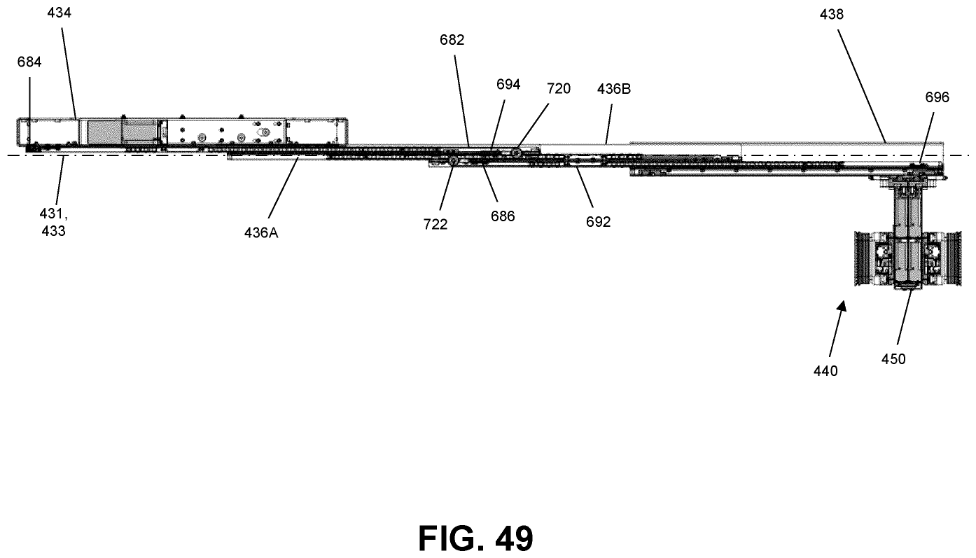

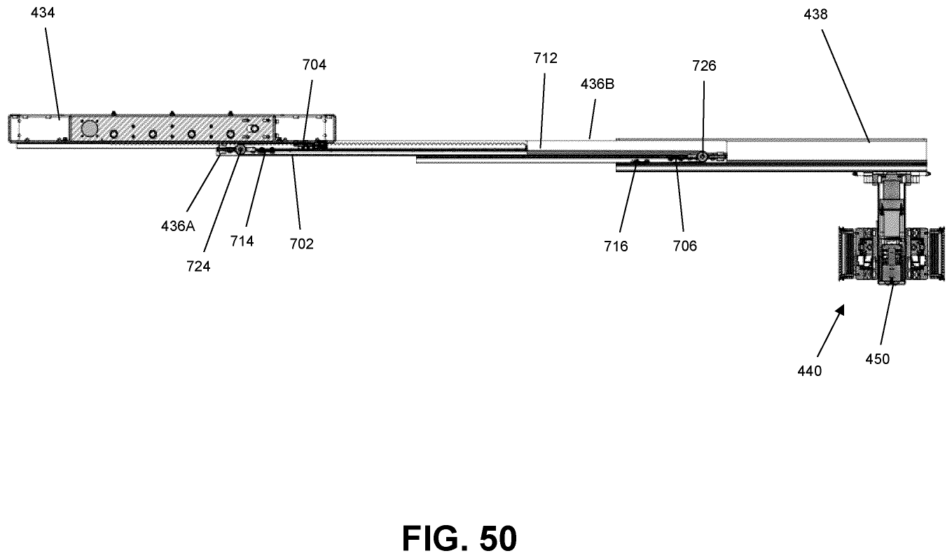

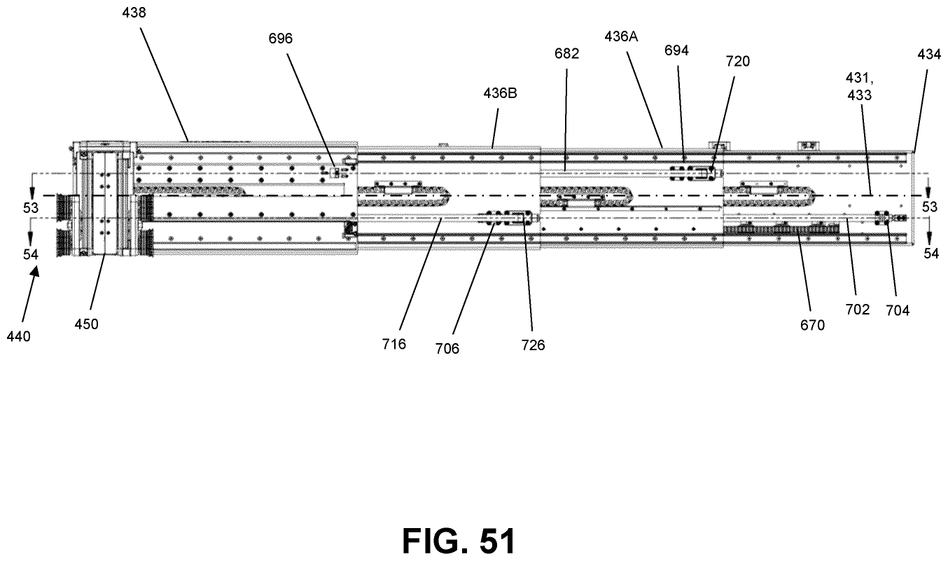

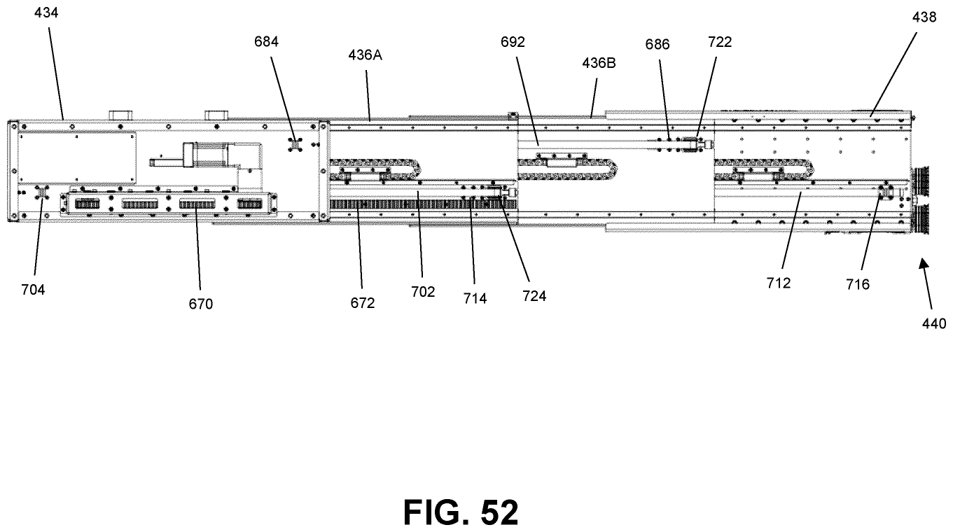

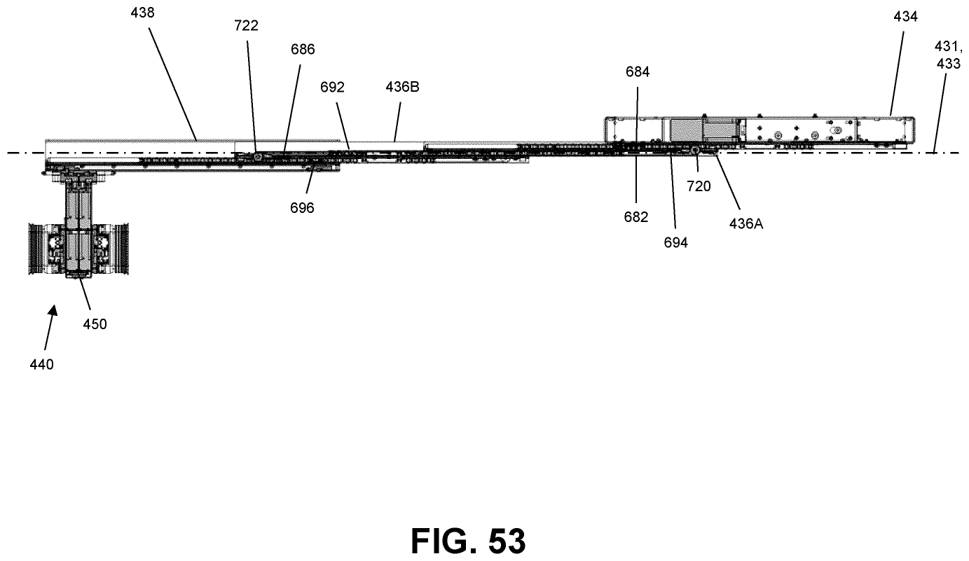

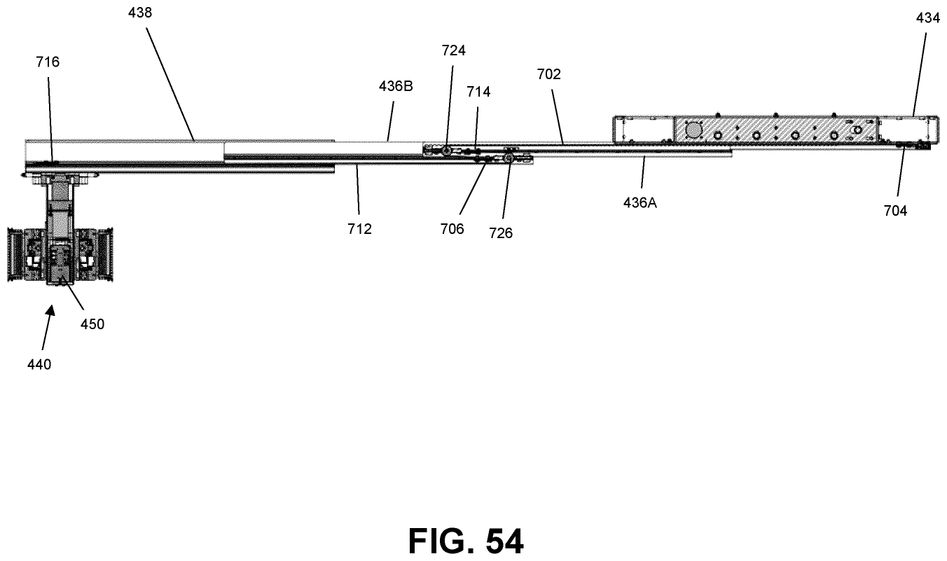

In some embodiments, for example, the telescoping arm is configurable in a retracted configuration, as depicted in FIG. 40 to FIG. 43, and an extended configuration, as depicted in FIG. 47 to FIG. 50, or as depicted in FIG. 51 to FIG. 54. While the telescoping arm is disposed in the retracted configuration, the at least one intermediate arm segment 436 is nested within the terminal arm segment 438, as depicted in FIG. 40 to FIG. 43. While the telescoping arm is disposed in the extended configuration, at least a portion of the at least one intermediate arm segment 436 is de-nested from the terminal arm segment 438, as depicted in FIG. 47 to FIG. 50, wherein the at least a portion of the at least one intermediate arm segment 436 is disposed outside of the terminal arm segment 438. In some embodiments, for example, while the telescoping arm is disposed in the extended configuration: (i) the intermediate arm segment 436A is disposed laterally, relative to the base arm segment 434, (ii) the intermediate arm segment 436B is disposed laterally, relative to the intermediate arm segment 436A, and (iii) terminal arm segment 438 is disposed laterally, relative to the intermediate arm segment 436B.

In some embodiments, for example, the extendible arm 432 includes guides 439, for example, guide tracks, for guiding the extension and retraction of the arm segments of the arm 432.

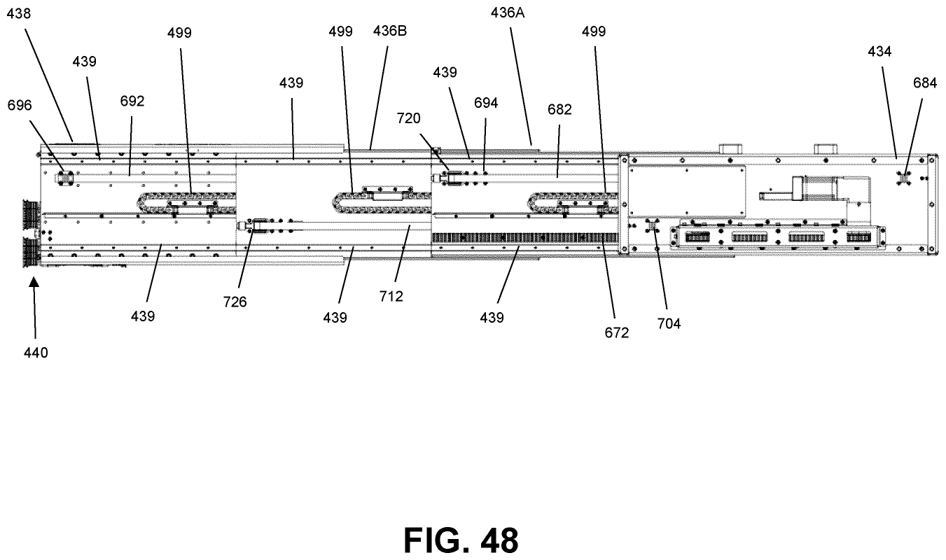

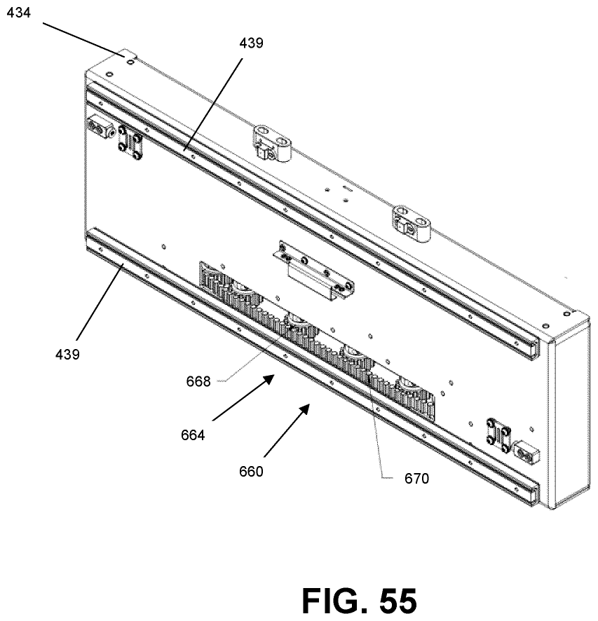

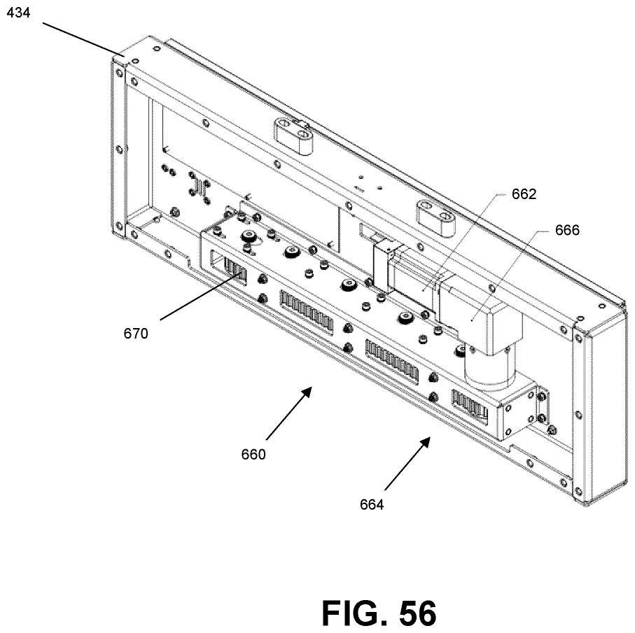

As described in greater detail below, the object manipulator 430 includes an actuator configuration 660, including a prime mover 662, for example, a motor, for example, an electric motor, and a transmission configuration 664, including a gear box 666, gears 668, a transmission component 670, such as a drive belt, a chain, a cable, and the like, and a rack 672 for actuation (e.g. extension or retraction) of the extendible arm 432 As depicted in FIG. 55, FIG. 56, and FIG. 48, the prime mover 662, gear box 666, gears 668, and transmission component 670 are coupled to the base arm segment 434, and the rack 672 is mounted to the intermediate arm segment 436A. In some embodiments, for example, the prime mover 662 and gear box 664 are disposed in electrical and data communication with the electrical and data connectors 428, for example, via electrical and data cables 435 and 437. While the cables 390 and 392 are disposed in electrical and data communication with the electrical and data connectors 428, the prime mover 662 and gear box 664 are disposed in data communication with the controller 202 and also disposed in electrical communication with the battery of the robot 110.

In some embodiments, for example, the object manipulator 430 includes an end effector 440 that is configured for grasping an object, such that a grasped object is established. “Grasping” means “taking hold of”. In some embodiments, for example, the grasping of an object is effective for suspending the object, and maintaining the suspension of the object during displacement of the object. “Grasping” is not limited to the taking hold of an object by any specific configuration of tool. It is not necessary that a tool, for grasping an object, be defined by any specific configuration. For example, it is not necessary that the tool includes a plurality of fingers which co-operate to take hold of the object. Example tools, that may be useful for grasping an object, include suction cups, upward facing hooks, and downward facing hooks, robot hands, grippers, electromagnets, winches, clasps, and the like. The end effector 440 is coupled to the extendible arm 432 such that the end effector 440 is displaceable, for example, laterally displaceable, relative to the base 302, in response to extension and retraction of the extendible arm 432. In some embodiments, for example, the displacement of the end effector 440, relative to the base 302, is in a lateral direction. In some embodiments, for example, the displacement of the end effector 440, relative to the base 302, is within a horizontal plane. In some embodiments, for example, the displacement of the end effector 440, relative to the base 302, in the lateral direction, is within the horizontal plane.

In some embodiments, for example, as described in greater detail herein, the coupling of the end effector 440 to the extendible arm is such that the end effector 440 is laterally displaceable, relative to the extendible arm 432

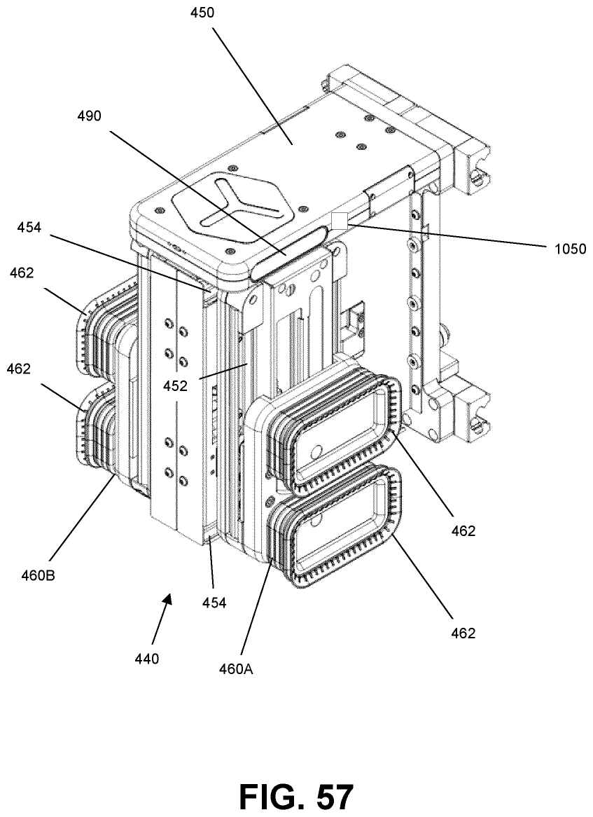

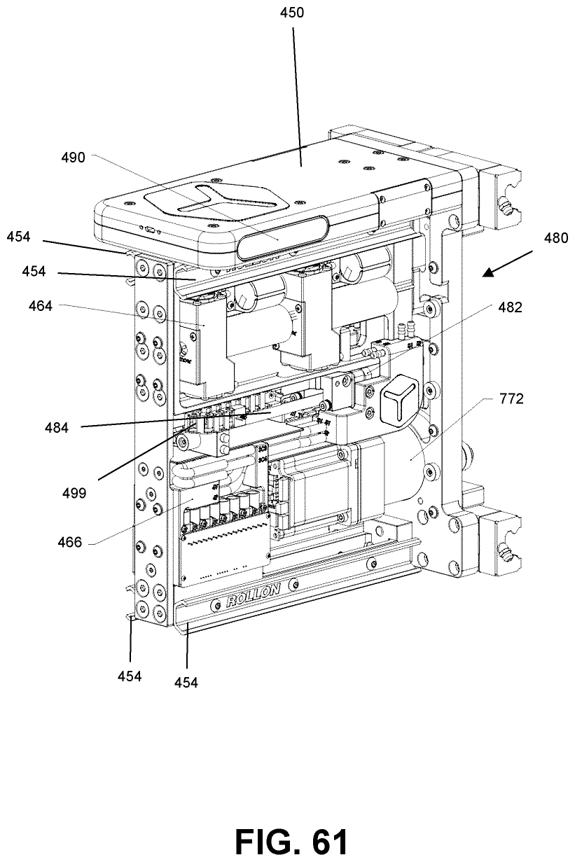

In some embodiments, for example, as depicted in FIG. 57 to FIG. 66, the object emplacement/removal tool 421 includes a driver 450. As depicted, the driver 450 is coupled to the extendible arm 432, in particular, the terminal arm segment 438. The driver 450 is coupled to the extendible arm 432 such that the driver 450 is displaceable, relative to the base 302, in response to extension and retraction of the extendible arm 432. In some embodiments, for example, the displacement of the driver 450, relative to the base 302, is in a lateral direction. In some embodiments, for example, the displacement of the driver 450, relative to the base 302, is within a horizontal plane. In some embodiments, for example, the displacement of the driver 450, relative to the base 302, in the lateral direction, is within the horizontal plane.

In some embodiments, for example, the end effector 440 is coupled to the driver 450. In some embodiments, for example, the coupling of the end effector 440 to the extendible arm 432 is effected via the coupling of the end effector 440 to the driver 450, which is coupled to the extendible arm 432.

The end effector 440 includes a grasping configuration 460 to grasp the object, such that a grasped object is established. In some embodiments, for example, the end effector 440 includes more than one grasping configuration 460, for example, two grasping configurations 460. As depicted in FIG. 57, a first grasping configuration 460 is coupled to a first side of the driver 450, for example, a right side of the driver 450, and a second grasping configuration 460 is coupled to a second side of the driver 450 that is opposite the first side of the driver 450, for example, a left side of the driver 450. Each one of the first grasping configuration 460 and the second grasping configuration 460, independently, is configured for grasping an object, such that a grasped object is established. As described in greater detail below, by having a grasping configuration 460 on the first side of the driver 450 and also on the second side of the driver 450, the robot 110 can grasp an object on a first side of the robot 110, for example, a right side of the robot 110, and also grasp an object on a second side of the robot 110 that is opposite the first side of the robot 110, for example, a left side of the robot 110.

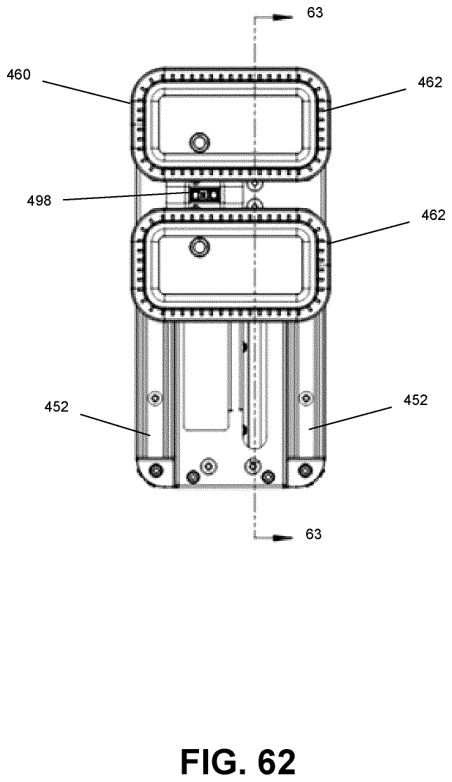

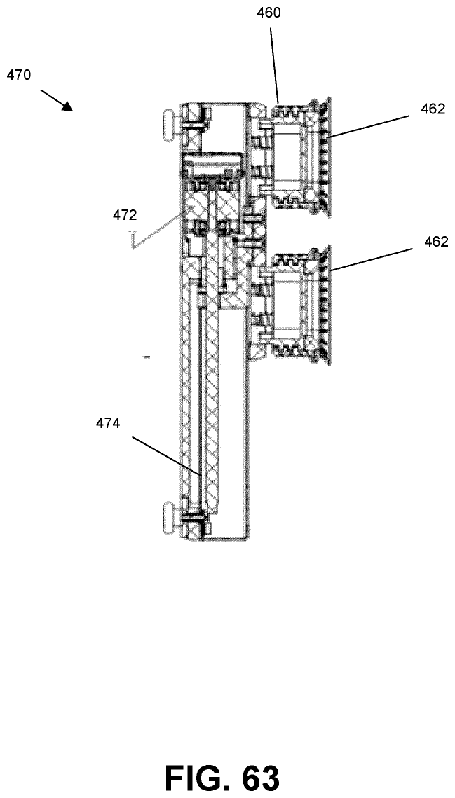

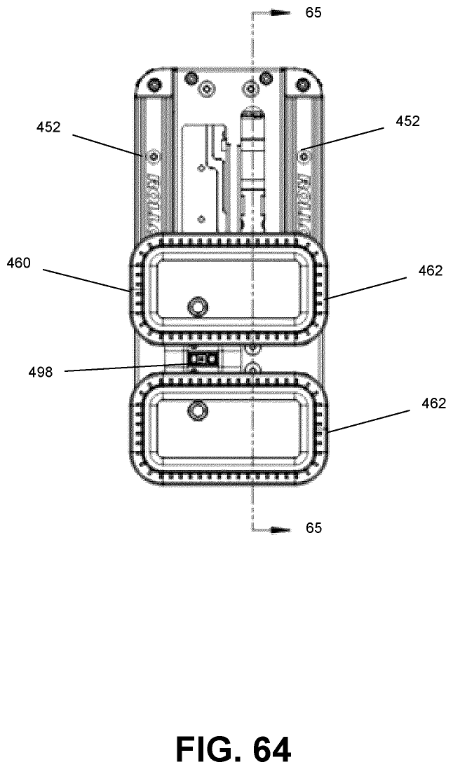

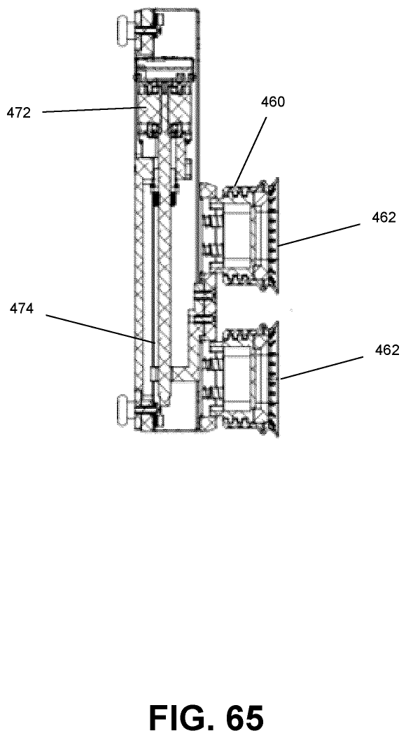

In some embodiments, for example, for each one of the grasping configurations 460, independently, the coupling of the grasping configuration 460 to the driver 450 is such that the grasping configuration 460 is vertically displaceable, relative to the driver 450, as depicted in FIG. 62 to FIG. 65. As depicted in FIG. 62 and FIG. 63, the grasping configuration 460 is disposed in a first vertical position, and as depicted in FIG. 64 and FIG. 65, the grasping configuration 460 is disposed in a second vertical position that is below the first vertical position In some embodiments, for example, for each one of the grasping configurations 460, independently, the object manipulator 430 includes an actuator configuration 470 to effect the vertical displacement of the grasping configuration 460. Each one of the actuator configurations 470, independently, includes a prime mover 472, for example, a motor, for example, an electric motor, and a transmission component 474, for example, a drive belt, a chain, or a cable, to operably communicate the prime mover 472 and the grasping configuration 460. Each prime mover 472, independently, is disposed in data communication with the controller 202 and electrical communication with the battery. For each motor, 472, independently, in response to a control command from the controller 202, the grasping configuration 460 is vertically displaced, relative to the driver 450, with effect that the grasping configuration 460 becomes disposed in a vertical position, relative to the driver 450, for grasping the object.

In some embodiments, for example, the driver 450 includes guides 452, for example, guide tracks, for guiding the vertical displacement of the grasping configurations 460, relative to the driver 450.

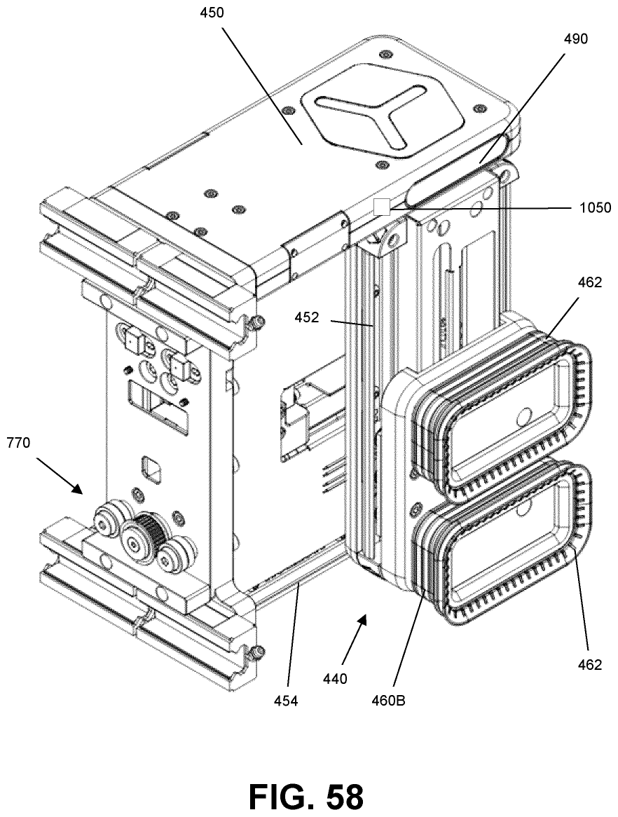

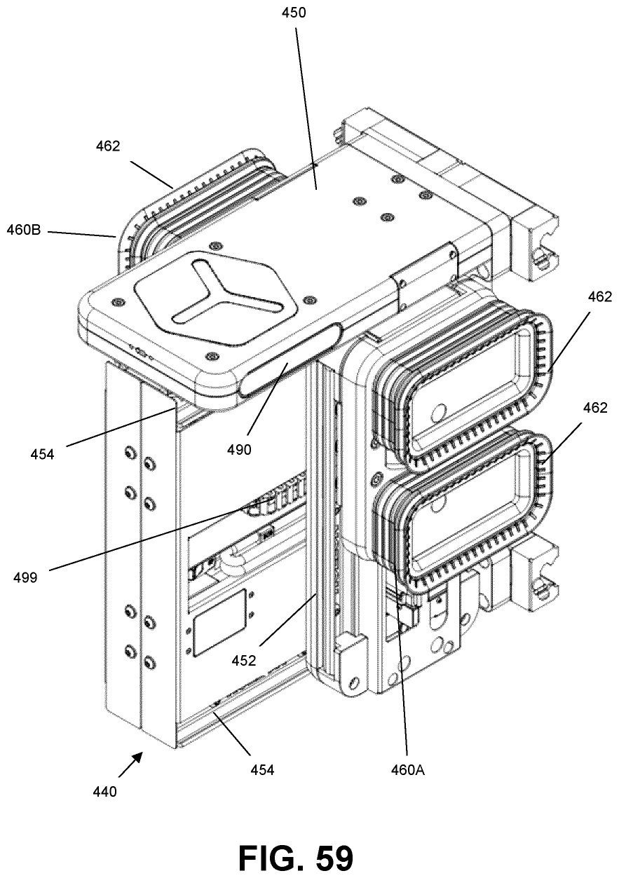

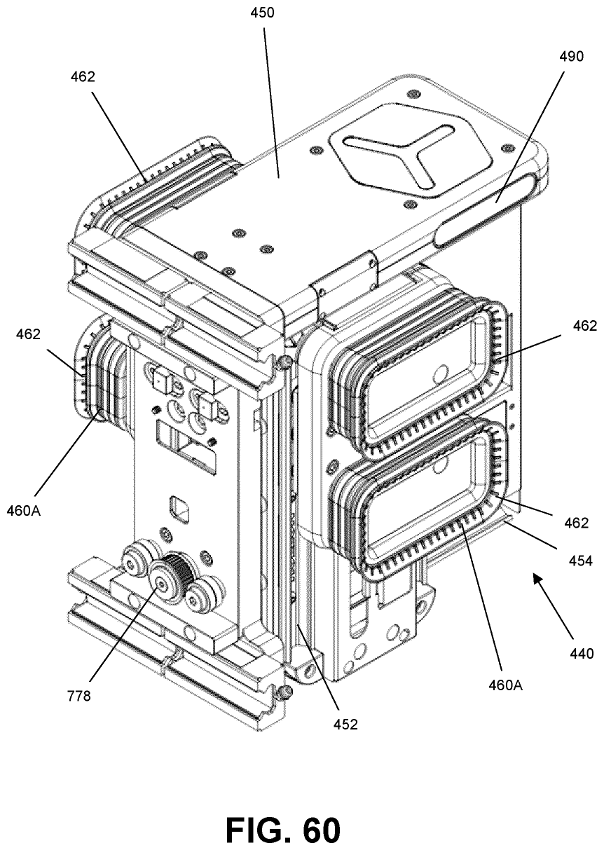

In some embodiments, for example, for each one of the grasping configurations 460, independently, the coupling of the grasping configuration 460 to the driver 450 is such that the grasping configuration 460 is longitudinally displaceable, relative to the driver 450, as depicted in FIG. 57 to FIG. 60. As depicted in FIG. 57 and FIG. 58, the grasping configurations 460 are disposed in a first longitudinal position, and as depicted in FIG. 59 and FIG. 60, the grasping configurations 460 are disposed in a second longitudinal position that is longitudinally rearward of the first vertical position. In some embodiments, for example, for each one of the grasping configurations 460, independently, the object manipulator 430 includes an actuator configuration 480 to effect the longitudinal displacement of the grasping configuration 460. Each one of the actuator configurations 480, independently, includes a prime mover 482, for example, a motor, for example, an electric motor, and a transmission component 484, for example, a drive belt, a chain, or a cable, to operably communicate the prime mover 482 and the grasping configuration 460. Each prime mover 482, independently, is disposed in data communication with the controller 202, and disposed in electrical communication with the battery. For each prime mover 482, independently, in response to a control command from the controller 202, the grasping configuration 460 is longitudinally displaced, relative to the driver 450, with effect that the grasping configuration 460 is disposed in a longitudinal position, relative to the driver 450, for grasping the object.

In some embodiments, for example, the driver 450 includes guides 454, for example, guide tracks, for guiding the longitudinal displacement of the grasping configurations 460, relative to the driver 450.

In some embodiments, for example, each one of the grasping configurations 460, independently, includes a suction cup 462. In some embodiments, for example, the object is grasped by the suction cup 462 by suctioning of a surface portion of the object by the suction cup 462. As depicted in FIG. 57, in some embodiments, for example, for each one of the grasping configurations 460, independently, the grasping configuration 460 includes two suction cups 462A and 462B, wherein the suction cup 462A is disposed above the suction cup 462B.

In some embodiments, for example, each one of the suction cups 462, independently, is disposed in fluid communication with a pump 464 via a valve block 466. The pump 464 and valve block 466 are disposed in the driver 450. Each one of the pump 464 and the valve block 466, independently, are disposed in data communication with the controller 202 and disposed in electrical communication with the battery. The controller 202 is configured to send control commands to the pump 464 to control the amount of suction at the suction cups 462. The controller 202 is configured to send control commands to the valve block 466 to open and close one or more valves of the valve block 466 control air flow between the pump 464 and the one or more suction cups 462.

In some embodiments, for example, for each suction cup 462 of the grasping configuration 460, the grasping configuration 460 includes a vacuum sensor. Each vacuum sensor, independently, is disposed in data communication with the controller 202. In some embodiments, for example, each vacuum sensor, independently, is disposed in electrical communication with the battery. Each vacuum sensor, independently, collects data representative of the suction pressure of a respective suction cup. Based on this data, the controller 202 determines if the suction cup 462 is suctioning a surface portion of the object, and therefore, if the object is grasped by the suction cup 462. Based on this data, the controller 202 can further determine if there is an absence of suction of a surface portion of an object by a suction cup 462, for example, due to a defect on the surface portion of the object, and send a control command to the pump 464 and the valve block 466 to divert suctioning from said suction cup 462 to one or more other suction cups 462.

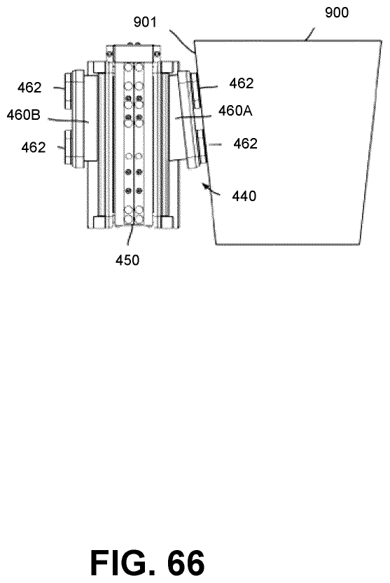

In some embodiments, for example, as depicted in FIG. 66, each one of the grasping configurations 460 of the end effector 440, independently, is coupled to the driver 450 such that the grasping configuration 460 is pivotable, relative to the driver 450, such that the grasping configuration 460 is disposable in contact engagement, for example, sealing engagement, with an angled surface 901 of an object 900, for grasping the object. In some embodiment, the coupling of the grasping configuration 460 to the driver 450 includes a hinge to effect the pivoting of the grasping configuration 460, relative to the driver 450. In some embodiments, for example, the grasping configuration 460 is pivotable, relative to the driver 450, by at least one degree, for example, five degrees.

In some embodiments, for example, each one of the suction cups 462 of the grasping configuration 460 of the end effector 440, independently, is coupled to the driver 450 such that the suction cup 462 is pivotable, relative to the driver 450, such that the suction cup 462 is disposable in contact engagement, for example, sealing engagement, with an angled surface 901 of an object 900, for grasping the object. In some embodiment, the coupling of the suction cup 462 to the driver 450 includes a hinge to effect the pivoting of the suction cup 462, relative to the drive bock 450. In some embodiments, for example, the suction cup 462 is pivotable, relative to the driver 450, by at least one degree, for example, five degrees.

In some embodiments, for example, the object manipulator 430 includes optical sensors 490, for example, stereo cameras, 3D cameras or LIDAR sensors. As depicted in FIG. 57 and FIG. 58, a first optical sensor 490 is mounted to a first side, for example, a right side, of the driver 450, and a second optical sensor 490 is mounted to a second side, for example, a left side, of the driver 450 that is opposite the first side of the driver 450. Each one of the optical sensors 490, independently, is configured for collecting data, including data representative of: (i) a shape of a surface of an object facing the sensor 490, (ii) the distance between the optical sensor 490 and the object, and (iii) identifying labels (e.g. printed label, stock-keeping unit (SKU), barcode, Quick Response (QR) code, and/or the like) on the object.

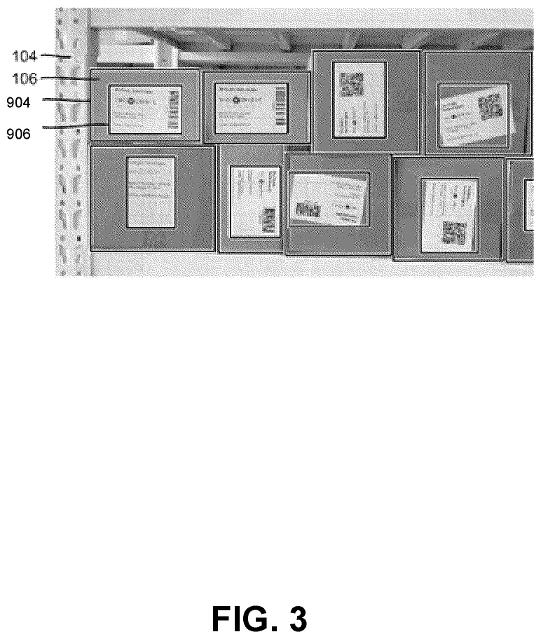

In some embodiments, for example, based on the data representative of the shape of the surface of the object facing the sensor 490, the Al engine 224 defines a bounding box 904 around the object, as depicted in FIG. 3, and the controller 202 determines the dimensions and the center of the object based on dimensions and center of the bounding box 904.

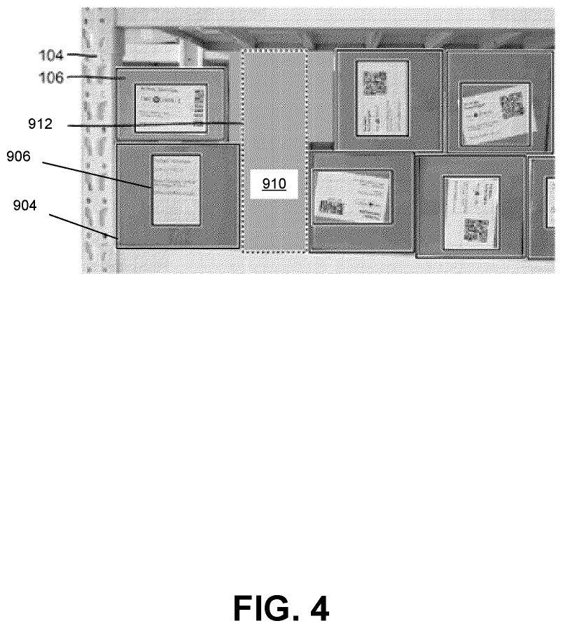

In some embodiments, for example, based on the data representative of the shape of an empty space 910 facing the sensor 490, the Al engine 224 defines a bounding box 912 around the empty space 910, as depicted in FIG. 4, and the controller 202 determines the dimensions of the empty space 910 based on the dimensions of the bounding box 912.

In some embodiments, for example, it is desirable for the grasping configuration 460 to grasp a central portion of the surface of the object that is facing the grasping configuration 460.

Based on the dimensions and center of the bounding box 904, the controller 202 sends a control command to the actuator configuration 470, for example, the prime mover 472, and/or the actuator configuration 480, for example, the prime mover 482, to vertically and/or longitudinally displace the grasping configuration 460, relative to the driver 450, such that, in response to extension of the extendible arm 432 to laterally displace the end effector 440 towards the object, the grasping configuration 480 becomes disposed in contact engagement with a central portion of the surface of the object that is facing the grasping configuration 460.

In some embodiments, for example, base on the dimensions of the bounding box 904, the controller 202 determines which of the suction cups 462 of the grasping configuration 460 is expected to become disposed in contact engagement with the surface of the object. Based on said determination, the controller 202 sends a control command to the valve block 466 such that only the suction cups 462 that are expected to become disposed in contact engagement with the surface of the object are suctioning.

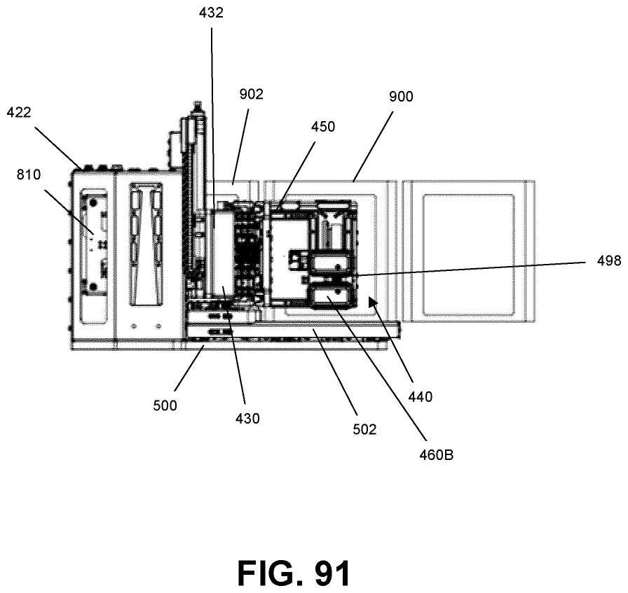

In some embodiments, for example, the object manipulator 430 includes displacement transducers 498, for example, infrared sensors. As depicted in FIG. 62 and FIG. 91, a first displacement transducer 498 is mounted to a first side, for example, a right side, of the driver 450, and a second displacement transducer 498 is mounted to a second side, for example, a left side, of the driver 450 that is opposite the first side of the driver 450. In some embodiments, for example, the first displacement transducer 498 is mounted between the suction cups 462 of the first grasping configuration 460, and the second displacement transducer 498 is mounted between the suction cups 462 of the second grasping configuration 460. Each one of the displacement transducer 498, independently, is configured for collecting data, including data representative of the distance between the displacement transducer 498 and the object. In some embodiments, for example, the object manipulator 430 includes the displacement transducers 498 such that the controller 202 has object distance data for processing if the optical sensors 490 are unable to provide object distance data, for example, if the optical sensor 490 is within a threshold minimum distance of (e.g. is too close to) the object.

In some embodiments, for example, based on the object distance data from the optical sensors 490 and the displacement transducers 498, the controller 202 is configured to control the speed of the lateral extension and retraction of the extendible arm 432, relative to the base 302, and as described in greater detail below, also control the speed of the lateral extension and retraction of the extendible arm 432. While the extendible arm 432 is being laterally extended, relative to the base 302, to laterally displace the grasping configuration 460, for example, the suction cups 462, relative to the base 302, for grasping the object, and while the suctions cups 462 are disposed outside of a threshold distance, relative to the object (e.g. the suction cups 462 are far away from the object), it is desirable for the speed of the extension of the extendible arm 432 to be relatively high, to reduce the overall time for grasping the object. While the extendible arm 432 is being laterally extended, relative to the base 302, to laterally displace the suction cups 462, relative to the base 302, for grasping the object, and while the suctions cups 462 are disposed within the threshold distance, relative to the object (e.g. the suction cups 462 are close to the object), it is desirable for the speed of the extension of the extendible arm 432 to be relatively slow, such that there is sufficient time for: (i) the suction cups 462 to establish contact engagement with the surface of the object to be grasped, and (ii) the pump 464 to pump air out of the suction cups 462, while the suction cups 462 are disposed in contact engagement with the surface of the object, for the suction cups 462 to suction onto the surface of the object.

In such embodiments, for example, in response to determination by the controller 202, based on the object distance data from the optical sensors 490 and the displacement transducers 498, that: (i) the grasping configuration 460 is disposed outside of a threshold distance, relative to the object, the controller 202 sends a control command to the actuator configuration 660, for example, to the prime mover 662 and to the transmission configuration 664, such that the extendible arm 432 extends at a first speed; and (ii) the grasping configuration 460 is disposed within the threshold distance, relative to the object, the controller 202 sends a control command to the actuator configuration 660, for example, to the prime mover 662 and to the transmission configuration 664, such that the extendible arm 432 extends at a second speed, wherein the second speed is less than the first speed.

In some embodiments, for example, based on the object distance data from the optical sensors 490 and the displacement transducers 498, the controller 202 is configured to determine that the suction cups 462 of the grasping configuration 460 are disposed in contact engagement with the surface of the object. Based on this determination, the controller 202 sends a control command to the actuator configuration 660, for example, to the prime mover 662 and to the transmission configuration 664, to stop the extension of the extendible arm 432. While the extension of the extendible arm 432 is stopped, the controller 202 sends a control command to the pump 464 to pump the air out of the suction cups 462 effect the suctioning of the object by the suction cups 462, such that the object is grasped by the suction cups 462.

In some embodiments, for example, as described in greater detail herein, the driver 450 is laterally displaceable, relative to the extendible arm 432, such that the end effector 440 is laterally displaceable, relative to the extendible arm 432.

In some embodiments, for example, actuators and sensors of the object manipulator 430, including the motors 472 and 482, pump 464, valve block 466, optical sensor 490, displacement transducers 498, and vacuum sensors, are disposed in electrical and data communication with the electrical and data connectors 428, for example, via an electrical and data cable 499. While the cables 390 and 392 are disposed in electrical and data communication with the electrical and data connectors 428, the actuators and sensors of the object manipulator 430 are disposed in data communication with the controller 202 and also disposed in electrical communication with the battery of the robot 110.

In some embodiments, for example, the object transitioning apparatus 420 includes a base or base configuration 500 and a robot-defined object supporter 502 or robot-defined object supporter 502. The base 500 is connected to the housing 422, and the robot-defined object supporter 502 is coupled to the base 500. The robot-defined object supporter 502 is configured to support an object, such that while the object is supported on the robot-defined object supporter 502, a supported object is established. In some embodiments, for example, while the object is supported on the robot-defined object supporter 502, the object is displaceable, relative to the base 302, for emplacement of the object on the object supporter. In some embodiments, for example, said displacement of the object includes (i) vertical displacement that is effectible by the lift mechanism 340, for disposition of the robot-defined object supporter 502 and the object supporter at the same elevation, and (ii) lateral displacement that is effectible by the object manipulator 420. In some embodiments, for example, while the object is supported on the object supporter, and the robot-defined object supporter 502 and the object supporter are at the same elevation, the object is displaceable, by the object manipulator 420, for emplacement of the object on the robot-defined object supporter 502. While the object is supported on the robot-defined object supporter 502, the robot 110 can move the object to a desired location within the site.

As described in greater detail below, the coupling of the robot-defined object supporter 502 to the base 500 is such that the robot-defined object supporter 502 is laterally displaceable, relative to the base 500. While the object transitioning apparatus 420 is coupled to the lift mechanism 340, which is coupled to the base 302, the lateral displacement of the robot-defined object supporter 502 is relative to the base 302.

In some embodiments, for example, as depicted in FIG. 9 to FIG. 14, the base configuration 302 includes an anchor configuration 510 for anchoring the robot 110 to the reaction surface. The base configuration 302 and the anchor configuration are co-operatively configured such that, while the base 302 is supported on the reaction surface, the anchor configuration 510 is emplaceable in an anchoring-effective state, with effect that the robot 110 becomes anchored to the reaction surface.

In some embodiments, for example, the anchoring is for mitigating tilting of the robot 110 while the end effector 440 is being displaced relative to the base 302.

In some embodiments, for example, the tilting of the robot 110, which the anchoring is mitigating while the end effector 440 is being displaced relative to the base 302, is being mitigated while the end effector 440 is grasping the object.

In some embodiments, for example, the displaceability of the end effector 440, relative to the base, includes displaceability within a horizontal plane, and the anchoring is for mitigating tilting of the robot 110 while the end effector 440 is being displaced relative to the base within a horizontal plane.

In some embodiments, for example, the tilting of the robot 110, which the anchoring is mitigating while the end effector 440 is being displaced relative to the base within a horizontal plane, is being mitigated while the end effector 440 is grasping the object.

In some embodiments, for example, the object manipulator and the base 302 are co-operatively configured such that, while the base 302 is supported on the reaction surface, the extendible arm 432 is extendible within a horizontal plane, and the end effector 440 is mounted to the extendible arm 432, such that the tilting of the robot, which the anchor is mitigating while the end effector 440 is being displaced relative to the base within a horizontal plane, is being mitigated by the anchor while the end effector 440 is being displaced by the extendible arm 432.

In some embodiments, for example, the displaceability of the end effector 440, relative to the base 302, includes lateral displaceability relative to the base 302; and the anchoring is for mitigating tilting of the robot while the end effector 440 is being displaced laterally relative to the base 302.

In some embodiments, for example, the tilting of the robot, which the anchoring is mitigating while the end effector 440 is being displaced laterally relative to the base 302, is being mitigated while the end effector 440 is grasping the object.

In some embodiments, for example, the object manipulator 302 and the base 302 are co-operatively configured such that while the base 302 is supported on the reaction surface, the extendible arm 432 is extendible laterally relative to the base 302, and the end effector 440 is mounted to the extendible arm 432, such that the tilting of the robot, which the anchoring is mitigating while the end effector 440 is being displaced laterally relative to the base 302, is being mitigated by the anchor while the end effector 440 is being displaced by the extendible arm 432.

In some embodiments, for example, the lateral displaceability of the end effector 440 is within a horizontal plane.

In some embodiments, for example, the tilting of the robot 110, which the anchoring is mitigating while the end effector 440 is being displaced laterally relative to the base 302 within a horizontal plane, is being mitigated while the end effector 440 is grasping the object.

In some embodiments, for example, the object manipulator 302 and the base 302 are co-operatively configured such that, while the base 302 is supported on the reaction surface, the extendible arm 432 is extendible laterally, relative to the base 302, within a horizontal plane, and the end effector 440 is mounted to the extendible arm 432, such that the tilting of the robot, which the anchor is mitigating while the end effector 440 is being displaced laterally, relative to the base 302, and within a horizontal plane, is being mitigated by the anchor while the end effector 440 is being displaced by the extendible arm 432.

In some embodiments, for example, the displaceability of the end effector 440 relative to the base 302 is such that the end effector 440 is displaceable relative to the base 302 between a lower vertical position and a higher vertical position, for example, by the lift mechanism 340, wherein the higher vertical position is elevated relative to the lower vertical position, and the anchoring is for mitigating tilting of the robot while the end effector 440 is disposed in the higher vertical position.

In some embodiments, for example, the tilting of the robot 110, which the anchoring is mitigating while the end effector 440 is disposed in the higher vertical position, is being mitigated while the end effector 440 is grasping the object.

In some embodiments, for example, the higher vertical position is elevated above the lower vertical position by a minimum vertical distance of at least 8 feet.

In some embodiments, for example, the anchoring is for mitigating tilting of the robot while the end effector 440 is being displaced between the lower vertical position and the higher vertical position.

In some embodiments, for example, the tilting of the robot, which the anchoring is mitigating while the end effector 440 is being displaced between the lower vertical position and the higher vertical position, is being mitigated while the end effector 440 is grasping the object.

In some embodiments, for example, the anchoring is such that the anchor configuration 510 engages the reaction surface in gripping engagement.

In some embodiments, for example, the anchor configuration 510 is additionally configured for emplacement in an anchoring-ineffective state, such that the emplacement of the anchor configuration 510 in the anchor-effective state includes transitioning of the anchor configuration 510 from the anchoring-ineffective state to the anchoring-effective state, and in the anchoring-ineffective state, there is an absence of anchoring of the robot 110 to the reaction surface by the anchor configuration 510.

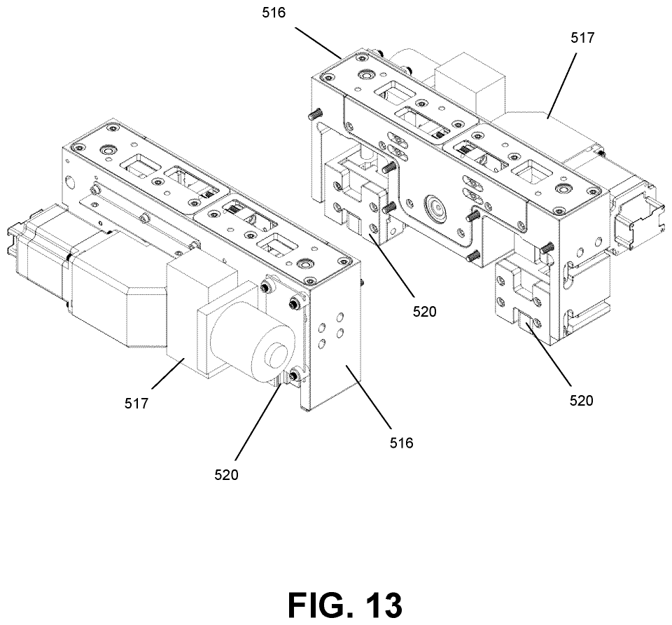

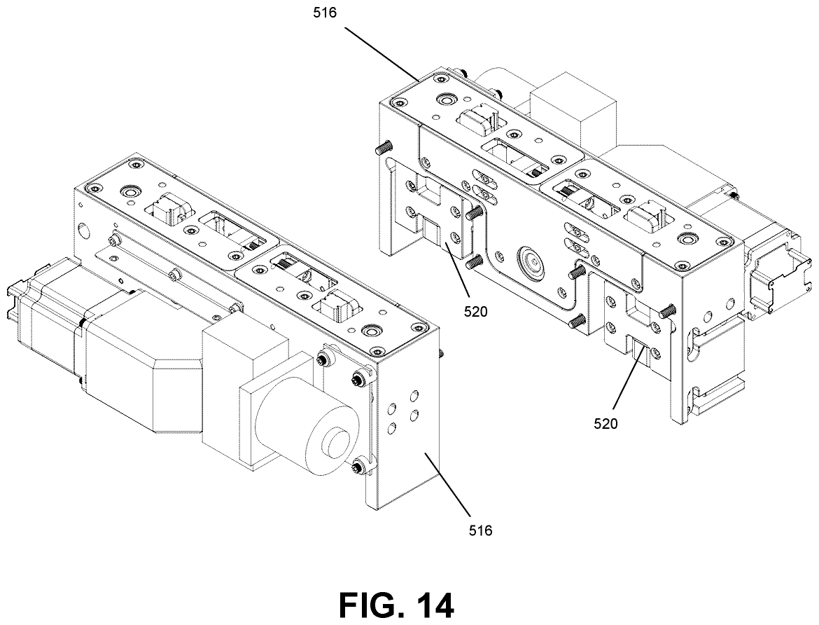

In some embodiments, for example, the anchor configuration 510 includes one or more anchor subconfigurations 512, one or more pneumatic actuators 514, such as one or more pneumatic pumps, and one or more anchor configuration displacement actuators 516. In some embodiments, for example, each one of the one or more anchor configuration displacement actuators 516, independently, includes a prime mover 517, for example, a motor, for example, an electric motor. As depicted, the anchor configuration 510 includes two anchor subconfigurations 512 disposed in a side by side configuration, wherein each one of the anchor subconfigurations 512, independently, includes two suction cups 518. Each suction cup 518, independently, is disposed in fluid communication with a pneumatic actuator 514 to effect the suctioning of the suction cup 518 to the reaction surface. As depicted, the anchor configuration 510 includes two anchor configuration displacement actuators 516, wherein each one of the anchor configuration displacement actuators 516, independently, is operably coupled to a respective anchor subconfiguration 512. In some embodiments, for example, each one of the anchor configuration displacement actuators 516, independently, includes anchor subconfiguration connectors 520 for connecting to the respective anchor subconfiguration 512. In some embodiments, for example, for each one of the one or more anchor configuration displacement actuators 516, the prime mover 517 is operable coupled to respective anchor subconfiguration connectors 520, and the prime mover 517 is configured to displace (e.g. extend or retract) the anchor subconfiguration connectors 520, relative to a platform 528. The anchor subconfiguration connectors 520 are displaceable between an extended configuration, as depicted in FIG. 13, and a retracted configuration, as depicted in FIG. 14. While the anchor subconfigurations 512 are connected to respective anchor subconfiguration connectors 520, each one of the anchor configuration displacement actuators 516, independently, is configured to displace a respective anchor subconfiguration 512, relative to a platform 528, to transition the anchor configuration 510 between the anchoring-effective state and the anchoring-ineffective state.

In some embodiments, for example, each one of the one or more pneumatic actuators 514, independently, is disposed in data communication with the controller 202 and further disposed in electrical communication with the battery.

In some embodiments, for example, each one of the one or more anchor configuration displacement actuators 516, independently, is disposed in data communication with the controller 202 and further disposed in electrical communication with the battery.

In some embodiments, for example, for each suction cup 518 of the anchor configuration 510, the anchor configuration 510 includes a vacuum sensor. Each vacuum sensor, independently, is disposed in data communication with the controller 202. In some embodiments, for example, each vacuum sensor, independently, is disposed in electrical communication with the battery. Each vacuum sensor, independently, collects data representative of the suction pressure of a respective suction cup 518. Based on this data, the controller 202 determines if the suction cup 518 is suctioning the reaction surface, and therefore, if the robot 110 is anchored to the reaction surface.

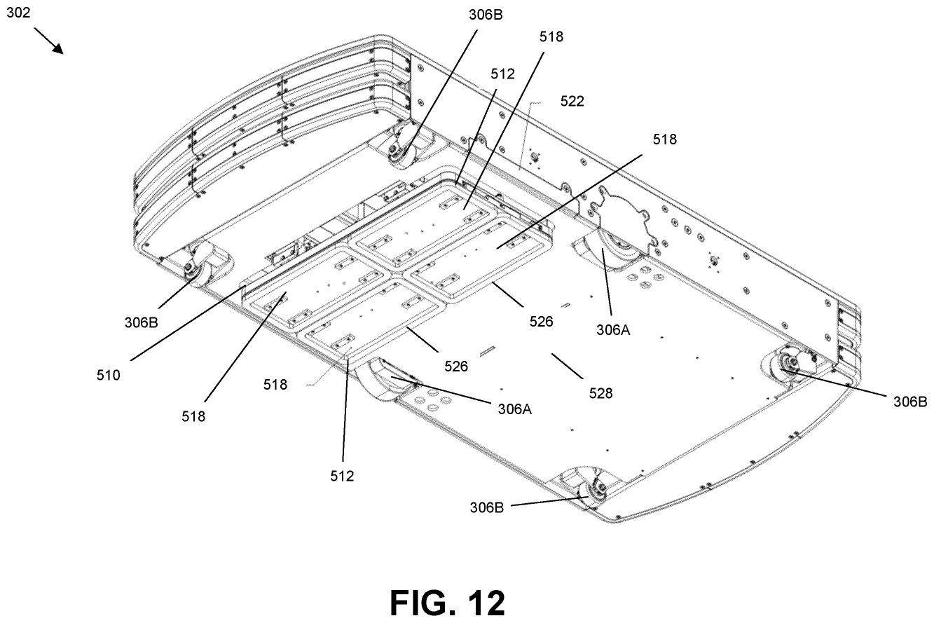

As depicted in FIG. 12, the anchor configuration 510 is disposed in the anchoring-effective state. As depicted, the anchor subconfigurations 512 are extended from the base 302, and the anchor subconfiguration connectors 520 are in an extended position. The base 302 and the anchor configuration 510 are co-operatively configured such that, while the base 302 is supported on the reaction surface, and the anchor configuration 510 is emplaced in the anchoring-effective state, the extension of the suction cups 518 from the base 302 is such that the suction cups 518 are disposed in contact engagement, for example, sealing engagement, with the reaction surface.

In some embodiments, for example, the anchoring is such that the suction cups 518 are suctioning the reaction surface.

In some embodiments, for example, the minimum anchoring force applied to the reaction surface by the anchor configuration 510 for mitigating tilting is at least 500 pounds of force. In some embodiments, for example, the anchoring force applied to the reaction surface by the anchor configuration 510 for mitigating tilting is 1000 pounds of force.

In some embodiments, for example, while the robot 110 is anchored to the reaction surface, the anchoring is defeatable via an anchor-defeating force. In some embodiments, for example, the anchor-defeating force has a magnitude with a minimum value of 2000 pounds. In some embodiments, for example, the anchor-defeating force has a direction that is parallel to the reaction surface.

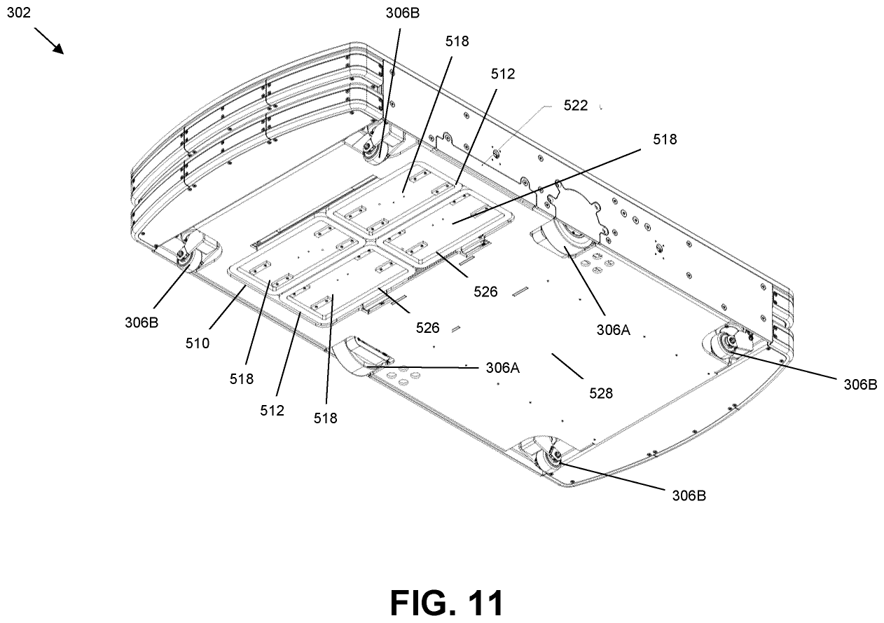

As depicted in FIG. 11, the anchor configuration 510 is disposed in the anchoring-ineffective state. As depicted, relative to their disposition in the anchoring-effective state, the anchor subconfigurations 512 are retracted towards base 302, and the anchor subconfiguration connectors 520 are in a retracted position. The base 302 and the anchor configuration 510 are co-operatively configured such that, while the base 302 is supported on the reaction surface, and the anchor configuration 510 is emplaced in the anchoring-ineffective state, there is an absence of contact engagement between the suction cups 518 and the reaction surface, such that there is an absence of anchoring of the robot 110 to the reaction surface by the anchor configuration 510.

To transition the anchor configuration 510 from the anchor ineffective state to the anchor effective state, to anchor the robot 110 to the reaction surface, while the anchor configuration 510 is emplaced in the anchor-ineffective state and supported on the reaction surface, the controller 202 sends a control command to the anchor configuration displacement actuators 516 to displace the anchor subconfiguration connectors 520 from the retracted position to the extended position. Due to the connection of the anchor subconfigurations 512 to the anchor subconfiguration connectors 520, the anchor subconfigurations 512 are displaced towards the reaction surface, for example, in a downward direction. As the anchor subconfigurations 512 are displaced towards the reaction surface, the controller 202 sends a control command to the pneumatic pumps to operate in an air-blow mode to blow air out of the suction cups 518 to remove solids, debris, dirt, and/or dust on the reaction surface to clean the reaction surface. The anchor subconfigurations 512 continue to be displaced towards the reaction surface until the suction cups 518 are disposed in contact engagement, for example, sealing engagement, with the reaction surface. Upon detection that the suction cups 518 are disposed in contact engagement with the reaction surface, the controller 202 sends a control command to the pneumatic pumps to operate in an air-suction mode for the suction cups 518 to suction onto the reaction surface, to anchor the robot 110 on the reaction surface via the suction pressure applied by the suction cups to the reaction surface. At this point, the anchor configuration 510 is emplaced in an anchoring-effective state, with effect that the robot 110 becomes anchored to the reaction surface.

In some embodiments, for example, the base 302 includes an access panel 522 disposed on a side surface of the base 302. A user can access the anchor configuration 510, for example, the suction cups 518, for maintenance or replacement, via the access panel 522.

In some embodiments, for example, while the robot 110 is moving on the reaction surface, in response to a determination by the controller 202 that an object, such as a box, bin, rack, person, and the like, is within a threshold distance of the robot 110, such that a collision with the object is imminent, the controller 202 is configured to send a control command to the anchor configuration displacement actuators 516 and the pneumatic pumps to emplace the anchor configuration 510 in the anchoring-effective state, to resist movement of the robot 110 on the reaction surface. In this respect, the anchor configuration 510 can function as an emergency stop for the robot 110.

In some embodiments, for example, each of the anchor subconfigurations 512, independently, includes one suction cup 518. In such embodiments, for example, the anchor configuration 510 has four anchor subconfigurations 512 disposed in a grid-like configuration.

In some embodiments, for example, the displacement of an anchor subconfiguration 512 is independent of the displacement of the other anchor subconfigurations 512. In such embodiments, for example, the anchor configuration 510 functions as a leveling mechanism, such that the displacement of the object transitioning apparatus 420, including the object manipulator 430, is along a vertical axis.

In some embodiments, for example, the object transitioning apparatus 420 is displaceable, relative to the base 302, along a travel axis 524, between a lower vertical position, as depicted in FIG. 5, and a higher vertical position, as depicted in FIG. 6, for effecting a change in elevation of the object transitioning apparatus 420, for example, via the lift mechanism 340. In some embodiments, for example, the base 302 and the object transitioning apparatus 420 co-operate such that, while the base 302 is supported on the reaction surface, such that the displaceability of the object transitioning apparatus 420 is along a travel axis 524 that is disposed at an angle relative to the vertical axis, the base 302 and the object transitioning apparatus 420 are configurable into a modified travel axis-establishing state, with effect that the travel axis 524 is modified to become a vertical axis.

In some embodiments, for example, the travel axis 524, that is disposed at an angle relative to the vertical axis, is disposed at an angle relative to the vertical axis of at least 1 degree.

In some embodiments, for example, the reaction surface, upon which the base 302 is supported while the displaceability of the object transitioning apparatus 420 is along the travel axis 524 that is disposed at an angle relative to the vertical axis, is a non-horizontal surface. In some embodiments, for example, the non-horizontal surface is disposed at an angle, relative to a horizontal plane, of at least 1 degree.

In some embodiments, for example, wherein the displacement of an anchor subconfiguration 512 is independent of the displacement of the other anchor subconfigurations 512, the anchor subconfigurations 512 function as extendible support legs 526. The base 302 further includes a platform 528. In some embodiments, for example, each one of the support legs 526, independently, is positionable relative to the platform 528, based on extension or retraction relative to the platform 528, such that a co-operative positioning of the support legs 526, relative to the platform, is establishable, and the modification to the travel axis 524 is based on a modification to the co-operative positioning of the support legs 526, relative to the platform 528. In some embodiments, for example, the configurability, of the base 302 and the object transitioning apparatus 420, into a modified travel axis-establishing state, is based on the modifiability of the co-operative positioning of the support legs 526.

In some embodiments, for example, while the travel axis 524 is non-vertical, the base 302 and the object transitioning apparatus 420 are co-operatively configured in a pre-modification state, and that transitioning of the base 302 and the object transitioning apparatus 420 from the pre-modification state to the modified travel axis-establishing state includes a modification to the co-operative positioning of the support legs 526. In some embodiments, for example, in the pre-modification state, the support legs 526 are co-operatively positioned such that a pre-modification support leg configuration is established, and the modification to the co-operative positioning of the support legs 526 is with effect that a modified support leg configuration is established.

In some embodiments, for example, the modification to the co-operative positioning of the support legs 526, to effect the transitioning of the base 302 and the object transitioning apparatus 420, from the pre-modification state to the modified travel axis-establishing state includes displacement of some of the support legs 526, relative to the other support legs 526. In some embodiments, for example, the modification to the co-operative positioning of the support legs 526, to effect the transitioning of the base 302 and the object transitioning apparatus 420, from the pre-modification state to the modified travel axis-establishing state includes displacement of one of the support legs 526, relative to the other support legs 526.

In some embodiments, for example, the robot 110 includes a level sensor 530, for example, a three-axis accelerometer or inclinometer, that is disposed in data communication with the controller 202. In some embodiments, for example, the level sensor 530 is mounted to the base 302. The level sensor configured to collect data representative of the inclination of the base 302 relative to a horizontal plane. The controller 202 is configured to process the data from the level sensor 530 to determine the inclination of the base 302 relative to the horizontal plane. Based on the determination of the inclination of the base 302 relative to the horizontal plane, the controller 202 is configured to modify the co-operative positioning of the support legs 526 relative to the platform 528. To modify the co-operative positioning of the support legs 526 relative to the platform 528, the controller 202 determines which of the anchor subconfigurations 512 to displace, relative to the other anchor subconfigurations 512, and also determines the amount of displacement of said anchor configurations 512, based on the determination of the inclination of the base 302 relative to the horizontal plane. In some embodiments, for example, said displacement of the anchor subconfigurations 512, relative to the other anchor subconfigurations 512, includes extension or retraction of the anchor subconfigurations 512, relative to the other anchor subconfigurations 512. The controller 202 sends a control command to the anchor configuration displacement actuators 516 that are coupled to said anchor subconfigurations 512 to be displaced, to effect the displacement of said anchor configurations 512 by the determined amount. As said anchor configurations 512 displace, relative to the other subconfigurations 512, the base 302 is displaced, relative to the reaction surface, such that the travel axis 524 becomes modified to be a vertical axis. After the anchor configurations 512 have displaced, relative to the other anchor configurations 512, to displace the base 302, relative to the reaction surface, the controller 202 can process additional data from the level sensor 530 to determine the inclination of the base 302 relative to the horizontal plane, to check if additional modification to the co-operative positioning of the support legs 526 is needed.

In some embodiments, for example, wherein the anchoring configuration 510 includes two anchor subconfigurations 512, a first anchor subconfiguration 512 is disposed on a first side of a longitudinal axis extending through the a point of the base 302, for example, the center of the base, and a second anchor subconfiguration 512 is disposed on a second side of the longitudinal axis extending through the point of the base 302. In such embodiments, for example, the traveling axis 524 is modifiable about said longitudinal axis extending through the center of the base 302 (e.g. pivoting about said longitudinal axis).

In some embodiments, for example, wherein the anchoring configuration 510 includes four anchor subconfigurations 512, a longitudinal axis extends through a point of the base, for example, the center of the base 302, and a lateral axis extends through the point of the base 302, such that said longitudinal axis and lateral axis define four quadrants, and each one of the four anchor subconfigurations 512 are disposed in a respective quadrant. In such embodiments, for example, the traveling axis 524 is modifiable about: (i) the longitudinal axis extending through the center of the base 302 (e.g. pivoting about said longitudinal axis), (ii) the lateral axis extending through the center of the base 302 (e.g. pivoting about said lateral axis), or (iii) both said longitudinal axis and lateral axis.

In some embodiments, for example, each one of the anchor subconfigurations 512 of the anchor configuration 510, independently, is coupled to the base 302 such that the anchor subconfiguration 512 is pivotable, relative to the base 302, such that the anchor subconfiguration 512 is disposable in contact engagement, for example, sealing engagement, with the non-horizontal reaction surface, for anchoring to the reaction surface. In some embodiment, the coupling of the anchor subconfiguration 512 to the base 302 includes a hinge to effect the pivoting of the anchor subconfiguration 512, relative to the base 302.

In some embodiments, for example, each one of the suction cups 518 of the anchor configuration 510, independently, is coupled to the base 302 such that the suction cup 518 is pivotable, relative to the base 302, such that the suction cup 518 is disposable in contact engagement, for example, sealing engagement, with the non-horizontal reaction surface, for anchoring to the reaction surface. In some embodiment, the coupling of the suction cup 462 to the base 302 includes a hinge to effect the pivoting of the suction cup 462, relative to the base 302.

In some embodiments, for example, while the object manipulator 430 is moving the grasped object across the object supporter, for example, pushing the object from the robot-defined object supporter 502 towards the object supporter, or pulling the object from the object supporter towards the robot-defined object supporter 502, friction is applied to the object, and a reaction force is applied to the object manipulator 430. Due to the connection of the object manipulator 430 to the lift mechanism 340, the reaction force is transmitted from the object manipulator 430 to the frame 342, with effect that a torque is applied to the frame 342.

In some embodiments, for example, the frame 342 is configured to resist the torque applied to the frame 342, for example, by increasing the rigidity of the frame 342.

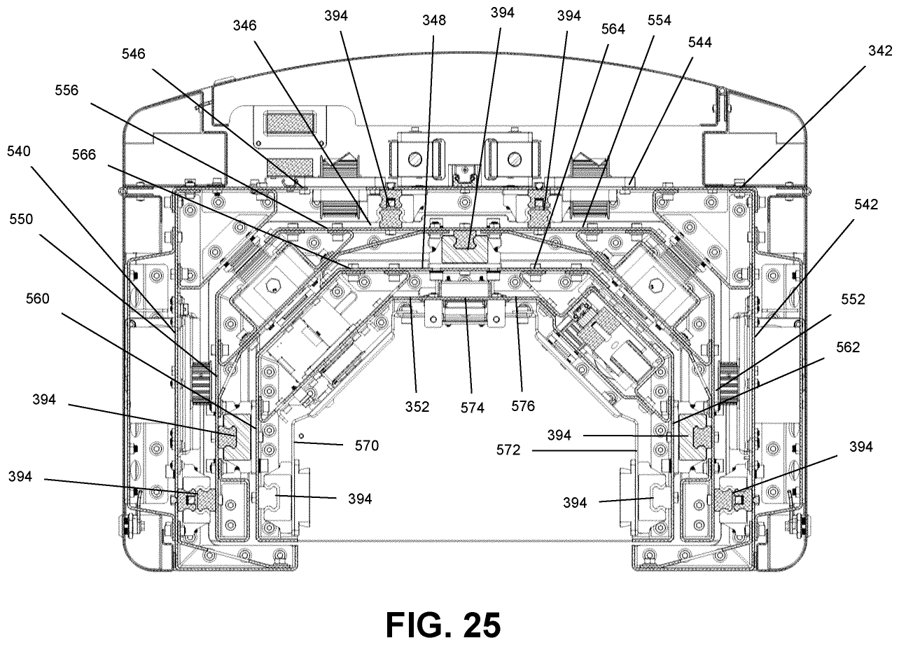

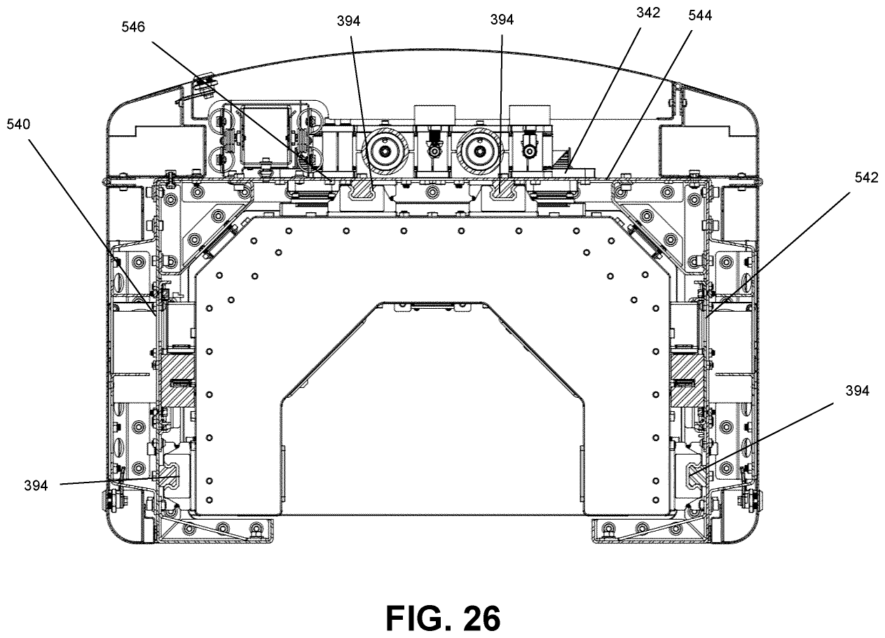

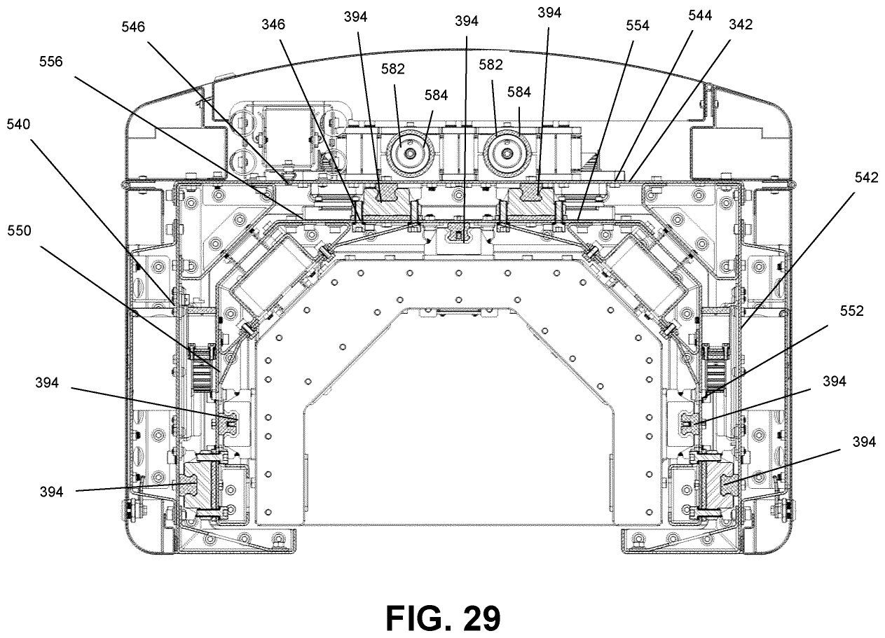

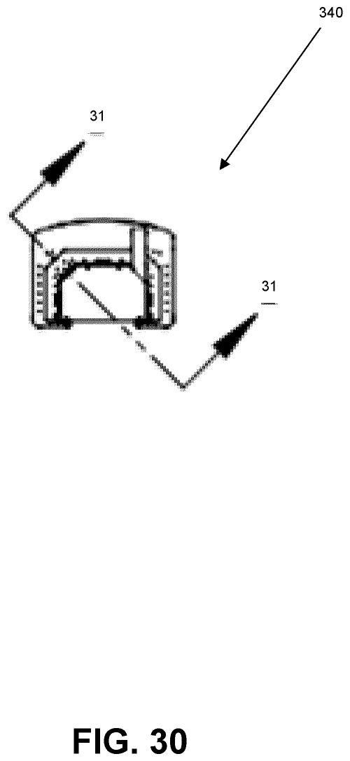

In some embodiments, for example, as depicted in FIG. 25, FIG. 26, and FIG. 29, the frame 342 comprises a first frame section 540, a second frame section 542, and an intermediate frame section 544 disposed between the first frame section 540 and the second frame section 542. The first frame section 540 and the second frame section 542 are disposed in opposing relationship. The first frame section 540, the second frame section 542, and the intermediate frame section 544 are co-operatively configured such that a torque-receiving frame portion 546 is defined.

In some embodiments, for example, the width of the frame 342, measured along a lateral axis, has a minimum value of at least 14 inches. In some embodiments, for example, the depth of the frame 342, measured along a longitudinal axis, has a minimum value of at least 8 inches.

In some embodiments, for example, the width of the intermediate carrier 346, measured along a lateral axis, has a minimum value of at least 10 inches. In some embodiments, for example, the depth of the intermediate carrier 346, measured along a longitudinal axis, has a minimum value of at least 8 inches.

In some embodiments, for example, the width of the inner carrier 348, measured along a lateral axis, has a minimum value of at least 6 inches. In some embodiments, for example, the depth of the inner carrier 348, measured along a longitudinal axis, has a minimum value of at least 8 inches.

In some embodiments, for example, the coupling of the object manipulator 430 to the frame 342 is such that, while the object manipulator 430 is moving the grasped object, a force, for example, the reaction force due to friction applied to the grasped object by the object supporter, is transmitted from the object manipulator 430 to the frame 342, with effect that a torque is applied to the torque-receiving frame portion 546. In some embodiments, for example, the torque-receiving frame portion 546 is configured to resist the torque applied to the frame 342.

In some embodiments, for example, the torque-receiving frame portion 546 has a C-shaped cross-section taken along a vertical axis. The C-shaped cross-section of the torque-receiving frame portion 546 increases the rigidity of the torque-receiving frame portion 546 for resisting the torque applied to the torque-receiving frame portion 546.

In some embodiments, for example, to further increase the rigidity of the frame 342, the first frame section 540 and the intermediate frame section 544 are connected together with a double lap joint, and reinforced with gusseting. The second frame section 542 and the intermediate frame section 544 are also connected together with a double lap joint, and reinforced with gusseting. The first frame section 540, second frame section 542, and intermediate frame section 544 also include flanges that join to a top end cap 547 and base end cap 548.

In some embodiments, for example, due to the resistance of the torque applied to the frame 342 by the torque-receiving frame portion 546, the lift mechanism 340 can vertically displace the object manipulator 430 to relatively high elevations. In some embodiments, for example, the lift mechanism 340 can elevate the object manipulator 430 to at least 10 feet, for example, 16 feet, for example, 30 feet.

In some embodiments, for example, the frame 342 is configured to be sufficiently large, in particular, have a large cross-section taken along the vertical axis. In some embodiments, for example, by increasing the size of the cross-section of the frame 342 taken along the vertical axis, the moment of inertia taken along the vertical axis is increased, which increases the rigidity of the frame 342 to resist against torque applied to the frame 342, for example, from reaction force due to friction applied to a grasped object being moved by the object manipulator 430. In some embodiments, for example, at least a portion of the mass of the frame 342 is disposed at least 6 inches, for example, 8 inches, for example, 8.5 inches, from the central longitudinal axis of the frame 342, wherein the central longitudinal axis of the frame 342 extends in the vertical direction. In some embodiments, for example, all of the mass of the frame 342 is disposed at least 6 inches, for example, 8 inches, for example, 8.5 inches, from the central longitudinal axis of the frame 342, wherein the central longitudinal axis of the frame 342 extends in the vertical direction.

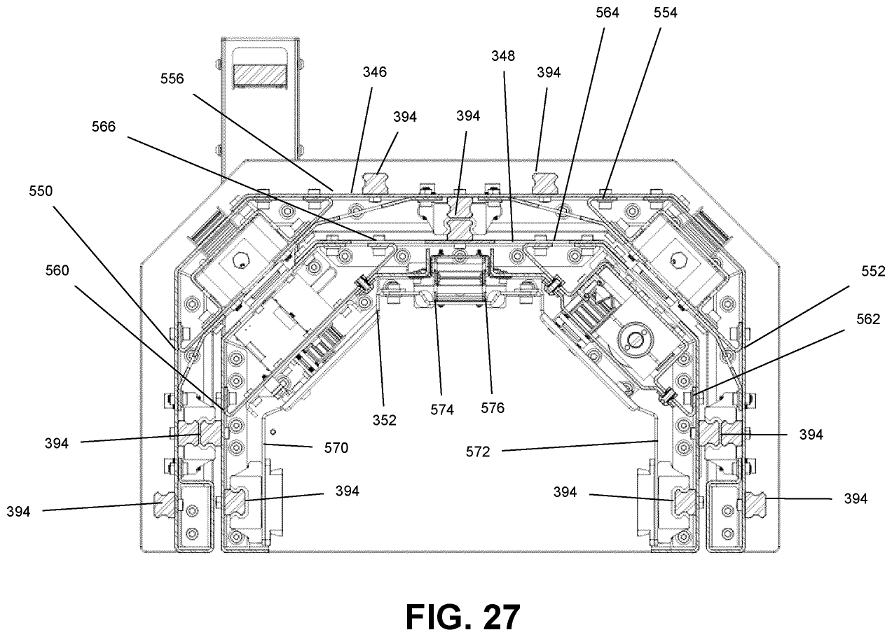

In some embodiments, for example, as depicted in FIG. 25, FIG. 27, and FIG. 29, similar to the frame 342, the intermediate carrier 346 comprises a first intermediate carrier section 550, a second intermediate carrier section 552, and an intermediate section 554 disposed between the first intermediate carrier section 550 and the second intermediate carrier section 552. The first intermediate carrier section 550 and the second intermediate carrier section 552 are disposed in opposing relationship. The first intermediate carrier section 550, the second intermediate carrier section 552, and the intermediate section 554 are co-operatively configured such that a torque-receiving intermediate carrier portion 556 is defined, wherein the torque-receiving intermediate carrier portion 556 is configured to resist torque applied to the intermediate carrier 346, for example, from the reaction force applied to the object manipulator 430 due to friction applied to the grasped object during movement of the grasped object by the object manipulator 430. In some embodiments, for example, the torque-receiving intermediate carrier portion 556 has a C-shaped cross-section taken along a vertical axis.

In some embodiments, for example, to further increase the rigidity of the intermediate carrier 346, the first intermediate carrier section 550 and the intermediate section 554 are connected together with a double lap joint, and reinforced with gusseting. The second intermediate carrier section 552 and the intermediate section 554 are also connected together with a double lap joint, and reinforced with gusseting. The first intermediate carrier section 550, second intermediate carrier section 552, and intermediate section 554 also include flanges that join to a top end cap 557 and base end cap 558.

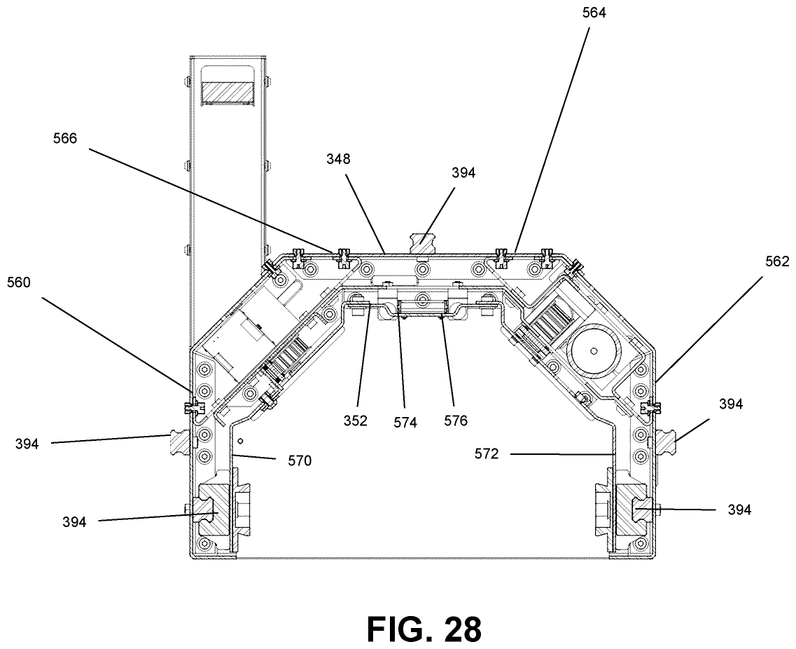

In some embodiments, for example, as depicted in FIG. 25, FIG. 27, and FIG. 28, similar to the frame 342, the inner carrier 348 comprises a first inner carrier section 560, a second inner carrier section 562, and an intermediate section 564 disposed between the first inner carrier section 560 and the second inner carrier section 562. The first inner carrier section 560 and the second inner carrier section 562 are disposed in opposing relationship. The first inner carrier section 560, the second inner carrier section 562, and the intermediate section 564 are co-operatively configured such that a torque-receiving inner carrier portion 566 is defined, wherein the torque-receiving inner carrier portion 566 is configured to resist torque applied to the inner carrier 348, for example, from the reaction force applied to the object manipulator 430 due to friction applied to the grasped object during movement of the grasped object by the object manipulator 430. In some embodiments, for example, the torque-receiving inner carrier portion 566 has a C-shaped cross-section taken along a vertical axis.

In some embodiments, for example, to further increase the rigidity of the inner carrier 348, the first inner carrier section 560 and the intermediate section 564 are connected together with a double lap joint, and reinforced with gusseting. The second inner carrier section 562 and the intermediate section 564 are also connected together with a double lap joint, and reinforced with gusseting. The first inner carrier section 560, second inner carrier section 562, and intermediate section 564 also include flanges that join to a top end cap 567 and base end cap 568.

In some embodiments, for example, as depicted in FIG. 25, FIG. 27, and FIG. 28, similar to the frame 342, the connector plate 352 comprises a first connector plate section 570, a second connector plate section 572, and an intermediate section 574 disposed between the first connector plate section 570 and the second connector plate section 572. The first connector plate section 570 and the second connector plate section 572 are disposed in opposing relationship. The first connector plate section 570, the second connector plate section 572, and the intermediate section 574 are co-operatively configured such that a torque-receiving in connector plate portion 576 is defined, wherein the torque-receiving connector plate portion 576 is configured to resist torque applied to the connector plate 352, for example, from the reaction force applied to the object manipulator 430 due to friction applied to the grasped object during movement of the grasped object by the object manipulator 430. In some embodiments, for example, the torque-receiving connector plate portion 576 has a C-shaped cross-section taken along a vertical axis.

In some embodiments, for example, it is desirable to reduce the rating of the prime mover 362 of the actuator configuration 360 to reduce energy consumption and be able to vertically displace the intermediate carrier 346 and inner carrier 348, relative to the frame 340 and the base 302, at higher speeds.

In this respect, in some embodiments, for example, the lift mechanism 340 includes a counterweight configuration. The counterweight configuration is coupled to the object manipulator 430, with effect that an opposing counterweight-based force is applied by the counterweight configuration to the object manipulator 430 such that the weight of the object manipulator 430 is opposed by the counterweight configuration, and such that the counterweight configuration 430 is effective for assisting the prime mover with the urging of the vertical displacement of the object manipulator 430 relative to the base 302.

In some embodiments, for example, the lift mechanism 340 includes a counterweight configuration 480. The counterweight configuration 580 is operably coupled to the intermediate carrier 346, such that an opposing force is applied by the counterweight configuration 580 to the intermediate carrier 346 to oppose the weight of the intermediate carrier 346 and the weight of components that are coupled to the intermediate carrier 346, for example, inner carrier 348, the object transitioning apparatus 420, and an object supported on the robot-defined object supporter 502 of the object transitioning apparatus 420.

In some embodiments, for example, the frame 342, intermediate carrier 346, the inner carrier 348, the object transitioning apparatus 420, the counterweight configuration 580, and the actuator configuration 360 are co-operatively configured such that, while: (i) the intermediate carrier 346 is coupled to the frame 342, such that the intermediate carrier 346 is vertically displaceable, relative to the frame 342, (ii) the inner carrier 348 is coupled to the intermediate carrier 346, such that the inner carrier 348 is vertically displaceable with the intermediate carrier 346 (and, as described in greater detail below, also vertically displaceable relative to the intermediate carrier 346), (iii) the object transitioning apparatus 420 is coupled to the inner carrier 348, (iv) the actuator configuration 360 is operably coupled to the intermediate carrier 346, such that a displacement force is applicable to the intermediate carrier 346 by the actuator configuration 360 (v) the counterweight configuration 580 is operably coupled to the intermediate carrier 346, such that the opposing force is applied by the counterweight configuration 580 to the intermediate carrier 346 to oppose the weight of the intermediate carrier 346, the inner carrier 348, and the transitioning apparatus 420, in response to application of the displacement force to the intermediate carrier 346 by the actuator configuration 360, the intermediate carrier 346 is vertically displaced, relative to the frame 342, and the inner carrier 348 is vertically displaced, relative to the intermediate carrier 346, with effect that the object transitioning apparatus 420 is vertically displaced, relative to the frame 342. In some embodiments, for example, the counterweight configuration 580 and the actuator configuration 360 co-operate to vertically displace the intermediate carrier 346, relative to the frame 342.

Without the counterweight configuration 580 applying the opposing counterweight-based force to the intermediate carrier 346, the actuator configuration 360 would have to apply more displacement force to the intermediate carrier 346 to vertically displace the intermediate carrier 346, relative to the frame 342. With the counterweight configuration 580 applying the opposing counterweight-based force to the intermediate carrier 346, the actuator configuration 360 can apply a displacement force of lesser value to vertically displace the intermediate carrier 346, relative to the frame 342. In this respect, the counterweight configuration 580 assists the actuator configuration 360 with the urging of the vertical displacement of the intermediate carrier 346, inner carrier 348, and object transitioning apparatus 420, relative to the frame 342,

In some embodiments, for example, while the frame 342 is coupled to the base 302, said vertical displacement of the intermediate carrier 346 and the inner carrier 348, relative to the frame 342, is also relative to the base 302, and said vertical displacement of the object transitioning apparatus 420, relative to the frame 342, is also relative to the base 302.

In some embodiments, for example, due to the application of the opposing force to the intermediate carrier 346 by the counterweight configuration 580, the displacement force applied to the intermediate carrier 346 by the actuator configuration 360 is less than the weight of the intermediate carrier 346, the inner carrier 348, and the object transitioning apparatus 420. In some embodiments, for example, the displacement force applied to the intermediate carrier 346 by the actuator configuration 360 is greater than the difference between the sum of the weight of the intermediate carrier 346, inner carrier 348, and the object transitioning apparatus 420, and the opposing force applied to the intermediate carrier 346 by the counterweight configuration 580.

In some embodiments, for example, the opposing force applied by the counterweight configuration 580 to the intermediate carrier 346 has a minimum value of 4000 pounds of force. In such embodiments, for example, the displacement force applied to the intermediate carrier 346 by the prime mover 362 of the actuator configuration 360 is in the order of magnitude of hundreds of pounds of force. In some embodiments, for example, the displacement force applied to the intermediate carrier 346 by the prime mover 362 of the actuator configuration 360 has a maximum value of 100 pounds.

In some embodiments, for example, the counterweight configuration 580 includes one or more pneumatic counterweight 582, for example, two pneumatic counterweights 582, and a transmission configuration 590.

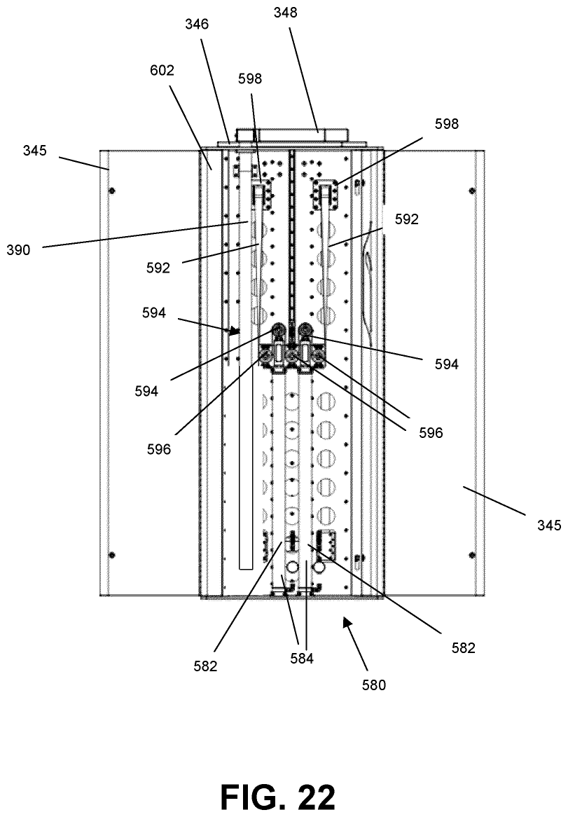

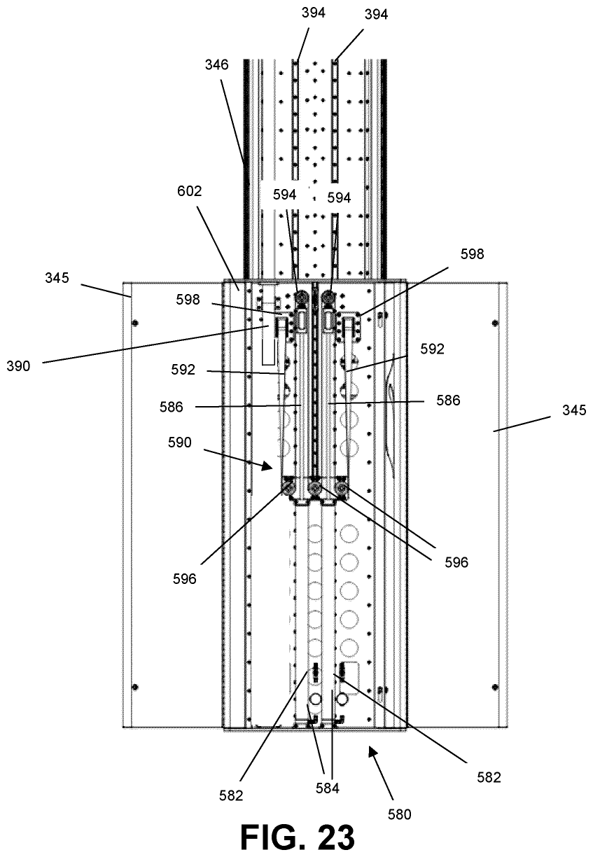

As depicted in FIG. 22 and FIG. 23, the counterweight configuration 580 includes two pneumatic counterweights 582 disposed in side by side relationship. Each one of the pneumatic counterweights 582, independently, includes a pneumatic gas cylinder 584 and a rod 586, wherein the rod 586 is extendible and retractable relative to the gas cylinder 584. For each one of the pneumatic gas cylinders 584, the pneumatic gas cylinder contains compressed gas, for example, nitrogen gas. In some embodiments, for example, the compressed gas has a pressure of 2000 pounds per square inch. For each one of the pneumatic counterweights 582, independently, the compressed gas in the cylinder 584 is disposed in fluid communication with the rod 586, such that the compressed gas applies a force to the rod 586, the force having a direction parallel to the longitudinal axis of the rod 586. The forces applied to the rods 586 from the compressed gas in the cylinders 584 are transferred to the intermediate carrier 346 as the opposing force for opposing the weight of the intermediate carrier 346 and components that are coupled to the intermediate carrier 346, such as the inner carrier 348, the object transitioning apparatus 420, and objects supported on the robot-defined object supporter 502 of the object transitioning apparatus 420.

In some embodiments, for example, the cylinders 584 are disposed in fluid communication, such that the pressure of the gas in the cylinders 584 are balanced.

The pneumatic counterweights are operably coupled with the intermediate carrier 346 via the transmission configuration 590, to transfer the forces applied to the rods 586 from the compressed gas in the cylinders 584 to the intermediate carrier 346. The transmission configuration 590 includes a transmission component 592, for example, a drive belt, a chain, a cable, and the like, pulleys 594 and 596, pulleys 598 mounted to the frame 342, and an intermediate carrier connector 600, for example, a plate.

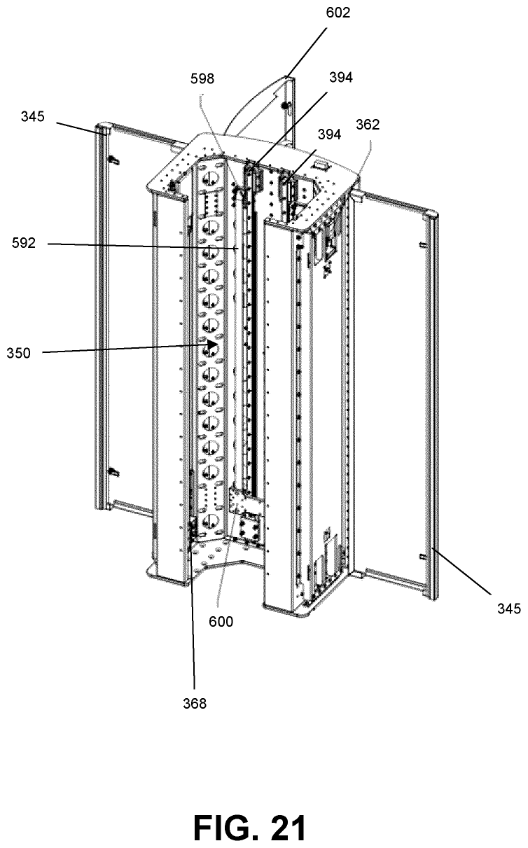

As depicted in FIG. 22 to FIG. 23, the transmission component 592 is looped around the pulleys 594 and 596 in a block and tackle configuration, wherein the pulleys 594 are mounted to the cylinders 584 such the pulleys 594 are not vertically displaceable relative to the cylinders 584 or relative to the frame 342, and the pulleys 596 coupled to the pulleys 594 and the frame 342 such that the pulleys 596 are vertically displaceable relative to the pulleys 594 and also relative to the frame 342. As depicted in FIG. 22 and FIG. 23, from the block and tackle configuration, the transmission component 592 is further looped around the pulleys 598, and the ends of the transmission component 592 are connected to the intermediate carrier connector 600. The intermediate carrier connector 600 is connectible to the intermediate carrier 346, via mechanical fasteners, such as nuts and bolts, screws, and the like. As depicted in FIG. 21, the intermediate carrier connector 600 is disposed in the cavity 350 defined by the frame 324.

In some embodiments, for example, the transmission component 592 is looped around the pulleys 594 and 596 in the block and tackle configuration in a four to one ratio, meaning that, while the pulleys 596 are vertically displaced, relative to the pulleys 594, by a certain distance, the intermediate carrier connector 600 is vertically displaced by four times that distance. In some embodiments, for example, the block and tackle configuration allows the counterweight configuration 580 to be disposed within the frame 342, for example, even while the rods 586 are fully extended from the cylinders 584 while the lift mechanism 340 is disposed in a fully extended configuration.

Each one of the rods 586 of the pneumatic counterweights 582, independently, is coupled to a respective block that is coupled to a respective pulley 596, to transfer the force applied from the compressed gas in the cylinder 584 to the transmission component 592. Due to the application of the forces from the compressed gas in the cylinders 584 to the transmission component 592 via the rods, the transmission component 592 becomes disposed in tension. Due to the connection of the transmission component 592 to the intermediate carrier connector 600, the tension in the transmission component 592 is transferred to the intermediate carrier connector 600 as the opposing force. While the intermediate carrier 346 is connected to the intermediate carrier connector 600, the tension in the transmission component 592 is transferred to the intermediate carrier 346, and components coupled to the intermediate carrier 346, such as the inner carrier 348 and the object transitioning apparatus 420, as the opposing counterweight-based force.

As depicted in FIG. 22, while the intermediate carrier connector 600 is connected to the intermediate carrier 346, and while the lift mechanism 340 is disposed in retracted configuration: (i) the rods 586 are disposed in the cylinder 584, (ii) the pulleys 594 and 596 are disposed in a retracted configuration, wherein the pulleys 594 and 596 are disposed proximate to each other, and (iii) the intermediate carrier connector 600 is disposed at a bottom end of the frame 342.

As depicted in FIG. 23, while the intermediate carrier connector 600 is connected to the intermediate carrier 346, and while the lift mechanism 340 is disposed in extended configuration: (i) the rods 586 are extended outside of the cylinder 584, (ii) the pulleys 594 and 596 are disposed in an extended configuration, wherein, relative to its disposition in the retracted configuration, the pulleys 596 are disposed further above the pulleys 594, and (iii) the intermediate carrier connector 600 is disposed at a top end of the frame 342

In some embodiments, for example, the pressure of the gas in the pneumatic gas cylinders 584 varies during vertical displacement of the intermediate carrier 346 and the inner carrier 348, relative to the base 302, such that the opposing force applied by the counterweight configuration 580 to the intermediate carrier 346 varies during vertical displacement of the intermediate carrier 346 and the inner carrier 346, relative to the base 302. While the lift mechanism 340 is disposed in the retracted configuration, the rods 586 are retracted into the cylinders 584, as depicted in FIG. 22, such that the volume of the cylinders 584 is at its lowest, and the pressure of the gas is at its highest. While the lift mechanism 340 is disposed in a fully extended configuration, wherein the intermediate carrier 346 and inner carrier 348 are positioned at a maximum vertical position, relative to the frame 342, as depicted in FIG. 17 and FIG. 23, the rods 586 are extended out of the cylinders 584, as depicted in FIG. 23, such that the volume of the cylinders 584 is at its highest, and the pressure of the gas is at its lowest. The volume of the cylinders 584 increases, and the pressure in the cylinders 584 decreases, as the lift mechanism 340 transitions from the retracted configuration to the fully extended configuration.

In some embodiments, for example, the opposing force is equal in magnitude to the weight of the intermediate carrier 346, the inner carrier 348, and the object transitioning apparatus 420, for example, while the lift mechanism 340 is disposed in a half-extended configuration, wherein the intermediate carrier 346 and inner carrier 348 are positioned at a vertical position that is half the maximum vertical position. In some embodiments, for example, while the opposing force is equal in magnitude to the weight of the intermediate carrier 346, the inner carrier 348, and the object transitioning apparatus 420, the actuator configuration 360 can vertically displace the intermediate carrier 346, the inner carrier 348, and the object transitioning apparatus 420 with a displacement force of relatively small magnitude, for example, one pound of force.

While the lift mechanism 340 is disposed in the retracted configuration, the force applied by the actuator configuration 360 to the intermediate carrier 346 is to oppose at least a portion of the opposing force, for retaining the disposition of the lift mechanism 340 in the retracted configuration. While the lift mechanism 340 is disposed in the fully extended configuration, the force applied by the actuator configuration 360 to the intermediate carrier 346 is to oppose at least a portion of the weight of the intermediate carrier 346, the inner carrier 348, and the object transitioning apparatus 420 to retain the disposition of the lift mechanism 340 in the fully extended configuration.

In some embodiments, for example, the counterweight configuration 580 is disposed in the frame 342, such that the pneumatic counterweights 582, the pulleys 594, 596, the transmission component 592, and the pulleys 598 are accessible via a back access panel 602 for ease of access, for example, for maintenance or replacement. In some embodiments, for example, the frame 342 defines an inner side and an outer side, wherein the intermediate carrier 600 is disposed on the inner side; and the counterweight configuration 580 is mounted to the frame 342 such that the counterweight configuration is accessible from the outer side of the frame 342.

In some embodiments, for example, instead of pneumatic counterweights 582, the counterweight configuration 580 includes coil springs.

In some embodiments, for example, similar to the prime mover 362, it is desirable to reduce the rating of the prime mover 402 of the actuator configuration 400 to reduce energy consumption and be able to vertically displace the connector plate 352, relative to the inner carrier 348, at higher speeds.

In this respect, in some embodiments, for example, the lift mechanism 340 includes a counterweight configuration 620. The counterweight configuration 620 is operably coupled to the connector plate 352, such that an opposing force is applied by the counterweight configuration 620 to the connector plate 352 to oppose the weight of the connector plate 352 and the weight of components that are coupled to the connector plate 352, for example, the object transitioning apparatus 420, and an object supported on the robot-defined object supporter 502 of the object transitioning apparatus 420.

In some embodiments, for example, the inner carrier 348, the connector plate 352, the object transitioning apparatus 420, the counterweight configuration 620, and the actuator configuration 400 are co-operatively configured such that, while: (i) the connector plate 352 is coupled to the inner carrier 348, such that the connector plate 352 is vertically displaceable, relative to the inner carrier 348, (ii) the object transitioning apparatus 420 is coupled to the connector plate 352, (iii) the actuator configuration 400 is operably coupled to the connector plate 352, such that a displacement force is applicable to the connector plate 352 by the actuator configuration 400, (iv) the counterweight configuration 620 is operably coupled to the connector plate 352, such that the opposing force is applied by the counterweight configuration 620 to the connector plate 352 to oppose the weight of the connector plate 352 and the object transitioning apparatus 420, in response to application of the displacement force to the connector plate 352 by the actuator configuration 400, the connector plate 352 is vertically displaced, relative to the inner carrier 348, with effect that the object transitioning apparatus 420 is vertically displaced, relative to the inner carrier 348. In some embodiments, for example, the counterweight configuration 620 and the actuator configuration 400 co-operate to vertically displace the connector plate 352, relative to the inner carrier 348.

Without the counterweight configuration 620 applying the opposing counterweight-based force to the connector plate 352, the actuator configuration 400 would have to apply more displacement force to the connector plate 352 to vertically displace the connector plate 352, relative to the inner carrier 348. With the counterweight configuration 620 applying the opposing counterweight-based force to the connector plate 352, the actuator configuration 400 can apply a displacement force of lesser value to vertically displace the connector plate 352, relative to the inner carrier 348. In this respect, the counterweight configuration 620 assists the actuator configuration 400 with the urging of the vertical displacement of the connector plate 352 and object transitioning apparatus 420, relative to the inner carrier 348,

In some embodiments, for example, while the inner carrier 348 is coupled to the base 302, for example, via coupling to the intermediate carrier 346, which is coupled to the frame 342 that is coupled to the base 302, said vertical displacement of the connector plate 352, relative to the inner carrier 348, is also relative to the base 302, and said vertical displacement of the object transitioning apparatus 420, relative to the inner carrier 348, is also relative to the base 302.

In some embodiments, for example, due to the application of the opposing force to the connector plate 352 by the counterweight configuration 620, the displacement force applied to the connector plate 352 by the actuator configuration 400 is less than the weight of the connector plate 352 and the object transitioning apparatus 420. In some embodiments, for example, the displacement force applied to the connector plate 352 by the actuator configuration 400 is greater than the difference between the sum of the weight of the connector plate 352 and the object transitioning apparatus 420 and the opposing force applied to the connector plate 352 by the counterweight configuration 620.

In some embodiments, for example, the opposing force applied by the counterweight configuration 620 to the connector plate 352 has a minimum value of 750 pounds. In such embodiments, for example, the displacement force applied to the connector plate 352 by the prime mover 402 of the actuator configuration 400 is in the order of magnitude of tens of pounds of force. In some embodiments, for example, the displacement force applied to the connector plate 352 by the prime mover 402 of the actuator configuration 400 has a maximum value of 75 pounds.

In some embodiments, for example, the counterweight configuration 620 includes a pneumatic counterweight 622, and a transmission configuration 630.

In some embodiments, for example, the pneumatic counterweight 622 includes a pneumatic gas cylinder 624 and a rod 626, wherein the rod 626 is extendible and retractable relative to the gas cylinder 624. The pneumatic gas cylinder 624 contains compressed gas, for example, nitrogen gas. In some embodiments, for example, the compressed gas has a pressure of 600 pounds per square inch. The compressed gas in the cylinder 624 is disposed in fluid communication with the rod 626, such that the compressed gas applies a force to the rod 626, the force having a direction that is parallel to the longitudinal axis of the rod 626. The force applied to the rod 626 from the compressed gas in the cylinder 624 is transferred to the connector plate 352 as the opposing force for opposing the weight of the connector plate 352 and components that are coupled to the connector plate 352, such as the object transitioning apparatus 420 and objects supported on the robot-defined object supporter 502 of the object transitioning apparatus 420.

In some embodiments, for example, by using compressed gas to apply force to the rod 626, rather than, for example, springs, the force applied to the rod 626 is generally constant.

The pneumatic counterweight 622 is operably coupled with the connector plate 352, via the transmission configuration 630, to transfer the forces applied to the rod 626 from the compressed gas in the cylinder 624 to the connector plate 352. The transmission configuration 630 includes a transmission component 632, for example, a drive belt, a chain, a cable, and the like, a pulley 634 coupled to the inner carrier 348 such that the pulley 634 is vertically displaceable relative to the inner carrier 348, a pulley 636 mounted to the inner carrier 348, for example, at an upper end of the inner carrier 348, such that the pulley 636 is not vertically displaceable relative to the inner carrier 348, and a connector plate connector 638, for example, a plate.

As depicted in FIG. 36 to FIG. 39, the transmission component 632 is connected, at one end 640, to the inner carrier 348, looped around the pulleys 634 and 636 in a block and tackle configuration, and connected, at a second end 642, to the connector plate connector 638. The connector plate connector 638 is connectible to the connector plate 352 via mechanical fasteners, such as nuts and bolts, screws, and the like.

In some embodiments, for example, the transmission component 632 is looped around the pulleys 634 and 636 in the block and tackle configuration in a two to one ratio, meaning that, while the pulley 634 is vertically displaced, relative to the pulley 636, by a certain distance, the connector plate connector 638 is vertically displaced by two times that distance.

The rod 626 is coupled to a block that is coupled to the pulley 634, to transfer the force applied from the compressed gas in the cylinder 624 to the transmission component 632. Due to the application of the force from the compressed gas in the cylinders 624 to the transmission component 632 via the rod 626, the transmission component 632 becomes disposed in tension. Due to the connection of the transmission component 632 to the connector plate connector 638 and to the inner carrier 348, the tension in the transmission component 632 is transferred to the connector plate connector 638 as the opposing force. While the connector plate 352 is connected to the connector plate connector 638, the tension in the transmission component 632 is transferred to the connector plate 352, and components coupled to the connector plate 352, such as the object transitioning apparatus 420, as the opposing counterweight-based force.

As depicted in FIG. 36, while the connector plate 352 is disposed at a bottom end of the inner carrier 348, and the connector plate connector 638 is connected to the connector plate 352: (i) the rod 626 is disposed in the cylinder 624, (ii) the pulley 634 is disposed at a middle portion of the inner carrier 348 that is between the top end and bottom end of the inner carrier 348, and (iii) the connector plate connector 638 is disposed at a bottom end of the inner carrier 348.

As depicted in FIG. 38, while the connector plate 352 is disposed at a top end of the inner carrier 348, and the connector plate connector 638 is connected to the connector plate 352: (i) the rods 626 is extended outside of the cylinder 624, (ii) the pulley 634 is disposed at a bottom end of the inner carrier 348, and (iii) the connector plate connector 638 is disposed at a top end of the inner carrier 348.

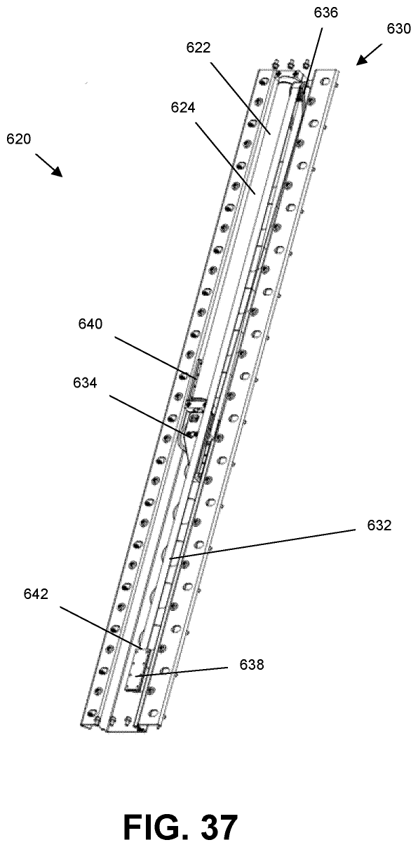

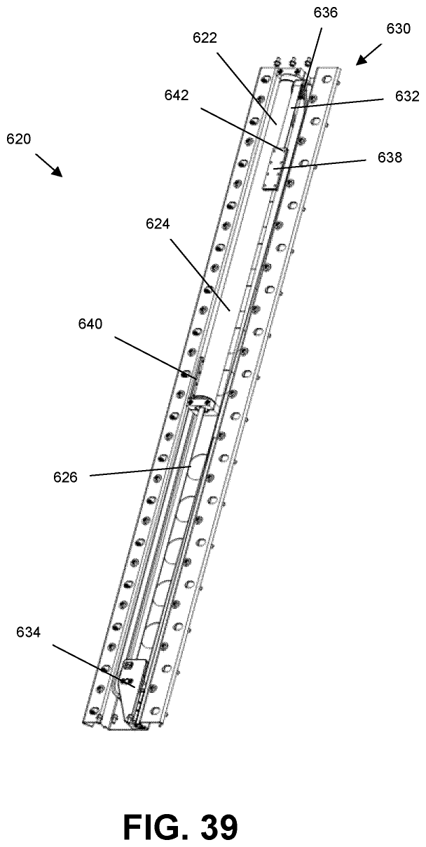

In some embodiments, for example, the pressure of the gas in the pneumatic gas cylinder 624 varies during vertical displacement of the connector plate 352, relative to the inner carrier 348, such that the opposing force applied by the counterweight configuration 620 to the connector plate 352 varies during vertical displacement of the connector plate 352, relative to the inner carrier 348. While the connector plate 352 is disposed at its lowest vertical position, relative to the inner carrier 348, as depicted in FIG. 36 and FIG. 37, the rods 626 is retracted into the cylinder 624, such that the volume of the cylinder 624 is at its lowest, and the pressure of the gas is at its highest. While the connector plate 352 is disposed in at the highest vertical position, relative to the inner carrier 348, as depicted in FIG. 38 and FIG. 39, the rod 626 is extended out of the cylinder 624, such that the volume of the cylinder 624 is at its highest, and the pressure of the gas is at its lowest. The volume of the cylinder 624 increases, and the pressure in the cylinder 624 decreases, as the connector plate 352 is vertically displaced from its lowest vertical position to its highest vertical positon, relative to the inner carrier 348.

In some embodiments, for example, the opposing force is equal in magnitude to the weight of the connector plate 352 and the object transitioning apparatus 420, for example, while the connector plate 352 is disposed in an intermediate position, wherein the connector plate 352 is positioned at a vertical position, relative to the inner carrier 348, that is half of its highest position. In some embodiments, for example, while the opposing force is equal in magnitude to the weight of the connector plate 352 and the object transitioning apparatus 420, and the object transitioning apparatus 420 is connected to the connector plate 352, the actuator configuration 400 can vertically displace the object transitioning apparatus 420 with a displacement force of relatively small magnitude, for example, one pound of force.

While the connector plate 352 is disposed in its lowest position, relative to the inner carrier 348, and the object transitioning apparatus 420 is connected to the connector plate 352, the force applied by the actuator configuration 400 to the connector plate 352 is to oppose at least a portion of the opposing force, for retaining the disposition of the connector plate 352 in the lowest position, relative to the inner carrier 348.

While the connector plate 352 is disposed in its highest position, relative to the inner carrier 348, and the object transitioning apparatus 420 is connected to the connector plate 352, the force applied by the actuator configuration 400 to the connector plate 352 is to oppose at least a portion of the weight of the connector plate 352 and the object transitioning apparatus 420 to retain the disposition of the connector plate 352 in the highest position, relative to the inner carrier 348.

In some embodiments, for example, instead of a pneumatic counterweight 622, the counterweight configuration 620 includes a coil spring.

In some embodiments, for example, the counterweight configuration 620 is disposed in the inner carrier 348. In some embodiments, for example, the actuator configuration 400 and the counterweight configuration 620 are disposed in opposing relationship.

In some embodiments, for example, wherein the extendible arm 432 is a telescoping arm, the telescoping arm is configured for increased rigidity, such that the telescoping arm has relatively long lateral reach, for example, to reach an object that is disposed at the rearmost portion of an object supporter.

In some embodiments, for example, at least one of the plurality of arm segments of the telescoping arm has a C-shaped cross-section, such that the telescoping arm includes at least one C-shaped cross-section defined arm segment. In some embodiments, for example, the cross-section, having the C-shape, is taken along a lateral axis.

In some embodiments, for example, at least one of the at least one intermediate arm segment, for example, at least one of intermediate arm segment 436A and intermediate arm segment 436B, has a C-shaped cross-section, such that the at least one C-shaped cross-section defined arm segment includes at least one of the at least one intermediate arm segment.

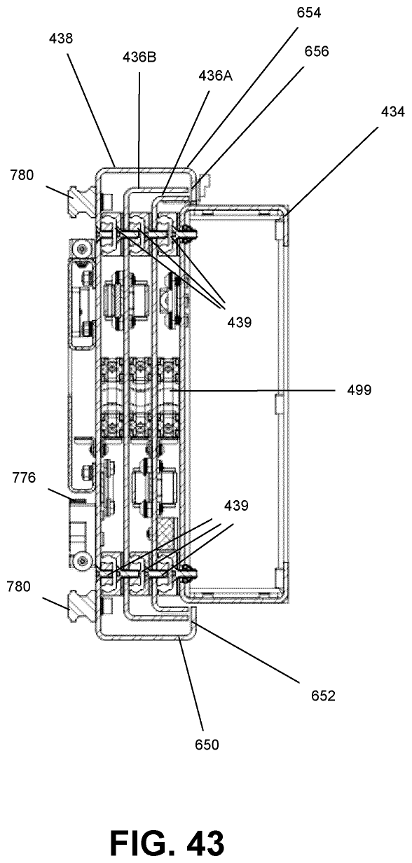

In some embodiments, for example, as depicted in FIG. 43, each one of the at least one intermediate arm segment, independently, has a C-shaped cross-section, such that the at least one C-shaped cross-section defined arm segment includes the at least one intermediate arm segment. In such embodiments, for example, each one of intermediate arm segment 436A and intermediate arm segment 436B, independently, has a C-shaped cross-section.

In some embodiments, for example, the C-shaped cross-section of the intermediate arm segment 436A increases the rigidity of the intermediate arm segment 436A.

In some embodiments, for example, the C-shaped cross-section of the intermediate arm segment 436B increases the rigidity of the intermediate arm segment 436B.

In some embodiments, for example, as depicted in FIG. 43, the terminal arm segment 438 has a C-shaped cross-section, such that the at least one C-shaped cross-section defined arm segment includes the terminal arm segment 438.

In some embodiments, for example, the C-shaped cross-section of the terminal arm segment 438 increases the rigidity of the terminal arm segment 438.

In some embodiments, for example, the terminal arm segment 438 includes: (i) a first end portion 650 defined by an upwardly extending fold 652, extending laterally, relative to the base 302, and (ii) a second end portion 654, defined by a downwardly extending fold 656, extend laterally, relative to the base 302.

In some embodiments, for example, the upwardly extending fold 652 and the downwardly extending fold 656 further increases the rigidity of the terminal arm segment 438.

In some embodiments, for example, by increasing the rigidity of the arm segments of the telescoping arm, the rigidity of the telescoping arm is increased. With increased rigidity, the telescoping arm is able to extend laterally further, such that the telescoping arm has increased lateral reach. By having increased lateral reach, the telescoping arm is extendible to laterally displace the end effector 440 by an extended lateral distance, for example, to grasp an object that is disposed at the rearmost part of an object supporter, or to push an object from the robot-defined object supporter 502 to the rearmost part of the object supporter.

In some embodiments, measured from a vertical center line, the telescoping arm is laterally extendible by at least 0.5 meters, for example, 1 meter, for example, 1.5 meters, for example, 1.95 meters. In some embodiments, for example, the telescoping arm can laterally extend to reach three bins deep into an object supporter.

In some embodiments, for example, the terminal arm segment 438 has a width, measured along a lateral axis, having a minimum value of at least 24 inches. In some embodiments, for example, the terminal arm segment 438 has a height, measured along a vertical axis, having a minimum value of at least four inches. In some embodiments, for example, the terminal arm segment 438 has a depth, measured along a longitudinal axis, having a minimum value of at least 1¼ inches.

In some embodiments, for example, the intermediate arm segment 436B has a width, measured along a lateral axis, having a minimum value of at least 24 inches. In some embodiments, for example, the intermediate arm segment 436B has a height, measured along a vertical axis, having a minimum value of at least 3.5 inches. In some embodiments, for example, the intermediate arm segment 436B has a depth, measured along a longitudinal axis, having a minimum value of at least ⅞ inches.

In some embodiments, for example, the intermediate arm segment 436A has a width, measured along a lateral axis, having a minimum value of at least 24 inches. In some embodiments, for example, the intermediate arm segment 436A has a height, measured along a vertical axis, having a minimum value of at least three inches. In some embodiments, for example, the intermediate arm segment 436A has a depth, measured along a longitudinal axis, having a minimum value of at least 0.5 inches.

In some embodiments, for example, the height of the upward extending fold 652 has a minimum value of at least 0.5 inches. In some embodiments, for example, the height of the downward extending fold 654 has a minimum value of at least 0.5 inches.

In some embodiments, for example, a first object supporter is disposed opposite a second object supporter in a spaced apart relationship such that an aisle is defined. In some embodiments, for example, a minimum spacing distance, between the first and second object supporters, of less than 12 feet, is defined within the aisle. In some embodiments, for example, the minimum spacing distance is greater than 25 inches. In some embodiments, for example, while the robot 110 is moving within the aisle, the target object of the robot 110, for example, the object to be retrieved by the robot 110, is a first object that is supported on the first object supporter, or a second object that is supported on the second object supporter. It is desirable for the robot 110 to be able to retrieve either the first object or the second object without having to exit the aisle, and then re-enter the aisle. In this respect, it is desirable for the extendible arm 432 to be able to extend in a first direction, and also to be able to extend in a second direction that is opposite the first direction.

In some embodiments, for example, the grasping of an object, for which the object manipulator 430 is configured, includes the grasping of the first object and the grasping of the second object.

In some embodiments, for example, the extendible arm 432 is configurable in a first extendible arm extended configuration, as depicted in FIG. 47 to FIG. 50, and a second extendible arm extended configuration, as depicted in FIG. 51 to FIG. 54.

In some embodiments, for example, in the first extendible arm extended configuration, the extendible arm 432 is extended, in a first direction. In some embodiments, for example, in the first extendible arm extended configuration, the extendible arm 432 is extended, such that the end effector 440 is disposed for grasping the first object that is supported on the first object supporter.

In some embodiments, for example, in the second extendible arm extended configuration, the extendible arm 432 is extended, in a second direction that is opposite the first direction. In some embodiments, for example, in the second extendible arm extended configuration, the extendible arm 432 is extended, such that the end effector 440 is disposed for grasping the second object that is supported on the second object supporter.

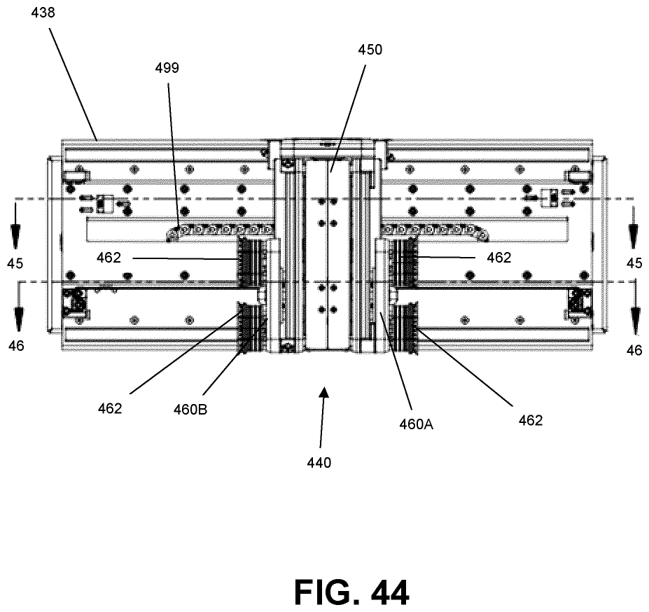

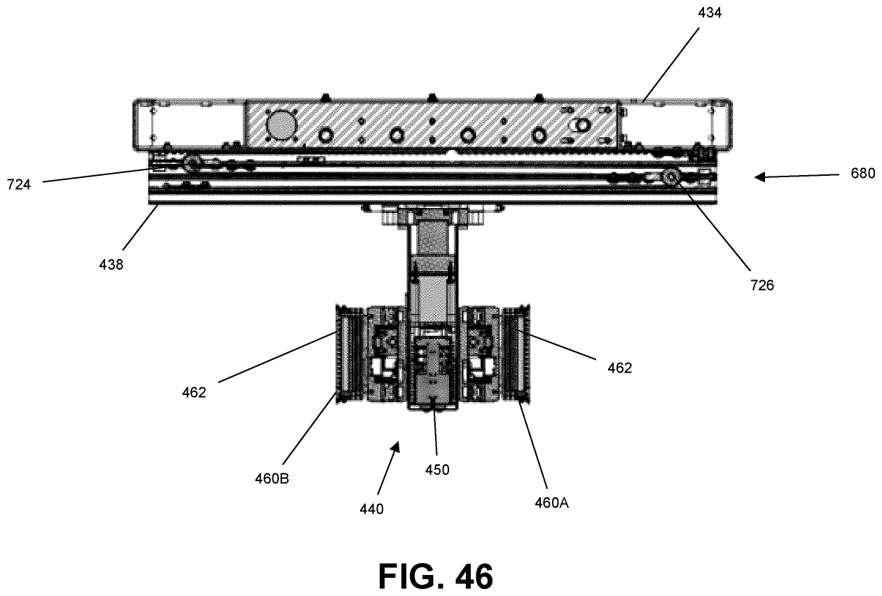

In some embodiments, for example the extendible arm 432 is extendible from a extendible arm retracted configuration, as depicted in FIG. 44 to FIG. 46, to the first extendible arm extended configuration, and also extendible from the extendible arm retracted configuration to the second extendible arm extended configuration. In transitioning from the extendible arm retracted configuration to the first extendible arm extended configuration, the extendible arm 432 is extended in the first direction, and in transitioning from the extendible arm retracted configuration to the second extendible arm extended configuration, the extendible arm is extended in the second direction.

In some embodiments, for example, the extension of the extendible arm 432, from the extendible arm retracted configuration to the first extendible arm extended configuration, is a lateral extension of the extendible arm 432 in the first direction, relative to the base 302. In some embodiments, for example, the extension of the extendible arm 432, from the extendible arm retracted configuration to the second extendible arm extended configuration, is a lateral extension of the extendible arm 432 in the second direction, relative to the base 302.

In some embodiments, for example, in the first extendible arm extended configuration, the extendible arm 432 is extended, in the first direction, along an extendible arm extension axis 431. In some embodiments, for example, in the second extendible arm extended configuration, the extendible arm 432 is extended, in the second direction, also along the extendible arm extension axis. In some embodiments, for example, the extendible arm extension axis extends laterally, relative the base 302.

In some embodiments, for example, while the extendible arm 432 is configured in the first extendible arm extended configuration, the extendible arm 432 is extended to the right of the base 302. In some embodiments, for example, while the extendible arm 432 is configured in the second extendible arm extended configuration, the extendible arm 432 is extended to the left of the base 302.

In some embodiments, for example, wherein the extendible arm 432 is a telescoping arm, the telescoping arm is configurable in a first telescoping arm extended configuration, as depicted in FIG. 47 to FIG. 50, a second telescoping arm extended configuration, as depicted in FIG. 51 to FIG. 54, and a telescoping arm retracted configuration, as depicted in FIG. 44 to FIG. 46.

In the first telescoping arm extended configuration, the telescoping arm is extended, in the first direction, along a telescoping arm axis 433, such that the end effector 440 is disposed for grasping the first object supported on the first object supporter.

In the second telescoping arm extended configuration, the telescoping arm is extended, in the second direction, also along the telescoping arm axis, such that the end effector 440 is disposed for grasping the second object supported on the second object supporter.

In some embodiments, for example, the telescoping arm axis extends laterally, relative to the base 302.

In some embodiments, for example, the object manipulator 430 includes an actuator configuration 660, including a prime mover 662, for example, a motor, for example, an electric motor, and a transmission configuration 664, including a gear box 666, gears 668, a transmission component 670, such as a drive belt, a chain, a cable, and the like, and a rack 672 for actuation of the extendible arm 432, wherein the extendible arm 432 is a telescoping arm. As depicted in FIG. 55, FIG. 56, and FIG. 48, the prime mover 662, gear box 666, gears 668, and transmission component 670 are coupled to the base arm segment 434, and the rack 672 is mounted to the intermediate arm segment 436A. In some embodiments, for example, the prime mover 662 and gear box 666 are disposed in electrical and data communication with the electrical and data connectors 428, for example, via electrical and data cables 435 and 437. While the cables 390 and 392 are disposed in electrical and data communication with the electrical and data connectors 428, the prime mover 662 and gear box 666 are disposed in data communication with the controller 202 and also disposed in electrical communication with the battery of the robot 110.

The prime mover 662 is configured to generate a displacement force that is applicable to the telescoping arm for laterally extending or retracting the telescoping arm, relative to the base 302. In response to application of the displacement force from the prime mover 662 to the telescoping arm, the telescoping arm is laterally extended or retracted, relative to the base 302.

In some embodiments, for example, the prime mover 662 is configurable in a first direction displacement drive state and a second direction displacement drive state. In some embodiments, for example, while the prime mover 662 is disposed in the first direction displacement drive state, the displacement force applied to the telescoping arm has a first direction, for example, a direction to the right, such that the telescoping arm extends or retracts in the first direction, relative to the base 302, in response to application of the displacement force to the telescoping arm. In some embodiments, for example, while the prime mover 662 is disposed in the second direction displacement drive state, the displacement force applied to the telescoping arm has a second direction that is opposite the first direction, for example, a direction to the left, such that the telescoping arm is displaced in the second direction, relative to the base 302, in response to application of the displacement force to the telescoping arm.

In some embodiments, for example, the prime mover 662 is disposed in data communication with the controller 202 and further disposed in electrical communication with the battery, for actuation of the prime mover 662 in the first direction displacement drive state and the second direction displacement drive state, via control commands from the controller 202.

In some embodiments, for example, the actuator configuration 660 includes the transmission configuration 664 to effect the operable communication between the prime mover 662 and the telescoping arm, in particular, between the prime mover 662 and the intermediate arm segment 436A. In some embodiments, for example, the transmission configuration 664 includes the transmission component 670. The transmission component 670 is disposed in operable communication with the prime mover 662 via the gearbox 666 and the gears 668. In some embodiments, for example, the transmission component 670 is configured to co-operate with the rack 672 such that force is transferable from the transmission component 670 to the rack 672, and therefore, to the intermediate arm segment 436A. In some embodiments for example, each one of the transmission component and the rack 672, independently, include threading or teeth for transferring force from the transmission component 670 to the rack 672. As depicted in FIG. 55 and FIG. 56, the prime mover 662 is disposed in operable communication with the rack 672 via the gearbox 666, gears 668, and transmission component 670, and the rack 672 is connected to the intermediate arm segment 436A, such that the displacement force generated by the prime mover 662 is applied to the intermediate arm segment 436A via the gearbox 666, gears 668, transmission component 670, and the rack 672. In this respect, the displacement force generated by the prime mover 662 is an intermediate arm segment displacement force. In response to application of the intermediate arm segment displacement force from the prime mover 662 to the intermediate arm segment 436A, the intermediate arm segment 436 is laterally displaced, relative to the base 302.

In some embodiments, for example, the base arm segment 434 is coupled to the base 302 such that there is an absence of lateral displacement of the base arm segment 434, relative to the base 302. In such embodiments, for example, in response to application of the intermediate arm segment displacement force from the prime mover 662 to the intermediate arm segment 436A, the intermediate arm segment 436 is laterally displaced, relative to the base arm segment 434.

In some embodiments, for example, to laterally displace the intermediate arm segment 436B, relative to the intermediate arm segment 436A, and also to laterally displace the terminal arm segment 438, relative to the intermediate arm segment 436B, for effecting the extension or retraction of the telescoping arm, the object manipulator 430 includes a transmission configuration 680. The base arm segment 434, the intermediate arm segment 436A, the intermediate arm segment 436B, the terminal arm segment 438, the transmission configuration 680 and the actuator configuration 660 are co-operatively configured such that, in response to application of the intermediate arm segment displacement force to the intermediate arm segment 436A by the actuator configuration 660 to effect the lateral displacement of the intermediate arm segment 436A, relative to the base arm segment 434: (i) an intermediate arm segment displacement force is applied by the transmission configuration 680 to the intermediate arm segment 436B, to effect lateral displacement of the intermediate arm segment 436B, relative to the intermediate arm segment 436A, and (ii) a terminal arm segment displacement force is applied by the transmission configuration 680 to the terminal arm segment 438, to effect lateral displacement of the terminal arm segment 438, relative to the intermediate arm segment 436B.

In some embodiments, for example, the transmission configuration 680 includes:
(i) a first upper transmission component 682, for example, a drive belt, a chain, a cable and the like, having a first end 684 and a second end 686,
(ii) a second upper transmission component 692, for example, a drive belt, a chain, a cable and the like, having a first end 694 and a second end 696;
(iii) a first lower transmission component 702, for example, a drive belt, a chain, a cable and the like, having a first end 704 and a second end 706;
(iv) second lower transmission component 712, for example, a drive belt, a chain, a cable and the like, having a first end 714 and a second end 716;
(v) a first upper pulley 720 coupled to the intermediate arm segment 436A and disposed on a right end of the intermediate arm segment 436A;
(vi) second upper pulley 722 coupled to the intermediate arm segment 436B and disposed on a left end of the intermediate arm segment 436B;
(vii) a first lower pulley 724 coupled to the intermediate arm segment 436A and disposed on a left end of the intermediate arm segment 436A; and
(viii) a second lower pulley 726 coupled to the intermediate arm segment 436B and disposed on a left end of the intermediate arm segment 436B.

As depicted in FIG. 44 to FIG. 54:
(i) the first upper transmission component 682 is connected, at the first end 684, to the base arm segment 434, and connected, at the second end 686, to the intermediate arm segment 436B, is looped around the first upper pulley 720 that is coupled to the intermediate arm segment 436A, and disposed in tension.
(ii) the second upper transmission component 692 is connected, at the first end 694, to the intermediate arm segment 436A, and connected, at the second end 696, to the terminal arm segment 438, and is looped around the second upper pulley 722 that is coupled to the intermediate arm segment 436B, and disposed in tension.
(iii) the first lower transmission component 702 is connected, at the first end 704, to the base arm segment 434, and connected, at the second end 706, to the intermediate arm segment 436B, and is looped around the first lower pulley 724 that is coupled to the intermediate arm segment 436A, and disposed in tension.
(iv) the second lower transmission component 712 is connected, at the first end 714, to the intermediate arm segment 436A, and connected, at the second end 716, to the terminal arm segment 438, and is looped around the second lower pulley 726 that is coupled to the intermediate arm segment 436B, and disposed in tension.

In response to lateral displacement of the intermediate arm segment 436A in the first direction, for example, in the right direction, in response to application of the intermediate arm segment displacement force having a first direction from the prime mover 662, the first upper pulley 720 and the first lower pulley 724 are displaced in the first direction. As the first upper pulley 720 is displaced in the first direction, the first upper pulley 720 exerts a force on the first upper transmission component 682, with effect that the first upper transmission component 682 becomes further disposed in tension. Due to the connection of the first upper transmission component 682 to: (i) the base arm segment 434, which is connected to the base such that there is an absence of lateral displacement of the base arm segment 434, relative to the base 302, and (ii) the intermediate arm segment 436B, which is coupled to the intermediate arm segment 436A such that the intermediate arm segment 436B is laterally displaceable, relative to the intermediate arm segment 436A, the tension in the first upper transmission component 682 is transferred to the intermediate arm segment 436B as an intermediate arm segment displacement force, having the first direction. In this respect, as the intermediate arm segment 436A is displaced laterally in the first direction, the first upper transmission component 682 applies the intermediate arm segment displacement force to the intermediate arm segment 436B. In response to application of the intermediate arm segment displacement force to the intermediate arm segment 436B, the intermediate arm segment 436B is displaced, relative to the intermediate arm segment 436A, in the first direction.

Similarly, in response to lateral displacement of the intermediate arm segment 436B in the first direction, for example, in the right direction, in response to application of the intermediate arm segment displacement force having a first direction from the first upper transmission component 682, the second upper pulley 722 and the second lower pulley 726 are displaced in the first direction. As the second lower pulley 726 is displaced in the first direction, the second lower pulley 726 exerts a force on the second lower transmission component 712, with effect that the second lower transmission component 712 becomes further disposed in tension. Due to the connection of the second lower transmission component 712 to: (i) the intermediate arm segment 436A, such that the intermediate arm segment 436B is laterally displaceable relative to the intermediate arm segment 436A, and (ii) terminal arm segment 438, which is coupled to the intermediate arm segment 436B such that the terminal arm segment 438 is laterally displaceable, relative to the intermediate arm segment 436B, the tension in the second lower transmission component 712 is transferred to the terminal arm segment as a terminal arm segment displacement force, having the first direction. In this respect, as the intermediate arm segment 436B is displaced laterally in the first direction, the second lower transmission component 712 applies the terminal arm segment displacement force to the terminal arm segment 438. In response to application of the terminal arm segment displacement force to the terminal arm segment 438, the terminal arm segment 438 is displaced, relative to the intermediate arm segment 436B, in the first direction.

In response to lateral displacement of the intermediate arm segment 436A in the second direction that is opposite the first direction, for example, in the left direction, in response to application of the intermediate arm segment displacement force having a second direction from the prime mover 662, the first upper pulley 720 and the first lower pulley 724 are displaced in the second direction. As the first lower pulley 724 is displaced in the second direction, the first lower pulley 724 exerts a force on the first lower transmission component 702, with effect that the first lower transmission component 702 becomes further disposed in tension. Due to the connection of the first lower transmission component 702 to: (i) the base arm segment 434, which is connected to the base 302 such that there is an absence of lateral displacement of the base arm segment 434, relative to the base 302, and (ii) the intermediate arm segment 436B, which is coupled to the intermediate arm segment 436A such that the intermediate arm segment 436B is laterally displaceable, relative to the intermediate arm segment 436A, the tension in the first lower transmission component 702 is transferred to the intermediate arm segment 436B as an intermediate arm segment displacement force, having the second direction. In this respect, as the intermediate arm segment 436A is displaced laterally in the second direction, the first lower transmission component 702 applies the intermediate arm segment displacement force to the intermediate arm segment 436B. In response to application of the intermediate arm segment displacement force to the intermediate arm segment 436B, the intermediate arm segment 436B is displaced, relative to the intermediate arm segment 436A, in the second direction.

Similarly, in response to lateral displacement of the intermediate arm segment 436B in the second direction, for example, in the left direction, in response to application of the intermediate arm segment displacement force having a second direction from the first lower transmission component 702, the second upper pulley 722 and the second lower pulley 726 are displaced in the first direction. As the second upper pulley 722 is displaced in the second direction, the second upper pulley 722 exerts a force on the second upper transmission component 692, with effect that the second upper transmission component 692 becomes further disposed in tension. Due to the connection of the second upper transmission component 692 to: (i) the intermediate arm segment 436A, such that the intermediate arm segment 436B is laterally displaceable relative to the intermediate arm segment 436A, and (ii) terminal arm segment 438, which is coupled to the intermediate arm segment 436B such that the terminal arm segment 438 is laterally displaceable, relative to the intermediate arm segment 436B, the tension in the second upper transmission component 692 is transferred to the terminal arm segment 438 as a terminal arm segment displacement force, having the second direction. In this respect, as the intermediate arm segment 436B is displaced laterally in the second direction, the second upper transmission component 692 applies the terminal arm segment displacement force to the terminal arm segment 438. In response to application of the terminal arm segment displacement force to the terminal arm segment 438, the terminal arm segment 438 is displaced, relative to the intermediate arm segment 436B, in the second direction.

In some embodiments, for example, while the telescoping arm is disposed in the first telescoping arm extended configuration, in response to disposition of the prime mover 662 in the second direction displacement drive state, the telescoping arm is retracted, from the first telescoping arm extended configuration to the telescoping arm retracted configuration. With the prime mover 662 still disposed in the second direction displacement drive state, the telescoping arm is extended, from the telescoping arm retracted configuration to the second telescoping arm extended configuration.

In some embodiments, for example, while the telescoping arm is disposed in the second telescoping arm extended configuration, in response to disposition of the prime mover 662 in the first direction displacement drive state, the telescoping arm is retracted, from the second telescoping arm extended configuration to the telescoping arm retracted configuration. With the prime mover 662 still disposed in the first direction displacement drive state, the telescoping arm is extended, from the telescoping arm retracted configuration to the first telescoping arm extended configuration.

In some embodiments, for example, the transition of the telescoping arm between the first telescoping arm extended configuration to the second telescoping arm extended configuration is a continuous transition.

In some embodiments, for example, because the extendible arm 432 can extend in the first direction and also in the second direction that is opposite the first direction, the robot 110 can enter an aisle from either a first end of the aisle or the second end of the aisle to grasp an object that is disposed on a first side (e.g. right side) of the robot 110 or a second side of the robot that is opposite the first side (e.g. left side). This reduces the time for the robot 110 to complete an object retrieval or storage operation. Without the ability of the extendible arm 432 to extend in the first direction and also in the second direction, the robot 110 may be required to enter an aisle from one of the first or second end, or after entering the aisle, exiting the aisle and re-entering the aisle in the opposite direction, which may increase the time for the robot 110 to complete an object retrieval or storage operation.

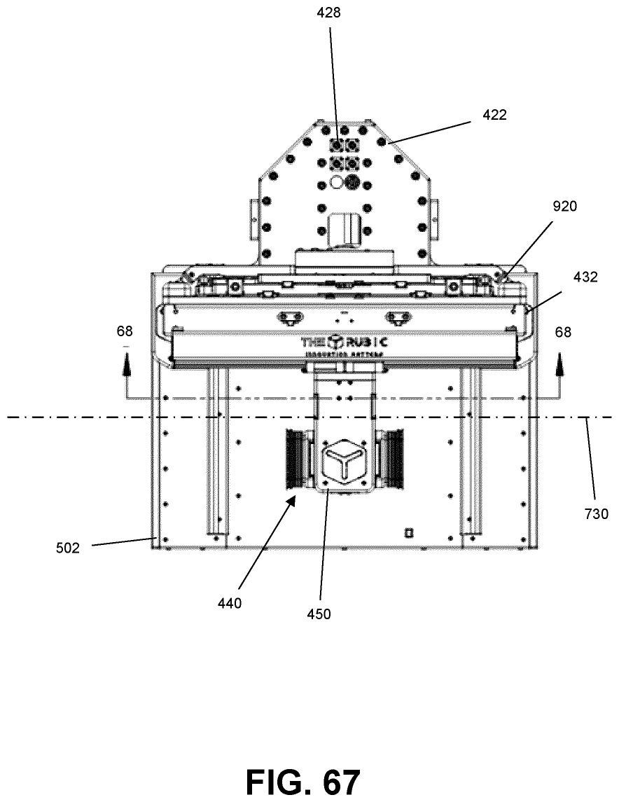

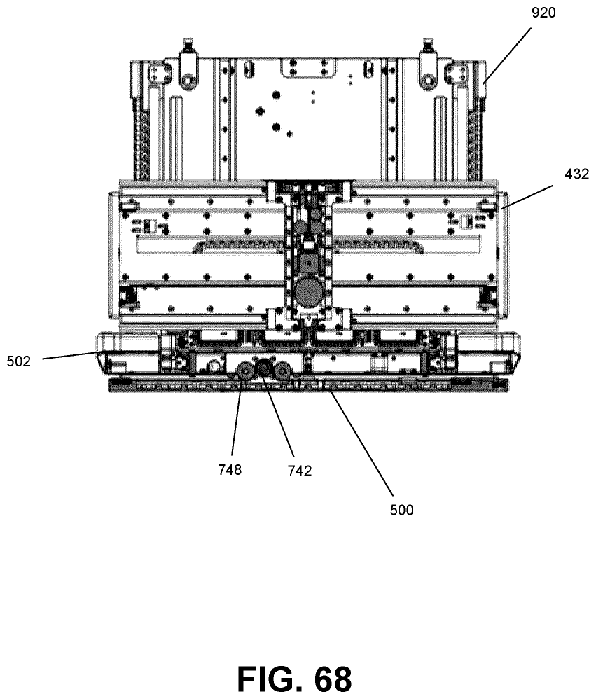

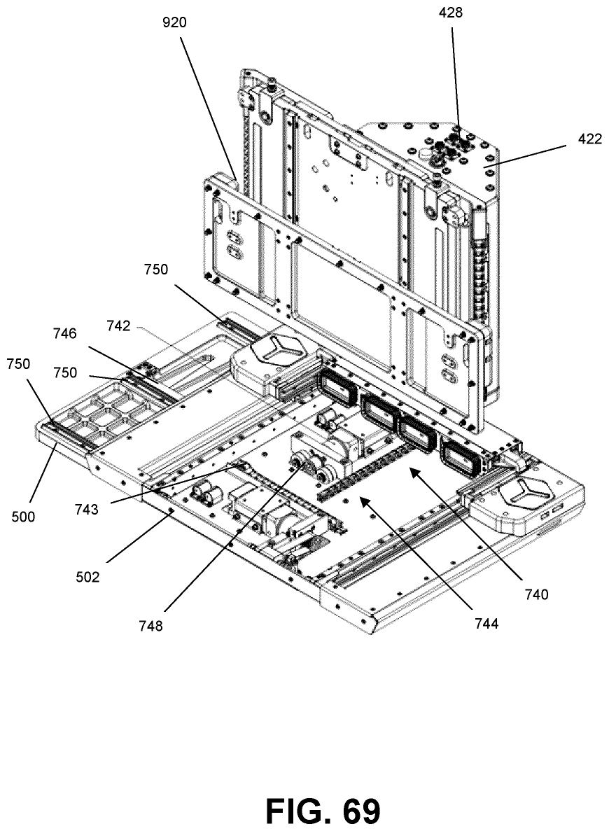

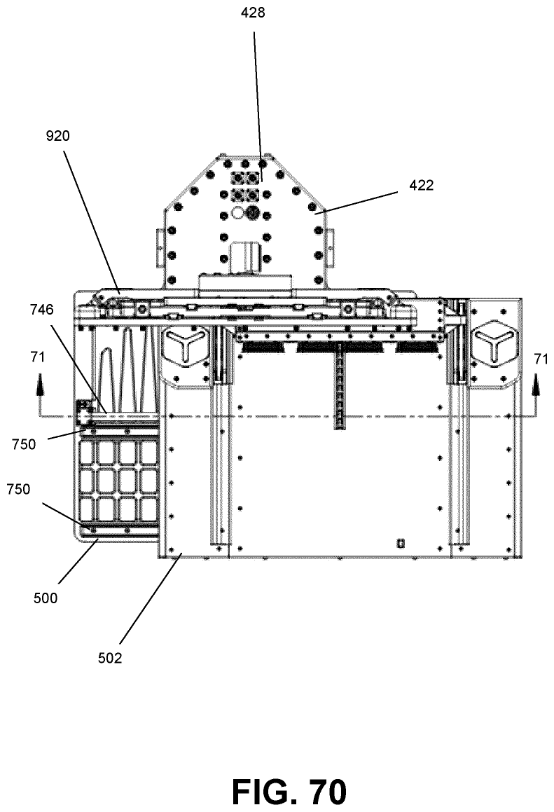

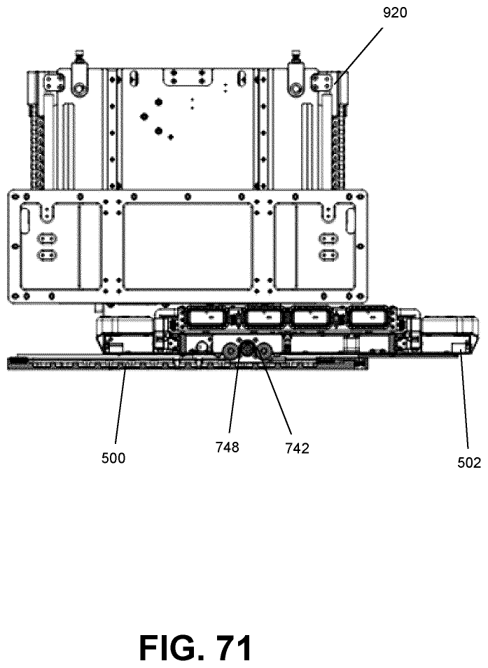

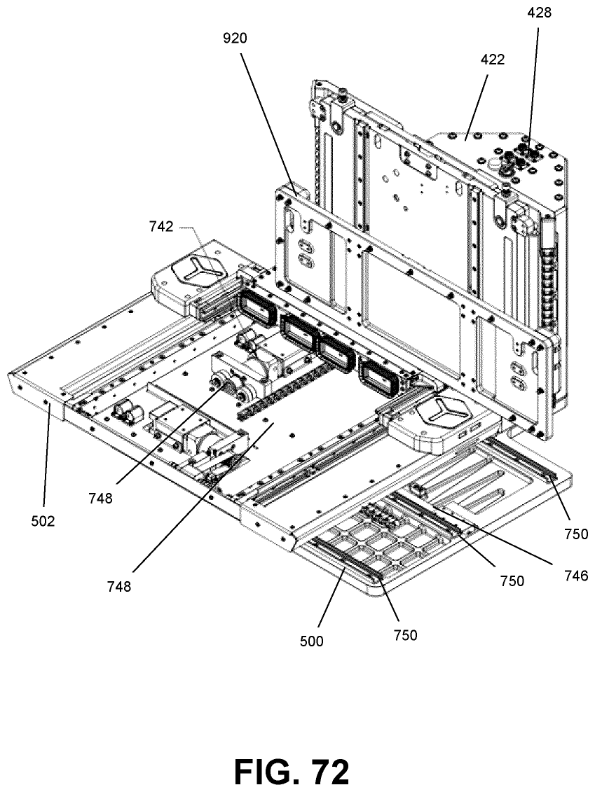

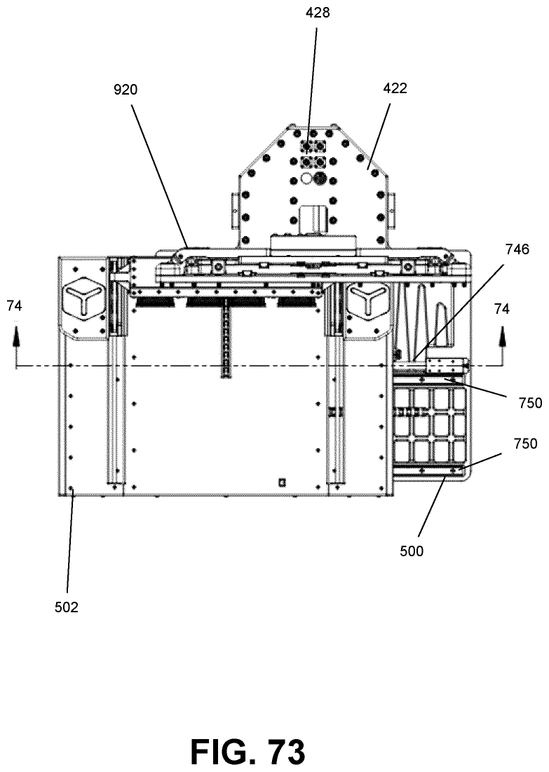

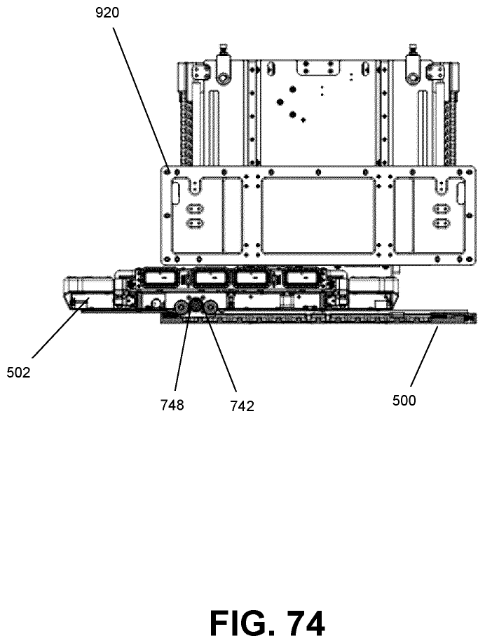

In some embodiments, for example, the robot-defined object supporter 502 is displaceable laterally, relative to the base 302, from a supporter retracted configuration, as depicted in FIG. 67 and FIG. 68, to a to a first supporter extended configuration, as depicted in FIG. 69 to FIG. 71, and also displaceable laterally from the supporter retracted configuration to a second supporter extended configuration, as depicted in FIG. 72 to FIG. 74.

In transitioning from the supporter retracted configuration to the first supporter extended configuration, the robot-defined object supporter 502 is displaced, relative to base 302, in a first direction, for example, in a right direction.

In transitioning from the supporter retracted configuration to the second supporter extended configuration, the robot-defined object supporter 502 is displaced, relative to the base 302, in a second direction that is opposite the first direction, for example, in a left direction.

In some embodiments, for example, the lateral displacement of the extendible arm 432, for example, the telescoping arm, is independent of the lateral displacement of the robot-defined object supporter 502.

In some embodiments, for example, while the robot 110 is disposed within the aisle between the first and second object supporters, such that the first object supporter is disposed on a first side of the robot 110, such as the right side of the robot, and that the second object supporter is disposed on a second side of the robot 110 that is opposite the first side of the robot, for example, the left side of the robot, transitioning from the retracted configuration to the first platform extended configuration is with effect that the minimum spacing between the robot-defined object supporter 502 and the first object supporter is reduced, and transitioning from the retracted configuration to the second platform extended configuration is with effect that the minimum spacing between the robot-defined object supporter 502 and the second object supporter is reduced.

In some embodiments, for example, the displacement of the robot-defined object supporter 502, in the first direction, for transitioning from the supporter retracted configuration to the first supporter extended configuration, is along a supporter extension axis 730, and the extension of the robot-defined object supporter 502, in the second direction, for transitioning from the supporter retracted configuration to the second supporter extended configuration, is also along the supporter extension axis 730.

In some embodiments, for example, the extendible arm extension axis 431 is parallel to the supporter extension axis 730. In some embodiments, for example, wherein the extendible arm 432 is a telescoping arm, the telescoping arm extension axis 433 is parallel to the supporter extension axis 730.

In some embodiments, for example, the object transitioning apparatus 420 includes an actuator configuration 740 to effect the lateral displacement of the robot-defined object supporter 502, relative to the base 302.

In some embodiments, for example, the actuator configuration 740 includes a prime mover 742, for example, a motor, for example, an electric motor, that is disposed in operable communication with the robot-defined object supporter 502. In some embodiments, for example, the prime mover 742 is disposed within and mounted to the robot-defined object supporter 502, such that the prime mover 742 is laterally displaceable with the robot-defined object supporter 502. The prime mover 742 is configured to generate a displacement force that is applicable to the robot-defined object supporter 502 for laterally displacing the robot-defined object supporter 502, relative to the base 302. In response to application of the displacement force from the prime mover 742 to the robot-defined object supporter 502, the robot-defined object supporter 502 is laterally displaced, relative to the base 302.

In some embodiments, for example, the prime mover 742 is configurable in a first direction displacement drive state and a second direction displacement drive state. In some embodiments, for example, while the prime mover 742 is disposed in the first direction displacement drive state, the displacement force applied to the robot-defined object supporter 502 has first direction, for example, the right direction, such that the robot-defined object supporter 502 is displaced in the first direction, relative to the base 302, in response to application of the displacement force to the robot-defined object supporter 502. In some embodiments, for example, while the prime mover 742 is disposed in the second direction displacement drive state, the displacement force applied to the robot-defined object supporter 502 has a second direction that is opposite the first direction, for example, the left direction, such that the robot-defined object supporter 502 is displaced in the second direction, relative to the base 302, in response to application of the displacement force to the robot-defined object supporter 502.

In some embodiments, for example, the prime mover 742 is disposed in data communication with the controller 202 and further disposed in electrical communication with the battery, for example, via electrical and data cable 743, which is disposed in electrical and data communication with the electrical and data connectors 428, for actuation of the prime mover 742 in the first direction displacement drive state and the second direction displacement drive state, via control commands from the controller 202. While the cables 390 and 392 are disposed in electrical and data communication with the electrical and data connectors 428, the prime mover 742 is disposed in data communication with the controller 202 and also disposed in electrical communication with the battery of the robot 110.

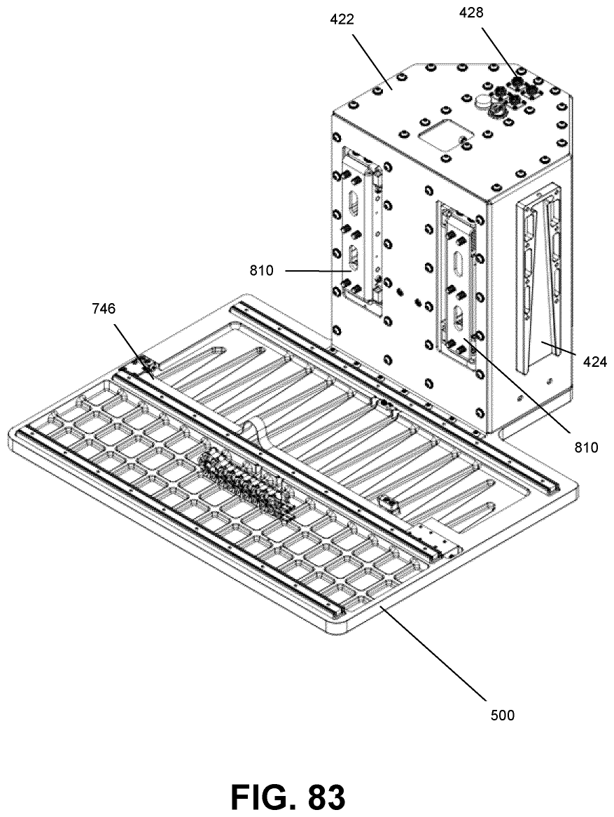

In some embodiments, for example, the actuator configuration 740 includes a transmission configuration 744 to effect the operable communication between the prime mover 742, the base 500, and the robot-defined object supporter 502. In some embodiments, for example, the transmission configuration 744 includes a transmission component 746, for example, a drive belt, a chain, a cable and the like. The transmission component 746 is mounted to the base 500 of the object transitioning apparatus 420, and, as depicted in FIG. 69, FIG. 72, and FIG. 83, is looped around rotatable components 748 of the prime mover 742, such as one or more wheels or gears of the prime mover 742. In response to configuration of the prime mover 742 in the first direction or second direction displacement drive state, the displacement force is applied by the rotatable component 748 to the transmission component 746. As the transmission component 746 is coupled to the base 500, the displacement force applied by the prime mover 742 to the transmission component 746 effects lateral displacement of the prime mover 742, relative to the transmission component 746, and also relative to the base 500. Due to the connection of the prime mover 742 to the robot-defined object supporter 502, the displacement force is transferred from the prime mover 742 to the robot-defined object supporter 502, such that the robot-defined object supporter 502 is also laterally displaced, relative to the base 500. In some embodiments, for example, while the object transitioning apparatus 420 is coupled to the base 302, via the lift mechanism 340, there is an absence of lateral displacement of the base 500, relative to the base 302. In such embodiments, for example, the lateral displacement of the robot-defined object supporter 502, relative to the base 500 of the object transitioning apparatus 420, is also relative to the base 302 of the robot 110.

In some embodiments, for example, as depicted in FIG. 69, the object transitioning apparatus 420 includes guides 750, for example, guide tracks that are mounted to the base 500, for guiding the lateral displacement of the robot-defined object supporter 502, relative to the base 500.

In some embodiments, for example, while the robot-defined object supporter 502 is disposed in the first supporter extended configuration, in response to disposition of the prime mover 742 in the second direction displacement drive state, the telescoping arm is retracted, from the first supporter extended configuration to the supporter retracted configuration. With the prime mover 742 still disposed in the second direction displacement drive state, the robot-defined object supporter 502 is extended, from the supporter retracted configuration to the second supporter extended configuration.

In some embodiments, for example, while the robot-defined object supporter 502 is disposed in the second supporter extended configuration, in response to disposition of the prime mover 742 in the first direction displacement drive state, the robot-defined object supporter 502 is retracted, from the second supporter extended configuration to the supporter retracted configuration. With the prime mover 742 still disposed in the first direction displacement drive state, the robot-defined object supporter 502 is extended, from the supporter retracted configuration to the first supporter extended configuration.

In some embodiments, for example, the transition of the robot-defined object supporter 502 between the first supporter extended configuration and the second supporter extended configuration is a continuous transition.

In some embodiments, for example, because the robot-defined object supporter 502 can displace laterally in the first direction and also in the second direction that is opposite the first direction, the robot 110 can enter an aisle from either a first end of the aisle or the second end of the aisle to grasp an object that is disposed on a first side (e.g. right side) of the robot 110 or a second side of the robot that is opposite the first side (e.g. left side). This reduces the time for the robot 110 to complete an object retrieval or storage operation. Without the ability of the robot-defined object supporter 502 to laterally displace in the first direction and also in the second direction, the robot 110 may be required to enter an aisle from one of the first or second end, or after entering the aisle, exiting the aisle and re-entering the aisle in the opposite direction, which may increase the time for the robot 110 to complete an object retrieval or storage operation.

In some embodiments, for example, the end effector 440 is coupled to the extendible arm 432 such that: (i) the end effector 440 is displaceable laterally, relative to the base 302, in response to extension or retraction of the extendible arm 432, and (ii) the end effector 440 is also displaceable laterally, relative to the extendible arm 432. In some embodiments, for example, the lateral displaceability of the end effector 440, relative to the base 302, in response to extension or retraction of the extendible arm 432, is independent of the lateral displaceability of the end effector 440, relative to the extendible arm 432.

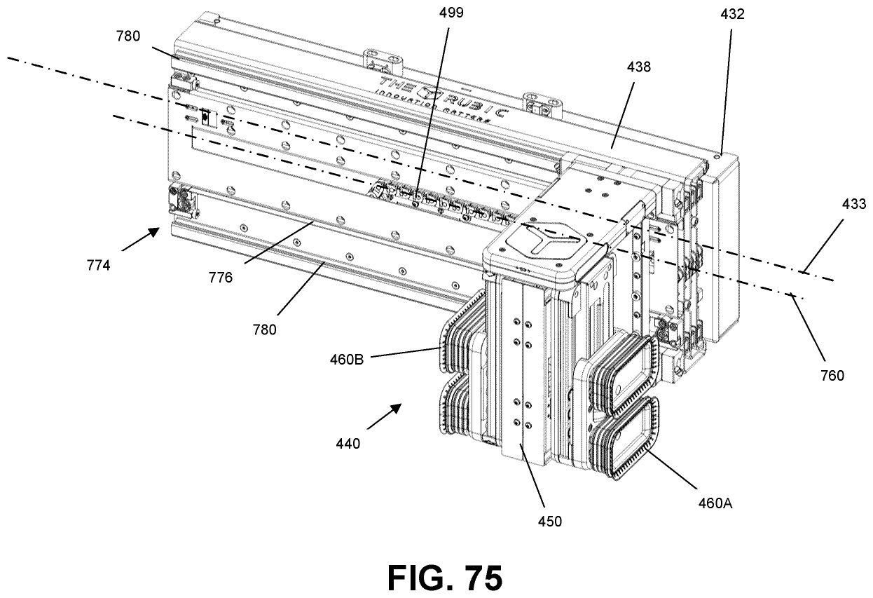

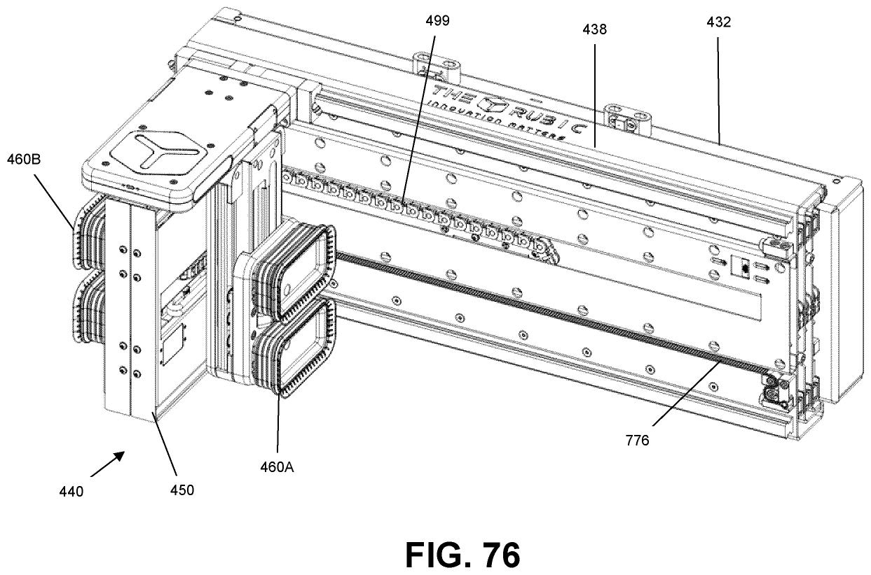

In some embodiments, for example, the end effector 440 is displaceable laterally, relative to the extendible arm 432, in a first direction, for example, in a right direction, as depicted in FIG. 75, and also in a second direction that is opposite the first direction, for example, in a left direction, as depicted in FIG. 76.

In some embodiments, for example, the lateral displaceability of the end effector 440, relative to the extendible arm 432, is such that the end effector 440 is displaceable, relative to extendible arm 432, between a first lateral position, as depicted in FIG. 75, and a second lateral position, as depicted by FIG. 76, wherein the first lateral position is disposed to the right, relative to the second lateral position.

In some embodiments, for example, wherein the extendible arm 432 is a telescoping arm, the end effector 440 is coupled to the terminal arm segment 438 of the telescoping arm. The coupling of the end effector 440 to the telescoping arm is effected by the coupling of the end effector 440 to the terminal arm segment 438. In some embodiments, for example, the end effector 440 is displaceable laterally, relative to the terminal arm segment 438.

In some embodiments, for example, the end effector 440 is displaceable laterally, relative to the telescoping arm 432, along a central longitudinal axis 760 of the telescoping arm. As depicted in FIG. 75, the central longitudinal axis 760 of the telescoping arm is a laterally extending axis.

In some embodiments, for example, the telescoping arm is extendible and retractable along the telescoping arm extension axis 433, and the end effector 440 is displaceable laterally, relative to the telescoping arm, along the extension axis 433.

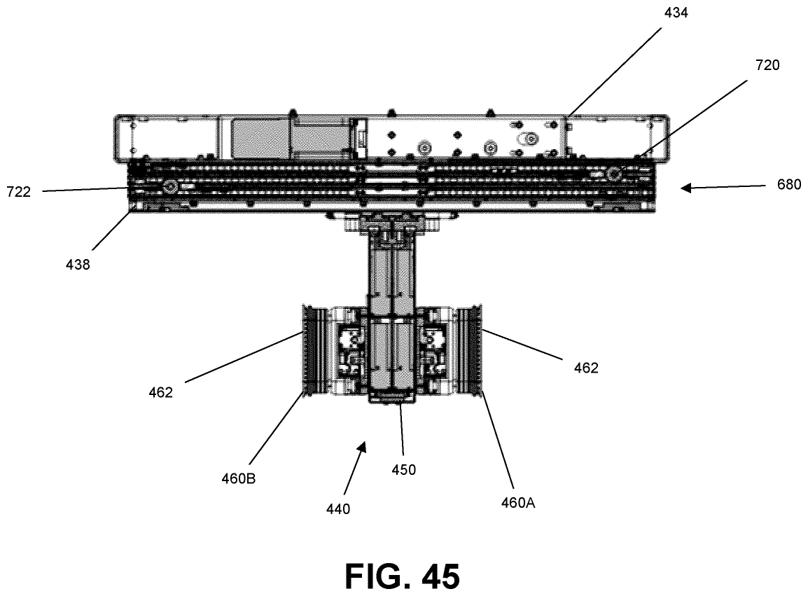

In some embodiments, the telescoping arm is extendible from the retracted configuration, as depicted in FIG. 45, to the first extended configuration, as depicted in FIG. 47, and also extendible from the retracted configuration to the second extended configuration, as depicted in FIG. 51.

In some embodiments, for example, the end effector 440 is displaceable laterally, relative to the telescoping arm, while the telescoping arm is disposed in the retracted configuration. In some embodiments, for example, the end effector 440 is displaceable laterally, relative to the telescoping arm, while the telescoping arm is disposed in the first extended configuration. In some embodiments, for example, the end effector 440 is displaceable laterally, relative to the telescoping arm, while the telescoping arm is disposed in the second configuration. In some embodiments, for example, the end effector 440 is displaceable laterally, relative to the telescoping arm, while the telescoping arm is transitioning between the first extended configuration and the second extended configuration.

In some embodiments, for example, the driver 450, to which the end effector 440 is coupled, is coupled to the extendible arm 432 such that the driver 450 is laterally displaceable, relative to the extendible arm 432. In such embodiments, for example, the lateral displaceability of the end effector 440, relative to the extendible arm 432, is effectible by the lateral displaceability of the driver 450, relative to the extendible arm 432.

In some embodiments, for example, wherein the extendible arm 432 is a telescoping arm, the driver 450, to which the end effector 440 is coupled, is coupled to the terminal arm segment 438 such that the driver 450 is laterally displaceable, relative to the terminal arm segment 438. In such embodiments, for example, the lateral displaceability of the end effector 440, is effectible by the lateral displaceability of the driver 450, relative to the terminal arm segment 438.

In some embodiments, for example the object transitioning apparatus 420 includes an actuator configuration 770 to effect the lateral displacement of the driver 450, relative to the terminal arm segment 438.

In some embodiments, for example, the actuator configuration 770 includes a motor 772, for example, a motor, for example, an electric motor, that is disposed in operable communication with the driver 450. In some embodiments, for example, as depicted in FIG. 58, the prime mover 772 is mounted to the driver 450, such that the prime mover 772 is laterally displaceable with the driver 450. The prime mover 772 is configured to generate a displacement force that is applicable to the driver 450 for laterally displacing the driver 450, relative to the terminal arm segment 438. In response to application of the displacement force from the prime mover 772 to the driver 450, the driver 450 is laterally displaced, relative to the terminal arm segment 438.

In some embodiments, for example, the prime mover 772 is configurable in a first direction displacement drive state and a second direction displacement drive state. In some embodiments, for example, while the prime mover 772 is disposed in the first direction displacement drive state, the displacement force applied to the driver 450 has first direction, for example, the right direction, such that the driver 450 is displaced in the first direction, relative to the terminal arm segment 438, in response to application of the displacement force to the driver 450. In some embodiments, for example, while the prime mover 772 is disposed in the second direction displacement drive state, the displacement force applied to the driver 450 has a second direction that is opposite the first direction, for example, the left direction, such that the driver 450 is displaced in the second direction, relative to the terminal arm segment 438, in response to application of the displacement force to the driver 450.

In some embodiments, for example, the prime mover 772 is disposed in data communication with the controller 202 and further disposed in electrical communication with the battery, for example, via electrical and data cable 499, which is disposed in electrical and data communication with the electrical and data connectors 428, for actuation of the prime mover 772 in the first direction displacement drive state and the second direction displacement drive state, via control commands from the controller 202. While the cables 390 and 392 are disposed in electrical and data communication with the electrical and data connectors 428, the prime mover 772 is disposed in data communication with the controller 202 and also disposed in electrical communication with the battery of the robot 110.

In some embodiments, for example, the actuator configuration 770 includes a transmission configuration 774 to effect the operable communication between the prime mover 772, the driver 450, and the terminal arm segment 438. In some embodiments, for example, the transmission configuration 744 includes a transmission component 776, for example, a drive belt, a chain, a cable and the like. The transmission component 776 is mounted to the terminal arm segment 438, as depicted in FIG. 75 and is looped around rotatable components 778 of the prime mover 772, such as one or more wheels or gears of the prime mover 772. In response to configuration of the prime mover 772 in the first direction or second direction displacement drive state, the displacement force is applied by the rotatable components 778 to the transmission component 776. As the transmission component 776 is coupled to the terminal arm segment 438, the displacement force applied by the prime mover 772 to the transmission component 776 effects lateral displacement of the prime mover 772, relative to the transmission component 776, and also relative to the terminal arm segment 438. Due to the connection of the prime mover 772 to the driver 450, the displacement force is transferred from the prime mover 772 to the driver 450, such that the driver 450 is also laterally displaced, relative to the terminal arm segment 438.

In some embodiments, for example, the lateral displacement of the driver 450, relative to the terminal arm segment 438, is also a lateral displacement of the driver 450, relative to the base 302, for example, while there is an absence of extension or retraction of the telescoping arm, relative to the base 302.

In some embodiments, for example, as depicted in FIG. 75, the object transitioning apparatus 420 includes guides 780, for example, guide tracks, that are mounted to the terminal arm segment 438, for guiding the lateral displacement of the driver 450, relative to the terminal arm segment 438.

In some embodiments, for example, while the robot 110 is disposed in an aisle, and while the telescoping arm is extended in a first direction for the end effector 440 to grasp an object on an object supporter, such that the grasped object is established, and while the telescoping arm being retracted, relative to the base 302, to laterally displace the grasped object from the object supporter to the robot-defined object supporter 502, the telescoping arm may become disposed in the telescoping arm retracted configuration before the object becomes emplaced above the robot-defined object supporter 502 for supporting by the robot-defined object supporter 502. In such embodiments, for example, the end effector 440 is laterally displaceable, relative to the telescoping arm, to further laterally displace the object, relative to the base 302, such that the object becomes emplaced above the robot-defined object supporter 502, such that the object is supportable by the robot-defined object supporter 502, without extension of the telescoping arm in a second direction that is opposite the first direction. This allows for the width of the aisle to be reduced, such that the space of the warehouse is available for storage of objects.

In some embodiments, for example, the object is laterally displaceable, relative to the base 302, via lateral displacement of the end effector 440, relative to the telescoping arm, for example, while there is an absence of extension or retraction of the telescoping arm, relative to the base 302, for example, where there is insufficient space to extend or retract the telescoping arm.

In some embodiments, for example, the object manipulator 430 includes: (i) an object emplacement/removal tool 421, which includes the extendible arm 432 and the driver 450, and (ii) the end effector 440.

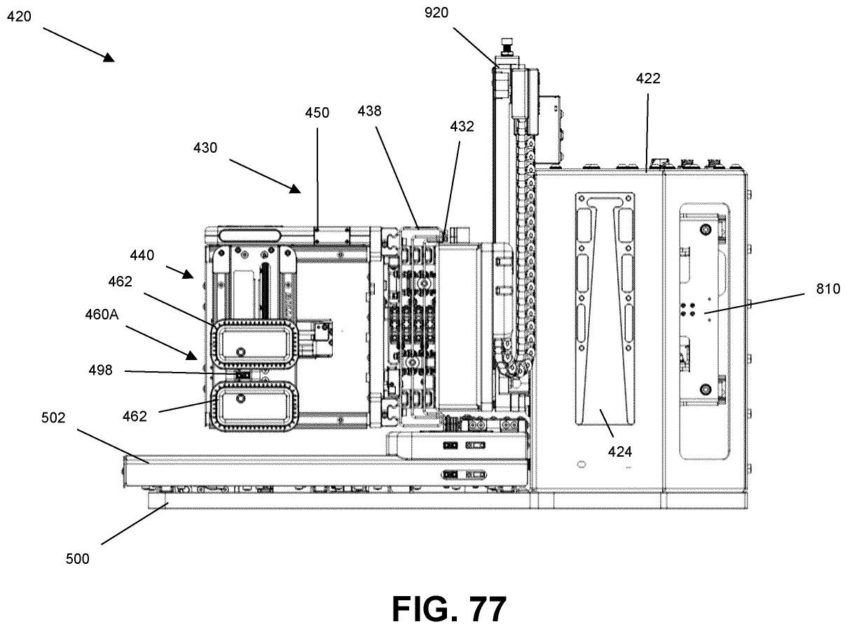

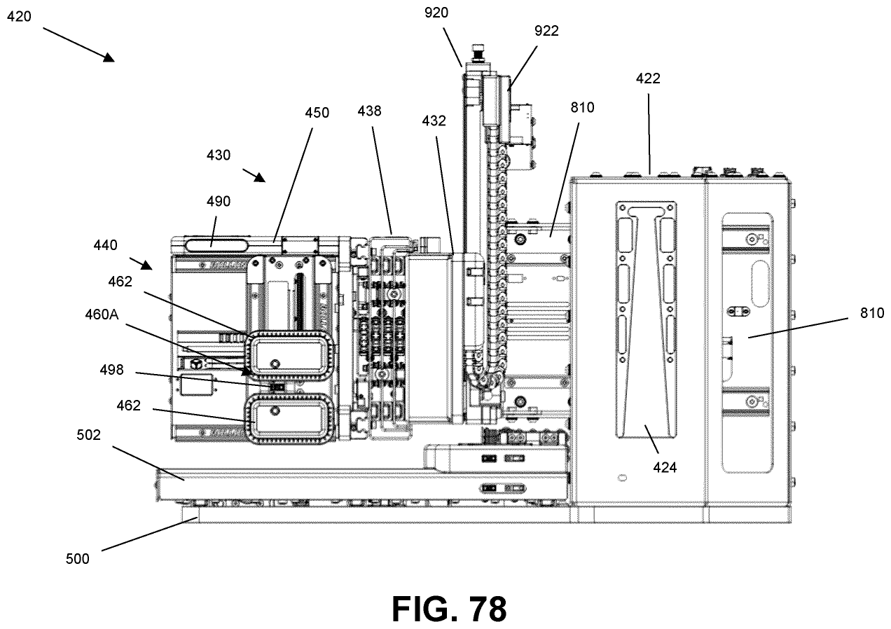

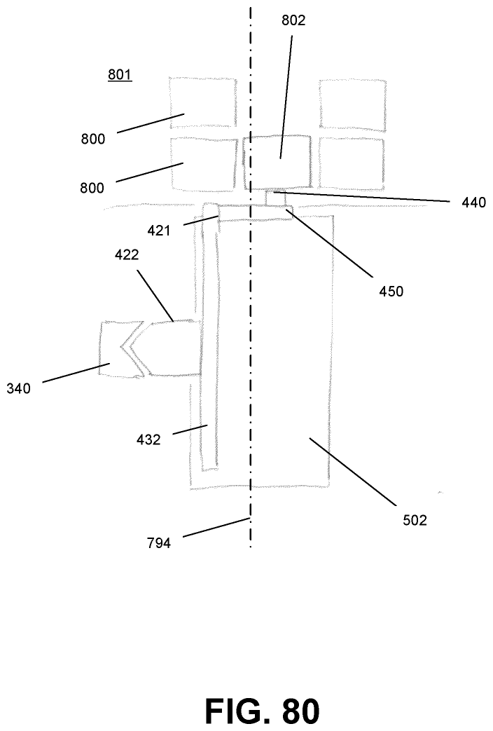

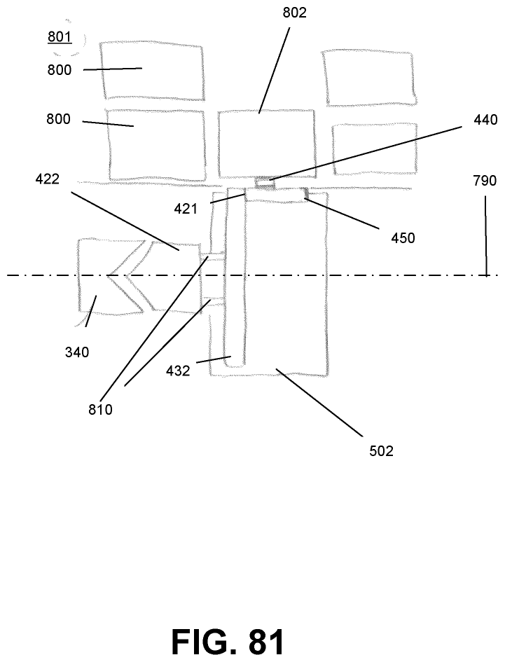

The object emplacement/removal tool 421 and the end effector 440 are co-operatively configurable with effect that the object emplacement/removal tool 421 is displaceable, relative to the base, independently of the end effector 440, and along a first axis 790 (in some embodiments, for example, along a longitudinal axis), such that displacement of the object emplacement/removal tool 421, relative to the base 302, and along a first axis 790, is obtainable, and the displacement of the object emplacement/removal tool 421, relative to the base 302, and along a first axis 790, is obtainable in absence of displacement of the end effector 440, relative to the base 302, and along the first axis 790, such that positioning of the end effector 440, relative to the base 302, remains unchanged (as depicted in FIG. 77 and FIG. 78), with effect that the object manipulator 430 is transitionable between an alignment ineffective configuration, as depicted in FIG. 80, and an alignment effective configuration, as depicted in FIG. 81, in response to the displacement of the object emplacement tool 421, relative to the end effector 440, and along the first axis 790, obtained in absence of displacement of the end effector 440, relative to the base 302, along the first axis 790.

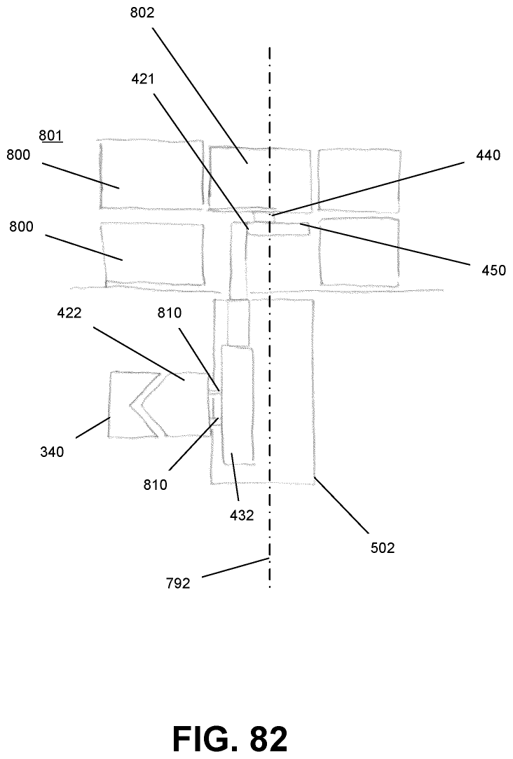

The object emplacement/removal tool 421 and the end effector 440 are co-operatively configurable with effect that the end effector 440 is displaceable, with the object emplacement/removal tool 421, relative to the base 302, along a second axis 792 (in some embodiments, for example, along a lateral axis), and in response to extension or retraction of the object emplacement/removal tool 421, such that displacement of the end effector 440, with the object emplacement/removal tool 421, relative to the base 302, along the second axis 792, and in response to extension or retraction of the object emplacement/removal tool 421, is obtainable, such that the object manipulator 430 is transitionable between the alignment effective configuration and an object emplacement/removal effective configuration, as depicted in FIG. 82, in response to the displacement of the end effector 440, relative to the base, along the second axis 792, and in response to the extension or the retraction of the object emplacement/removal tool 421.

In some embodiments, for example, the second axis 792 is disposed parallel to an axis that is transverse to the first axis 790. In some embodiments, for example, the axis, that is transverse to the first axis 790, and to which the second axis 792 is disposed in parallel relationship, is perpendicular to the first axis 790.

In some embodiments, for example, the object emplacement/removal tool 421 and the end effector 440 are further co-operatively configurable with effect that displacement of the end effector 440, relative to the object emplacement/removal tool 421, along the second axis, is restricted. The restriction of the displacement of the end effector 440, relative to the object emplacement/removal tool 421, along the second axis 792, is effective for establishing the displaceability of the end effector 440 with the object emplacement/removal tool 421. In some embodiments, for example, the displacement of the end effector 440, relative to the object emplacement/removal tool 421, along the second axis, is prevented.

In some embodiments, for example, extension or retraction of the object emplacement/removal tool 421 is based on a corresponding extension or retraction of the extendible arm 432.

In some embodiments, for example, the extendible arm 432 and the end effector are co-operatively configurable such that the extendible arm 432 is displaceable, relative to the base 302, and along a first axis 790, such that displacement of the extendible arm 432, relative to the base 302, and along a first axis 790, is obtainable, and the displacement of the extendible arm 432, relative to the base 302, and along a first axis 790, is obtainable in absence of displacement of the end effector 440, relative to the base 302, and along the first axis 790, such that the displacement of the object emplacement/removal tool 421, relative to the base 302, and along a first axis 790, is obtainable in response to the displacement of the extendible arm 432, relative to the base 302, and along a first axis 790.

In some embodiments, for example, the extendible arm 432 and the driver 450 are co-operatively configurable with effect that: (i) the driver 450 is displaceable with the extendible arm 432, relative to the base 302, and along the first axis 790, in response to the displacement of the extendible arm 432, relative to the base 302, and along a first axis 790, such that displacement of the driver 450, relative to the base 302, and along a first axis 790, is obtainable, and the displacement of the driver 450, relative to the base 302, and along a first axis 790, is obtainable in absence of displacement of the end effector 440, relative to the base 302, and along the first axis 790; such that the driver 450 is displaceable, with the extendible arm 432, relative to the base 302, and along the first axis 790, during transitioning of the object manipulator between the alignment ineffective configuration and the alignment effective configuration, and (ii) the driver 450 is displaceable with the extendible arm 432, relative to the base 302, and along the second axis 792, in response to the extension or the retraction of the extendible arm 432, relative to the base 302, such that the driver 450 is displaceable, in response to the extension or the retraction of the extendible arm 432, relative to the base 302, during transitioning of the object manipulator 430 between the alignment effective configuration and the object emplacement/removal effective configuration.

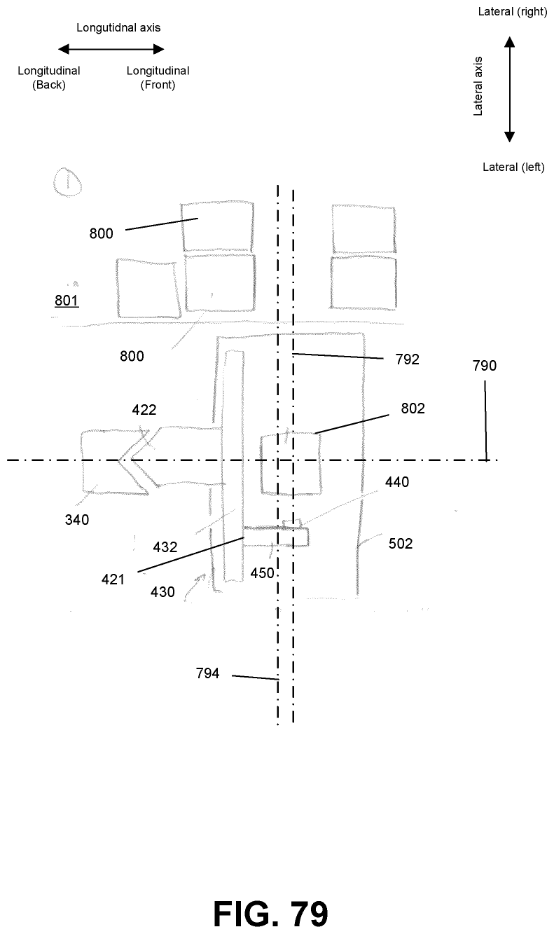

In some embodiments, for example, the extendible arm 432 and the driver 450 are co-operatively configurable with effect that the driver 450 is displaceable, relative to the base 302, independently of the extendible arm 432, and along a third axis 794 (in some embodiments, for example, a lateral axis), such that displacement of the driver 450, relative to the base 302, and along the third axis 794 is obtainable, and such that the object manipulator 430 is transitionable between an object distribution ready configuration, as depicted in FIG. 79, and the alignment ineffective configuration in response to the displacement of the driver 450, relative to the extendible arm 432, and along the third axis 794.

In some embodiments, for example, the end effector 440 is coupled to, for example, mounted to, the driver 450.

In some embodiments, for example, the end effector 440 and the driver 450 are co-operatively configurable with effect that: (i) the end effector 440 is displaceable with the driver 450, relative to the base 302, and along the third axis 794, in response to the displacement of the driver 450, relative to the base 302, and along a third axis 794, (ii) the obtainability of the displacement of the driver 450, relative to the base 302, and along a first axis 790, in the absence of displacement of the end effector 440, relative to the base 302, and along the first axis 790, is established, and (iii) the end effector 440 is displaceable with the driver 450, relative to the base 302, and along the second axis 792, in response to the extension or the retraction of the extendible arm 432, relative to the base 302.

In some embodiments, for example, as depicted in FIG. 77 and FIG. 78, the absence of displacement of the end effector 440, relative to the base 302, and along the first axis 790, while the object emplacement/removal tool 421, which includes the extendible arm 432 and the driver 450, is displaced, relative to the base 302, and along the first axis 790, is effected by displacement of the end effector 440, relative to the driver 450, and along the first axis 790 in a direction that is opposite the direction of displacement of the object emplacement/removal tool 421, relative to the base 302, and along the first axis 790.

In some embodiments, for example, while the object emplacement/removal tool 421 is displaced, relative to the base 302, and along the first axis 790, in a first direction, for example, a forward direction, the end effector 440 is displaced, relative to the driver 450, along the first axis 790 in a second direction that is opposite the first direction, for example, a rearward direction. In some embodiments, for example, the magnitude of the displacement of the object emplacement/removal tool 421, relative to the base 302, and along the first axis 790, in a first direction, is the same as the magnitude of the displacement of the end effector 440, relative to the driver 450, along the first axis 790, in the second direction. In some embodiments, for example, said displacement of the end effector 440, relative to the driver 450, is effectible via the actuator configuration 480.

In some embodiments, for example, (i) the displacement of the object emplacement/removal tool 421 is displaced, relative to the base 302, and along the first axis 790, in the first direction, and (ii) the displacement of the end effector 440, relative to the driver 450, along the first axis 790, in the second direction, occurs simultaneously.

In some embodiments, for example, the third axis 794 is disposed parallel to an axis that is transverse to the first axis 790. In some embodiments, for example, the axis, that is transverse to the first axis 790, and to which the third axis 794 is disposed in parallel relationship, is perpendicular to the first axis 790. In some embodiments, for example, the third axis 794 is parallel to the second axis 792.

In some embodiments, for example, the extendible arm 432 and the driver 450 are further co-operatively configurable with effect that displacement of the driver 450, relative to the extendible arm 432, along the first axis 790 (in some embodiments, for example, along a longitudinal axis) is restricted (in some embodiments, for example, prevented), wherein the restriction of the displacement of the driver, relative to the extendible arm 432, along the first axis 790, is effective for establishing the displaceability of the driver 450 with the extendible arm 432 in response to displacement of the extendible arm 432, relative to the base 302, and along a first axis 790. In some embodiments, for example, the coupling of the driver 450 to the extendible arm 432, for example, to the terminal arm segment 438, (e.g. via the guides 780, and the looping of the remission component 776 around the rotatable components 778 of the motor 772) is such that displacement of the driver 450, relative to the extendible arm 432, along the first axis 790 (in some embodiments, for example, along a longitudinal axis) is restricted (in some embodiments, for example, prevented).

In some embodiments, for example, the coupling of the driver 450 to the extendible arm 432 (for example, to the terminal arm segment 438 of the extendible arm 432 wherein the extendible arm 432 is a telescoping arm) is such that the driver 450 is not longitudinally displaceable, relative to the extendible arm 432. Accordingly, while the extendible arm 432 is displaced along the first axis 790 (e.g. in a longitudinal direction), the driver 450 also is displaced along the first axis 790 with the extendible arm 432.

In some embodiments, for example, the extendible arm 432 and the driver 450 are further co-operatively configurable with effect that displacement of the driver 450, relative to the extendible arm 432, along the second axis 792 (in some embodiments, for example, along a lateral axis) is restricted (in some embodiments, for example, prevented), wherein the restriction of the displacement of the driver 450, relative to the object emplacement/removal tool 421, along the second axis 792, is effective for establishing the displaceability of the driver 450 with the extendible arm 432 in response to the extension or the retraction of the extendible arm 432.

In some embodiments, for example, the restriction, for example, prevention, of the displacement of the driver 450, relative to the extendible arm 432, along the second axis 792, is due to the friction between the rotatable components 778 of the prime mover 772 and the transmission component 776.

In some embodiments, for example, the restriction, for example, prevention, of the displacement of the driver 450, relative to the extendible arm 432, along the second axis 792, is effected by the application of a restriction force or prevention force by the prime mover 772 to the rotatable components 778, to restrict or prevent rotation of the rotatable components 778, such that the rotatable components 778 is not rotatable, relative to the transmission component 776.

In some embodiments, for example, the object supporter is configured to support the object and another object in a side by side configuration.

In some embodiments, for example, the robot 110 is configured for co-operation with a pre-existing object 800 and an object supporter 801, wherein the pre-existing object 800 is being supported by the object supporter 801, for emplacing a robot-manipulatable object 802, relative to the supported pre-existing object 800, such that the robot-manipulatable object 802 becomes supported by the object supporter in a side-by-side relationship with the pre-existing object 800.

In some embodiments, for example, the emplacing includes:
while the end effector 440 is disposed in the object distribution ready configuration, as depicted in FIG. 79, and grasping the robot-manipulatable object 802, such that a grasped robot-manipulatable object 802 is established, transitioning the object manipulator 430 to, in sequence, the alignment ineffective configuration, as depicted in Figure the alignment effective configuration, as depicted in FIG. 81, and the object emplacement/removal effective configuration, as depicted in FIG. 82; and
while the object manipulator 430 is disposed in the object emplacement/removal effective configuration, releasing the grasped robot-manipulatable object 802, with effect that the robot-manipulatable object 802 becomes supported on the object supporter in a side-by-side relationship with the supported pre-existing object 800.

In some embodiments, for example, the supported pre-existing object 800 is disposed such that:
while the object manipulator 430 is disposed in the alignment ineffective configuration, the supported pre-existing object 800 is effective for interfering with an extension of the extendible arm 432, and
while the object manipulator 430 is disposed in the alignment effective configuration, there is an absence of interference, by the supported pre-existing object 800, for interfering with an extension of the extendible arm 432.

In some embodiments, for example, the interference, to an extension of the extendible arm 432, by the supported pre-existing object 800, is with effect that the object manipulator 430 collides with the supported pre-existing object 800.

In some embodiments, for example, disposition of the supported pre-existing object 800 is such that, the emplacement of the robot manipulatable object 802, relative to the supported pre-existing object 800, such that the robot manipulatable object 802 is supported by the object supporter in a side-by-side relationship with the supported pre-existing object 800, the minimum spacing distance between opposing sides of the supported robot manipulatable object 802 and the supported pre-existing object 800 is less than two (2) inches.

In some embodiments, for example, the robot 110 is configured for co-operation with a target object (e.g. a robot manipulatable object 802 that has been emplaced on the object supporter 801), an adjacent object (e.g. a pre-existing object 800), and an object supporter 801 for removing the target object, wherein the target object and the adjacent object are being supported by the object supporter 801 and disposed in a side-by-side relationship, wherein the removing includes:
while the object manipulator 430 is disposed in the object emplacement/removal effective configuration, grasping the target object with the end effector 440, such that a grasped robot-manipulatable object is established;
while the object manipulator 430 is disposed in the object emplacement/removal effective configuration and the end effector 440 is grasping the target object, transitioning the object manipulator 430 to, in sequence, the alignment effective configuration, the alignment ineffective configuration, and the object distribution ready configuration;
wherein:
while the object manipulator 430 is disposed in the alignment effective configuration, the co-operative disposition of the extendible arm 432 and the grasped robot-manipulatable object is effective for interfering with the displacement of the driver 450, relative to the base 302, and along the third axis 794; and
while the object manipulator 430 is disposed in the alignment ineffective configuration, the extendible arm 432 and the grasped robot-manipulatable object are co-operatively disposed such that there is an absence of interference to the displacement of the driver 450, relative to the base 302, and along the third axis 794.

In some embodiments, for example, the minimum spacing distance between opposing sides of the target object and the adjacent object is less than two (2) inches.

In some embodiments, for example, the object manipulator 430, which includes the object emplacement/removal tool 421 and the end effector 440, is coupled to the housing 422 such that the displacement of the object manipulator 430, along the first axis 790, for example, the longitudinal axis, relative to the base 302, is effectible.

As depicted in FIG. 77 and FIG. 78, the object manipulator 430, in particular, the base arm segment 434 of the extendible arm 432 of the object manipulator 430, is coupled to a vertical displacement mechanism 920 (which, as described greater detail below, is configured to vertically displace the object manipulator 430, relative to the robot-defined object supporter 502, wherein said vertical displacement is independent of the vertical displacement of the object manipulator 430 effectible by the lift mechanism 340), and the vertical displacement mechanism 920 is coupled to blocks 810, which is operably coupled to the housing 422.

In some embodiments, for example, the coupling of the object manipulator 430 to the vertical displacement mechanism 920 is such that the extendible arm 432 is longitudinally displaceable with the vertical displacement mechanism 920. In some embodiments, for example, the coupling of the vertical displacement mechanism 920 to the blocks 810 is such that the vertical displacement mechanism 920 is longitudinally displaceable with the blocks 810. In some embodiments, for example, the coupling of the blocks 810 to the housing 422 is such that the blocks 810 are longitudinally displaceable, relative to the housing 422. Accordingly, while the blocks 810 are longitudinally displaced, relative to the housing 422, the coupling of vertical displacement mechanism 920 to the blocks 810, and the coupling of the extendible arm 432 to the vertical displacement mechanism 920, is such that the vertical displacement mechanism 920 and the extendible arm 432 are longitudinally displaced, relative to the housing 422.

In some embodiments, for example the object transitioning apparatus 420 includes an actuator configuration 820 to effect the longitudinal displacement of the blocks 810, relative to the housing 422.

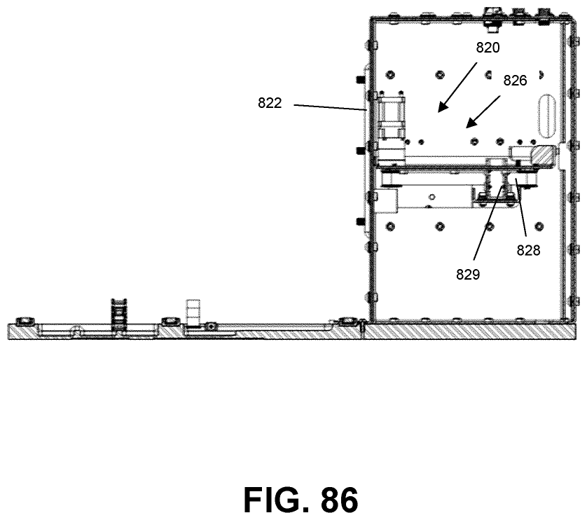

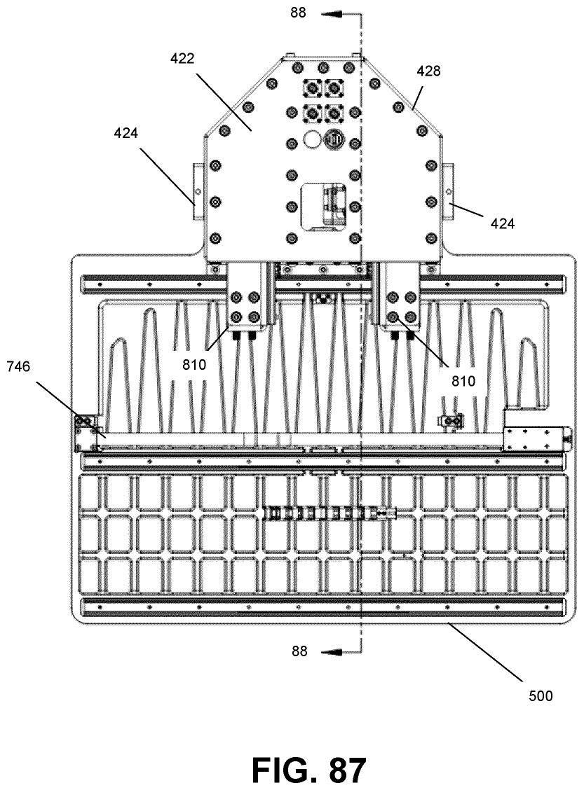

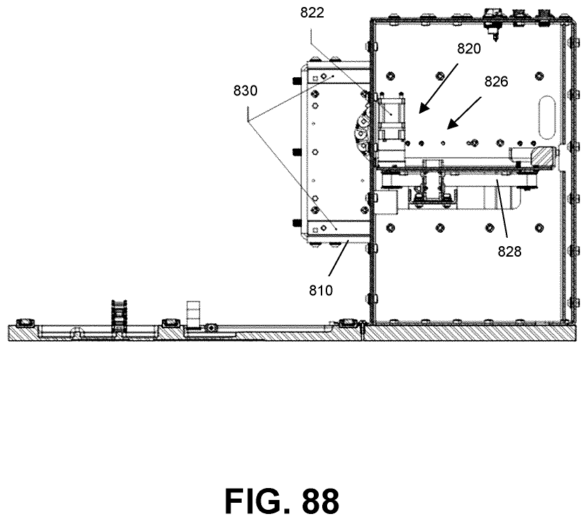

In some embodiments, for example, the actuator configuration 820 includes a prime mover 822, for example, a motor, for example, an electric motor, that is disposed in operable communication with the blocks 810. In some embodiments, for example, as depicted in FIG. 86 and FIG. 88, the prime mover 822 is mounted to the housing 422. The prime mover 822 is configured to generate a displacement force that is applicable to the blocks 810 for longitudinally displacing the blocks 810, relative to the housing 422. In response to application of the displacement force from the prime mover 822 to the blocks 810, the blocks 810 are longitudinally displaced, relative to the housing 422.

In some embodiments, for example, the prime mover 822 is configurable in a first direction displacement drive state and a second direction displacement drive state. In some embodiments, for example, while the prime mover 822 is disposed in the first direction displacement drive state, the displacement force applied to the drive blocks 810 has first direction, for example, the forward direction, such that the drive blocks 810 are displaced in the first direction, relative to the housing 422, and along the longitudinal axis, in response to application of the displacement force to the blocks 810. In some embodiments, for example, while the prime mover 822 is disposed in the second direction displacement drive state, the displacement force applied to the blocks 810 has a second direction that is opposite the first direction, for example, the rearward direction, such that the blocks 810 is displaced in the second direction, relative to the housing 422, and along the longitudinal axis, in response to application of the displacement force to the blocks 810.

In some embodiments, for example, the prime mover 822 is disposed in data communication with the controller 202 and further disposed in electrical communication with the battery, for example, via electrical and data cable 824, which is disposed in electrical and data communication with the electrical and data connectors 428, for actuation of the prime mover 822 in the first direction displacement drive state and the second direction displacement drive state, via control commands from the controller 202. While the cables 390 and 392 are disposed in electrical and data communication with the electrical and data connectors 428, the prime mover 822 is disposed in data communication with the controller 202 and also disposed in electrical communication with the battery of the robot 110.

In some embodiments, for example, the actuator configuration 820 includes a transmission configuration 826 to effect the operable communication between the prime mover 822 and the blocks 810. The transmission configuration 826 is disposed in the housing 422. In some embodiments, for example, the transmission configuration 826 includes a transmission component 828, for example, a drive belt, a chain, a cable and the like, and block connectors 829, for example, plates that are connected to the blocks 810, for example, via mechanical fasteners. The prime mover 822 is disposed in operable communication with the blocks 810 via the transmission component 828 and the block connectors 829, such that the displacement force generated by the prime mover 822 is applied to the blocks 810 via the transmission component 828 and the block connectors 829. The displacement force generated by the prime mover 822 is transferable to the blocks 810 via the transmission component 828 and the block connectors 829. In response to application of the displacement force by the prime mover 822 to the blocks 810, the blocks 810 are longitudinally displaced, relative to the housing 422.

In some embodiments, for example, while the vertical displacement mechanism 920 is connected to the blocks 810, and while the object manipulator 430 is connected to the vertical displacement mechanism 920, in response to application of the displacement force by the prime mover 822 to the blocks 810, the object manipulator 430 is longitudinally displaced, relative to the housing 422.

In some embodiments, for example, the longitudinal displacement of the blocks 810, relative to the housing 422, is also a longitudinal displacement of the blocks 810, relative to the base 302, for example, while the object transitioning apparatus 420 is coupled to the base 302 via the lift mechanism 340.

In some embodiments, for example, the longitudinal displacement of the object manipulator 430, relative to the housing 422, is also a longitudinal displacement of the object manipulator 430, relative to the base 302, for example, while the object transitioning apparatus 420 is coupled to the base 302 via the lift mechanism 340.

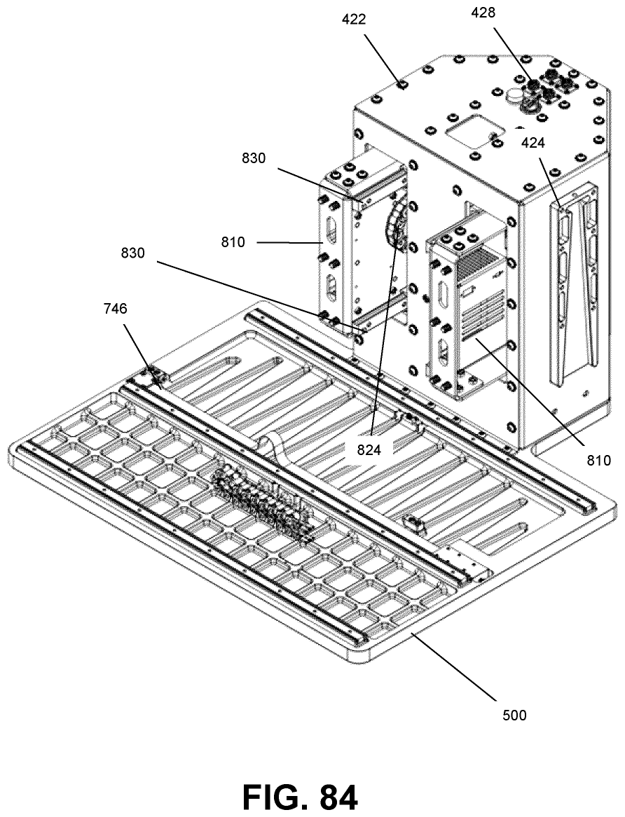

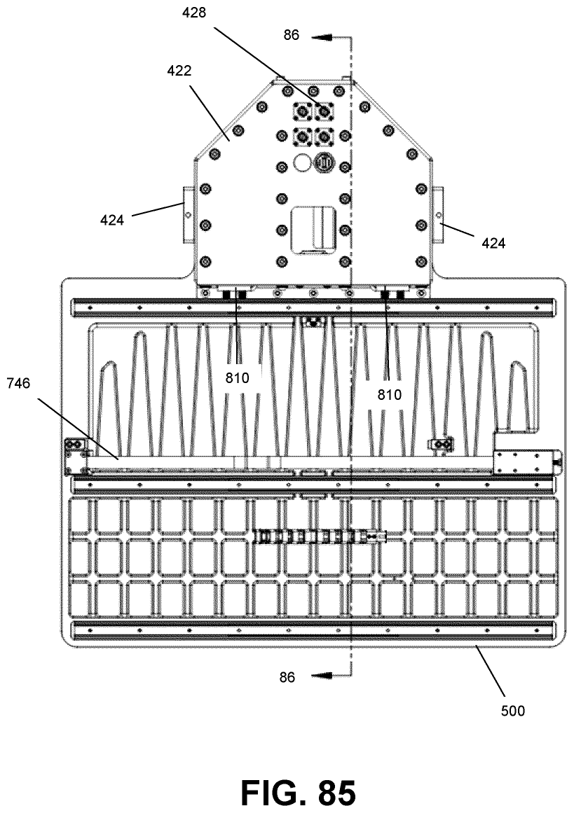

In some embodiments, for example, as depicted in FIG. 84, the object transitioning apparatus 420 includes guides 830, for example, guide tracks, that are mounted to the blocks 810, for guiding the longitudinal displacement of the guide blocks 810, relative to the housing 310.

In some embodiments, for example, the blocks 810 are configurable in a retracted configuration, as depicted in FIG. 83, and an extended configuration, as depicted in FIG. 84. While the blocks 810 are disposed in the retracted configuration, the blocks 810 are retracted into the housing 422. While the blocks 810 are disposed in the extended configuration, at least a portion of the blocks 810 are longitudinally extended, relative to the housing 422.

In some embodiments, for example, the housing 422 is configured to be sufficiently large for disposition of the blocks 810 within the housing 422 while the blocks 810 are configured in the retracted configuration. In some embodiments, for example, by increasing the size of the housing 422, in particular, by increasing the size of the cross-section of the housing 422 taken along the vertical axis, the moment of inertia taken along the vertical axis is increased, which increases the rigidity of the housing 422 to resist against torque applied to the housing 422, for example, from reaction force due to friction applied to a grasped object being moved by the object manipulator 430.

In some embodiments, for example, the ability of the object manipulator 430 to transition between the alignment ineffective configuration and the alignment effective configuration, while removing an object from an object supporter or emplacing an object on the object supporter, allows the objects on the object supporter to be placed closer together. In some embodiments, for example, the minimum spacing distance between opposing sides of the target object and the adjacent object is less than two (2) inches. Without the ability for the object manipulator 430 to transition between the alignment ineffective configuration and the alignment effective configuration, the objects on the object supporter may have to be spaced further apart to defeat: (i) the interference of the extension of the extendible arm 432 by the supported pre-existing object, and (ii) the interference of the displacement of the driver 450, relative to the base, by the grasped robot manipulatable object. In some embodiments, for example, the ability of the object manipulator 430 to transition between the alignment ineffective configuration and the alignment effective configuration allows more objects to be stored on the object supporter, which more efficiently uses the supporting surface of the object supporter and also increases the space efficiency of the site 102.

In operation, the controller 202 receives a command from a client computing device 120 via the server 114 to retrieve a target object 900 from an object supporter in a target area of the warehouse, and move the object to a desired location of the warehouse, such as a loading zone 112.

Based on the data representative of the target area of the warehouse in which the object is located, the controller 202 determines a path to the target area from the current location of the robot 110, and the robot 110 moves to the target area. While moving to the target area, the robot 110 detects nearby objects via the optical sensors 490 and proximity sensors to avoid collision.

As the robot 110 enters the target area, the optical sensors 490 collect data representative of: (i) the dimension of the objects on the object supporters, including the dimension of the surface of the objects facing the optical sensors 490, and (ii) the labels on the objects. In some embodiments, for example, the robot 110 turns on one or more of its lighting components, such as one or more LED lights, for illuminating the field of view (FOV) of the optical sensors 490.

In some embodiments, for example, the object transitioning apparatus 420 is vertically displaced, for example, elevated, relative to the base 302, such that objects disposed at object supporters of higher elevation become disposed within the field of view of the optical sensors 490. In some embodiments, for example, the telescoping arm is laterally extended, relative to the base 302, for example, to the left or right direction, such that objects disposed in deeper portions of the object supporters become within the field of view of the optical sensors 490. In some embodiments, for example, the driver 450 is laterally displaced, relative to the telescoping arm, and relative to the base 302, for example, to the left or right direction, such that objects disposed in deeper portions of the object supporters become within the field of view of the optical sensors 490.

In some embodiments, for example, based on the data from the optical sensors 490, the controller 202 defines a bounding box 904 around the objects 900, for example, via a suitable algorithm such as a single-shot detector (SSD) algorithm. In some embodiments, for example, the controller 202, for example, the Al engine 224, defines a bounding box 906 around the labels of the objects 900.

Based on the data collected by the optical sensors 490 representative of the labels on the objects, the controller 202, for example, the Al engine 224, identifies each of the objects, and determines that one of the identified objects is the target object 900. As depicted, the target object 900 is disposed on the right side of the robot 110.

After identifying the target object 900, based on the data collected by the optical sensors 490 representative of the dimensions of the object 900, the controller 202, for example, the Al engine 224, determines the dimensions of the object 900, the distance between the object 900 and the object manipulator 430, the relative position of the object 900 and the object manipulator 430,

Based on the bounding box 904, the controller 202 determines a desirable surface portion of the object 900, for example, the center of the surface of the object 900 facing the optical sensors 490, for grasping by the grasping configuration 460 of the end effector 440, for example, suction cups 462.

Based on the position of the robot 110, in particular, the object manipulator 430, relative to the object 900, the controller 202 determines: (i) the vertical displacement of the object transitioning apparatus 420, relative to the base 302, for positioning the robot-defined object supporter 502 at the same elevation as the object supporter on which the object 900 is supported; (ii) the lateral displacement of the telescoping arm, relative to the base 302, and the lateral displacement of the driver 450, relative to the telescoping arm, to laterally displace the end effector 440 for grasping the object; (iii) the longitudinal displacement of the object emplacement/removal tool 421, relative to the base 302, in the first direction, and the longitudinal displacement of suction cups 462, in the second direction opposite the first direction, to effect the extension of the telescoping arm without colliding with a pre-existing object 902 on the object supporter; (iv) the longitudinal displacement and vertical displacement of the suction cups 462, relative to the driver 450, for grasping the desirable surface portion of the object 900. Based on said determinations by the controller 202, the position of the robot 110, relative to the object 900, can be adjusted, via movement of the robot 110, relative to the object 900, by the base 302, such that the object 900 is graspable by the object manipulator 430.

At this point, the robot 110 is anchored to the floor of the warehouse via the anchor configuration 510.

With the robot 110 anchored to the floor, the object transitioning apparatus 420 is vertically displaced, relative to the base 302, via the lift mechanism 340 such that the robot-defined object supporter 502 is disposed at the same elevation as the object supporter on which the object 900 is supported.

Based on the identification of the desirable surface portion of the object 900 for grasping by the suction cups 462, the longitudinal and vertical positions of the suction cups 462, relative to the driver 450, are adjusted, via longitudinal and vertical displacement of the suction cups 462, relative to the driver 450, by the actuator configuration 480 and the actuator configuration 470, respectively, such that the suction cups 462 are positioned, relative to the object 900, for grasping the desirable surface portion of the object 900.

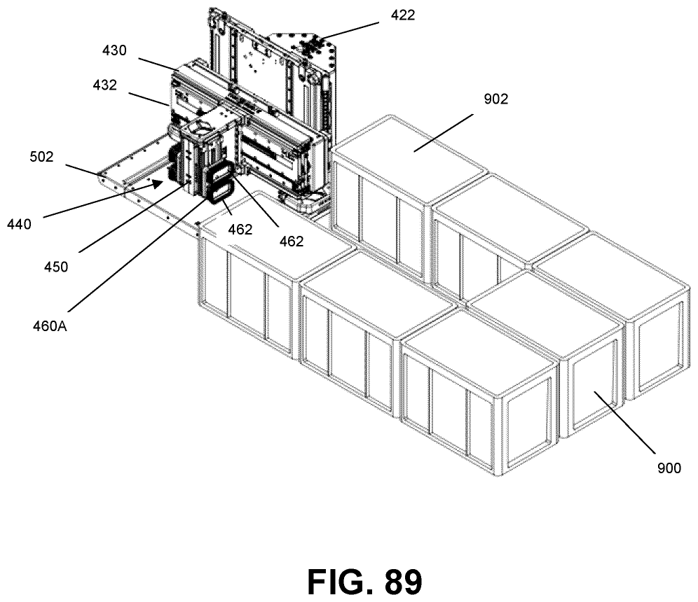

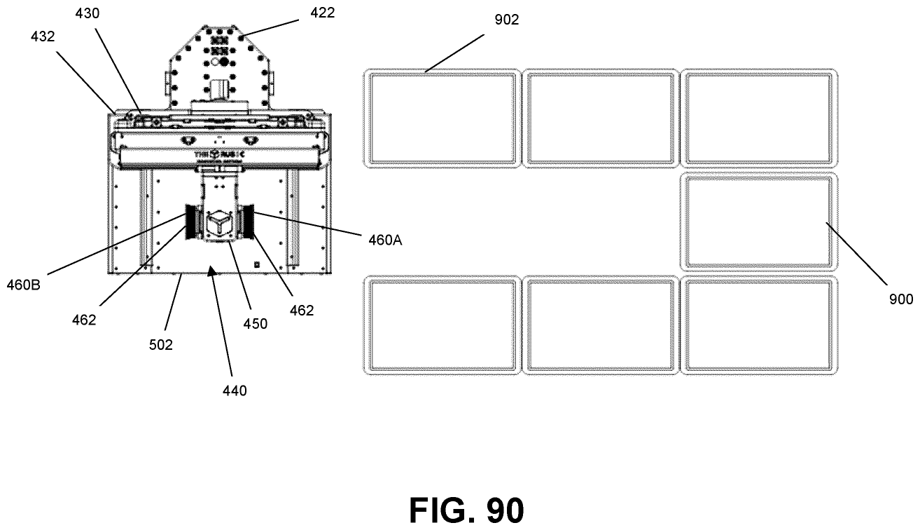

At this point, the object manipulator 439 is disposed in the object distribution ready configuration, as depicted in FIG. 89 to FIG. 91.

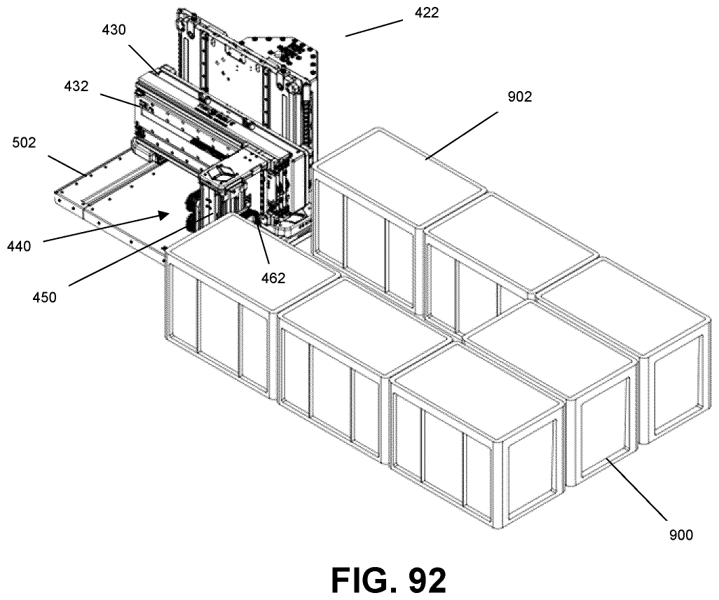

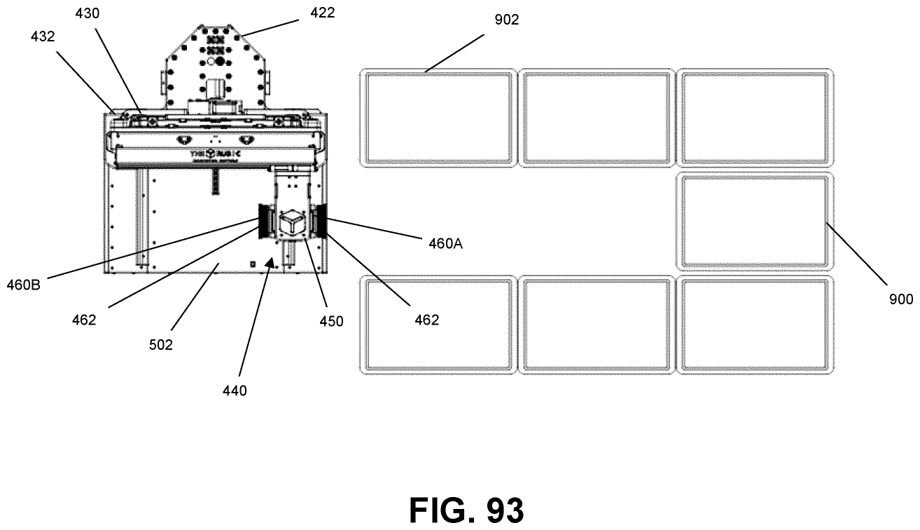

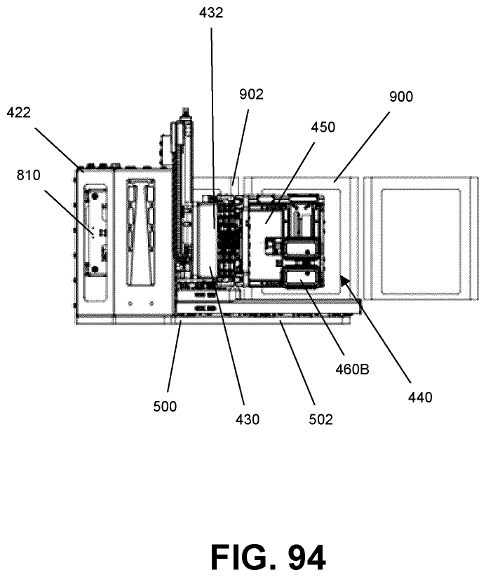

To grasp the object 900, in some embodiments, for example, the driver 450 is laterally displaced, in the right direction, relative to the terminal arm segment 438, until the driver 450 is disposed at the terminal right end of the terminal arm segment 438. At this point, the object manipulator 430 is disposed in the alignment ineffective configuration, as depicted in FIG. 92 to FIG. 94.

To clear the interference of the extension of the telescoping arm by the pre-existing object 902, the object emplacement/removal tool 421 is displaced longitudinally in a first direction (e.g. a forward direction), relative to the base 302, by the actuator configuration 820. In some embodiments, for example, the suction cups 462 are longitudinally displaced, in a second direction opposite the first direction, (e.g. a rearward direction) relative to the driver 450, by the actuator configuration 480, such that there is an absence of displacement of the suction cups 462, relative to the base 302, and such that the suction cups 462 continue to be disposed, relative to the object 900, for grasping the desirable surface portion of the object 900.

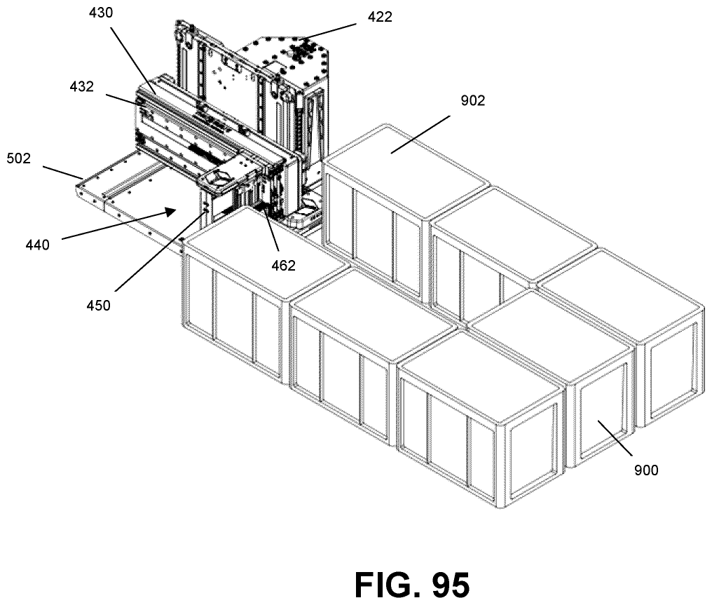

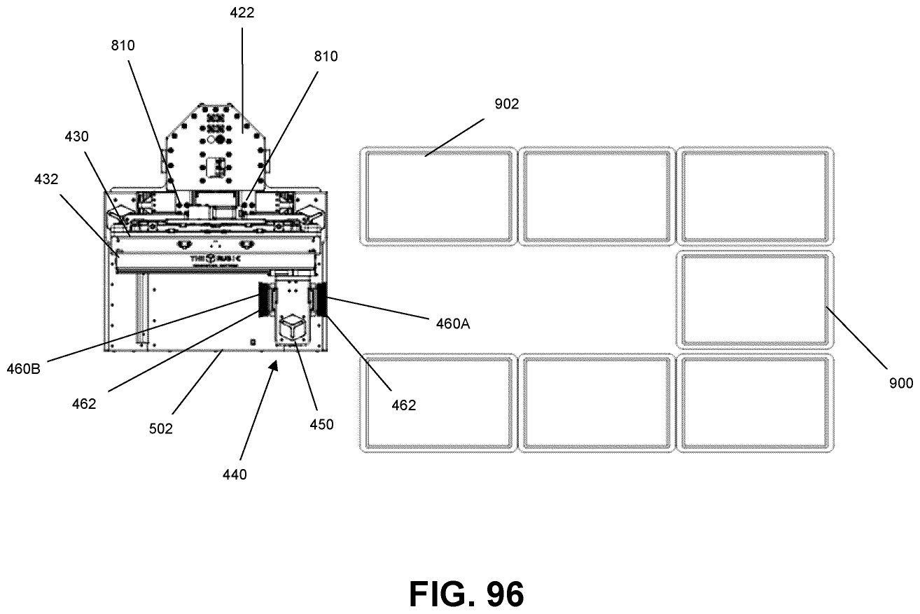

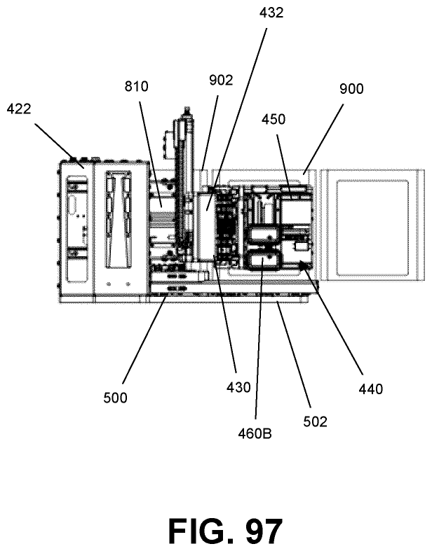

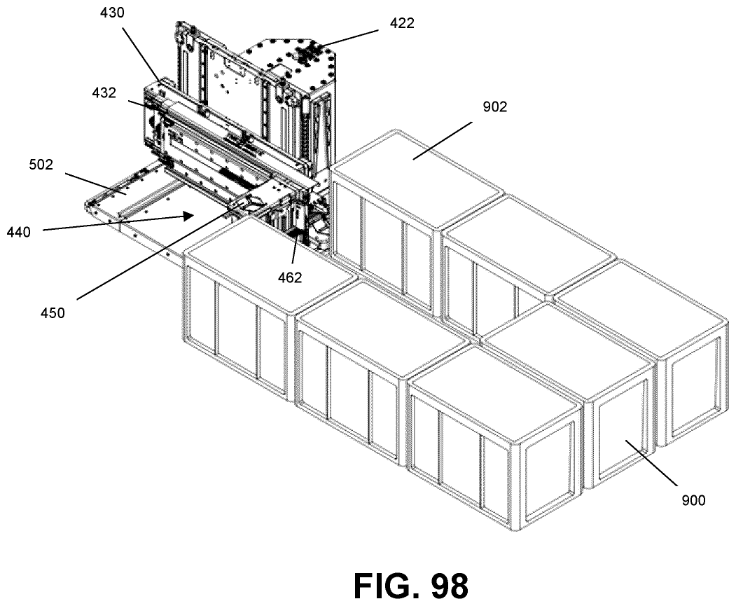

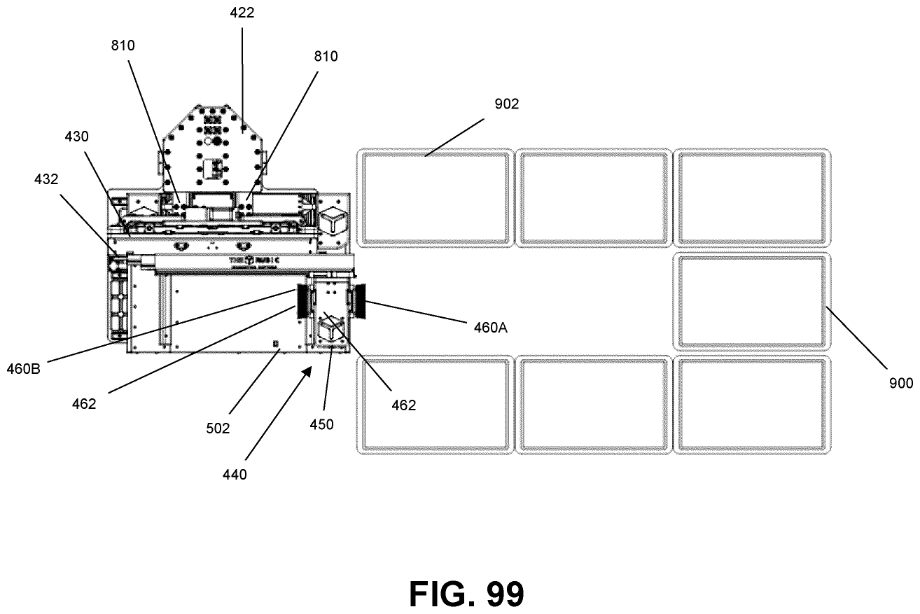

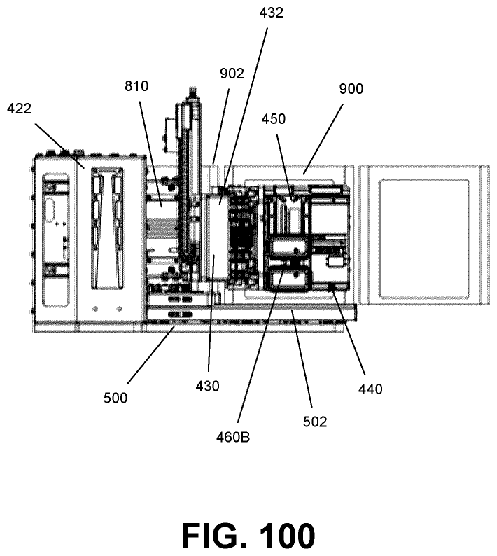

At this point, the object manipulator 430 is disposed in the alignment effective configuration, as depicted in FIG. 95 to FIG. 97. While the object manipulator 430 is disposed in the alignment effective configuration, the telescoping arm is laterally extendible towards the object 900, as depicted in FIG. 98 to FIG. 100.

In some embodiments, for example, the robot-defined object supporter 502 is displaced laterally, relative to the base 302, in the right direction, towards the object supporter on which the object 900 is supported, such that the minimum spacing distance between the robot-defined object supporter 502 and the object supporter is reduced.

At this point, the telescoping arm is laterally extended to displace the suction cups 462 towards the object 900. In some embodiments, for example, the lateral displacement of the driver 450, relative to the terminal arm segment 438, is restricted or prevented, such that the driver 450 and suction cups 462 are laterally displaced towards the object 900 via lateral extension of the telescoping arm.

In some embodiments, for example, the speed of the lateral extension of the telescoping arm is controlled based on object distance data collected from the optical sensors 490 and displacement transducers 498.

While the suction cups 462 becomes disposed within a threshold distance of the surface of the object, for example, within 2 inches, for example, 2.2 inches, the controller 202 sends a control command to the pump 464 and the valve block 466 to blow air out of the suction cups 462 to clean the surface of the object 900.

Then, the controller 202 sends a control command to the pump 464 to operate in an air suction mode to suction the air from the suction cups 462, for suctioning the surface of the object 900 by the suction cups 462. In some embodiments, for example, the controller 202 sends a control command to the valve block 466 to control which of the suction cups 462 is suctioning. In some embodiments, for example, based on the determination of the dimension of the object 900 by the controller 202, the controller 202 determines that some of the suction cups 462 is unable to become disposed in contact engagement with the surface of the object 900, and based on said determination, the controller 202 sends a control command to the valve block 466 such that only the suction cups 462 that are able to become disposed in contact engagement with the surface of the object 900 has suction.

While the telescoping arm and the suction cups 462 continue to extend towards the object 900, the controller 202 monitors the suction pressure via the vacuum sensors of the object manipulator 430, and also monitors the distance between the suction cups 462 and the object 900 via the optical sensors 490 and displacement transducers 498, to determine if one or more suction cups 462 are disposed in contact engagement with, and suctioning, the object 900. In some embodiments, for example, an increase in suction pressure, for example, to a threshold pressure, at a suction cup 462 is indicative of the suction cup 462 becoming disposed in contact engagement with the object 900 and suctioning the object 900. In some embodiments, for example, the disposition of a suction cup 462 within a threshold distance of the object 900, is indicative of the suction cup 462 becoming disposed in contact engagement with the object 900.

In response to determination by the controller 202 that the suction cups 462 are suctioning the object 900, the lateral extension of the telescoping arm is stopped.

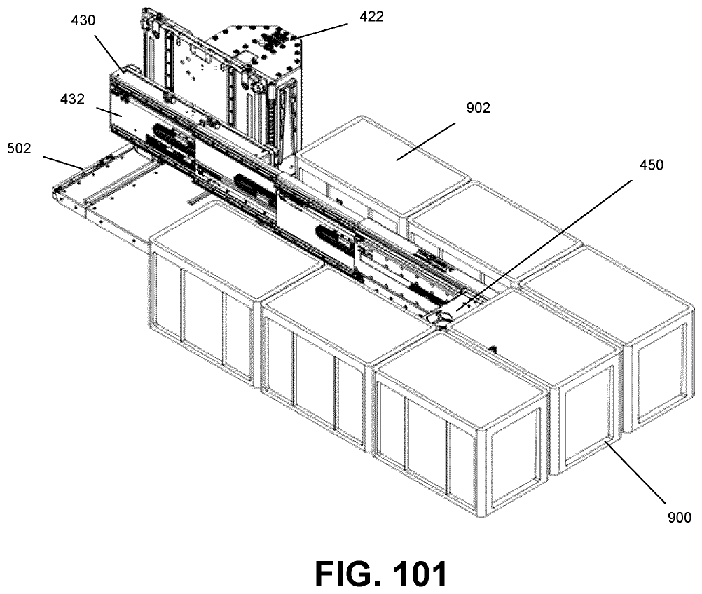

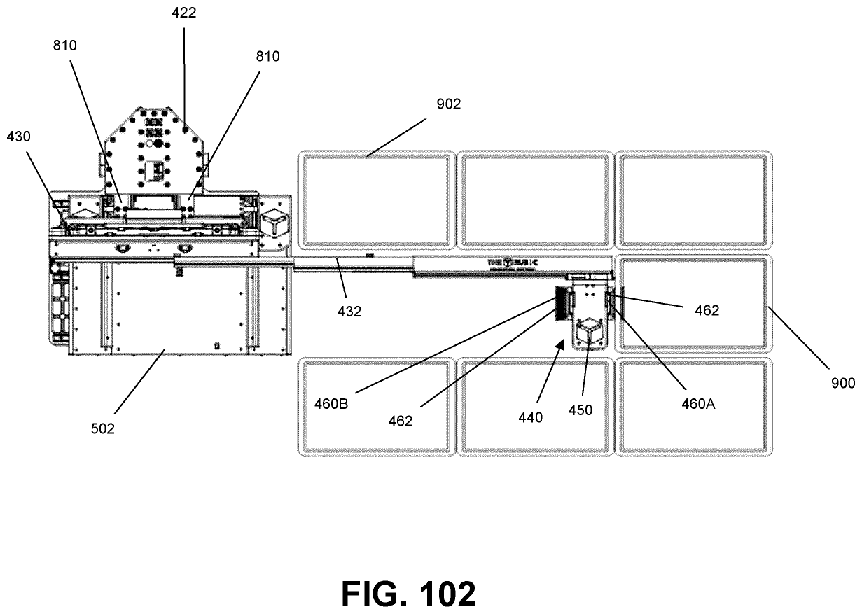

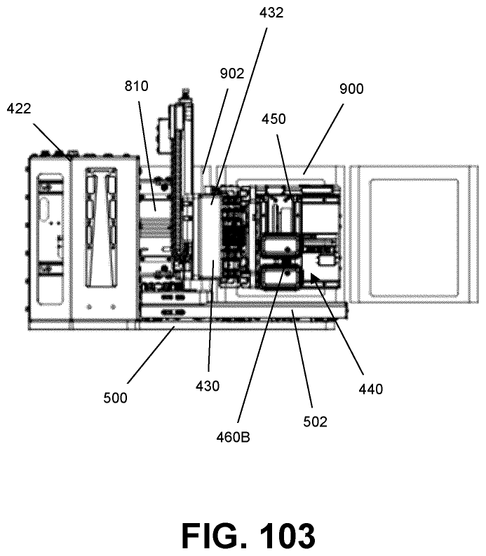

At this point, the object manipulator 430 is disposed in the object emplacement/removal effective configuration, as depicted in FIG. 101 to FIG. 103.

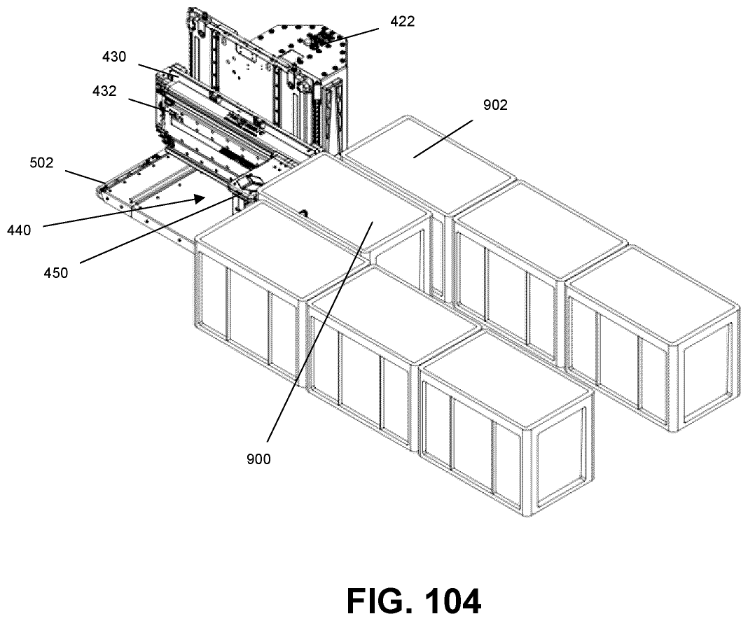

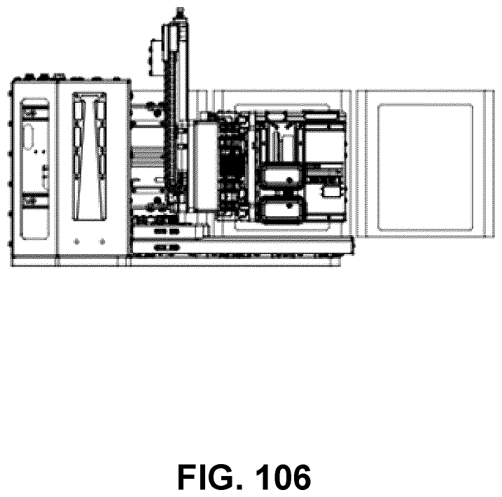

With the object 900 grasped by the suction cups 462, the telescoping arm is retracted to transition the object manipulator 430 from the object emplacement/removal effective configuration to the alignment effective configuration, as depicted in FIG. 104 to FIG. 106.

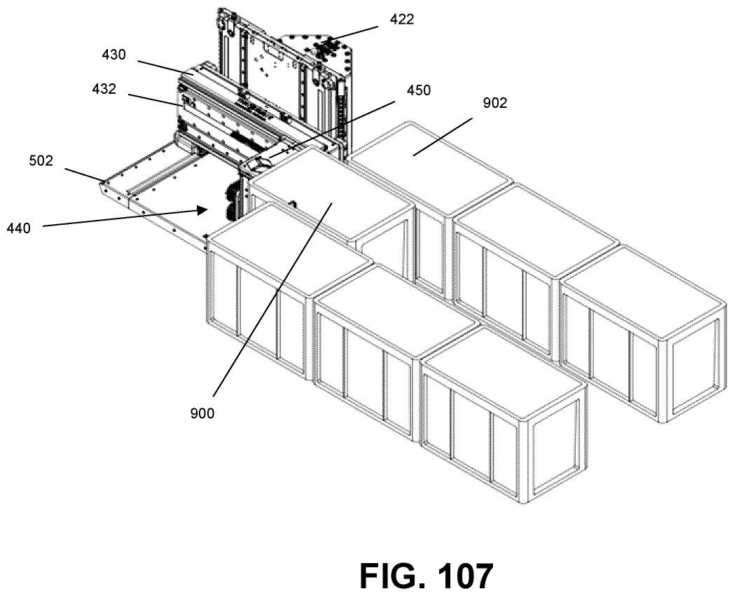

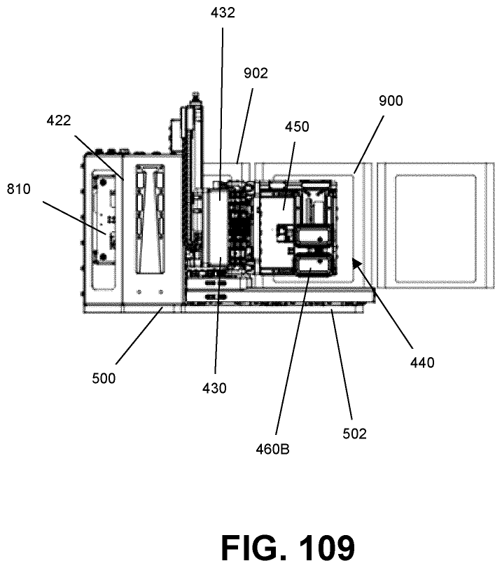

Then, the object emplacement/removal tool 421 is longitudinally displaced, in the second direction (e.g. rearward direction), by the actuator configuration 820, and the suction cups 462 are longitudinally displaced in first direction (e.g. a forward direction), relative to the driver 450, by the actuator configuration 480, to transition the object manipulator 430 from the alignment effective configuration to the alignment ineffective configuration, as depicted in FIG. 107 to FIG. 109. In some embodiments, for example, the longitudinal displacement of the object emplacement/removal tool 421 in the second direction and the longitudinal displacement of the suction cups 462 in the first direction occurs simultaneously, such that there is an absence of longitudinal displacement of the suction cups 462, relative to the base 302, and such that there is an absence of longitudinal displacement of the object 900, relative to the base 302, while the object 900 is grasped by the suction cups 462. In some embodiments, for example, such longitudinal displacement of the object 900, relative to the base 302, may effect collision of the object 900 with a pre-existing object on the object supporter.

As depicted, while the object manipulator 430 is disposed in the alignment ineffective configuration, there is an absence of interference of lateral displacement of the object 900 towards the robot-defined object supporter 502 by the telescoping arm.

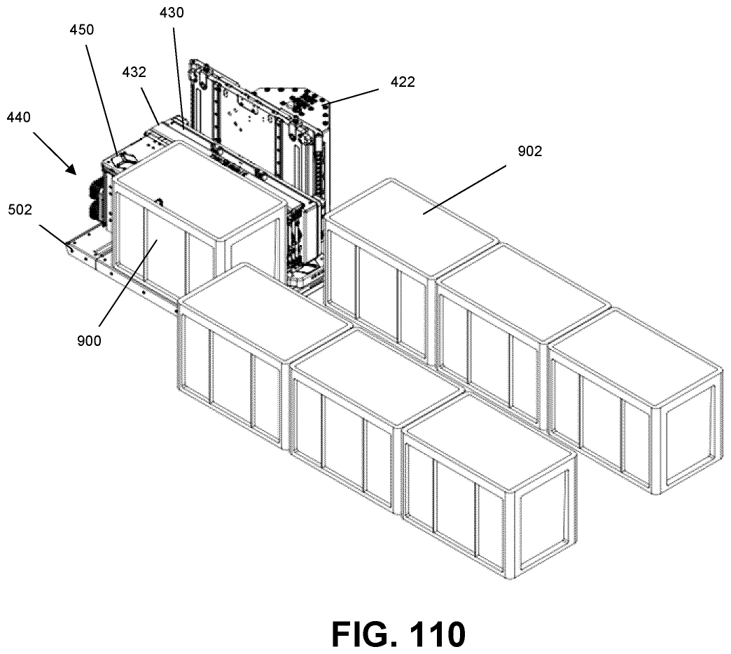

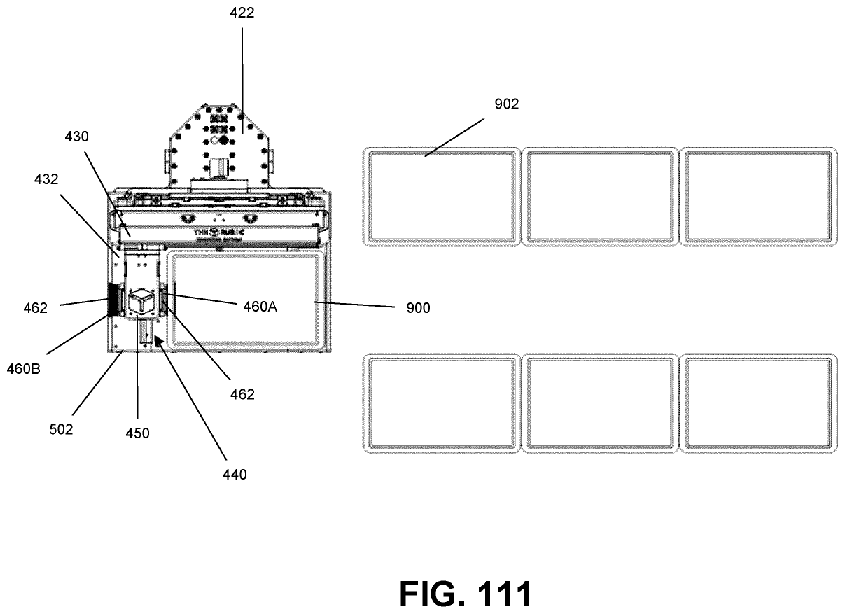

At this point, the telescoping arm is further laterally retracted, and the driver 450 is laterally displaced, in the second direction, for example, the left direction, to emplace the object on the robot defined object supporter 502, as depicted in FIG. 110 to FIG. 112. The lateral displacement of the object 900 is facilitated by the reduction in minimum spacing between the robot defined object supporter 502 and the object supporter.

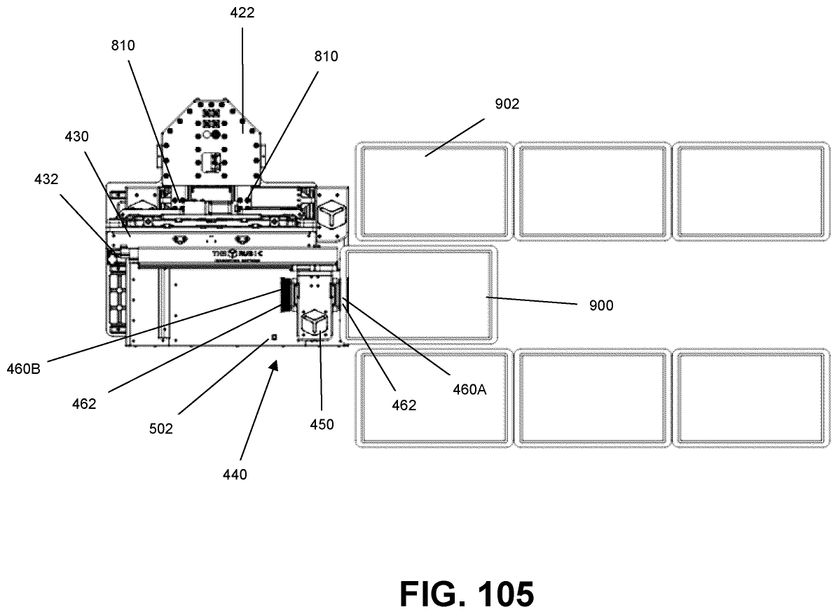

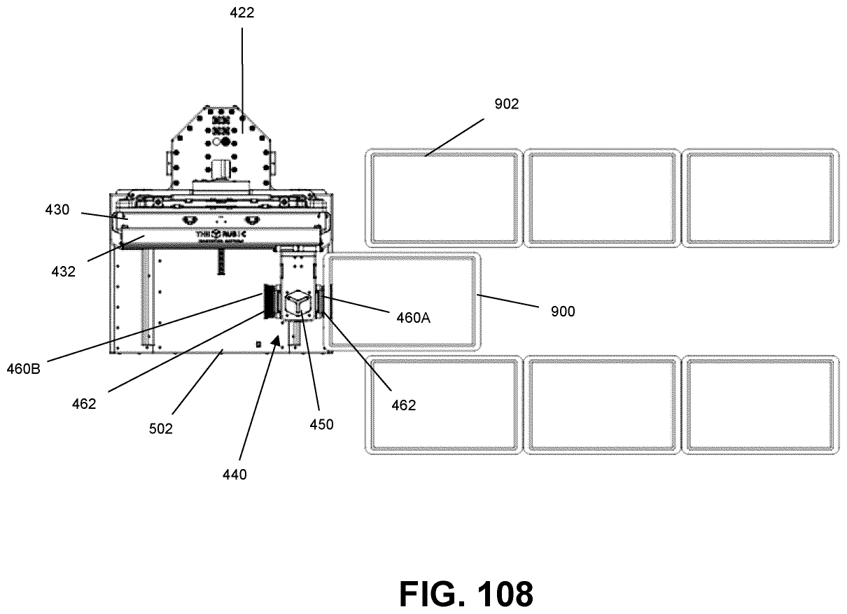

In some embodiments, for example, as the object 900 is being laterally displaced from the object supporter to the robot-defined object supporter 502 for emplacement of the object on the robot-defined object supporter 502, the robot-defined object supporter 502 is laterally displaced to the retracted configuration, as depicted in FIG. 105 and FIG. 108.

In some embodiments, for example, the controller 202 monitors the suction pressure as the telescoping arm is being retracted. If the suction pressure of a suction cup 462 is reduced, for example, suddenly reduced (e.g., lower than a predefined pressure threshold), the controller 202 adjusts the suction pressures of other suction cup(s) to maintain a suitable grasping force applied to the object 900.

In some embodiments, for example, controller 202 monitors the resistance to the lateral retraction of the telescoping arm, which is indicative of interference to lateral displacement of the object 900 towards the robot-defined object supporter 502 (e.g. the object 900 is stuck). In some embodiments, for example, wherein there is interference to the lateral displacement of the object 900 towards the robot defined object supporter 502, the controller 202 sends a control command to the actuator configuration 480 and the actuator configuration 470 to effect minor vertical and longitudinal displacement of the suction cups 462 and the object 900 to overcome the interference. In some embodiments, the controller 202 further sends a control command to the actuator 820 to effect minor longitudinal displacement of the object emplacement/removal tool 421 to overcome the interference.

With the object emplaced on the robot defined object supporter 502, the controller 202 sends a control command to the pump 464 to turn off the pump 464, such that there is an absence of suction at the suction cups 462. This effects the release of the grasping of the object 900 by the suction cups 462, with effect that the object 900 becomes supported by the robot-defined object supporter 502.

With the object 900 supported by the robot-defined object supporter 502, the lift mechanism 340 becomes disposed to the retracted configuration.

At this point, the controller 202 sends a control command to the anchoring configuration 510 to dispose the anchoring configuration 510 in the anchoring-ineffective state, and the base 302 moves the robot 110 to a desired location of the warehouse to move the object 900 to said desired location of the warehouse, such as a loading zone.

As depicted in FIG. 89, the target object 900 to be retrieved is disposed to the right of the robot 110. In some embodiments, for example, the target object 900 to be retrieved can be disposed to the left of the robot 110 and can be retrieved by the robot 110 in a similar manner

In some embodiments, for example, the controller 202 receives a control command from a client computing device 120 via the server 114 to store a target object 900 on an object supporter in a target area of the warehouse.

In some embodiments, for example, the server computer 114 determines the target area in the warehouse based on, for example, the inventory rules, and send the control command to the robot 110. In some embodiments, for example, the robot 110 grasps the target object 900 from a loading zone 112, for example, via the object manipulator 430, and is emplaced on the robot-defined object supporter 502, and the robot 110 moves the object 900 to the target area of the warehouse along a calculated path. In some embodiments, for example, the object 900 is placed on the robot-defined object supporter 502 by an operator.

While the object 900 is supported on the robot-defined object supporter 502, the optical sensors 490 collect data representative of the shape and dimensions of the object 900, including the shape and dimensions of the surface of the object that is 900 opposing the optical sensors 490.

As the robot 110 enters the target area, the optical sensors 490 collect data representative of the object supporters, the objects on the supporters, and available storage space on the object supporters. In some embodiments, for example, the robot 110 turns on one or more of its lighting components, such as one or more LED lights, for illuminating the field of view (FOV) of the optical sensors 490.

Based on the data collected from the optical sensors 490, the controller 202, for example, the Al engine 224, identifies and locates the empty spaces 910, and defines a boundary box 912 around each of the empty spaces 910, using a suitable algorithm such as a SSD algorithm.

Based on the bounding box 912, the dimensions of each empty space 910 are determined by the controller 202, and compared with the dimensions of the object 900, for example, the dimension of the surface of the object 900 facing the optical sensors 490. The controller 202 identifies an empty space 910 that is able to receive the object 900, based on the comparison of the dimensions of the object 900 and the dimensions of the space 910. In response to identification of the suitable empty space 910 suitable for receiving the object 900, the object 900 is moved from the robot defined object supporter 502 to the object supporter, in particular, moved into the empty space 910, via a process similar (but reversed) to that described with respect to retrieving the object 900 from the object supporter disposed forwardly of the robot defined object supporter 502.

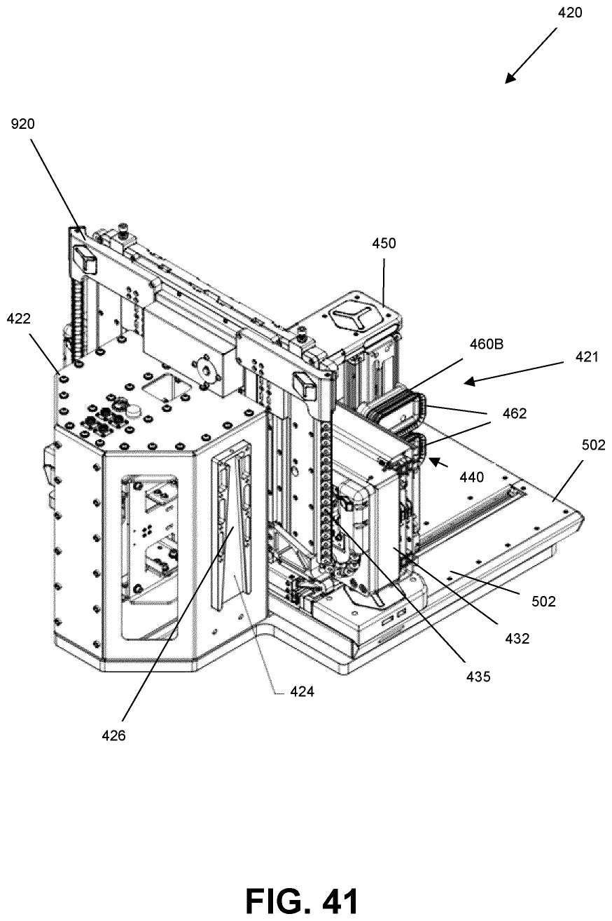

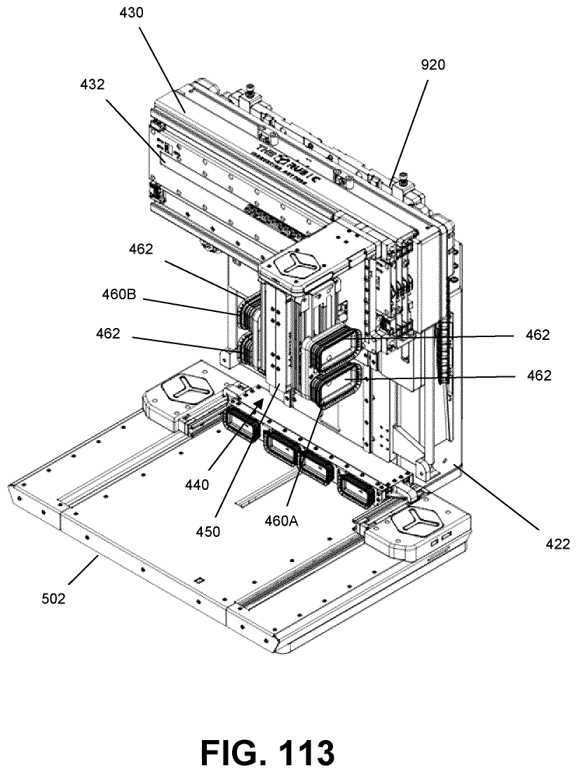

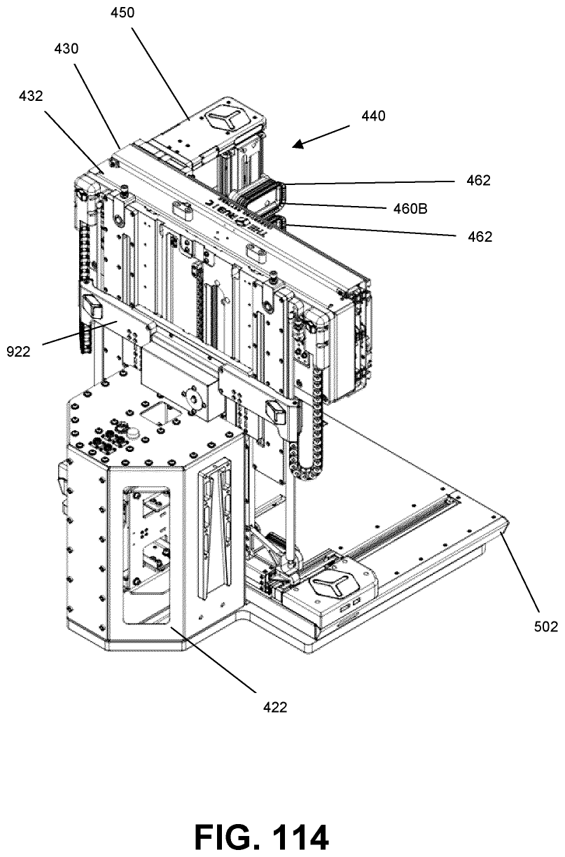

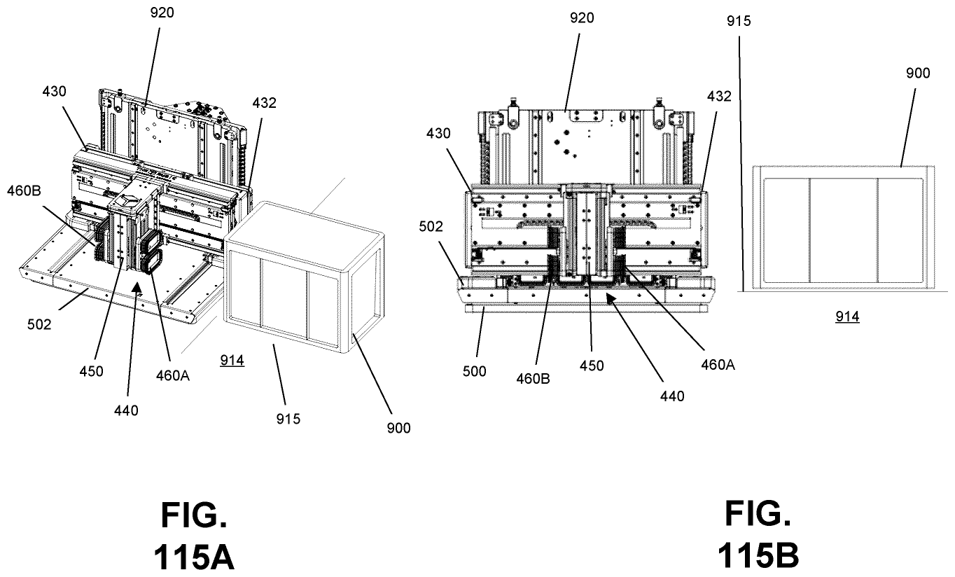

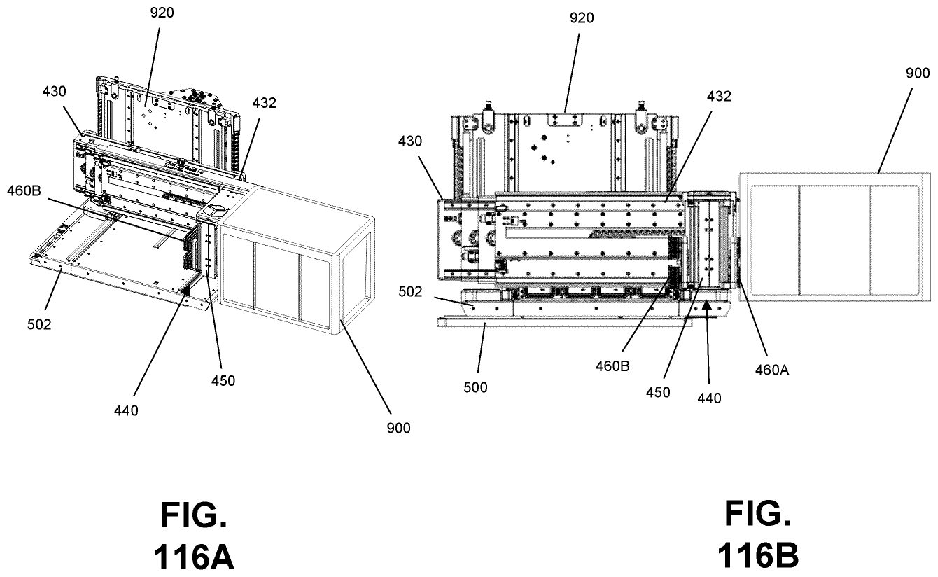

In some embodiments, for example, the object manipulator 430 is vertically displaceable, relative to the robot defined object supporter 502, as depicted in FIG. 113 and FIG. 114. In some embodiments, for example, as depicted in FIG. 40 and FIG. 41, the object manipulator 430 is disposed in a first vertical position, relative to the robot-defined object supporter 502, and as depicted in FIG. 113 and FIG. 114, the object manipulator 430 is disposed in a second vertical position, relative to the robot-defined object supporter 502, wherein the second vertical position is elevated relative to the first vertical position. In some embodiments, for example, as depicted in FIG. 115A and FIG. 115B to FIG. 116A and FIG. 116B, after grasping an object 900 from a first object supporter 914, disposed on a first side of the robot 110, for example, the right side of the robot 110, and emplacing the object 900 on the robot-defined object supporter 502, instead of lowering the object transitioning apparatus 420 and moving the object to another location in the warehouse, the object can be displaced from the robot-defined object supporter 502 to a second object supporter 916, disposed at the same elevation as the first object supporter 914 and on a second side of the robot 110 that is opposite the first side, for example, the left side of the robot 110. In some embodiments, for example, this reduces the time for emplacing the object retrieved from the first object supporter 914 on the second object supporter 916.

In some embodiments, for example, as depicted in FIG. 113, the end effector 440 includes a first grasping configuration 460A, disposed on a first side, for example, a right side, of the end effector 440, and a second grasping configuration 460B, disposed on a second side of the end effector 440 that is opposite the first side, for example, a left side, of the end effector 440.

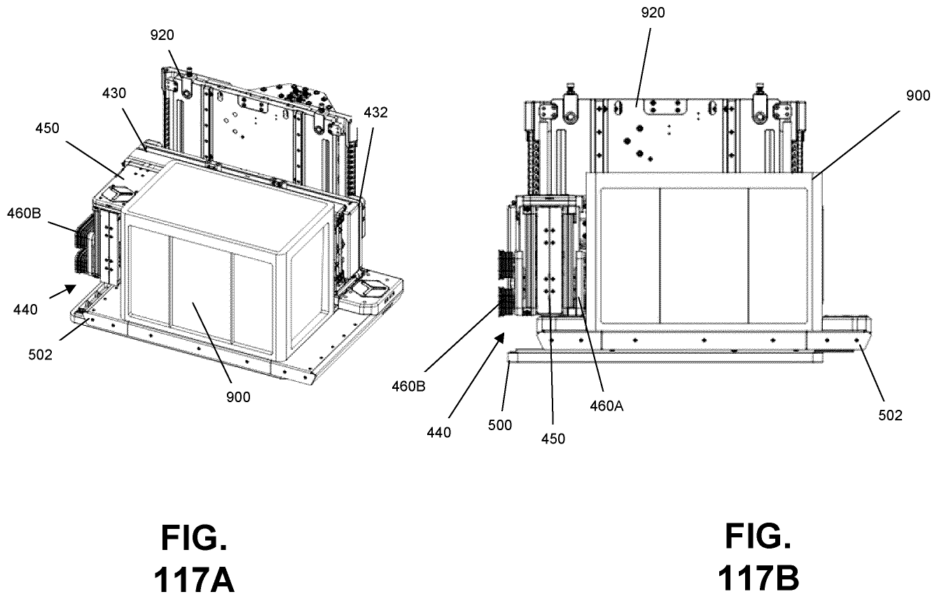

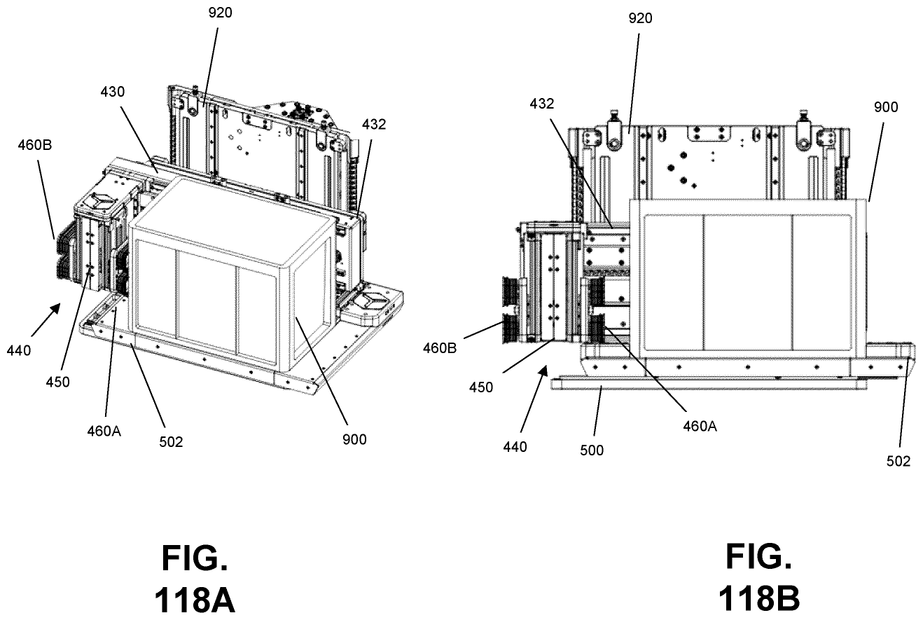

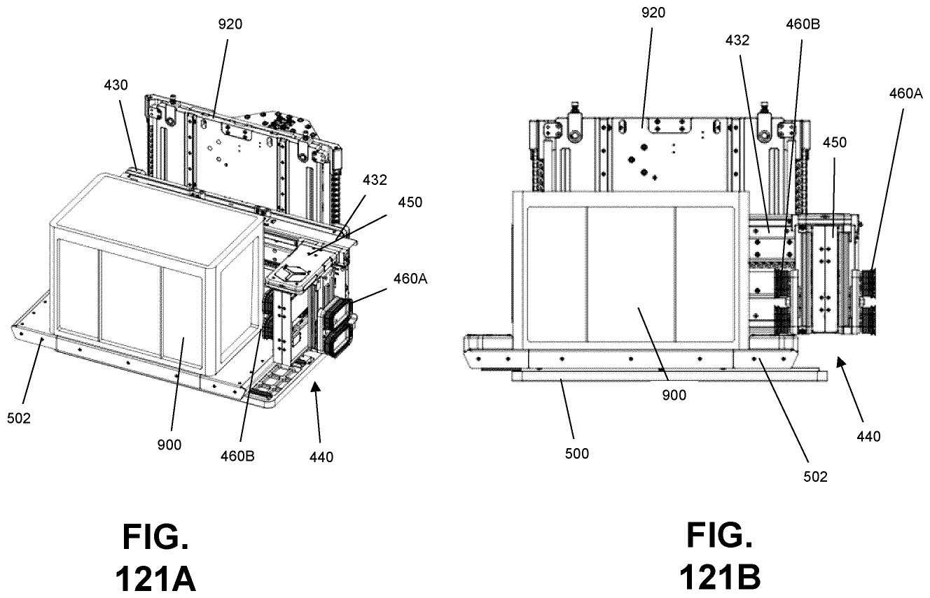

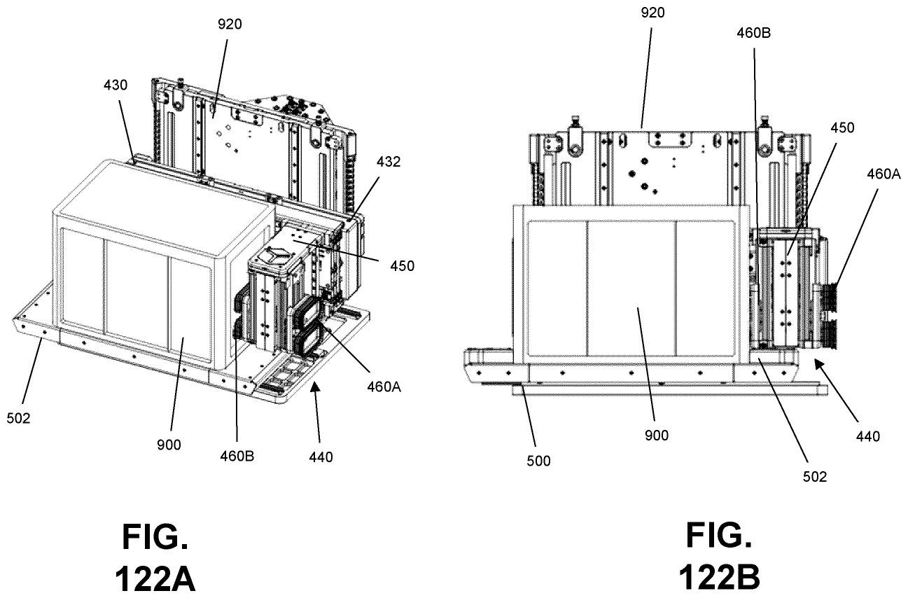

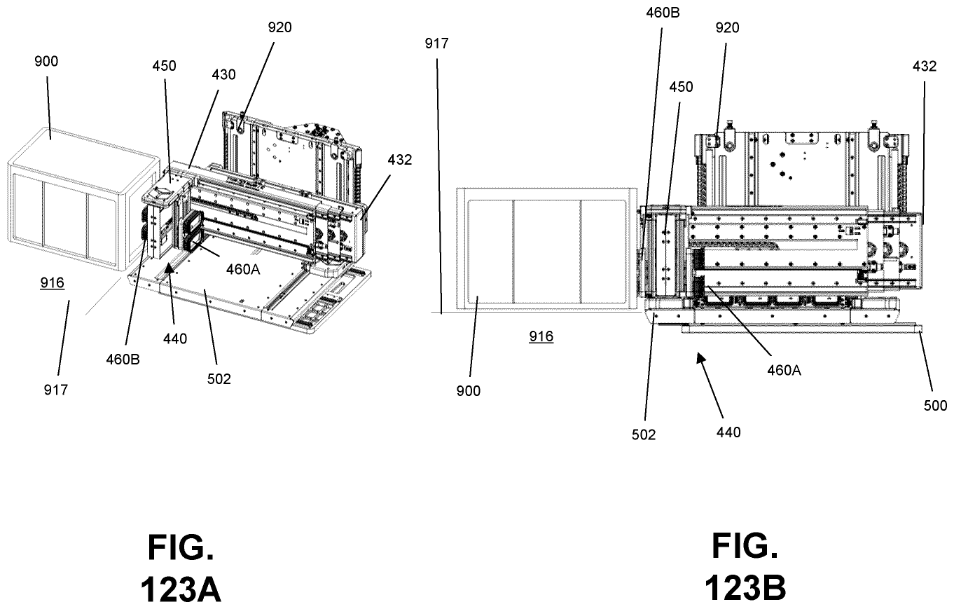

In some embodiments, for example, while the object 900 is supported by the robot-defined object supporter 502, the object manipulator 430 is configurable in a first configuration, as depicted in FIG. 117A and FIG. 117B, a second configuration, as depicted in FIG. 118A and FIG. 118B, a third configuration, as depicted in FIG. 121A and FIG. 121B, and a fourth configuration, as depicted in FIG. 122A and FIG. 122B.

In the first configuration, a first side, for example, a left side, of the supported object 900 is grasped by the first grasping configuration 460A, such that the end effector 440 is coupled to the first side of the supported object 900. As depicted in FIG. 117A and FIG. 117B, the driver 450 is disposed to the left of the object 900 and at the same elevation as the object 900.

In the second configuration, there is an absence of coupling between the end effector 440 and the supported object, and the first grasping configuration 460A and the first side of the supported object 900 are disposed in opposing relationship. As depicted in FIG. 118A and FIG. 118B, the grasping of the object 900 by the grasping configuration 460A is absent, such that there is an absence of coupling between the end effector 440 and the supported object. As depicted, the driver 450 is disposed to the left of the object 900 and at the same elevation as the object 900.

In the third configuration, there is an absence of coupling between the end effector 440 and the supported object 900, and the second grasping configuration 460B and a second side of the supported object 900, for example, the right side of the object 900, are disposed in opposing relationship, wherein, relative to the first side, the second side of the supported object is disposed on an opposite side of the supported object 900. As depicted in FIG. 121A and FIG. 121B, the grasping of the object 900 by the grasping configuration 460B is absent, such that there is an absence of coupling between the end effector 440 and the supported object 900. As depicted, the driver 450 is disposed to the right of the object 900 and at the same elevation as the object 900.

In the fourth configuration, the second side of the supported object 900 is grasped by the second grasping configuration 460B, such that the end effector 440 is coupled to the second side of the supported object 900. As depicted in FIG. 122A and FIG. 122B, the driver 450 is disposed to the right of the object 900 and at the same elevation as the object 900.

In some embodiments, for example, the object manipulator 430 is: transitionable from the first configuration to the second configuration, transitionable from the second configuration to the third configuration, and transitionable from the third configuration to the fourth configuration.

In some embodiments, for example, the transition from the second configuration to the third configuration is with effect that the end effector 440 clears the supported object 900.

In some embodiments, for example, the transitioning from the second configuration to the third configuration is with effect that the end effector 440 is vertically displaced during the transitioning. In some embodiments, for example, said vertical displacement of the end effector 440 is relative to the robot-defined object supporter 502.

In some embodiments, for example, the transitioning from the second configuration to the third configuration includes:
an upwardly displacement of the end effector 440, with effect that the end effector 440 becomes emplaced above the supported object 900;
while the end effector 440 is emplaced above the supported object 900, a lateral displacement of the end effector, with effect that the end effector 440 traverses the supported object 900;
after the traversing of the supported object 900 by the end effector, a downwardly displacement of the end effector 440.

In some embodiments, for example, the extendible arm 432 is vertically displaceable, relative to the robot-defined object supporter 502, and the vertical displacement of the end effector 440 during transition of the object manipulator 430 from the second configuration to the third configuration is effected by vertical displacement of the extendible arm 432, relative to the robot-defined object supporter 502.

In some embodiments, for example, the lateral displacement of the end effector 440, for effecting the transition of the object manipulator 430 from the second configuration to the third configuration, is lateral displacement of the end effector 440, relative to the robot-defined object supporter 502, the lateral displacement effectible in response to extension or retraction of the extendible arm 430.

In some embodiments, for example, an end effector actuator configuration, for example, the actuator configuration 660, is disposed in operable communication with the end effector 440. The end effector 440 is coupled to the extendible arm 432, such that the end effector 440 is displaceable laterally, relative to the extendible arm 432, in response to actuation by the end effector actuator configuration 660. In some embodiments, for example, the lateral displacement of the end effector 440, for effecting the transition of the object manipulator 430 from the second configuration to the third configuration, is lateral displacement of the end effector 440, relative to the extendible arm 432.

In some embodiments, for example, the lateral displacement of the end effector 440, relative to the extendible arm 432, effectible in response to actuation by the end effector actuator configuration 660, is independent of displacement of the end effector 440, in response to extension or retraction of the extendible arm 432.

While the robot 110 is disposed between a first object supporter 914 and second object supporter 916, wherein the first object supporter 914 defines a first supporting surface 915, the second object supporter 916 defines a second supporting surface 917, and the first and second supporting surfaces are disposed at the same elevation,
and while one of the first and second grasped configurations 460 is grasping an object on the first object supporter 914 such that the grasped object is established:
the object manipulator 430 is emplaceable in the first configuration in response to displacement of the object 900, by the object manipulator 430 from the first object supporter 914 to the robot-defined object supporter 502, as depicted in FIG. 117A and FIG. 117B;
and while the object manipulator 430 is disposed in the fourth configuration, the supported object is displaceable, by the object manipulator 430, from the robot-defined object supporter 502, to the second object supporter 916 for supporting of the object by the second supporting surface 917, as depicted in FIG. 122A and FIG. 122B.

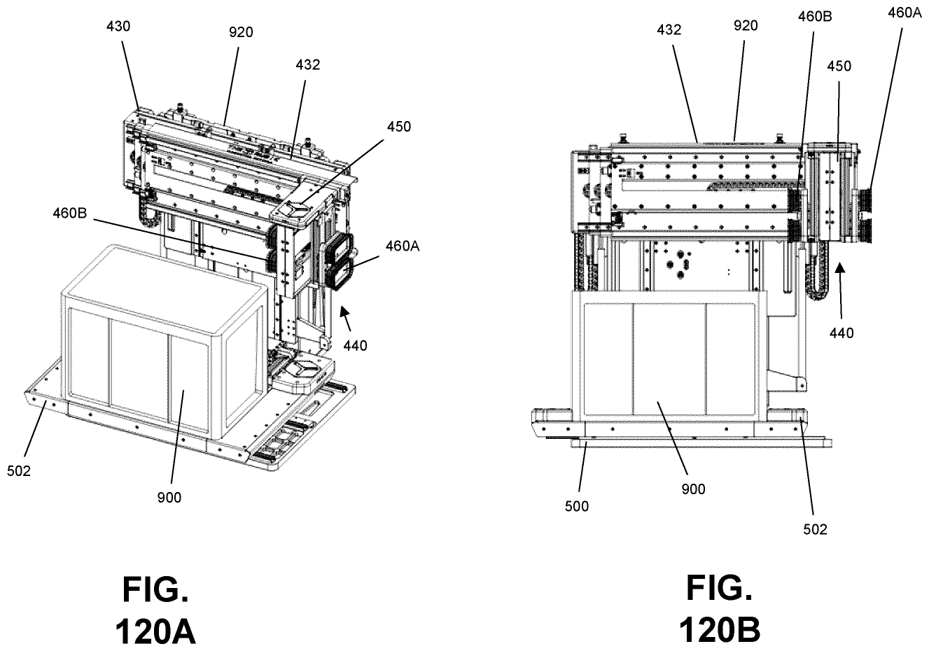

In some embodiments, for example, as depicted in FIG. 120A and FIG. 120B, the robot-defined object supporter 502 is displaced laterally towards the second object supporter 916 to reduce the minimum spacing distance between the robot-defined object supporter 502 is displaced laterally towards the second object supporter 916 to facilitate displacement of the supported object by the object manipulator 430, from the robot-defined object supporter 502, to the second object supporter 916.

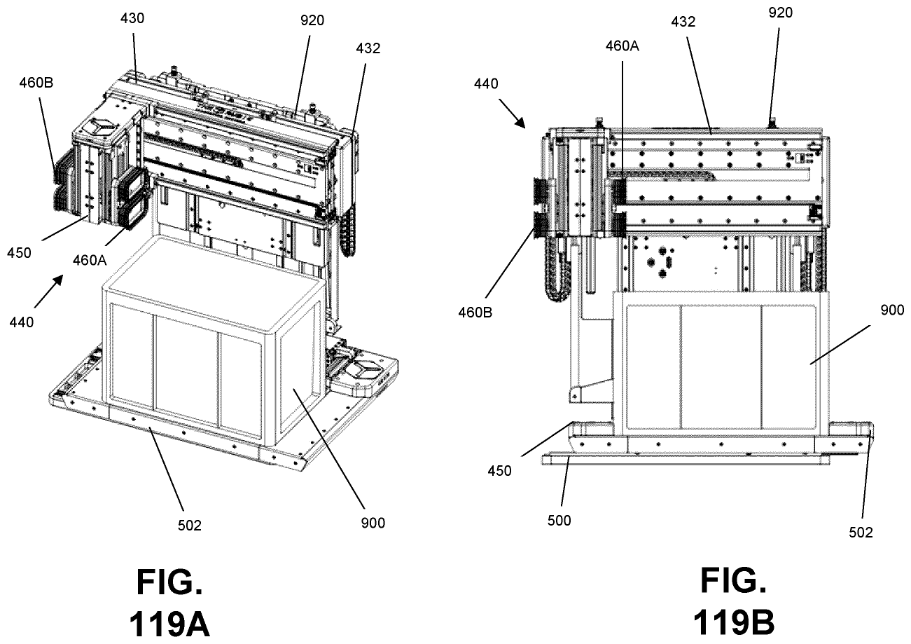

In some embodiments, for example, the object manipulator is configurable in a fifth configuration, as depicted in FIG. 119A and FIG. 119B, and a sixth configuration, as depicted in FIG. 120A and FIG. 120B.

In the fifth configuration, there is an absence of coupling between the end effector 440 and the supported object 900, and the first grasping configuration 460A and the first side of the supported object 900 are disposed in opposing relationship. As depicted in FIG. 119A and FIG. 119B, the grasping of the object 900 by the grasping configuration 460A is absent, such that there is an absence of coupling between the end effector 440 and the supported object 900. As depicted, the end effector 440 is disposed to the left of the object 900 and the extendible arm 432, the driver 450, and the end effector 440 are disposed above the object 900.

In the sixth configuration, there is an absence of coupling between the end effector 440 and the supported object 900, and the first grasping configuration 460B and the second side of the supported object 900 are disposed in opposing relationship. As depicted in FIG. 120A and FIG. 120B, the grasping of the object 900 by the grasping configuration 460B is absent, such that there is an absence of coupling between the end effector 440 and the supported object 900. As depicted, the end effector 440 is disposed to the left of the object 900 and the extendible arm 432, the driver 450, and the end effector 440 are disposed above the object 900.

In some embodiments, for example, the object manipulator 430 is transitionable from the second configuration to the fifth configuration, from the fifth configuration to the sixth configuration, and from the sixth configuration to the third configuration.

In some embodiments, for example, the transitioning from the second configuration to the fifth configuration includes an upwardly displacement of the object manipulator 430, relative to the robot defined object supporter 502, with effect that the end effector 440 becomes emplaced above the supported object.

In some embodiments, for example, the transitioning from the fifth configuration to the sixth configuration includes a lateral displacement of the end effector 440, relative to the extendible arm 432, with effect that the end effector traverses the supported object 900.

In some embodiments, for example, the transitioning from the sixth configuration to the third configuration includes a downwardly displacement of the object manipulator 430, relative to the robot defined object supporter 502.

The vertical displacement of the end effector 440, to transition the object manipulator from the second configuration to the third configuration, is effected by vertical displacement of the object manipulator 430, which includes the extendible arm 432, the driver 450, and the end effector 440. In some embodiments, for example, said vertical displacement of the object transitioning apparatus 420 is relative to the robot-defined object supporter 502.

The vertical displacement of the object manipulator 430, relative to the robot-defined object supporter 502, is effectible by a vertical displacement mechanism 920 of the object transitioning apparatus 420. The vertical displacement mechanism 920 includes a frame 922 that is coupled to the blocks 810, an intermediate plate 924, and an end plate 926 that is coupled to the extendible arm 432, for example, to the base arm segment 434 of the extendible arm 432, wherein the intermediate plate 924 is disposed between the frame 922 and the end plate 926.

The coupling of the frame 922 to the blocks 810 is such that the frame 922 is longitudinally displaceable with the blocks 810, but the frame 922 is not displaceable relative to the blocks 810.

The coupling of the intermediate plate 924 to the frame 922 is such that the intermediate plate 924 is longitudinally displaceable with the frame 922, and the intermediate plate 924 is vertically displaceable, relative to the frame 922.

The coupling of the end plate 926 to the intermediate plate 924 is such that the end plate 926 is longitudinally displaceable with the intermediate plate 924, and the end plate 926 is vertically displaceable, relative to the intermediate plate 924.

The coupling of the object manipulator 430, for example, the base arm segment 434 of the extendible arm 432, to the end plate 926 is such that the object manipulator 430 is longitudinally and vertically displaceable with the end plate 926, but the object manipulator 430 is not displaceable relative to the end plate 926.

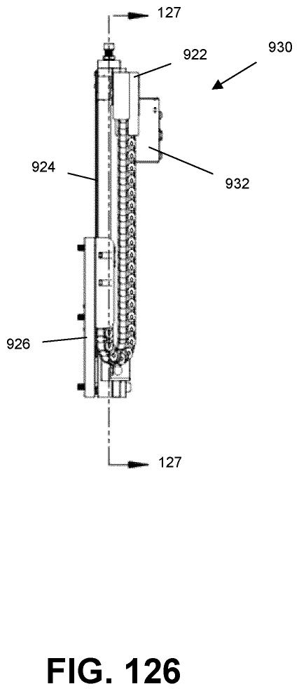

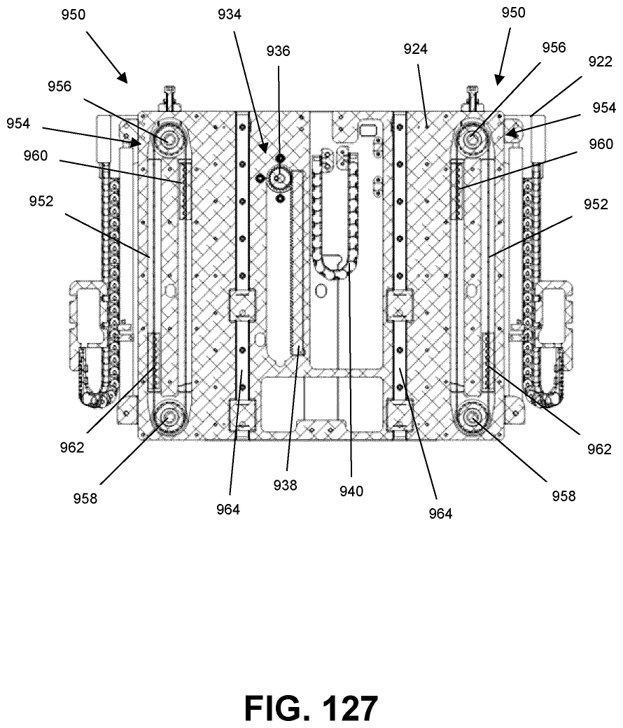

In some embodiments, for example, the object transitioning apparatus 420 includes an actuator configuration 930, including a prime mover 932, for example, a motor, for example, an electric motor, and a transmission configuration 934, including a transmission component 936, for example, a gear, and a rack 938 for actuation of the vertical displacement mechanism 920. As depicted in FIG. 126 and FIG. 127, the prime mover 932 and gear 936 are mounted to the frame 922, and the rack 938 is mounted to the intermediate plate 924. In some embodiments, for example, the prime mover 932 is disposed in electrical and data communication with the electrical and data connectors 428, for example, via an electrical and data cable 940. While the data cables 390 and 392 are disposed in electrical and data communication with the electrical and data connectors 428, the prime mover 932 is disposed in data communication with the controller 202 and also disposed in electrical communication with the battery of the robot 110.

The prime mover 932 is configured to generate a displacement force that is applicable to the object manipulator 430, for example, to the extendible arm 432, for vertically displacing the object manipulator 430, relative to the robot defined object supporter 502. In response to application of the displacement force from the prime mover 932 to the object manipulator 430, the object manipulator 430 is vertically displaced upwardly or downwardly, relative to the robot defined object supporter 502.

In some embodiments, for example, the prime mover 932 is configurable in a first direction displacement drive state and a second direction displacement drive state. In some embodiments, for example, while the prime mover 932 is disposed in the first direction displacement drive state, the displacement force applied to the object manipulator 430 has a first direction, for example, an upward direction, such that the object manipulator 430 displaces vertically upwardly, relative to the robot defined object supporter 502, in response to application of the displacement force to the object manipulator 430. In some embodiments, for example, while the prime mover 932 is disposed in the second direction displacement drive state, the displacement force applied to the object manipulator 430 has a second direction that is opposite the first direction, for example, a downward direction, such that the object manipulator 430 is displaced in the second direction, relative to the robot defined object supporter 502, in response to application of the displacement force to the object manipulator 430.

In some embodiments, for example, the prime mover 932 is disposed in data communication with the controller 202 and further disposed in electrical communication with the battery, for actuation of the prime mover 932 in the first direction displacement drive state and the second direction displacement drive state, via control commands from the controller 202.

In some embodiments, for example, the actuator configuration 930 includes the transmission configuration 934 to effect the operable communication between the prime mover 932 and the object manipulator 430, in particular, between the prime mover 932 and the intermediate frame 924. In some embodiments, for example, the transmission configuration 934 includes the transmission component 936. The transmission component 936 is disposed in operable communication with the prime mover 932, for example, via a drive shaft. In some embodiments, for example, the transmission component 936 is configured to co-operate with the rack 938 such that force is transferable from the transmission component 936 to the rack 938, and therefore, to the intermediate plate 924. In some embodiments for example, each one of the transmission component 936 and the rack 938, independently, include threading or teeth for transferring force from the transmission component 936 to the rack 938. As depicted in FIG. 127, the prime mover 932 is disposed in operable communication with the rack 938 via transmission component 936, which is connected to the intermediate plate 924, such that the displacement force generated by the prime mover 932 is applied to the intermediate plate 924 via the transmission component 936 and the rack 938. In this respect, the displacement force generated by the prime mover 932 is an intermediate plate displacement force. In response to application of the intermediate plate displacement force from the prime mover 932 to the intermediate plate 924, the intermediate plate 924 is vertically displaced, relative to the frame 922.

In some embodiments, for example, to vertically displace the end plate 926, relative to the intermediate plate 924, the object transitioning apparatus 420 includes a transmission configuration 950. The frame 922, the intermediate plate 924, the end plate 926, the transmission configuration 950 and the actuator configuration 930 are co-operatively configured such that, in response to application of the intermediate frame displacement force to the intermediate plate 924 by the actuator configuration 930 to effect the vertical displacement of the intermediate plate 924, relative to the frame 922, an end plate displacement force is applied by the transmission configuration 950 to the end plate 926, to effect vertical displacement of the end plate 926, relative to the intermediate plate 924.

As depicted in FIG. 127, in some embodiments, for example, the transmission configuration 950 includes a transmission component 952, for example, a drive belt, a chain, a cable, and the like, and a pulley configuration 954, wherein the pulley configuration 954 includes two pulleys 956 and 958. The pulleys 956 and 958 are mounted to the intermediate plate 924 with the pulley 956 positioned above the pulley 958, and the transmission component 952 is looped around the pulleys 956 and 958 and extend between the pulleys 956 and 958 and disposed in tension, with a first portion 960 of the transmission component 952 connected to the frame 922, and a second portion 962 of the transmission component 952 connected to the end plate 926.

In response to upward vertical displacement of the intermediate plate 924, for example, in response to application of the intermediate plate displacement force having an upward vertical direction from the prime mover 932, the pulleys 956 and 958 are displaced upwards. As the pulley 956 is displaced upwards, the pulley 956 exerts a force on the transmission component 952, with effect that the transmission component 952 becomes further disposed in tension. Due to the connection of the transmission component 952 to: (i) the frame 922, which is connected to the blocks 810 such that there is an absence of vertical displacement of the frame 922 relative to the robot defined object supporter 502, and (ii) the end plate 926, which is vertically displaceable relative to the intermediate plate 924, as the transmission component 952 becomes further disposed in tension, the tension in the transmission component 952 is transferred to the end plate 926 as an end plate displacement force, having an upward direction. In this respect, as the intermediate plate 924 is displaced vertically upwards, the transmission component 952 applies the end plate displacement force to the end plate 926. In response to application of the end plate displacement force to the end plate 926, the end plate 926 is displaced, relative to the intermediate plate 924, in the upward direction.

Similarly, in response to downward vertical displacement of the intermediate plate 924, for example, in response to application of the intermediate plate displacement force having a downward vertical direction from the prime mover 932, the pulleys 956 and 958 are displaced downwards. As the pulley 958 is displaced downwards, the pulley 958 exerts a force on the transmission component 952, with effect that the transmission component 952 becomes further disposed in tension. Due to the connection of the transmission component 952 to: (i) the frame 922, which is connected to the blocks 810 such that there is an absence of vertical displacement of the frame 922 relative to the robot defined object supporter 502, and (ii) the end plate 926, which is vertically displaceable relative to the intermediate plate 924, as the transmission component 952 becomes further disposed in tension, the tension in the transmission component 952 is transferred to the end plate 926 as an end plate displacement force, having a downward direction. In this respect, as the intermediate plate 924 is displaced vertically downwards, the transmission component 952 applies the end plate displacement force to the end plate 926. In response to application of the end plate displacement force to the end plate 926, the end plate 926 is displaced, relative to the intermediate plate 924, in the downward direction.

In some embodiments, for example, the vertical displacement mechanism 920 includes more than one transmission configuration 950, for example, two transmission configurations 950, as depicted in FIG. 127. In some embodiments, for example, the two transmission configurations 950 are disposed, relative to the end plate 926, such that the end plate displacement forces applied to the end plate 926 by the transmission configurations 950 are balanced about a central vertical axis of the end plate 926. In some embodiments, for example, the two transmission configurations 950 are disposed on opposite ends of the intermediate plate 924.

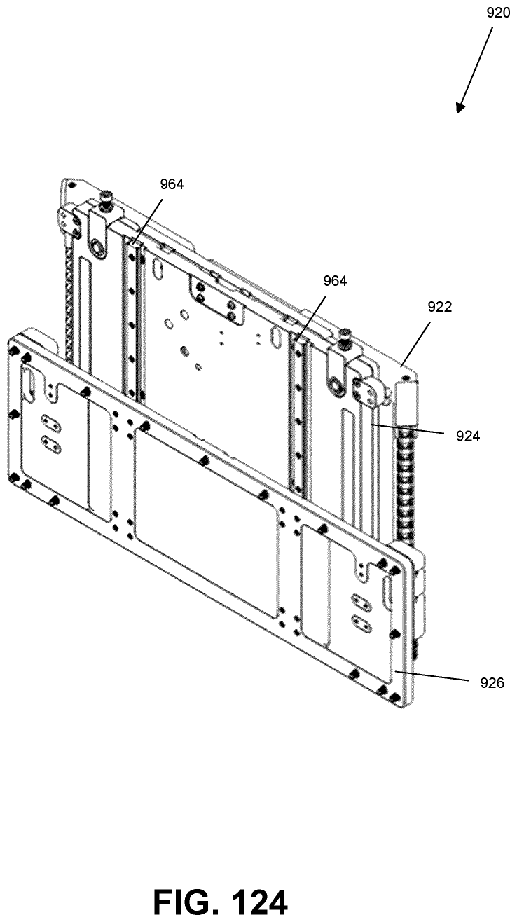

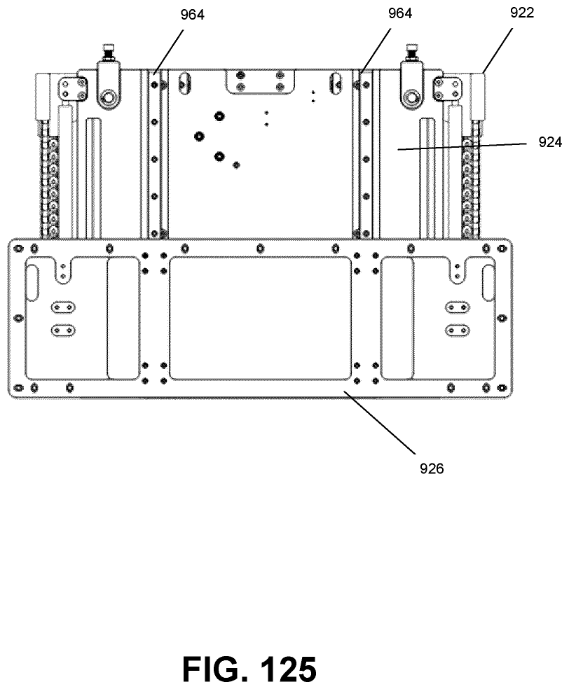

FIG. 124 to FIG. 127 depict the vertical displacement mechanism 920 in a retracted configuration. While the vertical displacement mechanism 920 is disposed in the retracted configuration, the intermediate plate 924 is disposed in a first position, and the end plate 926 is disposed in a first position. As depicted, the intermediate 924 and the end plate 926 are disposed at the same elevation.

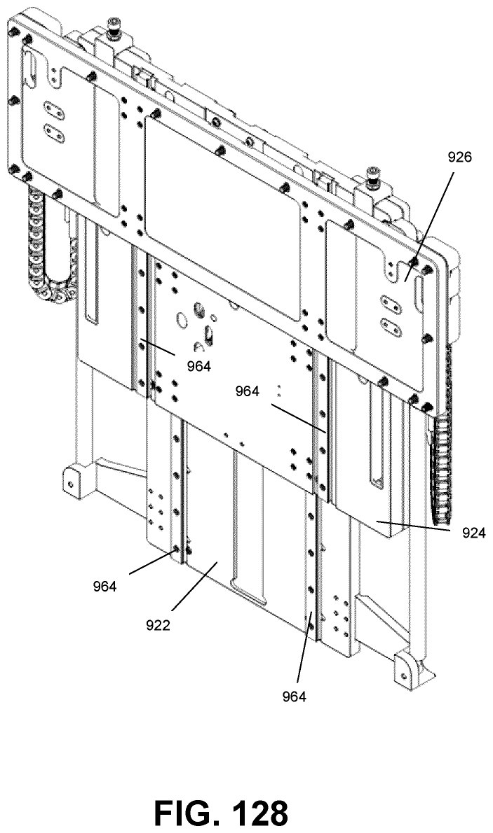

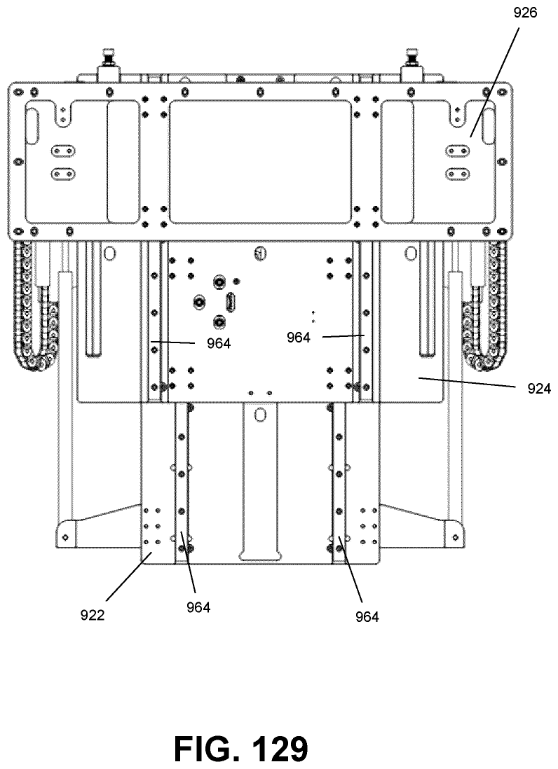

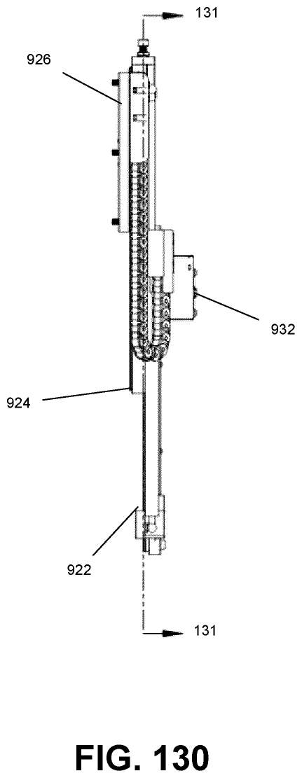

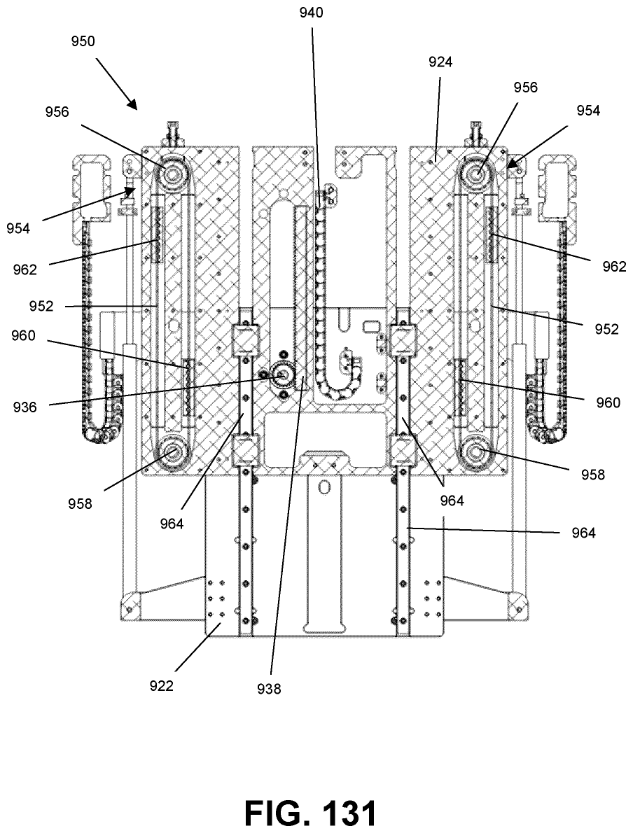

FIG. 128 to FIG. 131 depict the vertical displacement mechanism 920 in an extended configuration. While the vertical displacement mechanism 920 is disposed in the extended configuration, relative to its disposition in the retracted configuration, the intermediate plate 924 is disposed in a vertical position that is higher than the first position. While the vertical displacement mechanism 920 is disposed in the extended configuration, relative to its disposition in the retracted configuration, the end plate 926 is disposed in a vertical position that is higher than the first position, and is also disposed higher than the intermediate plate 924.

In some embodiments, for example, the vertical displacement mechanism 920 includes guides 964, for example, guide tracks, for guiding the vertical displacement of the intermediate plate 924, relative to the frame 922, and also for guiding the vertical displacement of the end plate 926, relative to the intermediate plate 924.

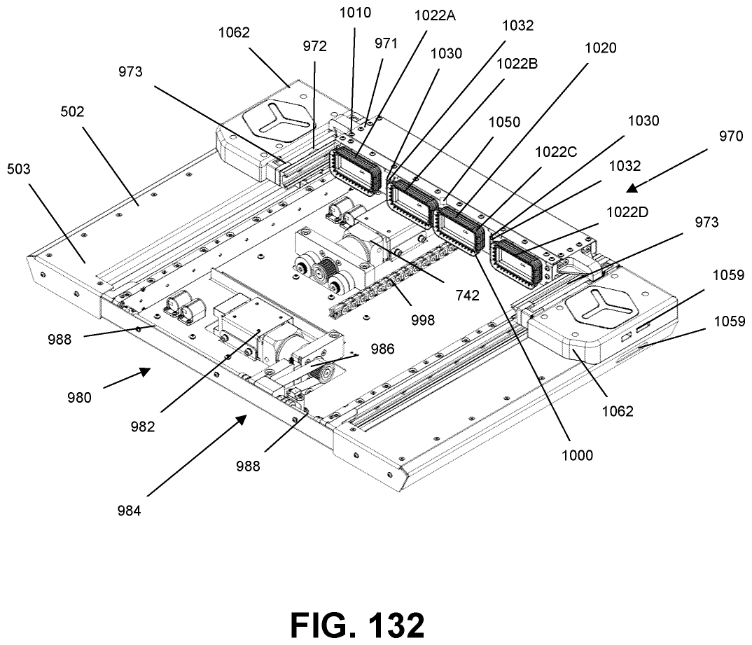

In some embodiments, for example, the object transitioning apparatus 420 further includes an object manipulator 970, as depicted in FIG. 132 to FIG. 142. While the object manipulator 430 is configured to grasp an object, such that a grasped object is established, and move the grasped object in a lateral direction, the object manipulator 970 is configured to grasp an object, such that a grasped object is established, and move the grasped object in a longitudinal direction (e.g. forward or rearward direction), relative to the base 302.

The object manipulator 970 is coupled to the robot defined object supporter 502, such that the object manipulator 970 is laterally displaceable with the robot defined object supporter 502, relative to the base 302, as depicted in FIG. 67 to FIG. 74.

In some embodiments, for example, the object manipulator 970 includes an object emplacement/removal tool 971. In some embodiments, for example, the emplacement/removal tool 971 includes a longitudinal displacement mechanism 972. The displacement mechanism 972 is actuatable for extension and retraction in a longitudinal direction, relative to the base 302, and also relative to the robot defined object supporter 502. In some embodiments, for example, the extension and retraction is within a horizontal plane. In some embodiments, for example, the extension and retraction in the longitudinal direction is within the horizontal plane.

In some embodiments, for example, as depicted in FIG. 132 to FIG. 136, the displacement mechanism 972 includes two displacement submechanisms 973. The displacement submechanisms 973 are disposed on opposite ends of the robot defined object supporter 502.

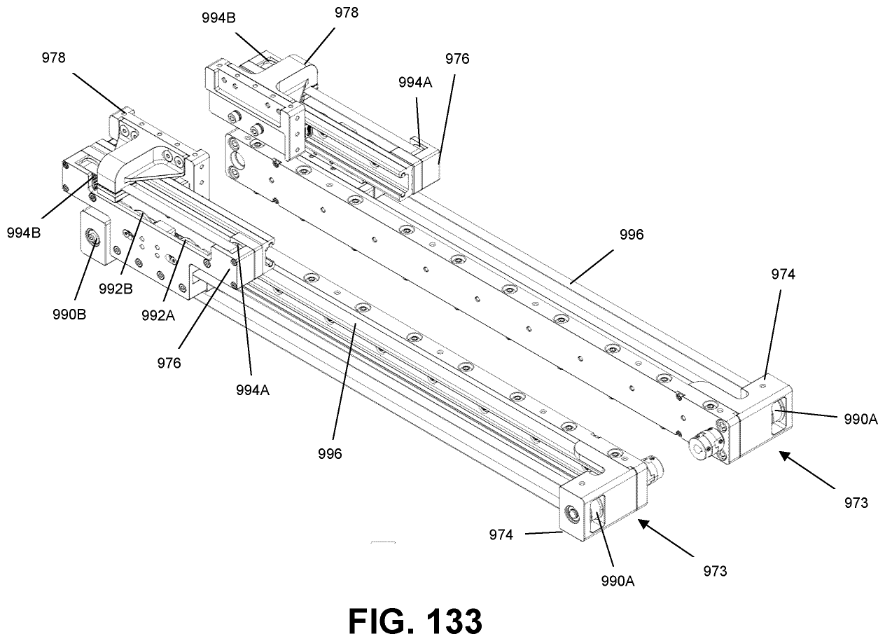

Each one of the displacement submechanisms 973, independently, as depicted in FIG. 133 to FIG. 136, includes a rail 974, a slider 976, and a bracket 978, wherein the slider 976 is disposed between the rail 974 and the bracket 978. The rail 974 is coupled to the robot defined object supporter 502 such that there is an absence of displacement of the rail 974, relative to the robot defined object supporter 502. The slider 976 is coupled to the rail 974 such that the slider 974 is longitudinally displaceable relative to the rail 974. The longitudinal displacement of the slider 976, relative to the rail 974, is guided by the rail 974. The bracket 978 is coupled to the slider 976 such that the bracket 978 is longitudinally displaceable relative to the slider 976. The longitudinal displacement of the bracket 978, relative to the slider 976, is guided by the slider 976.

Each one of the displacement submechanisms 973, independently, is coupled to the robot defined object supporter 502 such that the rail 974 is disposed within the robot defined object supporter 502, and the slider 976 and the bracket 978 are disposed above an object supporting surface 503 of the robot defined object supporter 502, wherein the object supporting surface 503 is configured to support an object.

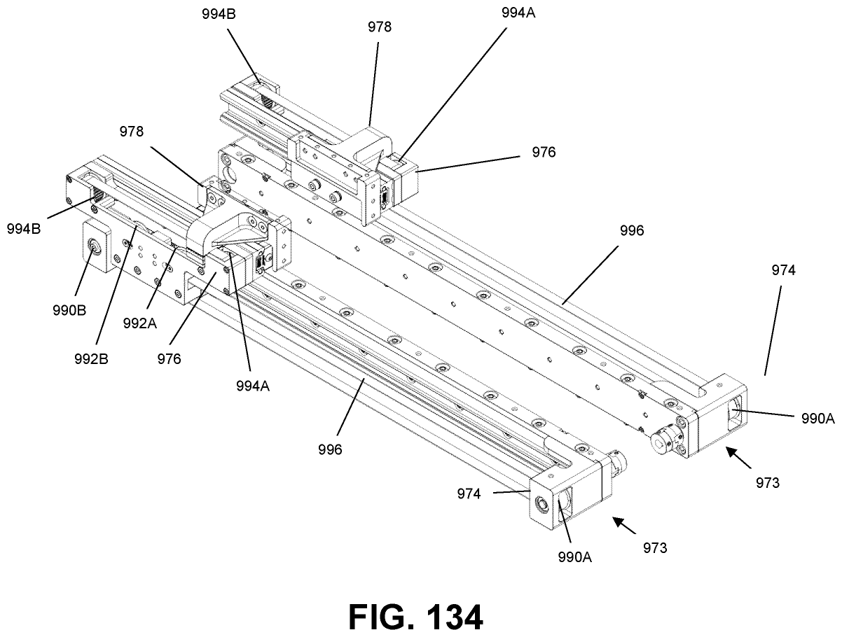

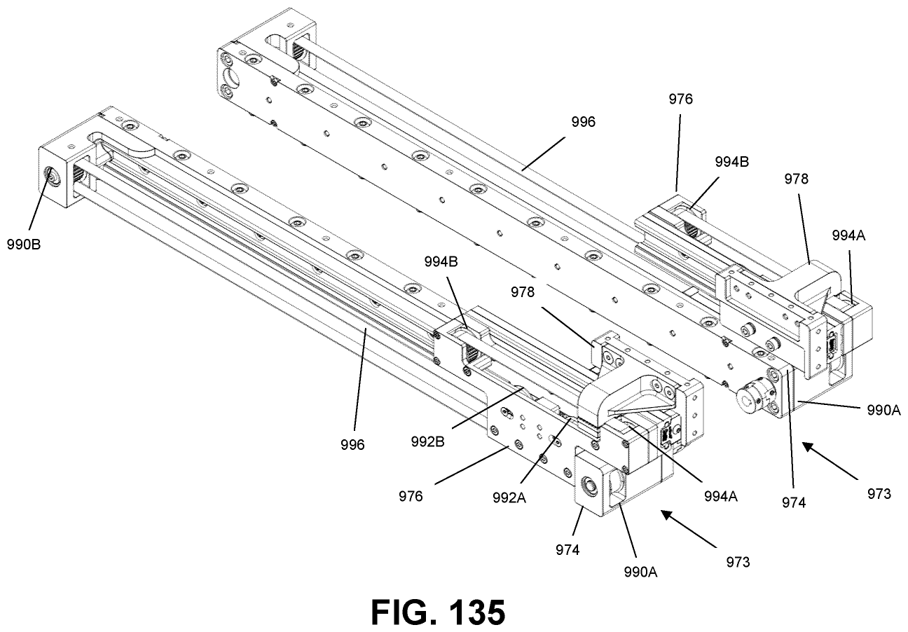

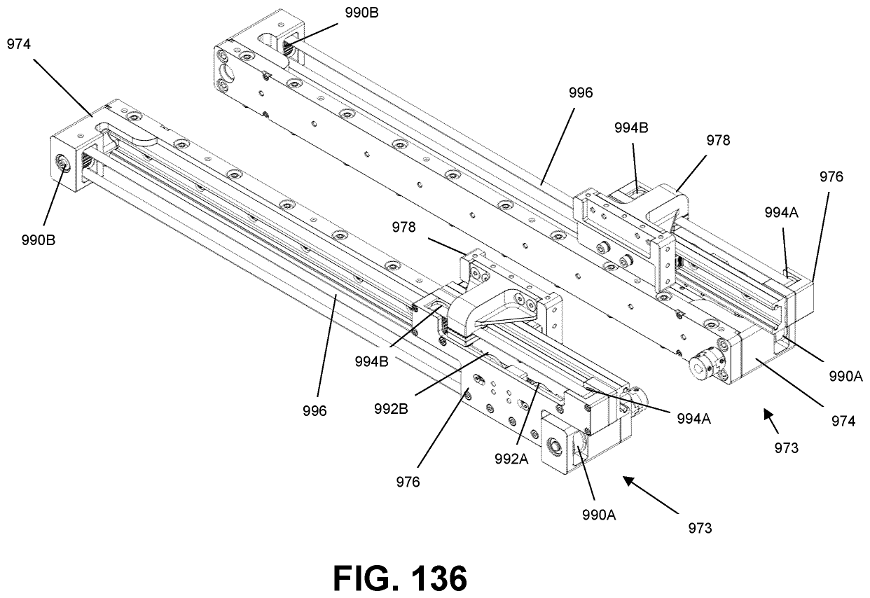

In some embodiments, for example, the longitudinal displacement mechanism 972 is configurable in a retracted configuration, as depicted in FIG. 133, an intermediate forward configuration, as depicted in FIG. 134, an extended configuration, as depicted in FIG. 135, and an intermediate rearward configuration, as depicted in FIG. 136.

In the retracted configuration, the slider 976 is disposed at a rearmost end of the rail 974, and the bracket 978 is disposed at a rearmost end of the slider 976.

In the intermediate forward configuration, the slider 976 is disposed at a rearmost end of the rail 974, and the bracket 978 is disposed at a forwardmost end of the slider 976.

In the extended configuration, the slider 976 is disposed at a forwardmost end of the rail 974, and the bracket 978 is disposed at a forwardmost end of the slider 976.

In the intermediate rearward configuration, the slider 976 is disposed at a forwardmost end of the rail 974, and the bracket 978 is disposed at a rearmost end of the slider 976.

The displacement mechanism 972 is transitionable from the retracted configuration to the intermediate forward configuration, transitionable from the intermediate forward configuration to the extended configuration, transitionable from the extended configuration to the intermediate rearward configuration, and transitionable from the intermediate rearward configuration to the retracted configuration.

In some embodiments, for example, the object manipulator 970 includes an actuator configuration 980 for transitioning the displacement mechanism 972 between the retracted configuration, intermediate forward configuration, extended configuration, and intermediate rearward configuration.

The actuator configuration 980 includes a prime mover 982, for example, a motor, for example, an electric motor, and a transmission configuration 984, including a transmission component 986, such as a drive belt, a chain, a cable, and the like, a drive shaft 988, pulleys 990A and 990B, pulleys 992A and 992B, pulleys 994A and 994B, and a transmission component 996, such as a drive belt, a chain, a cable, and the like. As depicted in FIG. 132, transmission component 986, and drive shaft 988 are disposed in the robot defined object supporter 502. As depicted in FIG. 133, the pulleys 990A and 990B are coupled to the rail 974, with the pulley 990A disposed forwardly relative to the pulley 990B. As depicted in FIG. 133, the pulleys 992A and 992B are coupled to the slider 976, with the pulley 992A disposed forwardly relative to the pulley 992B. As depicted in FIG. 133, the pulleys 994A and 994B are coupled to the slider 976, with the pulley 994A disposed forwardly relative to the pulley 992B, the pulley 994A disposed forwardly of the pulley 992A, the pulley 994B disposed rearwardly relative to the pulley 992B. As depicted in FIG. 133, the bracket 978 is disposed in engagement with, for example, gripping engagement, to the transmission component 996, wherein said engagement is disposed between the pulley 994A and the pulley 994B.

As depicted in FIG. 133, the transmission component 996 is looped around the pulley 990A, the pulley 990B, the pulley 992B, the pulley 994B, the pulley 994A, the pulley 992A, and back to the pulley 990A.

In some embodiments, for example, the prime mover 982 is disposed in electrical and data communication with the electrical and data connectors 428, for example, via electrical and data cable 998. While the cables 390 and 392 are disposed in electrical and data communication with the electrical and data connectors 428, the prime mover 982 is disposed in data communication with the controller 202 and also disposed in electrical communication with the battery of the robot 110.

The prime mover 982 is configured to generate a displacement force that is applicable to the displacement mechanism 972 for longitudinally displacing the slider 976 and bracket 978, relative to the base 302. In response to application of the displacement force from the prime mover 982 to the slider 976 and bracket 978, the slider 976 and bracket 978 are longitudinally extended or retracted, relative to the base 302.

In some embodiments, for example, the prime mover 982 is configurable in a first direction displacement drive state and a second direction displacement drive state. In some embodiments, for example, while the prime mover 982 is disposed in the first direction displacement drive state, the displacement force applied to the slider 976 and bracket 978 has a first direction, for example, a forward direction, such that the slider 976 and bracket 978 are displaced in the first direction, relative to the base 302, in response to application of the displacement force to the slider 976 and bracket 978. In some embodiments, for example, while the prime mover 982 is disposed in the second direction displacement drive state, the displacement force applied to the slider 976 and bracket 978 has a second direction that is opposite the first direction, for example, a rearward direction, such that the slider 976 and bracket 978 are displaced in the second direction, relative to the base 302, in response to application of the displacement force to the slider 976 and bracket 978.

In some embodiments, for example, the prime mover 982 is disposed in data communication with the controller 202 and further disposed in electrical communication with the battery, for actuation of the prime mover 982 in the first direction displacement drive state and the second direction displacement drive state, via control commands from the controller 202.

In some embodiments, for example, the actuator configuration 980 includes the transmission configuration 984 to effect the operable communication between the prime mover 982 and the displacement mechanism 972, in particular, between the prime mover 982, the slider 976, and the bracket 978. In some embodiments, for example, the transmission configuration 984 includes the transmission component 986 and the drive shaft 988. The transmission component 986 is disposed in operable communication with the prime mover 982, and the drive shaft 988 is disposed in operable communication with the transmission component 986, such that the prime mover 982 drives rotation of the drive shaft 988 via the transmission component 986. The drive shaft 988 is connected to the pulleys 990A of the displacement submechanisms 973, such that rotation of the drive shaft 988 rotates the pulleys 990A. In this respect, the drive shaft 988 is a common drive shaft for the displacement submechanisms 973. Due to the looping of the transmission component 996 around the pulleys 990, 992, and 994, rotation of the pulleys 990A drives movement of the transmission component 996 as guided by the pulleys 990, 992, and 994.

In some embodiments, for example, as depicted in FIG. 132, the prime mover 982 is disposed in operable communication with the transmission component 996 via the transmission component 986, drive shaft 988, and pulleys 990, 992, and 994, such that the displacement force generated by the prime mover 982 is applied to the slider 976 and the bracket 978.

While the displacement mechanism 972 is disposed in the retracted configuration, tor each one of the displacement submechanisms 973, independently, while the prime mover 982 is disposed in the first direction displacement drive state, the prime mover 982 rotates the drive shaft 988 in a first direction, for example, clockwise direction, which rotates the pulley 990A in the first direction. This drives movement of the transmission component 996 about the pulleys 990, 992, and 994. Due to the engagement of the bracket 978 to the transmission component 996, the movement of the transmission component 996 is with effect that the bracket 978 is displaced longitudinally forward, relative to the slider 976 and relative to the robot defined object supporter, until the bracket 978 is disposed at the forwardmost end of the slider 976 and disposed in abutting engagement with the slider 976, for example, a front stop of the slider 976. At this point, the displacement mechanism 972 is disposed in the intermediate forward configuration.

In response to further rotation of the pulley 990A in the first direction, the transmission component 996 continues to be driven to move about the pulleys 990, 992, and 994. Due to the engagement of the bracket 978 to the transmission component 996, and due to the abutting engagement of the bracket 978 and the slider 976, the movement of the transmission component 996 is with effect that the bracket 978 and the slider 976 are displaced longitudinally forward, relative to the rail 974 and relative to the robot defined object supporter 502, until the slider 976 is disposed at the forwardmost end of the rail 974 and disposed in abutting engagement with the rail 974, for example, a front stop of the slider 976. At this point, the displacement mechanism 972 is disposed in the extended configuration.

While the displacement mechanism 972 is disposed in the extended configuration, in response to further rotation of the pulley 990A in a second direction that is opposite the first direction, for example, a counter clockwise direction, by the prime mover 982 configured in the second direction displacement drive state, the transmission component 996 is driven to move about the pulleys 990, 992, and 994 in the opposite direction. Due to the engagement of the bracket 978 to the transmission component 996, the movement of the transmission component 996 is with effect that the bracket 978 is displaced longitudinally rearward, relative to the slider 976 and relative to the robot defined object supporter 502, until the bracket 978 is disposed at the rearmost end of the slider 976 and disposed in abutting engagement with the slider 976, for example, a rear stop of the slider 976. At this point, the displacement mechanism 972 is disposed in the intermediate rearward configuration.

In response to further rotation of the pulley 990A in the second direction, the transmission component 996 continues to be driven to move about the pulleys 990, 992, and 994. Due to the engagement of the bracket 978 to the transmission component 996, and due to the abutting engagement of the bracket 978 and the slider 976, the movement of the transmission component 996 is with effect that the bracket 978 and the slider 976 are displaced longitudinally rearward, relative to the rail 974 and relative to the robot defined object supporter 502, until the slider 976 is disposed at the rearmost end of the rail 974 and disposed in abutting engagement with the rail 974, for example, a rear stop of the slider 976. At this point, the displacement mechanism 972 is disposed in the retracted configuration.

In some embodiments, for example, the object transitioning apparatus 420 is coupled to the base 302, for example, via the lift mechanism 340. While the object transitioning apparatus 420 is coupled to the base 302, said longitudinal displacements of the slider 976 and bracket 978, relative to the robot defined object supporter 502, are also relative to the base 302.

In some embodiments, for example, the object manipulator 970 includes an end effector 1000 that is configured for grasping an object, such that a grasped object is established. The end effector 1000 is coupled to the displacement mechanism 972 such that the end effector 1000 is longitudinally displaceable, relative to the robot defined object supporter 502, in response to longitudinal displacement of the slider 976 and the bracket 978. In some embodiments, for example, the displacement of the end effector 1000, relative to the robot defined object supporter 502, is in a longitudinal direction. In some embodiments, for example, the displacement of the end effector 1000, relative to the robot defined object supporter 502, is within a horizontal plane. In some embodiments, for example, the displacement of the end effector 1000, relative to the robot defined object supporter 502, in the longitudinal direction, is within the horizontal plane.

In some embodiments, for example, as depicted in FIG. 132, the object emplacement/removal tool 971 includes a mounting block 1010. As depicted, the mounting block 1010 is coupled to the displacement mechanism 972, in particular, the brackets 978. The brackets 978 are connected to the mounting block 1010 at opposite ends of the mounting block 1010. The mounting block 1010 is coupled to the brackets 978 such that the mounting block 1010 is displaceable, relative to the robot defined object supporter 502, in response to displacement of the bracket 978 and slider 976, relative to the robot defined object supporter 502. In some embodiments, for example, the displacement of the mounting block 1010, relative to the robot defined object supporter 502, is in a longitudinal direction. In some embodiments, for example, the displacement of the mounting block 1010, relative to the robot defined object supporter 502, is within a horizontal plane. In some embodiments, for example, the displacement of the mounting block 1010, relative to the robot defined object supporter 502, in the longitudinal direction, is within the horizontal plane.

In some embodiments, for example, the end effector 1000 is coupled to the mounting block 1010. In some embodiments, for example, the end effector 1000 is mounted to the mounting block 1010, such that the end effector 1000 is longitudinally displaceable with the mounting block 1010. In some embodiments, for example, the coupling of the end effector 1000 to the displacement mechanism 972 is effected via the coupling of the end effector 1000 to the mounting block 1010, which is coupled to the brackets 978 of the displacement mechanism 972.

In some embodiments, for example, the end effector 1000 includes a grasping configuration 1020 to grasp the object, such that a grasped object is established.

In some embodiments, for example, the grasping configurations 1020 includes a suction cup 1022. In some embodiments, for example, the object is grasped by the suction cup 1022 by suctioning of a surface portion of the object by the suction cup 1022. As depicted in FIG. 132, in some embodiments, for example, the grasping configuration 1020 includes four suction cups 1022A, 1022B, 1022C, and 1022D, wherein the suction cups 1022 are disposed in side by side relationship. In some embodiments, for example, the suction cups 1022 are mounted to the mounting block 1010 such that they are facing in a longitudinally forward direction.

Similar to the object manipulator 430, in some embodiments, for example, each one of the suction cups 1022, independently, is disposed in fluid communication with a pump via a valve block. The pump and valve block are disposed within the mounting block 1010. Each one of the pump and the valve block, independently, is disposed in data communication with the controller 202 and disposed in electrical communication with the battery, for example, via the electrical and data cable 998. The controller 202 is configured to send control commands to the pump to control the amount of suction at the suction cups 1022. The controller 202 is configured to send control commands to the valve block to open and close one or more valves of the valve block control air flow between the pump and the one or more suction cups 1022.

In some embodiments, for example, for each suction cup 1022 of the grasping configuration 1020, the grasping configuration 1020 includes a vacuum sensor. Each vacuum sensor, independently, is disposed in data communication with the controller 202, for example, via the electrical and data cable 998. In some embodiments, for example, each vacuum sensor, independently, is disposed in electrical communication with the battery, for example, via the electrical and data cable 998. Each vacuum sensor, independently, collects data representative of the suction pressure of a respective suction cup. Based on this data, the controller 202 determines if the suction cup 1022 is suctioning a surface portion of the object, and therefore, if the object is grasped by the suction cup 1022. Based on this data, the controller 202 can further determine if there is an absence of suction of a surface portion of an object by a suction cup 1022, for example, due to a defect on the surface portion of the object, and send a control command to the pump and the valve block to divert suctioning from said suction cup 1022 to one or more other suction cups 1022.

In some embodiments, for example, each grasping configuration 1020 of the end effector 1000, independently, is coupled to the mounting block 1010 such that the grasping configuration 1020 is pivotable, relative to the mounting block 1010, such that the grasping configuration 1020 is disposable in contact engagement, for example, sealing engagement, with an angled surface of an object, for grasping the object. In some embodiment, the coupling of the grasping configuration 1020 to the mounting block 1010 includes a hinge to effect the pivoting of the grasping configuration 1020, relative to the mounting block 1010. In some embodiments, for example, the grasping configuration 1020 is pivotable, relative to the mounting block 1010, by at least one degree, for example, five degrees.

In some embodiments, for example, each suction cup 1022 of the grasping configuration 1020 of the end effector 1000, independently, is coupled to the mounting block 1010 such that the suction cup 1022 is pivotable, relative to the mounting block 1010, such that the suction cup 1022 is disposable in contact engagement, for example, sealing engagement, with an angled surface of an object, for grasping the object. In some embodiment, the coupling of the suction cup 1022 to the mounting block 1010 includes a hinge to effect the pivoting of the suction cup 1022, relative to the mounting block 1010. In some embodiments, for example, the suction cup 1022 is pivotable, relative to the mounting block 1010, by at least one degree, for example, five degrees.

In some embodiments, for example, similar to the optical sensors 490 and displacement transducers 498 of the object manipulator 430, the object manipulator 970 includes optical sensors 1030, for example, stereo cameras, 3D cameras or LIDAR sensors, and displacement transducers 1032, for example, infrared sensors. The optical sensors 1030 and displacement transducers 1032 are mounted on a front surface of the mounting block 1010, between the suction cups 1022A and 1022B, and between 1022C and 1022D.

Each one of the optical sensors 1030, independently, is configured for collecting data, including data representative of: (i) a shape of a surface of an object facing the sensor 1030, (ii) the distance between the optical sensor 1030 and the object, and (iii) identifying labels (e.g. printed label, stock-keeping unit (SKU), barcode, Quick Response (QR) code, and/or the like) on the object.

In some embodiments, for example, based on the data representative of the shape of the surface of the object facing the sensor 1030, the Al engine 224 defines a bounding box 904 around the object, as depicted in FIG. 3 and the controller 202 determines the dimensions and the center of the object based on dimensions and center of the bounding box 904.

In some embodiments, for example, based on the data representative of the shape of the empty space facing the sensor 1030, the Al engine 224 defines a bounding box 912 around an empty space 910, as depicted in FIG. 4, and the controller 202 determines the dimensions of the empty space 910 based on the dimensions of the bounding box 912.

In some embodiments, for example, the object manipulator 970 includes displacement transducers 1032, for example, infrared sensors. Each one of the displacement transducer 1032, independently, is configured for collecting data, including data representative of the distance between the displacement transducer 1032 and the object. In some embodiments, for example, the object manipulator 970 includes the displacement transducers 1032 such that the controller 202 has object distance data for processing if the optical sensors 1030 are unable to provide object distance data, for example, if the optical sensors 1030 are within a threshold minimum distance of (e.g. is too close to) the object.

In some embodiments, for example, the controller 202 controls the speed of the longitudinal displacement of the slider 976 and the bracket 978 based on the object distance data from the optical sensors 1030 and the displacement transducers 1032, similar to controlling the speed of extension of the extendible arm 432.

In some embodiments, for example, the optical sensors 1030 and displacement transducers 1032 are disposed in electrical and data communication with the controller 202 and battery of the robot 110, for example, via electrical and data cable 998.

In some embodiments, for example, the end effector 1000 is displaceable longitudinally, relative to the robot defined object supporter 502, via the actuator configuration 980. In some embodiments, for example, while the object transitioning apparatus 420 is coupled to the base 302, the end effector 1000 is displaceable longitudinally, relative to the base 302.

In some embodiments, for example, while the end effector 1000 is coupled to the mounting block 1010, and the mounting block 1010 is coupled to the bracket 978, and the displacement mechanism 972 is disposed in the retracted configuration, the end effector 1000 is disposed in a retracted configuration.

In some embodiments, for example, while the end effector 1000 is coupled to the mounting block 1010, and the mounting block 1010 is coupled to the bracket 978, and the displacement mechanism 972 is disposed in the extended configuration, the end effector 1000 is disposed in an extended configuration.

In some embodiments, for example, the end effector 440, the end effector 1000, the extendible arm 432, and the robot-defined object supporter 502 are co-operable with an object and a first object supporter such that:
while: (i) a first object supporter is disposed on a side of the robot-defined object supporter 502, (ii) the object is supported by the first object supporter, and (iii) the end effector 432 is grasping the object, such that the grasped object is established:
in the retracted configuration, the end effector 1000 is disposed, relative to the extendible arm 432, such that there is absence of interference, by the end effector 1000, to effect lateral movement of the grasped object, towards the robot-defined object supporter 502, by the extendible arm 432.

In some embodiments, for example, the end effector 1000 and the robot-defined object supporter 502 are co-operable with the object and a second object supporter such that:
while: (i) a second object supporter is disposed in front of the robot-defined object supporter 502, (ii) the object is supported by the second object supporter, and (iii) the end effector 1000 is disposed in the extended configuration and is grasping the object, such that the grasped object is established:
the grasped object is movable towards the robot-defined object supporter 502 by the end effector 1000.

In some embodiments, for example, the movement of the grasped object towards the robot-defined object supporter 502 by the second end effector is effectible in response to the longitudinal displacement of the end effector 1000, relative to the robot defined object supporter 502. In some embodiments, for example, the movement of the grasped object towards the robot-defined object supporter 502 by the second end effector is effectible in response to the longitudinal displacement of the end effector 1000, relative to the base 302.

In some embodiments, for example, the longitudinal displacement of the end effector 1000, relative to the base 302, is independent of the lateral displacement of the end effector 440, relative to the base 302.

In some embodiments, for example, if the displacement mechanism 972 did not include the slider 976 and the pulleys 992 and 994, and the bracket 978 was coupled to the transmission component 996 that looped only around the pulleys 990A, the bracket 978 would be limited to being longitudinally displaceable, relative to the rail 974, between the pulleys 990. In such embodiments, for example, the rearmost positioning of the bracket 978, relative to the rail 974, would be defined forwardly of the pulley 990B (e.g. a pulley 990B-defined rearmost position). Said rearmost positioning would be similar to the positioning of the pulley 992B as depicted in FIG. 133 or FIG. 134. In such embodiments, for example, while the mounting block 1010 is coupled to the brackets 978 of the displacement mechanism 972 and the displacement mechanism 972 is disposed in the retracted configuration, such that the brackets 978 are disposed at the pulley 990B-defined rearmost position, the mounting block 1010 and/or the grasping configuration 1020 may be disposed, relative to the extendible arm 432 or to the grasped object, such that there may be interference, by the mounting block 1010 and/or grasping configuration 1020, of the lateral movement of the grasped object, towards the robot-defined object supporter 502, by the extendible arm 432.

However, due to the configuration of the slider 976, in particular, the disposition of the pulley 994B rearwardly of the pulley 990B while the displacement mechanism 972 is disposed in the retracted configuration, the rearmost positioning of the bracket 978, relative to the rail 974, which is effected while the displacement mechanism 972 is disposed in the retracted configuration, is rearward of said pulley 990B-defined rearmost position.

In such embodiments, for example, while the mounting block 1010 is coupled to the brackets 978 of the displacement mechanism 972 and the displacement mechanism 972 is disposed in the retracted configuration, such that the brackets 978 are disposed at its rearmost position, relative to the rail 974, which is rearwardly of the pulley 990B-defined rearmost position, the grasping configuration 1020 is disposed, relative to the extendible arm 432 or to the grasped object, such that there is an absence of the lateral movement of the grasped object, towards the robot-defined object supporter 502, by the extendible arm 432.

Similarly, in some embodiments, for example, if the displacement mechanism 972 did not include the slider 976 and the pulleys 992 and 994, and the bracket 978 was coupled to the transmission component 996 that looped only around the pulleys 990A, the bracket 978 would be limited to being longitudinally displaceable, relative to the rail 974, between the pulleys 990. In such embodiments, for example, the forwardmost positioning of the bracket 978, relative to the rail 974, would be defined rearwardly of the pulley 990A (e.g. a pulley 990A-defined forwardmost position). Said forwardmost positioning would be similar to the positioning of the pulley 992A as depicted in FIG. 135 or FIG. 136. In such embodiments, for example, while the mounting block 1010 is coupled to the brackets 978 of the displacement mechanism 972 and the displacement mechanism 972 is disposed in the extended configuration, such that the brackets 978 are disposed at the pulley 990A-defined forwardmost position, the grasping configuration 1020 may be disposed, relative to the robot-defined object supporter 502, such that the grasping configuration 102 is disposed rearwardly of a forwardmost surface 999 of the robot-defined object supporter 502. In such embodiments, for example, the object manipulator 970 may not be able to fully push a supported object off the robot-defined object supporter 502 for displacing the object from the robot-defined object supporter 502 to an object supporter disposed forwardly of the robot-defined object supporter 502, or may not be able to grasp an object that is supported on said object supporter for displacing the object from the object supporter to the robot-defined object supporter 502.

However, due to the configuration of the slider 976, in particular, the disposition of the pulley 994A rearwardly of the pulley 990A while the displacement mechanism 972 is disposed in the extended configuration, the forwardmost positioning of the bracket 978, relative to the rail 974, which is effected while the displacement mechanism 972 is disposed in the extended configuration, is forward of said pulley 990A-defined rearmost position.

In such embodiments, for example, while the mounting block 1010 is coupled to the brackets 978 of the displacement mechanism 972 and the displacement mechanism 972 is disposed in the extended configuration, such that the brackets 978 are disposed at its forwardmost position, relative to the rail 974, which is forwardly of the pulley 990A-defined rearmost position, the grasping configuration 1020 is disposed, relative to the robot-defined object supporter 502, such that the grasping configuration 102 is disposed forwardly of the forwardmost surface 999 of the robot-defined object supporter 502. In such embodiments, for example, the object manipulator 970 is configured to fully push a supported object off the robot-defined object supporter 502 for displacing the object from the robot-defined object supporter 502 to an object supporter disposed forwardly of the robot-defined object supporter 502, and is configured to grasp an object that is supported on said object supporter for displacing the object from the object supporter to the robot-defined object supporter 502.

The robot 110 is configured to retrieve an object from an object supporter disposed longitudinally forward of the robot defined object supporter 502, in a manner similar to retrieving an object from an object supporter disposed laterally of the robot defined object supporter 502, as described above with respect to FIG. 89 to FIG. 112.

The controller 202 receives a command from a client computing device 120 via the server 114 to retrieve a target object 900 from an object supporter in a target area of the warehouse, and move the object to a desired location of the warehouse, such as a loading zone 112.

The controller 202 determines the path to the target area from the current location of the robot 110, and move to the target area.

The optical sensors 1030 collect data representative of the objects supported by the object supporters in the area, and the controller 202 identifies the target object 900, and the robot 110 is positioned relative to the object supporter such that the object supporter is disposed longitudinally forward of the robot 110.

Then, the robot 110 is anchored to the floor via the anchor configuration 510.

With the robot 110 anchored to the floor, the object transitioning apparatus 420 is elevated by the lift mechanism 340 such that the robot-defined object supporter 502 is disposed at the same elevation as the object supporter on which the object 900 is supported.

To grasp the object, while the displacement mechanism 972 is disposed in the retracted configuration and the end effector 1000 is disposed in the retracted configuration, the end effector 1000, which includes the suction cups 1022, the end effector 1000 is longitudinally displaced forwardly towards the object via longitudinal displacement of the mounting block 1010 by the displacement mechanism 972. Similar to the object manipulator 430, the speed of the longitudinal displacement of the suction cups 1022 are controlled by the controller 202 based on the object distance data from the optical sensors 1030 and displacement transducers 1032.

Similar to the object manipulator 430, while the suction cups 1022 becomes disposed within a threshold distance of the surface of the object, for example, within 2 inches, for example, 2.2 inches, the controller 202 sends a control command to the pump and the valve block to blow air out of the suction cups 1022 to clean the surface of the object 900. Then, the controller 202 sends a control command to the pump to operate in an air suction mode to suction the air from the suction cups 1022, for suctioning the surface of the object 900 by the suction cups 1022.

While the telescoping arm and the suction cups 1022 continue to extend towards the object 900, the controller 202 monitors the suction pressure via the vacuum sensors of the object manipulator 970, and also monitors the distance between the suction cups 1022 and the object 900 via the optical sensors 1030 and displacement transducers 1032, to determine if one or more suction cups 1022 are disposed in contact engagement with, and suctioning, the object 900. In some embodiments, for example, an increase in suction pressure, for example, to a threshold pressure, at a suction cup 1022 is indicative of the suction cup 1022 becoming disposed in contact engagement with the object 900 and suctioning the object 900. In some embodiments, for example, the disposition of a suction cup 1022 within a threshold distance of the object 900, is indicative of the suction cup 1022 becoming disposed in contact engagement with the object 900.

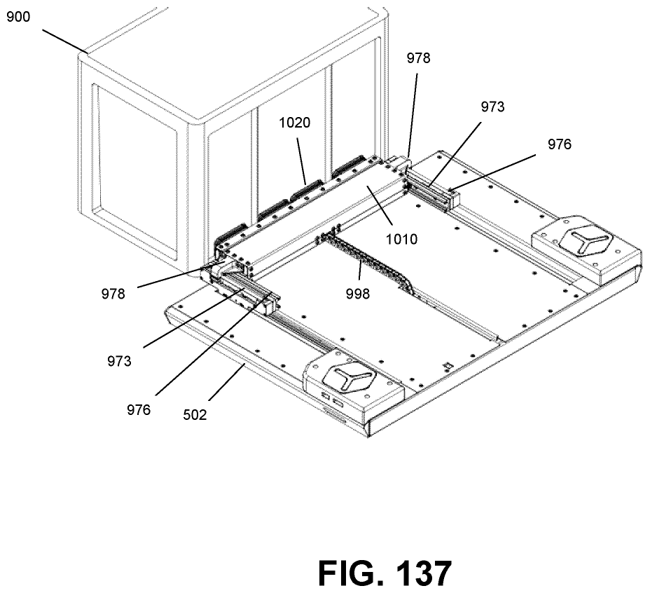

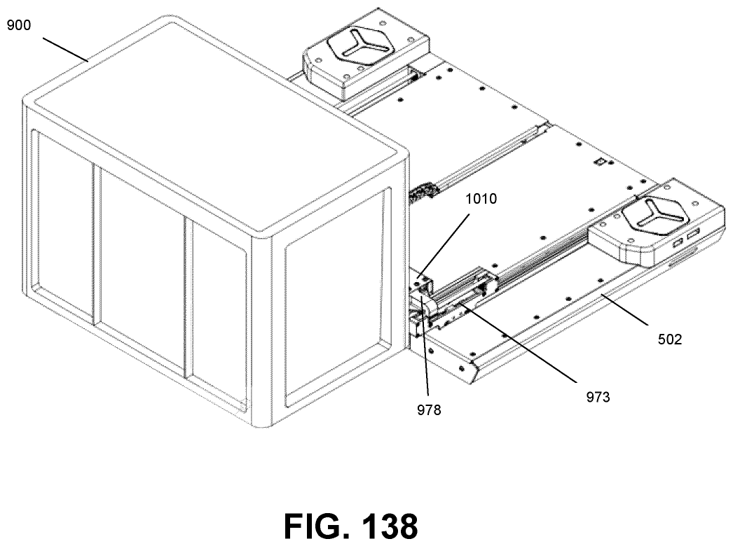

In response to determination by the controller 202 that the suction cups 1022 are suctioning the object 900, the longitudinal extension, in the forward direction, of the displacement mechanism 972 is stopped, with effect that the longitudinal displacement of the suction cups 1022 is stopped. In some embodiments, for example, at this point, as depicted in FIG. 137 and FIG. 138, the displacement mechanism 972 is disposed in the extended configuration. In some embodiments, for example, at this point, as depicted in FIG. 137 and FIG. 138, the end effector 1000 is disposed in the extended configuration.

In some embodiments, for example, as depicted FIG. 137 to FIG. 142, the object 900 has a width, measured along the lateral axis, that is greater than the minimum spacing distance between the sliders 976, measured along the lateral axis. With the object 900 grasped by the suction cups 1022, the brackets 978 are displaced in a rearward direction to longitudinally displace the object 900, in a rearward direction, towards the robot-defined object supporter 502.

The object 900 is displaced in a rearward direction until the object 900 is disposed in abutting engagement with the sliders 976. While: (i) the brackets 978 are urged to displace in the rearward direction, (ii) the end effector 1000, for example, the suction cups 1022, is grasping the object 900, and (iii) the object 900 is disposed in abutting engagement with the sliders 976, the object 900 urges the sliders 976 to displace in the rearward direction. This is with effect that the brackets 978, the sliders 976, and the object 900 are displaced in the rearward direction.

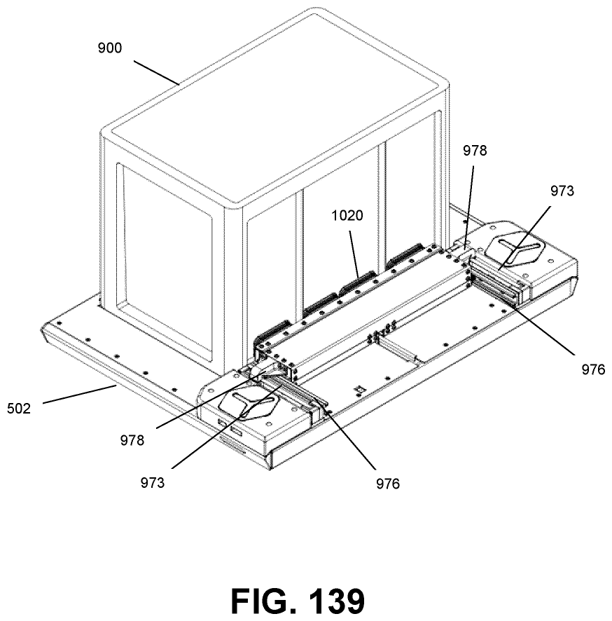

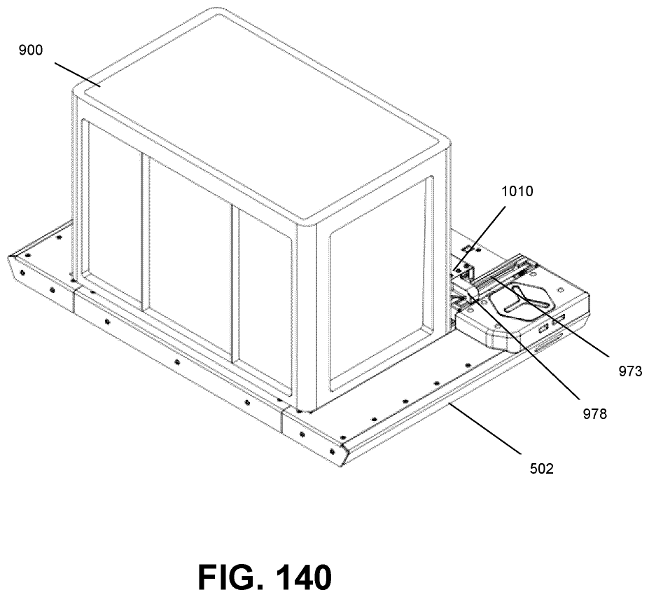

The brackets 978, the sliders 976, and the object 900 are longitudinally displaced in the rearward direction until the sliders 976 are disposed in abutting engagement with the rails 974, for example, the rear tops of the rails 974, as depicted in FIG. 139 and FIG. 140. At this point, the object 900 is emplaced on the robot defined object supporter 502.

With the object emplaced on the robot defined object supporter 502, the controller 202 sends a control command to the pump to turn off the pump, such that there is an absence of suction at the suction cups 1022. This effects the release of the grasping of the object 900 by the suction cups 1022, with effect that the object 900 becomes supported by the robot-defined object supporter 502.

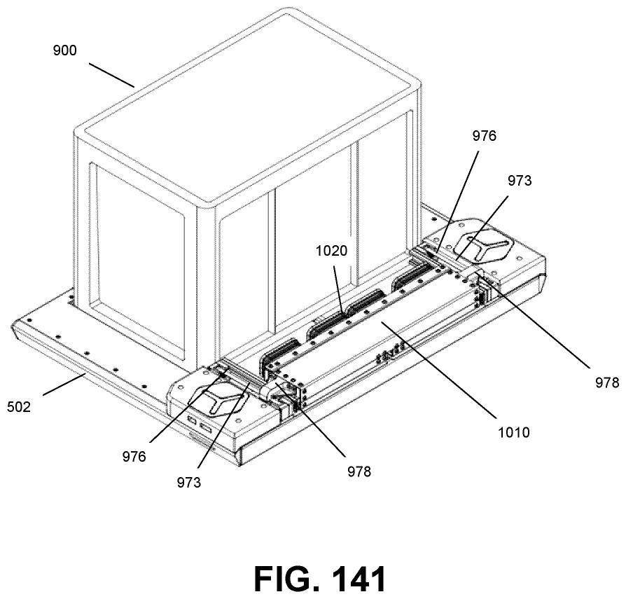

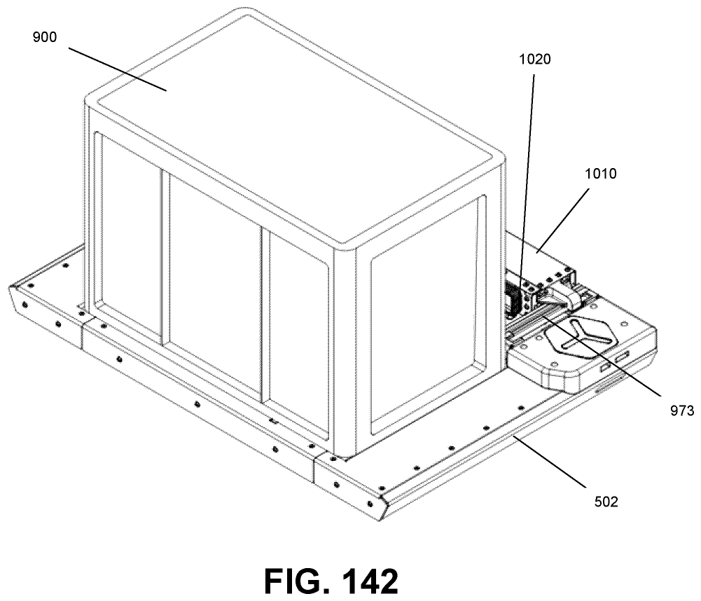

At this point, the brackets 978 are longitudinally displaced in the rearward direction until the brackets 978 abuts against the sliders 976, for example, the rear stops of the sliders 976, with effect that the displacement mechanism 972 becomes disposed in the retracted configuration, as depicted in FIG. 141 and FIG. 142.

At this point, the controller 202 sends a control command to the anchoring configuration 510 to dispose the anchoring configuration 510 in the anchoring-ineffective state, and the base 302 moves the robot 110 to a desired location of the warehouse to move the object 900 to said desired location of the warehouse, such as a loading zone. While the robot 110 is at the loading zone, the object can be emplaced on an object supporter disposed in the loading zone by the object manipulator 430 or the object manipulator 970.

In some embodiments, for example, the object 900 has a width, measured along the lateral axis, that is less than the minimum spacing distance between the sliders 976, measured along the lateral axis. In such embodiments, for example, with the object 900 grasped by the suction cups 1022, the brackets 978 are displaced in a rearward direction to longitudinally displace the object 900, in a rearward direction, towards the robot-defined object supporter 502, with effect that the object 900 is displaced longitudinally, in a rearward direction, towards the robot-defined object supporter 502.

The object 900 is displaced in a rearward direction until the brackets 978 are disposed in abutting engagement with the sliders 976, for example, the rear stop of the sliders 976. At this point, the displacement mechanism 972 is disposed in the intermediate rearward configuration.

In response to further displacement in the rearward direction of the brackets 978, while: (i) the end effector 1000 is grasping the object 900, and (ii) the displacement mechanism 972 is disposed in the intermediate rearward configuration, the brackets 978 urge the sliders 976 to displace in the rearward direction. This is with effect that the brackets 978, the sliders 976, and the object 900 are displaced in the rearward direction.

The object 900 is displaced in the rearward direction until the object 900 is emplaced on the robot defined object supporter 502. The controller 202 monitors the longitudinal displacement of the brackets 978, the sliders 976, and the object 900 in the rearward direction, such that the object 900 does not become disposed between the blocks 1062. In some embodiments, for example, said monitoring is effected by the controller 202, based on data collected from the optical sensor 490 and/or displacement transducers 498, which are disposed in opposing relationship, relative to the brackets 978, the sliders 976, and the object 900.

With the object emplaced on the robot defined object supporter 502, the controller 202 sends a control command to the pump to turn off the pump, such that there is an absence of suction at the suction cups 1022. This effects the release of the grasping of the object 900 by the suction cups 1022, with effect that the object 900 becomes supported by the robot-defined object supporter 502.

In some embodiments, for example, the controller 202 determines the depth of the object 900, measured along the longitudinal axis. Based on data from the optical sensor 490 and/or displacement transducers 498. In some embodiments, for example, the controller 202 monitors the displacement of the brackets 978, the sliders 976, and the object 900 in the rearward direction, such that the object 900, such that the object 900 longitudinally displaces in the rearward direction by a distance that has a value of at least the depth of the object 900, before sending a control command to the pump to turn off the pump to release the grasping of the object 900 by the suction cups 1022.

At this point, with the grasping of the object 900 by the suction cups 1022 released, and the object 900 emplaced on the robot-defined object supporter 502, the brackets 978 and the sliders 976 are longitudinally displaced in the rearward direction until the sliders 976 abuts against the rails 974, for example, the rear stops of the rails 974, with effect that the displacement mechanism 972 becomes disposed in the retracted configuration, as depicted in FIG. 141 and FIG. 142.

The robot 110 is configured to emplace an object on an object supporter disposed longitudinally forward of the robot defined object supporter 502, for example, for storage of the object, in a manner similar to emplacement of an object supporter disposed laterally of the robot defined object supporter 502, as described above with respect to FIG. 89 to FIG. 112.

In some embodiments, for example, the controller 202 receives a control command from a client computing device 120 via the server 114 to store a target object 900 on an object supporter in a target area of the warehouse.

In some embodiments, for example, the server computer 114 determines the target area in the warehouse based on, for example, the inventory rules, and send the control command to the robot 110. In some embodiments, for example, the robot 110 grasps the target object 900 from a loading zone 112, for example, via the object manipulator 430 or the object manipulator 970, and is emplaced on the robot-defined object supporter 502, and the robot 110 moves the object 900 to the target area of the warehouse along a calculated path. In some embodiments, for example, the object 900 is placed on the robot-defined object supporter 502 by an operator.

While the object 900 is supported on the robot-defined object supporter 502, the optical sensors 1030 collect data representative of the shape and dimensions of the object 900, including the shape and dimensions of the surface of the object that is 900 opposing the optical sensors 1030.

As the robot 110 enters the target area, the optical sensors 1030 collect data representative of the object supporters, the objects on the supporters, and the available storage space on the object supporters. In some embodiments, for example, the robot 110 turns on one or more of its lighting components, such as one or more LED lights, for illuminating the field of view (FOV) of the optical sensors 490.

Based on the data collected from the optical sensors 1030, the controller 202, for example, the Al engine 224, identifies and locates the empty spaces 910, and defines a boundary box 912 around each of the empty spaces 910, using a suitable algorithm such as a SSD algorithm.

Based on the bounding box 912, the dimensions of each empty space 910 are determined by the controller 202, and compared with the dimensions of the object 900, for example, the dimension of the surface of the object 900 facing the optical sensors 1030. The controller 202 identifies an empty space 910 that is able to receive the object 900, based on the comparison of the dimensions of the object 900 and the dimensions of the space 910. In response to identification of the suitable empty space 910 suitable for receiving the object 900, the object 900 is moved from the robot defined object supporter 502 to the object supporter, in particular, moved into the empty space 910, via a process similar (but reversed) to that described with respect to retrieving the object 900 from the object supporter disposed forwardly of the robot defined object supporter 502.

In some embodiments, for example, wherein the object transitioning apparatus 420 includes the end effector 440 and the end effector 1000, the object transitioning apparatus 420 does not have to rotatable, for example, about a vertical axis, for example, by lift mechanism 340, relative to the base 302, for interaction with an object supported on a first object supporter disposed laterally of the robot 110, and also for interaction with an object supported on a second object supporter disposed forward of the robot 110. Such rotation of the object transitioning apparatus 420 about the vertical axis may require an increase in the minimum spacing distance between objects supporters that define an aisle, for example, the width of an aisle, such that the object transitioning apparatus 402 is clear of object supporters or objects while the object transitioning apparatus 420 is being rotated. By avoiding rotation of the object transitioning apparatus 420 about a vertical axis, relative to the base 302, the increasing of the width of an aisle can be avoided, such that the warehouse space can be more efficiently used to store objects.

In some embodiments, for example, while the robot 110 is disposed in a certain location of the warehouse, for example, a loading area 112, or at an object storage area having one or more object supporters, it is desirable for the robot 110 to interact with more than one object being moving to another location of the warehouse.

In some embodiments, for example, the robot 1040 includes a rack 1040, as depicted in FIG. 5, the rack 1040 including one or more object supporters 1042 that are each, independently, configured to support an object, such that a supported object is established.

In some embodiments, for example, the rack 1040 is releasably couplable to the base 302. While the rack 1040 is releasably coupled to the base 1040, the rack 1040 is disposed in opposing relationship with the robot defined object supporter 502, for example, disposed in front of the robot defined object supporter 502.

In some embodiments, for example, the rack 1040 comprises a connection counterpart, for example, an opening, disposed at a height of a corresponding connection counterpart, for example, an extension that is extendible into the opening, of the base 302. In some embodiments, for example, the robot 110 is displaceable relative to the rack 1040 to align the connection counterpart of the rack 1040 and the connection counterpart of the base 302. With the connection counterparts aligned, the robot 100 is displaced forward, relative to the rack 1040, to effect interaction with the connection counterpart of the rack 1040 and the base 302. The interaction of the connection counterpart of the rack 1040 and the base 302 is with effect that the rack 1040 and the base 302 become coupled, such that the rack 1040 is displaceable with the base 302.

In some embodiments, for example, after displacing an object from an object supporter that is disposed laterally of the robot 110, relative to the robot defined object supporter 502, and after emplacing the object on the robot defined object supporter 502, via the object manipulator 430, the elevation of the object transitioning apparatus 402 is adjustable, by the lift mechanism 340. While the elevation of the object transitioning apparatus 402 is being adjusted, the optical sensors 1030 and/or the displacement transducers 1032 are collecting data representative of the object supporters 1042, for example, if there is an object on the object supporter 1042 or if there are no objects on the object supporter 1042. In some embodiments, for example, the controller 202 determines that an object supporters 1042 is able to support the object, based on data collected from the optical sensors 1030 and/or the displacement transducers 1032.

In response to said determination, the elevation of the object transitioning apparatus 402 is such that the robot defined object supporter 502 and one of the object supporters 1042 of the rack become disposed at the same elevation

At this point, the object supported on the robot defined object supporter 502 can be emplaced on one of the object supporters 1042 via the object manipulator 970.

With the rack 1040 coupled to the base 302, the robot 110 can retrieve and move more than one object at a time. For example, the robot 110 can retrieve a first object from an object supporter disposed laterally of the robot 110, and emplace the first object on one of the object supporters 1042 of the rack 1040, such that the first object is supported by the object supporters 1042 of the rack 1040. Then, the robot 110 can retrieve a second object, from the same or a different object supporter, disposed laterally of the robot 110, and emplace the second object on another object supporter 1042 of the rack 1040. Then, the robot 110 can move the plurality of objects to a desired location, for example, a loading zone 112.

After moving the rack 1040, which is supporting the plurality of objects to a desired location, the rack 1040 is decoupled from the base 302, and the base 302 is coupled to another rack 1040 that is empty, and move to one or more object supporters to retrieve additional objects.

Similarly, with a plurality of objects supported by the rack 1040, the robot 110 can move a first object from the rack 1040 to an object supporter disposed laterally of the robot 110, for example, for storage of the first object on the object supporter. Then, the robot 110 can move a second object from the rack 1040, to the same or a different object supporter, disposed laterally of the robot 110. After the objects are emplaced on the object supporters, the robot 110 can retrieve objects, or couple with another rack 1040 for storing additional objects.

In some embodiments, for example, it is desirable to retrieve a target object on an object supporter disposed laterally of the robot 110, but there is a pre-existing object disposed between the object manipulator 430 and the object, such that the object is occluded by the pre-existing object. In such embodiments, for example, the pre-existing object may be moved to an object supporter 1042 of the rack 1040, such that the occlusion of the target object by the pre-existing object is defeated. With the occlusion defeated, the target object can be move to another object supporter 1042 of the rack 1040, and the pre-existing object can be moved back to the object supporter.

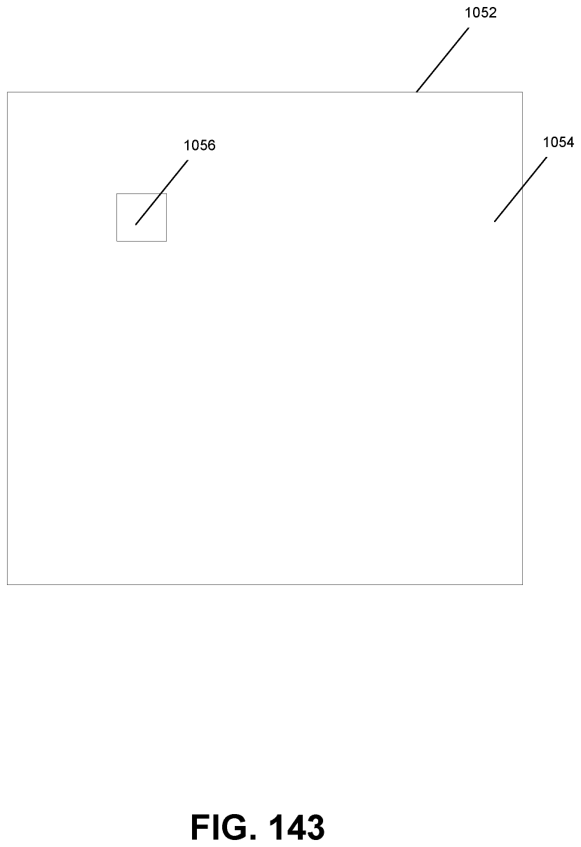

In some embodiments, the robot 100 includes a temperature sensor 1050 that is displaceable with the end effector 440 for collecting temperature data while the end effector 440 is being displaced, for example, laterally displaced, relative to the base 302. In such embodiments, for example, the temperature sensor 1050 is mounted to the object manipulator 430, for example, the extendible arm 432 or the driver 450. As depicted in FIG. 143, the temperature sensor 1050 is mounted to the driver 450. The temperature sensor 1050 is longitudinally displaceable with the object manipulator 430, for example, via the lateral displacement of the extendible arm 432, relative to the base 302, or via lateral displacement of the driver 450, relative to the base 302 or relative to the extendible arm 432.

The end effector 440 and the temperature sensor 1050 are co-operatively configured such that, while the end effector 400 is being displaced relative to the base 302, the temperature sensor 1050 is effective for collecting a plurality of temperature data, wherein each one of the temperature data, independently, is representative of a temperature.

In some embodiments, for example, the end effector 440 is co-operable with an object and an object supporter for executing an object displacement operation (e.g. while the end effector 440 is displaced by the object emplacement/removal tool 421 to grasp the object, and then moving the grasped object towards the robot defined object supporter 502), wherein the object displacement operation includes:
while the end effector 440 is spaced-apart from the object supporter, and there is an absence of grasping of an object by the end effector such that the end effector is disposed in an object grasping-absent state:
displacing the end effector 440, relative to the base 302, towards the object supporter, such that the end effector 440 becomes disposed, relative to the object, in a grasping-effective relationship, and while the end effector 440 is disposed in the grasping-effective relationship, grasping the object, such that a grasped object is established;
and
while the end effector 440 is grasping the object, displacing the end effector 440, relative to the base 302, away from the object supporter, such that the grasped object is displaced away from the object supporter.

In some embodiments, for example, the end effector 400 is co-operable with an object and an object supporter for executing an object emplacement operation (e.g. while the object is pushed from the robot defined object supporter 502 to the object supporter to emplace the object on the object supporter), wherein the object emplacement operation includes:
while the end effector 400 is grasping an object and spaced-apart from the object supporter:
displacing the end effector 400, relative to the base 302, towards the object supporter, such that the grasped object becomes disposed in a releasing-effective relationship with the object supporter; and while the grasped object is disposed in a releasing-effective relationship with the object supporter, releasing the object, such that the object becomes supported on the object supporter and the end effector 400 becomes disposed in the object grasping-absent state;
and
after the releasing of the grasped object, and while the end effector 400 is disposed in the grasping-absent state, displacing the end effector 400, relative to the base 302, away from the object supporter.

In some embodiments, for example, the end effector 440 and the temperature sensor 1050 are co-operatively configured such that, during at least one of the object displacement operation and the object emplacement operation:
for each one of the at least one of the object displacement operation and the object emplacement operation, independently, the temperature sensor 1050 is effective for collecting a plurality of temperature data, wherein each one of the collected data, independently, is representative of a temperature.

In some embodiments, for example, the at least one of the object displacement operation and the object emplacement operation is both of the object displacement operation and the object emplacement operation, such that the temperature sensor 1050 is effective for collecting the plurality of temperature data for, independently, each one of the object displacement operation and the object emplacement operation.

In some embodiments, for example, for each one of the collected data, independently, the collected datum is representative of a temperature at a discrete location in space.

In some embodiments, for example, the controller 202 is disposed in operable communication with the temperature sensor 1050. Based on the data from the temperature sensor 1050, the controller 202 is configured to generate a temperature map 1052, or the controller 202 sends the data to the server 114, and the server 114 is configured to generate the temperature map 1052. In some embodiments, for example, the temperature map, as depicted in FIG. 143, is viewable by a user on the client computing device 120.

FIG. 143 depicts an example embodiment of the temperature map 1052. In some embodiments, for example, the temperature map 1052 depicts the temperature of the environment around the object manipulator, object supporter, and the object. In some embodiments, for example, the temperature map 1052 depicts a first area having a first temperature 1054, and a second area having a second temperature 1056. In some embodiments, for example, the temperature map can be presented as a temperature gradient. In some embodiments, for example, the temperature of the environment around the object manipulator, the object supporter, and the object is an important factor for storing temperature sensitive objects. The user can review the temperature map and determine if the temperature around the object manipulator, object supporter, and the object is appropriate. If the temperature is above or below a certain threshold, the user can adjust the temperature accordingly.

Similarly, in some embodiments, for example, the robot 100 includes a temperature sensor 1050 that is displaceable with the end effector 1000 for collecting temperature data while the end effector 1000 is being displaced, for example, longitudinally displaced, relative to the base 302. In such embodiments, for example, the temperature sensor 1050 is mounted to the object transitioning apparatus 971, for example, the slider 976 or bracket 978 of the displacement mechanism 972, or the mounting block 1010, and is longitudinally displaceable with the object transitioning apparatus 971, for example, via the longitudinal displacement of the displacement mechanism 972, relative to the base 302, or via longitudinal displacement of the mounting block 1010, relative to the base 302.

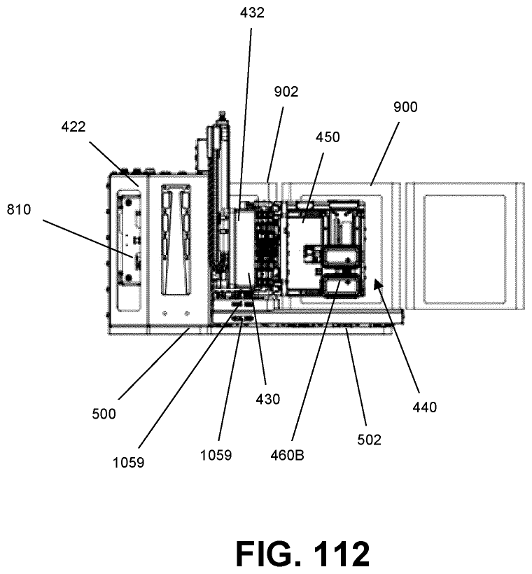

In some embodiments, for example, as depicted in FIG. 112 and FIG. 132, the robot 110 includes additional optical sensors 1059, mounted to blocks 1062, and facing in a lateral direction, for collecting data for the controller 202, for example, the data representative of the environment of the robot, dimensions and shapes of objects, labels on the objects, and the like.

In some embodiments, for example, while the displacement mechanism 972 and the end effector 1000 are disposed in the retracted configuration, the mounting block 1010, the slider 976, and the bracket 978, are disposed between the blocks 1062. In such embodiments, for example, the blocks 1062 function to protect the mounting block 1010, the slider 976, and the bracket 978 against

In some embodiments, for example, as depicted in FIG. 112 and FIG. 132, the robot 110 includes additional optical sensors 1059, mounted to the platform 502, and facing in a lateral direction, for collecting data for the controller 202, for example, the data representative of the environment of the robot, dimensions and shapes of objects, labels on the objects, and the like.

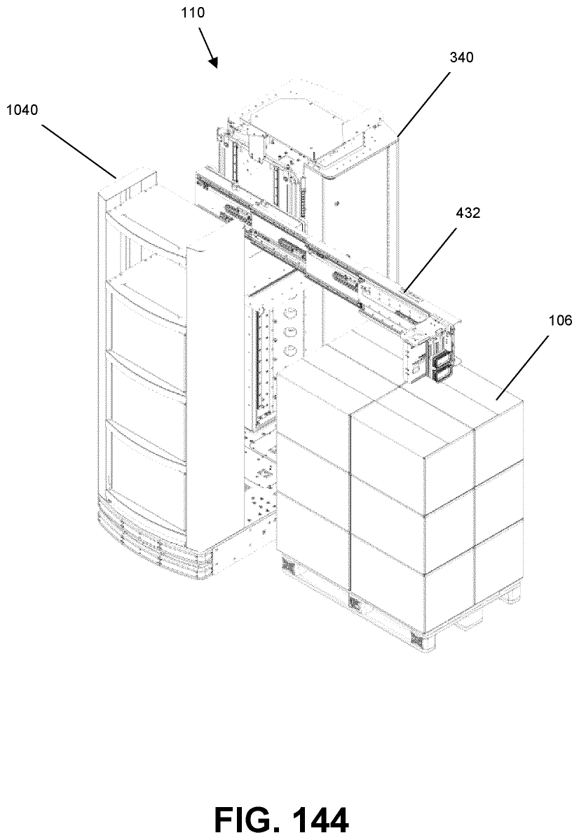

In some embodiments, for example, as depicted in FIG. 144, the system 100 is usable for palletizing and depalletizing activities in the site 102. The robot 110 is able to depalletize arrival pallets of objects 106 from shipping trucks to distribution centers or warehouses. The robotic system 100 may also palletize the objects 106 and get them ready for shipment.

As described above, the grasping configuration 460 of the end effector 440 and the grasping configuration 1020 of the end effector 1000 includes suction cups.

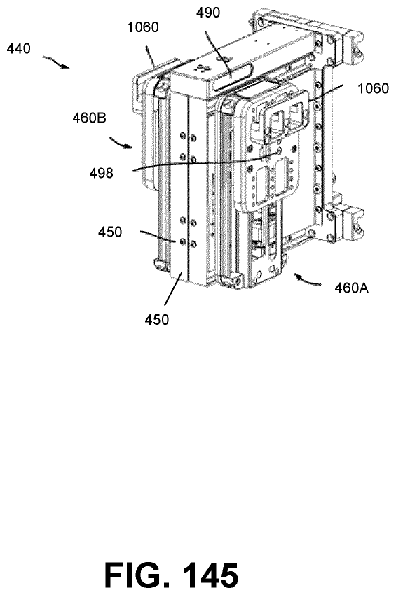

As depicted in FIG. 145 to FIG. 147, in some embodiments, for example, the grasping configuration 460 of the end effector 440 and the grasping configuration 1020 of the end effector 1000 includes upward-facing or downward-facing hooks.

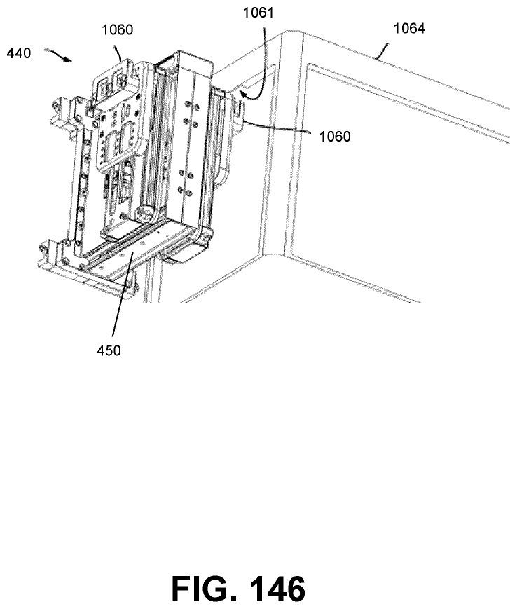

FIG. 145 depicts the grasping configurations 460 of the end effector 440 including an upward-facing hook 1060. As depicted in FIG. 146, the hook 1060 can be received in a handle 1061 of an object 1064 to effect grasping of the object 1064 by the end effector 440.

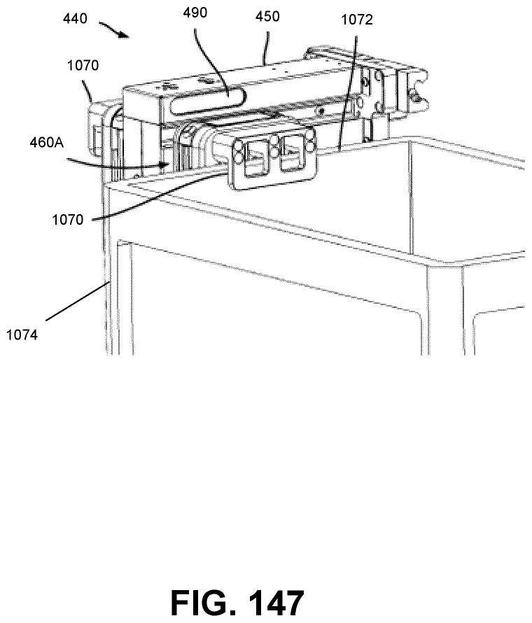

FIG. 147 depicts the grasping configurations 460 of the end effector 440 including a downward-facing hook 1070. As depicted in FIG. 147, the hook 1070 can receive a portion of a front surface-defining wall 1072 of an object 1074 to effect grasping of the object 1074 by the end effector 440.

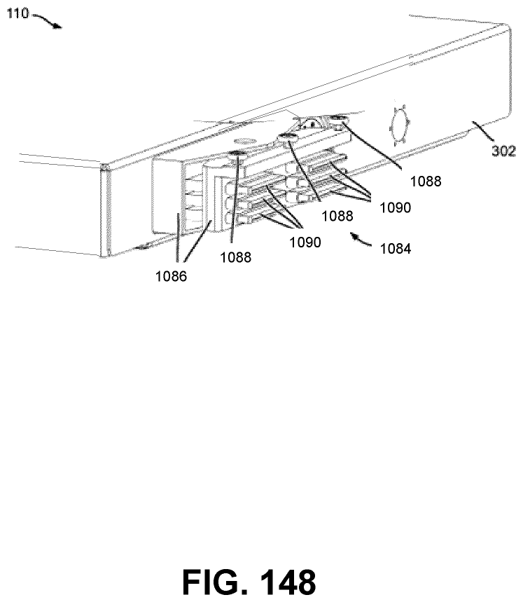

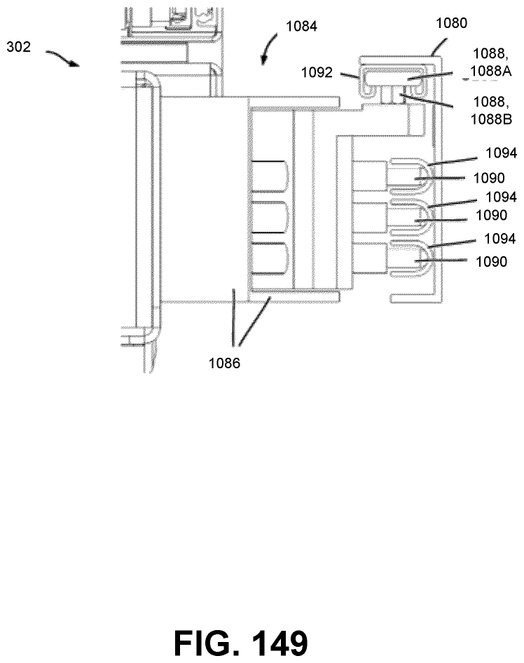

In some embodiments, as depicted in FIG. 148 and FIG. 149, the robot 110 is movable along a rail 1080, having a plurality of tracks 1082 extending in parallel along the rail 1080.

As depicted in FIG. 148 and FIG. 149, in such embodiments, for example, the base 302 comprises a rail-coupling structure 1084 laterally extending from a lateral side of the base 302. The rail-coupling structure 1084 comprises a laterally extending support frame 1086 with one or more vertically extending connectors 1088 extending upwardly from the top of the support frame 1086 and one or more guides 1090 extending laterally from a lateral side of the support frame 1086.

As depicted in FIG. 148 and FIG. 149, each vertically extending connector 1088 has a cylindrical body 1088A with a radially outwardly extended head portion 1088B for engaging a hanging track 1092 of the rail 1080, which comprises a longitudinal bore with a longitudinally extending, reduced-width bottom opening. Each guide 1090 comprises a lateral protrusion for extending into a longitudinally extending side opening of a corresponding longitudinal guiding track 1094 and engaging therewith.

In some embodiments, for example, the robotic system 100 does not need an operator to manually record the exact location of each object 106 in the site 102. Rather, after training of the Al engine 224 using deep learning techniques on robotic vision, the controller 202, via the trained Al engine 224, is configured to determine, in real-time, the location of the target object in the target area based on the data captured by the optical sensors 490, identify the target object based on, e.g., the recognition of the labels, and then associate the location with the identity of the target object. The controller 202 or the server 114 is configured to build a map of the objects 106 and their locations in the site 102. In some embodiments, for example, such a map is stored in a database or as a file (e.g., a CSV file), displayed on a user interface of a client computing device 120 in response to the user's query, and/or integrated with other management systems such as a warehouse execution system (WES), via an application programming interface (API).

The robot 110 described herein is configured such that objects on an object supporter can be placed closer together, such that more objects may be stored in the site 102.

In some embodiments, for example, the object manipulator 430 and the object manipulator 970 are configured to grasp the surface of an object that is opposing the end effector 440 and the end effector 1000, respectfully. In some embodiments, for example, the objects being grasped do not need to be rotated to be grasped and moved by the object manipulator 430 and the object manipulator 970, which allows objects on an object supporter to be placed closer together, such that more objects may be stored in the site 102.

In the preceding description, for purposes of explanation, numerous details are set forth in order to provide a thorough understanding of the embodiments; however the specific details are not necessarily required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

The steps and/or operations in the flowcharts and drawings described herein are for purposes of example only. There may be many variations to these steps and/or operations without departing from the teachings of the present disclosure. For instance, the steps may be performed in a differing order, or steps may be added, deleted, or modified.

The coding of software for carrying out the above-described methods described for execution by a controller (or processor) of the dolly apparatus 14 or other apparatus is within the scope of a person of ordinary skill in the art having regard to the present disclosure. Machine readable code executable by one or more processors of one or more respective devices to perform the above-described method may be stored in a machine readable medium such as the memory of the data manager. The terms “software” and “firmware” are interchangeable within the present disclosure and comprise any computer program stored in memory for execution by a processor, comprising RAM memory, ROM memory, erasable programmable ROM (EPROM) memory, electrically EPROM (EEPROM) memory, and non-volatile RAM (NVRAM) memory. The above memory types are example only, and are thus not limiting as to the types of memory usable for storage of a computer program.

All values and sub-ranges within disclosed ranges are also disclosed. In addition, although the systems, devices and processes disclosed and shown herein may comprise a specific plurality of elements/components, the systems, devices, configurations, and assemblies may be modified to comprise additional or fewer of such elements/components. For example, although any of the elements/components disclosed may be referenced as being singular, the embodiments disclosed herein may be modified to comprise a plurality of such elements/components. The subject matter described herein intends to cover and embrace all suitable changes in technology.

Although the present disclosure is described, at least in part, in terms of methods, a person of ordinary skill in the art will understand that the present disclosure is also directed to the various components for performing at least some of the aspects and features of the described methods, be it by way of hardware (DSPs, ASIC, or FPGAs), software or a combination thereof. Accordingly, the technical solution of the present disclosure may be embodied in a non-volatile or non-transitory machine readable medium (e.g., optical disk, flash memory, etc.) having stored thereon executable instructions tangibly stored thereon that enable a processing device (e.g., a data manager) to execute examples of the methods disclosed herein.

The term “processor” may comprise any programmable system comprising systems using micro- or nano-processors/controllers, reduced instruction set circuits (RISC), application specific integrated circuits (ASICs), logic circuits, and any other circuit or processor capable of executing the functions described herein. The term “database” may refer to either a body of data, a relational database management system (RDBMS), or to both. As used herein, a database may comprise any collection of data comprising hierarchical databases, relational databases, flat file databases, object-relational databases, object oriented databases, and any other structured collection of records or data that is stored in a computer system. The above examples are example only, and thus are not intended to limit in any way the definition and/or meaning of the terms “processor” or “database”.

The present disclosure may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

What is claimed is:

1. A robot, comprising:
a base;
an object manipulator, comprising:
an extendible arm;
an end effector that is coupled to the extendible arm;
wherein:
the end effector is configured for grasping an object, such that a grasped object is established; and
the extendible arm is extendible and retractable for displacing the grasped object relative to the base;
the extendible arm is configurable in a first extendible arm extended configuration and a second extendible arm extended configuration;
in the first extendible arm extended configuration, the extendible arm is extended, in a first direction;
in the second extendible arm extended configuration, the extendible arm is extended, in a second direction that is opposite the first direction.

2. The robot of claim 1, wherein:
the extendible arm is extendible from a extendible arm retracted configuration to the first extendible arm extended configuration, and also extendible from the extendible arm retracted configuration to the second extendible arm extended configuration;
in transitioning from the extendible arm retracted configuration to the first extendible arm extended configuration, the extendible arm is extended in the first direction; and
in transitioning from the extendible arm retracted configuration to the second extendible arm extended configuration, the extendible arm is extended in the second direction.

3. The robot of claim 2, wherein:
the extension of the extendible arm, from the extendible arm retracted configuration to the first extendible arm extended configuration, is a lateral extension of the extendible arm in the first direction, relative to the base; and
the extension of the extendible arm, from the extendible arm retracted configuration to the second extendible arm extended configuration, is a lateral extension of the extendible arm in the second direction, relative to the base.

4. The robot of claim 3, further comprising:
a robot-defined object supporter configured to support the object, the robot-defined object supporter being displaceable laterally, relative to the base, from a supporter retracted configuration to a first supporter extended configuration, and also displaceable laterally from the supporter retracted configuration to a second supporter extended configuration;
wherein:
in transitioning from the supporter retracted configuration to the first supporter extended configuration, the robot-defined object supporter is displaced, relative to the base, in a first direction; and
in transitioning from the supporter retracted configuration to the second supporter extended configuration, the robot-defined object supporter is displaced, relative to the base, in a second direction that is opposite the first direction.

5. The robot of claim 4, wherein the lateral displacement of the extendible arm is independent of the lateral displacement of the robot-defined object supporter.

6. The robot of claim 4 or claim 5, wherein:
the robot-defined object supporter is displaceable laterally, relative to the base.

7. The robot of any one of claims 1 to 6 wherein the base is a mobile base including a mobility platform configured for becoming co-operatively disposed in contact engagement with a reaction surface for facilitating movement of the robot across the reaction surface

8. The robot of any one of claims 4 to 7, and being configured for: (i) displacing a first object relative to a first object supporter, the first object supporter being configured to support the first object, and (ii) displacing a second object relative to a second object supporter, the second object supporter is configured to support the second object, wherein the first object supporter is disposed opposite the second object supporter in a spaced-apart relationship such that an aisle is defined, and the grasping of an object, for which the end effector is configured, includes the grasping of the first object and the grasping of the second object, wherein:
while the robot is disposed within the aisle between the first and second object supporters:
transitioning from the retracted configuration to the first platform extended configuration is with effect that the minimum spacing between the robot-defined object supporter and the first object supporter is reduced;
transitioning from the retracted configuration to the second platform extended configuration is with effect that the minimum spacing between the robot-defined object supporter and the second object supporter is reduced.

9. The robot of claim 8, wherein:
the extendible arm is a telescoping arm;
the telescoping arm is configurable in a first telescoping arm extended configuration and a second telescoping arm extended configuration;
in the first telescoping arm extended configuration, the telescoping arm is extended, in the first direction, along a telescoping arm axis, such that the end effector is disposed for grasping a first object supported on the first object supporter;
in the second telescoping arm extended configuration, the telescoping arm is extended, in the second direction, along the telescoping arm axis, such that the end effector is disposed for grasping a second object supported on the second object supporter.

10. The robot of claim 8 or 9, wherein the base is a mobile base including a mobility platform configured for becoming co-operatively disposed in contact engagement with a reaction surface for facilitating movement of the robot across the reaction surface within the aisle.

11. The robot of claim 10, wherein:
the displacement of the robot-defined object supporter, in the first direction, for transitioning from the supporter retracted configuration to the first supporter extended configuration, is along a supporter extension axis;
the extension of the robot-defined object supporter, in the second direction, for transitioning from the supporter retracted configuration to the second supporter extended configuration, is also along the supporter extension axis.

12. The robot of claim 11, wherein:
the telescoping arm extension axis is parallel to the supporter extension axis.

13. The robot as claimed in any one of claims 8 to 12;
wherein:
a minimum spacing distance, between the first and second object supporters, of less than 12 feet is defined within the aisle.

14. The robot as claimed in claim 13, wherein:
the minimum spacing distance is greater than 25 inches.

15. The robot of any one of claims 1 to 14, further comprising:
a lift mechanism;
wherein the object manipulator is displaceable vertically by the lift mechanism, relative to the base.

16. A robot, configured for: (i) displacing a first object relative to a first object supporter, the first object supporter being configured to support the first object, and (ii) displacing a second object relative to a second object supporter, the second object supporter is configured to support the second object, wherein the first object supporter is disposed opposite the second object supporter in a spaced-apart relationship such that an aisle is defined, comprising:
a base;
an object manipulator, comprising:
an extendible arm;
an end effector that is coupled to the extendible arm;
wherein:
the end effector, wherein, for each one of the first and second objects, independently, the end effector is configured for grasping a respective one of the first and second objects, such that a grasped object is established; and
the extendible arm is extendible and retractable for displacing the grasped object relative to the base;
the extendible arm is configurable in a first extendible arm extended configuration and a second extendible arm extended configuration;
in the first extendible arm extended configuration, the telescoping arm is extended, such that the end effector is disposed for grasping the first object;
in the second extendible arm extended configuration, the extendible arm is extended, such that the end effector is disposed for grasping the second object.

17. The robot of claim 16, wherein:
the extendible arm is extendible from a extendible arm retracted configuration to the first extendible arm extended configuration, and also extendible from the extendible arm retracted configuration to the second extendible arm extended configuration;
in transitioning from the extendible arm retracted configuration to the first extendible arm extended configuration, the extendible arm is extended in a first direction; and
in transitioning from the extendible arm retracted configuration to the second extendible arm extended configuration, the extendible arm is extended in a second direction that is opposite the first direction.

18. The robot of claim 17, wherein:
the extension of the extendible arm, from the extendible arm retracted configuration to the first extendible arm extended configuration, is a lateral extension of the extendible arm in the first direction, relative to the base; and
the extension of the extendible arm, from the extendible arm retracted configuration to the second extendible arm extended configuration, is a lateral extension of the extendible arm in the second direction, relative to the base.

19. The robot of claim 18, further comprising:
a robot-defined object supporter configured to support the object, the robot-defined object supporter displaceable laterally, relative to the base, from a supporter retracted configuration to a first supporter extended configuration, and also displaceable laterally from the supporter retracted configuration to a second supporter extended configuration;
wherein:
transitioning of the robot-defined object supporter from the supporter retracted configuration to the first supporter extended configuration is with effect that the robot-defined object supporter is displaced in a first direction; and
transitioning of the robot-defined object supporter from the supporter retracted configuration to the second supporter extended configuration is with effect that the robot-defined object supporter is displaced in a second direction that is opposite the first direction.

20. The robot of claim 19, wherein the lateral displacement of the extendible arm is independent of the lateral displacement of the robot-defined object supporter.

21. The robot of claim 19 or claim 20, wherein:
the robot-defined object supporter is displaceable laterally, relative to the base.

22. The robot of any one of claims 19 to 21, wherein:
transitioning of the robot-defined object supporter from the supporter retracted configuration to the first supporter extended configuration is with effect that the minimum spacing between the robot-defined object supporter and the first object supporter is reduced;
transitioning of the robot-defined object supporter from the supporter retracted configuration to the second supporter extended configuration is with effect that the minimum spacing between the robot-defined object supporter and the second object supporter is reduced.

23. The robot of any one of claims 19 to 22, wherein:
the extendible arm is a telescoping arm;
the telescoping arm is configurable in a first telescoping arm extended configuration and a second telescoping arm extended configuration;
in the first telescoping arm extended configuration, the telescoping arm is extended, in the first direction, along a telescoping arm axis, such that the end effector is disposed for grasping the first object;
in the second telescoping arm extended configuration, the telescoping arm is extended, in the second direction, along the telescoping arm axis, such that the end effector is disposed for grasping the second object.

24. The robot of claim 23, wherein:
the displacement of the robot-defined object supporter, in the first direction, for transitioning from the supporter retracted configuration to the first supporter extended configuration, is along a supporter extension axis;
the extension of the robot-defined object supporter, in the second direction, for transitioning from the supporter retracted configuration to the second supporter extended configuration, is also along the supporter extension axis.

25. The robot of claim 24, wherein:
the telescoping arm extension axis is parallel to the platform extension axis.

26. The robot of any one of claims 16 to 25, further comprising:
a lift mechanism;
wherein the object manipulator is displaceable vertically by the lift mechanism, relative to the base.

27. The robot of any one of claims 16 to 26, wherein the base is a mobile base including a mobility platform configured for becoming co-operatively disposed in contact engagement with a reaction surface for facilitating movement of the robot across the reaction surface within the aisle.

28. The robot as claimed in any one of claims 16 to 27
wherein:
a minimum spacing distance, between the first and second object supporters, of less than 12 feet is defined within the aisle.

29. The robot as claimed in claim 28, wherein:
the minimum spacing distance is greater than 25 inches.

30. A robot, comprising:
a base;
an object manipulator, comprising:
an extendible arm, extendible from a extendible arm retracted configuration to a first extendible arm extended configuration, and also extendible from the extendible arm retracted configuration to a second extendible arm extended configuration;
an end effector that is coupled to the extendible arm;
wherein:
the end effector is configured for grasping an object, such that a grasped object is established; and
the extendible arm is extendible and retractable for displacing he grasped object relative to the base;
in transitioning from the extendible arm retracted configuration to the first extendible arm extended configuration, the extendible arm is extended in a first direction; and
in transitioning from the extendible arm retracted configuration to the second extendible arm extended configuration, the extendible arm is extended in a second direction that is opposite the first direction.

31. The robot of claim 30, wherein:
the extension of the extendible arm, in the first direction, for transitioning from the extendible arm retracted configuration to the first extendible arm extended configuration, is along a extendible arm extension axis;
the extension of the extendible arm, in the second direction, for transitioning from the extendible arm retracted configuration to the second extendible arm extended configuration, is also along the extension axis.

32. The robot of claim 31, wherein:
the extension of the extendible arm, from the extendible arm retracted configuration to the first extendible arm extended configuration, is a lateral extension of the extendible arm in the first direction, relative to the base; and
the extension of the extendible arm, from the extendible arm retracted configuration to the second extendible arm extended configuration, is a lateral extension of the extendible arm in the second direction, relative to the base.

33. The robot of claim 32 further comprising:
a platform configured to support the object, the platform displaceable laterally, relative to the base, from a platform retracted configuration to a first platform extended configuration, and also displaceable laterally from the platform retracted configuration to a second platform extended configuration;
wherein:
in transitioning from the platform retracted configuration to the first platform extended configuration, the platform is displaced in a first direction; and
in transitioning from the platform retracted configuration to the second platform extended configuration, the platform is displaced in a second direction that is opposite the first direction.

34. The robot of claim 33, wherein the lateral displacement of the extendible arm is independent of the lateral displacement of the platform.

35. The robot of claim 33 or claim 34, wherein:
the platform is displaceable laterally, relative to the base.

36. The robot of any one of claims 33 to 35, wherein:
the extendible arm is a telescoping arm;
the telescoping arm is configurable in a first telescoping arm extended configuration and a second telescoping arm extended configuration;
in the first telescoping arm extended configuration, the telescoping arm is extended, in the first direction, along a telescoping arm axis;
in the second telescoping arm extended configuration, the telescoping arm is extended, in the second direction, along the telescoping arm axis.

37. The robot of claim 36, wherein:
the displacement of the platform, in the first direction, for transitioning from the platform retracted configuration to the first platform extended configuration, is along a platform extension axis;
the extension of the platform, in the second direction, for transitioning from the platform retracted configuration to the second platform extended configuration, is also along the platform extension axis.

38. The robot of claim 37, wherein:
the telescoping arm extension axis is parallel to the platform extension axis.

39. The robot of any one of claims 30 to 38, further comprising:
a lift mechanism;
wherein the object manipulator is displaceable vertically by the lift mechanism, relative to the base.

40. The mobile apparatus of any one of claims 30 to 39, wherein the base is a mobile base including a mobility platform configured for becoming co-operatively disposed in contact engagement with a reaction surface for facilitating movement of the robot across the reaction surface

41. A robot comprising:
a base supportable by a reaction surface;
an object manipulator, supported by the base, including:
an end effector for grasping an object,
wherein the end effector is displaceable relative to the base such that, while the end effector is grasping the object, the object is displaceable by the end effector;
an anchor configuration;
wherein:
the base and the anchor configuration are co-operatively configured such that, while the base is supported on the reaction surface:
the anchor configuration is emplaceable in an anchoring-effective state, with effect that the robot becomes anchored to the reaction surface.

42. The robot as claimed in claim 41;
wherein:
the anchoring is for mitigating tilting of the robot while the end effector is being displaced relative to the base.

43. The robot as claimed in claim 42;
wherein:
the tilting of the robot, which the anchoring is mitigating while the end effector is being displaced relative to the base, is being mitigated while the end effector is grasping the object.

44. The robot as claimed in claim 41;
wherein:
the displaceability of the end effector, relative to the base, includes displaceability within a horizontal plane;
the anchoring is for mitigating tilting of the robot while the end effector is being displaced relative to the base within a horizontal plane.

45. The robot as claimed in claim 44;
wherein:
the tilting of the robot, which the anchoring is mitigating while the end effector is being displaced relative to the base within a horizontal plane, is being mitigated while the end effector is grasping the object.

46. The robot as claimed in claim 44 or 45;
wherein:
the object manipulator further includes an extendible arm;
the object manipulator and the base are co-operatively configured such that, while the base is supported on the reaction surface, the extendible arm is extendible within a horizontal plane; and
the end effector is mounted to the extendible arm, such that the tilting of the robot, which the anchor is mitigating while the end effector is being displaced relative to the base within a horizontal plane, is being mitigated by the anchor while the end effector is being displaced by the extendible arm.

47. The robot as claimed in claim 41;
wherein:
the displaceability of the end effector, relative to the base, includes lateral displaceability relative to the base; and
the anchoring is for mitigating tilting of the robot while the end effector is being displaced laterally relative to the base.

48. The robot as claimed in claim 47;
wherein:
the tilting of the robot, which the anchoring is mitigating while the end effector is being displaced laterally relative to the base, is being mitigated while the end effector is grasping the object.

49. The robot as claimed in claim 47 or 48;
wherein:
the object manipulator further includes an extendible arm;
the object manipulator and the base are co-operatively configured such that while the base is supported on the reaction surface, the extendible arm is extendible laterally relative to the base;
the end effector is mounted to the extendible arm, such that the tilting of the robot, which the anchoring is mitigating while the end effector is being displaced laterally relative to the base, is being mitigated by the anchor while the end effector is being displaced by the extendible arm.

50. The robot as claimed in claim 47;
wherein:
the lateral displaceability of the end effector is within a horizontal plane.

51. The robot as claimed in claim 50;
wherein:
the tilting of the robot, which the anchoring is mitigating while the end effector is being displaced laterally relative to the base within a horizontal plane, is being mitigated while the end effector is grasping the object.

52. The robot as claimed in claim 50 or 51;
wherein:
the object manipulator further includes an extendible arm;
the object manipulator and the base are co-operatively configured such that, while the base is supported on the reaction surface, the extendible arm is extendible laterally, relative to the base, within a horizontal plane;
the end effector is mounted to the extendible arm, such that the tilting of the robot, which the anchor is mitigating while the end effector is being displaced laterally, relative to the base, and within a horizontal plane, is being mitigated by the anchor while the end effector is being displaced by the extendible arm.

53. The robot as claimed in claim 41;
wherein:
the displaceability of the end effector relative to the base is such that the end effector is displaceable relative to the base between a lower vertical position and a higher vertical position, wherein the higher vertical position is elevated relative to the lower vertical position; and
the anchoring is for mitigating tilting of the robot while the end effector is disposed in the higher vertical position.

54. The robot as claimed in claim 53;
wherein:
the tilting of the robot, which the anchoring is mitigating while the end effector is disposed in the higher vertical position, is being mitigated while the end effector is grasping the object.

55. The robot as claimed in claim 53 or 54;
wherein:
the higher vertical position is elevated above the lower vertical position by a minimum vertical distance of at least 8 feet.

56. The robot as claimed in claim 41
wherein:
the displaceability of the end effector relative to the base is such that the end effector is displaceable relative to the base between a lower vertical position and a higher vertical position; and
the anchoring is for mitigating tilting of the robot while the end effector is being displaced between the lower vertical position and the higher vertical position.

57. The robot as claimed in claim 56;
wherein:
the tilting of the robot, which the anchoring is mitigating while the end effector is being displaced between the lower vertical position and the higher vertical position, is being mitigated while the end effector is grasping the object.

58. The robot as claimed in claim 56 or 57;
wherein:
the higher vertical position is elevated above the lower vertical position by a vertical distance of at least 8 feet.

59. The robot as claimed in any one of claims 53 to 58;
further comprising:
a lift mechanism mounted to the base;
wherein:
the displacement of the end effector, relative to the base, between the lower vertical position and the higher vertical position, is effectible by the lift mechanism.

60. The robot as claimed in any one of claims 41 to 59;
wherein:
the anchoring is such that the anchor engages the reaction surface in gripping engagement.

61. The robot as claimed in any one of claims 41 to 60;
wherein:
the anchor configuration is additionally configured for emplacement in an anchoring-ineffective state, such that the emplacement of the anchor configuration in the anchor-effective state includes transitioning of the anchor from the anchoring-ineffective state to the anchoring-effective state; and
in the anchoring-ineffective state, there is an absence of anchoring of the robot to the reaction surface by the anchor configuration.

62. The robot of any one of claims 41 to 61, wherein:
while the robot is anchored to the reaction surface, the anchoring is defeatable via an anchor-defeating force, the anchor-defeating force having a magnitude with a minimum value of at least 2000 pounds.

63. The robot of claim 62, wherein the anchor-defeating force has a direction that is parallel to the reaction surface.

64. The robot as claimed in any one of claims 41 to 63;
further comprising:
a mobility platform;
wherein:
the base and the mobility platform are co-operatively configured such that, while the base is supported on the reaction surface, the robot is movable across the reaction surface.

65. The robot as claimed in claim 64;
wherein:
the mobility platform includes a plurality of wheels.

66. The robot as claimed in any one of claims 41 to 63, being configured for: (i) displacing a first object relative to a first object supporter, the first object supporter being configured to support the first object, and (ii) displacing a second object relative to a second object supporter, the second object supporter is configured to support the second object, wherein the first object supporter is disposed opposite the second object supporter in a spaced-apart relationship such that an aisle is defined, wherein a minimum spacing distance, between the first and second object supporters, of less than 12 feet is defined within the aisle, and the grasping of an object, for which the object manipulator is configured, includes the grasping of the first object and the grasping of the second object.

67. The robot as claimed in claim 66, wherein the minimum spacing distance is greater than 25 inches.

68. The robot as claimed in claim 66 or claim 67;
wherein:
the base is a mobile base including a mobility platform configured for becoming co-operatively disposed in contact engagement with a reaction surface for facilitating movement of the robot across the reaction surface within the aisle.

69. A robot comprising:
a base supportable by a reaction surface;
an object manipulator, supported on the base, and including:
an end effector for grasping an object, such that a grasped object is established;
wherein:
the object manipulator is displaceable, relative to the base, along a travel axis, between a lower vertical position and a higher vertical position, for effecting a change in elevation of the object manipulator; and
the base and the object manipulator co-operate such that, while the base is supported on a reaction surface, such that the displaceability of the object manipulator is along a travel axis that is disposed at angle relative to the vertical, the base and the object manipulator are configurable into a modified travel axis-establishing state, with effect that the travel axis is modified to become a vertical axis.

70. The robot as claimed in claim 69;
wherein:
the travel axis, that is disposed at an angle relative to the vertical, is disposed at angle relative to the vertical of at least 1 degree.

71. The robot as claimed in claim 69 or 70;
wherein:
the reaction surface, upon which the base is supported while the displaceability of the object manipulator is along the travel axis that is disposed at angle relative to the vertical, is a non-horizontal surface.

72. The robot as claimed in claim 71;
wherein:
the non-horizontal surface is disposed at an angle, relative to the horizontal, of at least 1 degree.

73. The robot as claimed in any one of claims 69 to 72;
further comprising:
a lift mechanism, mounted to the base, and co-operating with the object manipulator, such that the displaceability of the object manipulator, relative to the base, along the travel axis, between a lower vertical position and a higher vertical position, is effectible by the lift mechanism.

74. The robot as claimed in any one of claims 69 to 72;
wherein:
the base includes:
a platform; and
a plurality of extendible support legs;
wherein:
each one of the support legs, independently, is positionable relative to the platform, based on extension or retraction relative to the platform, such that a co-operative positioning of the support legs, relative to the platform, is establishable;
the modification to the travel axis is based on a modification to the co-operative positioning of the support legs, relative to the platform.

75. The robot as claimed in claim 74;
wherein:
the configurability, of the base and the object manipulator, into a modified travel axis-establishing state, is based on the modifiability of the co-operative positioning of the support legs.

76. The robot as claimed in claim 74 or claim 75, further comprising:
a level sensor configured to collect data representative of the inclination of the base relative to a horizontal plane;
a memory;
a controller for executing instructions stored in the memory that, when executed, causes the controller to:
process the data from the level sensor to determine the inclination of the base relative to the horizontal plane; and
based on the determination, modifying the co-operative positioning of the support legs relative to the platform.

77. The robot as claimed in any one of claims 69 to 76;
wherein:
the base is a mobile base including a mobility platform configured for becoming co-operatively disposed in contact engagement with a reaction surface for facilitating movement of the robot across the reaction surface.

78. The robot as claimed in any one of claims 67 to 75, being configured for: (i) displacing a first object relative to a first object supporter, the first object supporter being configured to support the first object, and (ii) displacing a second object relative to a second object supporter, the second object supporter is configured to support the second object, wherein the first object supporter is disposed opposite the second object supporter in a spaced-apart relationship such that an aisle is defined, wherein a minimum spacing distance, between the first and second object supporters, of less than 12 feet is defined within the aisle, and the grasping of an object, for which the end effector is configured, includes the grasping of the first object and the grasping of the second object.

79. The robot as claimed in claim 78, wherein the minimum spacing distance is greater than 25 inches.

80. The robot as claimed in claim 78 or claim 79;
wherein:
the base is a mobile base including a mobility platform configured for becoming co-operatively disposed in contact engagement with a reaction surface for facilitating movement of the robot across the reaction surface within the aisle.

81. A robot comprising:
a base;
an object manipulator configured for grasping an object; and
a lift mechanism configured for vertically displacing the object manipulator, relative to the base, including:
a prime mover for generating a force for urging the vertical displacement of the object manipulator relative to the base; and
a counterweight configuration, coupled to the object manipulator, with effect that an opposing counterweight-based force is applied by the counterweight configuration to the object manipulator such that the weight of the object manipulator is opposed by the counterweight configuration, and such that the counterweight configuration is effective for assisting the prime mover with the urging of the vertical displacement of the object manipulator relative to the base.

82. The robot as claimed in claim 81;
wherein:
the counterweight configuration includes a pneumatic counterweight configuration including at least one pneumatic gas cylinder, the pneumatic gas cylinder housing a pressurized gas for generating the opposing force that is applied to the object manipulator.

83. The robot as claimed in claim 81 or 82;
wherein
the lift mechanism includes a frame, the frame defining an inner side and an outer side, wherein:
the inner side is disposed in opposing relation relative to the object manipulator; and
the counterweight configuration is mounted to the frame such that the counterweight configuration is accessible from the outer side of the frame.

84. The robot as claimed in any one of claims 81 to 83;
wherein:
the base is a mobile base including a mobility platform configured for becoming co-operatively disposed in contact engagement with a reaction surface for facilitating movement of the robot across the reaction surface.

85. The robot as claimed in any one of claims 81 to 84, being configured for: (i) displacing a first object relative to a first object supporter, the first object supporter being configured to support the first object, and (ii) displacing a second object relative to a second object supporter, the second object supporter is configured to support the second object, wherein the first object supporter is disposed opposite the second object supporter in a spaced-apart relationship such that an aisle is defined, wherein a minimum spacing distance, between the first and second object supporters, of less than 12 feet is defined within the aisle, and the grasping of an object, for which the object manipulator is configured, includes the grasping of the first object and the grasping of the second object.

86. The robot as claimed in claim 85, wherein the minimum spacing distance is greater than 25 inches.

87. The robot as claimed in claim 85 or claim 86;
wherein:
the base is a mobile base including a mobility platform configured for becoming co-operatively disposed in contact engagement with a reaction surface for facilitating movement of the robot across the reaction surface within the aisle.

88. A robot configured to displace an object relative to an object supporter, the robot comprising:
a base;
an object manipulator including:
an object emplacement/removal tool; and
an end effector configured for grasping an object;
wherein:
the object emplacement/removal tool and the end effector are co-operatively configured with effect that:
the object emplacement/removal tool is displaceable, relative to the base, independently of the end effector, and along a first axis;
the end effector is displaceable, with the object emplacement/removal tool, along a second axis; and
the second axis is disposed parallel to an axis that is transverse to the first axis.

89. The robot as claimed in claim 88;
wherein:
displacement of the end effector, relative to the object emplacement/removal tool, along the second axis, is restricted.

90. The robot as claimed in claim 88 or 89;
wherein:
the object emplacement/removal tool and the end effector are further co-operatively configured with effect that:
displacement of the object emplacement/removal tool, relative to the base, independently of the end effector, and along the first axis, is obtainable, and the obtained displacement of the object emplacement/removal tool, relative to the base, independently of the end effector, and along the first axis, is obtainable in absence of displacement of the end effector, relative to the base, along the first axis.

91. The robot as claimed in any one of claims 88 to 90;
wherein:
the absence of displacement of the end effector, relative to the base, along the first axis, is with effect that positioning of the end effector, relative to the base, remains unchanged.

92. The robot as claimed in any one of claim 88 or 91;
wherein:
the base is a mobile base including a mobility platform configured for becoming co-operatively disposed in contact engagement with a reaction surface for facilitating movement of the robot across the reaction surface.

93. The robot as claimed in any one of claim 88 or 92, being configured for: (i) displacing a first object relative to a first object supporter, the first object supporter being configured to support the first object, and (ii) displacing a second object relative to a second object supporter, the second object supporter is configured to support the second object, wherein the first object supporter is disposed opposite the second object supporter in a spaced-apart relationship such that an aisle is defined, wherein a minimum spacing distance, between the first and second object supporters, of less than 12 feet is defined within the aisle, and the grasping of an object, for which the end effector is configured, includes the grasping of the first object and the grasping of the second object.

94. The robot as claimed in claim 93, wherein:
the minimum spacing distance is greater than 25 inches.

95. The robot as claimed in claim 93 or 94;
wherein:
the base is a mobile base including a mobility platform configured for becoming co-operatively disposed in contact engagement with a reaction surface for facilitating movement of the robot across the reaction surface within the aisle.

96. A robot configured to displace an object relative to an object supporter, the robot comprising:
a base;
an object manipulator including:
an object emplacement/removal tool; and
an end effector configured for grasping an object;
wherein:
the object emplacement/removal tool and the end effector are co-operatively configurable with effect that the object emplacement/removal tool is displaceable, relative to the base, independently of the end effector, and along a first axis, such that displacement of the object emplacement/removal tool, relative to the base, and along a first axis, is obtainable, and the displacement of the object emplacement/removal tool, relative to the base, and along a first axis, is obtainable in absence of displacement of the end effector, relative to the base, and along the first axis, such that positioning of the end effector, relative to the base, remains unchanged, with effect that the object manipulator is transitionable between an alignment ineffective configuration and an alignment effective configuration in response to the displacement of the object emplacement tool, relative to the end effector, and along the first axis, obtained in absence of displacement of the end effector, relative to the base, along the first axis;
the object emplacement/removal tool and the end effector are co-operatively configurable with effect that the end effector is displaceable, with the object emplacement/removal tool, relative to the base, along a second axis, and in response to extension or retraction of the object emplacement/removal tool, such that displacement of the end effector, with the object emplacement/removal tool, relative to the base, along the second axis, and in response to extension or retraction of the object emplacement/removal tool, is obtainable, such that the object manipulator is transitionable between the alignment effective configuration and an object emplacement/removal effective configuration in response to the displacement of the end effector, relative to the base, along the second axis, and in response to the extension or the retraction of the object emplacement/removal tool; and
the second axis is disposed parallel to an axis that is transverse to the first axis.

97. The robot as claimed in claim 96;
wherein:
the axis, that is transverse to the first axis, and to which the second axis is disposed in parallel relationship, is perpendicular to the first axis.

98. The robot as claimed in claim 96 or 97;
wherein:
the object emplacement/removal tool and the end effector are further co-operatively configurable with effect that displacement of the end effector, relative to the object emplacement/removal tool, along the second axis, wherein the restriction of the displacement of the end effector, relative to the object emplacement/removal tool, along the second axis, is effective for establishing the displaceability of the end effector with the object emplacement/removal tool.

99. The robot as claimed in any one of claims 96 to 98;
wherein:
the object emplacement/removal tool includes:
an extendible arm;
extension or retraction of the object emplacement/removal tool is based on a corresponding extension or retraction of the extendible arm; and
the extendible arm and the end effector are co-operatively configurable such that the extendible arm is displaceable, relative to the base, and along a first axis, such that displacement of the extendible arm, relative to the base, and along a first axis, is obtainable, and the displacement of the extendible arm, relative to the base, and along a first axis, is obtainable in absence of displacement of the end effector, relative to the base, and along the first axis;
such that the displacement of the object emplacement/removal tool, relative to the base, and along a first axis, is obtainable in response to the displacement of the extendible arm, relative to the base, and along a first axis.

100. The robot as claimed in claim 99;
wherein:
the object emplacement/removal tool further includes:
a driver;
the extendible arm and the driver are co-operatively configurable with effect that: (i) the driver is displaceable with the extendible arm, relative to the base, and along the first axis, in response to the displacement of the extendible arm, relative to the base, and along a first axis, such that displacement of the driver, relative to the base, and along a first axis, is obtainable, and the displacement of the driver, relative to the base, and along a first axis, is obtainable in absence of displacement of the end effector, relative to the base, and along the first axis; and (ii) the driver is displaceable with the extendible arm, relative to the base, and along the second axis, in response to the extension or the retraction of the extendible arm, relative to the base;
the extendible arm and the driver are co-operatively configurable with effect that the driver is displaceable, relative to the base, independently of the extendible arm, and along a third axis, such that displacement of the driver, relative to the base, and along the third axis is obtainable, and such that the object manipulator is transitionable between an object distribution ready configuration and the alignment ineffective configuration in response to the displacement of the driver, relative to the extendible arm, and along the third axis;
the end effector is mounted to the driver;
the end effector and the driver are co-operatively configurable with effect that: (i) the end effector is displaceable with the driver, relative to the base, and along the third axis, in response to the displacement of the driver, relative to the base, and along a third axis, (ii) the obtainability of the displacement of the driver, relative to the base, and along a first axis, in the absence of displacement of the end effector, relative to the base, and along the first axis, is established, and (iii) the end effector is displaceable with the driver, relative to the base, and along the second axis, in response to the extension or the retraction of the extendible arm, relative to the base; and
the third axis is disposed parallel to an axis that is transverse to the first axis.

101. The robot as claimed in claim 100;
wherein:
the axis, that is transverse to the first axis, and to which the third axis is disposed in parallel relationship, is perpendicular to the first axis.

102. The robot as claimed in claim 100 or 101;
wherein:
the third axis is parallel to the second axis.

103. The robot as claimed in any one of claims 100 to 102;
wherein:
the extendible arm and the driver are further co-operatively configurable with effect that displacement of the driver, relative to the extendible arm, along the first axis is restricted, wherein the restriction of the displacement of the driver, relative to the extendible arm, along the first axis, is effective for establishing the displaceability of the driver with the extendible arm in response to displacement of the extendible arm, relative to the base, and along a first axis.

104. The robot as claimed in any one of claims 100 to 103;
wherein:
the extendible arm and the driver are further co-operatively configurable with effect that displacement of the driver, relative to the extendible arm, along the second axis is restricted, wherein the restriction of the displacement of the driver, relative to the object emplacement/removal tool, along the second axis, is effective for establishing the displaceability of the driver with the extendible arm in response to the extension or the retraction of the extendible arm.

105. The robot as claimed in any one of claims 96 to 104, and being configured for co-operation with a pre-existing object and an object supporter, wherein the pre-existing object is being supported by the object supporter for emplacing a robot-manipulatable object, relative to the supported pre-existing object, such that the robot-manipulatable object becomes supported by the object supporter in a side-by-side relationship with the pre-existing object, wherein the emplacing includes:
while the end effector is disposed in the object distribution ready configuration and grasping the robot-manipulatable object, such that a grasped robot-manipulatable object is established, transitioning the object manipulator to, in sequence, the alignment ineffective configuration, the alignment effective configuration, and the object emplacement/removal effective configuration; and
while the object manipulator is disposed in the object emplacement/removal effective configuration, releasing the grasped robot-manipulatable object, with effect that the robot-manipulatable object becomes supported on the object supporter in a side-by-side relationship with the supported pre-existing object;
wherein:
the supported pre-existing object is disposed such that:
while the object manipulator is disposed in the alignment ineffective configuration, the supported pre-existing object is effective for interfering with an extension of the extendible arm; and
while the object manipulator is disposed in the alignment effective configuration, there is an absence of interference, by the supported pre-existing object, for interfering with an extension of the extendible arm.

106. The robot as claimed in claim 105;
wherein:
the interference, to an extension of the extendible arm, by the supported pre-existing object, is with effect that the object manipulator collides with the supported pre-existing object.

107. The robot as claimed in claim 105 or 106;
wherein:
the disposition of the supported pre-existing object is such that, the emplacement of the robot manipulatable object, relative to the supported pre-existing object, such that the robot manipulatable object is supported by the object supporter in a side-by-side relationship with the supported pre-existing object, the minimum spacing distance between opposing sides of the supported robot manipulatable object and the supported pre-existing object is less than two (2) inches.

108. The robot as claimed in any one of claims 100 to 104, and being configured for co-operation with a target object, an adjacent object, and an object supporter for removing the target object, wherein the target object and the adjacent object are being supported by the object supporter and disposed in a side-by-side relationship, wherein the removing includes:
while the object manipulator is disposed in the object emplacement/removal effective configuration, grasping the target object with the end effector, such that a grasped robot-manipulatable object is established;
while the object manipulator is disposed in the object emplacement/removal effective configuration and the end effector is grasping the target object, transitioning the object manipulator to, in sequence, the alignment effective configuration, the alignment ineffective configuration, and the object distribution ready configuration;
wherein:
while the object manipulator is disposed in the alignment effective configuration, the co-operative disposition of the extendible arm and the grasped robot-manipulatable object is effective for interfering with the displacement of the driver, relative to the base, and along the third axis; and
while the object manipulator is disposed in the alignment ineffective configuration, the extendible arm and the grasped robot-manipulatable object are co-operatively disposed such that there is an absence of interference to the displacement of the driver, relative to the base, and along the third axis.

109. The robot as claimed in claim 108;
wherein:
the minimum spacing distance between opposing sides of the target object and the adjacent object is less than two (2) inches.

110. The robot as claimed in any one of claims 96 to 109, and being configured for displacing an object relative to an object supporter, the object supporter being configured to support the object and another object in a side by side configuration, and further comprising:
a robot-defined object supporter configured to support the object.

111. The robot as claimed in any one of claims 96 to 110;
wherein:
the base is a mobile base including a mobility platform configured for becoming co-operatively disposed in contact engagement with a reaction surface for facilitating movement of the robot across the reaction surface.

112. The robot as claimed in any one of claims 96 to 111, being configured for: (i) displacing a first object relative to a first object supporter, the first object supporter being configured to support the first object, and (ii) displacing a second object relative to a second object supporter, the second object supporter is configured to support the second object, wherein the first object supporter is disposed opposite the second object supporter in a spaced-apart relationship such that an aisle is defined, wherein a minimum spacing distance, between the first and second object supporters, of less than 12 feet is defined within the aisle, and the grasping of an object, for which the end effector is configured, includes the grasping of the first object and the grasping of the second object.

113. The robot as claimed in claim 112, wherein the minimum spacing distance is greater than 25 inches.

114. The robot as claimed in claim 112 or 113;
wherein:
the base is a mobile base including a mobility platform configured for becoming co-operatively disposed in contact engagement with a reaction surface for facilitating movement of the robot across the reaction surface within the aisle.

115. A robot, comprising:
a base;
an object manipulator, comprising:
an extendible arm configured for extension and retraction;
an end effector configured for grasping an object;
wherein:
the end effector is coupled to the extendible arm such that:
the end effector is displaceable laterally, relative to the base, in response to extension or retraction of the extendible arm; and
the end effector is displaceable laterally, relative to the extendible arm.

116. The robot of claim 115, wherein:
the end effector is displaceable laterally, relative to the extendible arm, in a first direction, and also in a second direction that is opposite the first direction.

117. The robot of claim 115 or claim 116, wherein the extendible arm is a telescoping arm.

118. The robot of claim 117, wherein:
the telescoping arm comprising a plurality of arm segments, the plurality of arm segments defining a terminal arm segment;
the end effector is coupled to the terminal arm segment, such that:
the coupling of the end effector to the telescoping arm is effected by the coupling of the end effector to the terminal arm segment; and
the end effector is displaceable laterally, relative to the terminal arm segment.

119. The robot of claim 117 or claim 118, wherein:
the end effector is displaceable laterally, relative to the telescoping arm, along the central longitudinal axis of the telescoping arm.

120. The robot of any one of claims 117 to 119, wherein:
the telescoping arm is extendible and retractable along an extension axis;
the end effector is displaceable laterally, relative to the telescoping arm, along the extension axis.

121. The robot of any one of claims 117 to 120, wherein:
the telescoping arm is extendible from a retracted configuration to a first extended configuration, and also extendible from the retracted configuration to a second extended configuration;
wherein:
in transitioning from the retracted configuration to the first extended configuration, the telescoping arm is extended in a first direction;
in transitioning from the retracted configuration to the second extended configuration, the telescoping arm is extended in a second direction that is opposite the first direction;
the end effector is displaceable laterally, relative to the telescoping arm, while the telescoping arm is disposed in the retracted configuration.

122. The robot of claim 121, wherein the end effector is displaceable laterally, relative to the telescoping arm, while the telescoping arm is disposed in the first extended configuration.

123. The robot of claim 121 or claim 122, wherein the end effector is displaceable laterally, relative to the telescoping arm, while the telescoping arm is disposed in the second extended configuration.

124. The robot of any one of claims 115 to 123, further comprising:
a lift mechanism, wherein the object manipulator is displaceable vertically by the lift mechanism, relative to the base.

125. The robot as claimed in any one of claims 115 to 124;
wherein:
the base is a mobile base including a mobility platform configured for becoming co-operatively disposed in contact engagement with a reaction surface for facilitating movement of the robot across the reaction surface.

126. The robot as claimed in any one of claims 115 to 125, being configured for: (i) displacing a first object relative to a first object supporter, the first object supporter being configured to support the first object, and (ii) displacing a second object relative to a second object supporter, the second object supporter is configured to support the second object, wherein the first object supporter is disposed opposite the second object supporter in a spaced-apart relationship such that an aisle is defined, wherein a minimum spacing distance, between the first and second object supporters, of less than 12 feet is defined within the aisle, and the grasping of an object, for which the end effector is configured, includes the grasping of the first object and the grasping of the second object.

127. The robot as claimed in claim 126, wherein:
the minimum spacing distance is greater than 25 inches.

128. The robot as claimed in claim 126 or claim 127;
wherein:
the base is a mobile base including a mobility platform configured for becoming co-operatively disposed in contact engagement with a reaction surface for facilitating movement of the robot across the reaction surface within the aisle.

129. A robot, comprising:
a base;
an object manipulator, comprising:
an end effector, the end effector comprising:
a first grasping configuration disposed on a first side of the end effector; and
a second grasping configuration disposed on a second side of the end effector that is opposite the first side;
a robot-defined object supporter configured to support the object, such that, while the object is supported on the robot-defined object supporter, a supported object is established;
wherein:
each one of the first grasping configuration and the second configuration, independently, is configured for grasping an object, such that a grasped object is established; and
while the object is supported by the robot-defined object supporter:
the object manipulator is configurable in a first configuration, a second configuration, a third configuration, and a fourth configuration;
in the first configuration:
a first side of the supported object is grasped by the first grasping configuration, such that the end effector is coupled to the first side of the supported object;
in the second configuration:
there is an absence of coupling between the end effector and the supported object, and
the first grasping configuration and the first side of the supported object are disposed in opposing relationship;
in the third configuration:
there is an absence of coupling between the end effector and the supported object, and
the second grasping configuration and a second side of the supported object are disposed in opposing relationship, wherein, relative to the first side, the second side of the supported object is disposed on an opposite side of the supported object;
in the fourth configuration:
the second side of the supported object is grasped by the second grasping configuration, such that the end effector is coupled to the second side of the supported object;
the object manipulator is:
transitionable from the first configuration to the second configuration;
transitionable from the second configuration to the third configuration; and
transitionable from the third configuration to the fourth configuration.

130. The robot as claimed in claim 129, wherein:
the transition from the second configuration to the third configuration is with effect that the end effector clears the supported object.

131. The robot as claimed in claim 129 or 130;
wherein:
the transitioning from the second configuration to the third configuration is with effect that the end effector is vertically displaced during the transitioning.

132. The robot as claimed in claim 129 or 130;
wherein:
the transitioning from the second configuration to the third configuration includes:
an upwardly displacement of the end effector, with effect that the end effector becomes emplaced above the supported object;
while the end effector is emplaced above the supported object, a lateral displacement of the end effector, with effect that the end effector traverses the supported object;
after the traversing of the supported object by the end effector, a downwardly displacement of the end effector.

133. The robot of any one of claims 129 to 132, wherein:
the object manipulator further comprises an extendible arm;
wherein the end effector is coupled to the extendible arm such that the extendible arm is extendible and retractable for moving the end effector.

134. The robot of claim 133, wherein:
the extendible arm is vertically displaceable, relative to the robot-defined object supporter;
the vertical displacement of the end effector during transition of the object manipulator from the second configuration to the third configuration is effected by vertical displacement of the extendible arm, relative to the robot-defined object supporter.

135. The robot of claim 134, wherein:
the lateral displacement of the end effector, for effecting the transition of the object manipulator from the second configuration to the third configuration, is lateral displacement of the end effector, relative to the robot-defined object supporter, the lateral displacement effectible in response to actuation of the extendible arm.

136. The robot of claim 134, further comprising:
an end effector actuator configuration that is disposed in operable communication with the end effector;
wherein:
the end effector is coupled to the extendible arm, such that the end effector is displaceable laterally, relative to the extendible arm, in response to extension or retraction of the extendible arm via actuation by the end effector actuator configuration;
the lateral displacement of the end effector, for effecting the transition of the object manipulator from the second configuration to the third configuration, is lateral displacement of the end effector, relative to the extendible arm.

137. The robot of claim 136, wherein:
the lateral displacement of the end effector, relative to the extendible arm, effectible in response to extension or retraction of the extendible arm via actuation by the end effector actuator configuration, is independent of displacement of the end effector, in response to extension or retraction of the extendible arm.

138. The robot of any one of claims 133 to 137, wherein the extendible arm is a telescoping arm.

139. The robot of any one of claims 129 to 138, wherein:
while the robot is disposed between a first object supporter and second object supporter, wherein the first object supporter defines a first supporting surface, the second object supporter defines a second supporting surface, and the first and second supporting surfaces are disposed at the same elevation,
and while one of the first and second grasped configurations is grasping an object on the first object supporter such that the grasped object is established:
the object manipulator is emplaceable in the first configuration in response to displacement of the object, by the object manipulator from the first object supporter to the robot-defined object supporter;
and while the object manipulator is disposed in the fourth configuration, the supported object is displaceable, by the object manipulator, from the robot-defined object supporter, to the second object supporter for supporting of the object by the second supporting surface.

140. The robot of any one of claims 129 to 139, wherein the object manipulator is vertically displaceable, relative to the base.

141. The robot of claim 140, further comprising:
a lift mechanism;
wherein the vertical displaceability of the object manipulator, relative to the base, is effected by the lift mechanism

142. The robot as claimed in any one of claims 129 to 141;
wherein:
the base is a mobile base including a mobility platform configured for becoming co-operatively disposed in contact engagement with a reaction surface for facilitating movement of the robot across the reaction surface.

143. The robot as claimed in any one of claims 129 to 142, being configured for: (i) displacing a first object relative to a first object supporter, the first object supporter being configured to support the first object, and (ii) displacing a second object relative to a second object supporter, the second object supporter is configured to support the second object, wherein the first object supporter is disposed opposite the second object supporter in a spaced-apart relationship such that an aisle is defined, wherein a minimum spacing distance, between the first and second object supporters, of less than 12 feet is defined within the aisle, and the grasping of an object, for which the end effector is configured, includes the grasping of the first object and the grasping of the second object.

144. The robot as claimed in claim 143, wherein:
the minimum spacing distance is greater than 25 inches.

145. The robot as claimed in claim 143 or claim 144;
wherein:
the base is a mobile base including a mobility platform configured for becoming co-operatively disposed in contact engagement with a reaction surface for facilitating movement of the robot across the reaction surface within the aisle.

146. A robot, comprising:
a base;
an object manipulator, comprising:
a first end effector configured for grasping an object;
a robot-defined object supporter configured to support the object, such that, while the object is supported on the robot-defined object supporter, a supported object is established;
a second end effector, configured for grasping the object;
wherein:
the first end effector is displaceable laterally, relative to the base; and
the second end effector is displaceable longitudinally, relative to the base.

147. The robot of claim 146, wherein the object manipulator further comprises:
an extendible arm;
the first end effector is coupled to the extendible arm such that the lateral displacement of the end effector, relative to the base, is effectible in response to extension or retraction of the extendible arm.

148. The robot of claim 147, further comprising:
a second end effector actuator configuration, disposed in operable communication with the second end effector;
the longitudinal displacement of the second end effector, relative to the base, is effectible in response to actuation by the second end effector actuator configuration.

149. The robot of any one of claims 146 to 148, wherein:
the second end effector is configurable in a retracted configuration and an extended configuration;
wherein:
the first end effector, the second end effector, the extendible arm, and the robot-defined object supporter are co-operable with an object and a first object supporter such that:
while: (i) a first object supporter is disposed on a side of the robot-defined object supporter, (ii) the object is supported by the first object supporter, and (iii) the first end effector is grasping the object, such that the grasped object is established:
in the retracted configuration, the second end effector is disposed, relative to the extendible arm, such that there is absence of interference, by the second end effector, to effect lateral movement of the grasped object, towards the robot-defined object supporter, by the extendible arm.

150. The robot of claim 149, wherein:
the second end effector and the robot-defined object supporter are co-operable with the object and a second object supporter such that:
while: (i) a second object supporter is disposed in front of the robot-defined object supporter, (ii) the object is supported by the second object supporter, and (iii) the second end effector is disposed in the extended configuration and is grasping the object, such that the grasped object is established:
the grasped object is movable towards the robot-defined object supporter by the second end effector.

151. The robot of claim 150, wherein:
the movement of the grasped object towards the robot-defined object supporter by the second end effector is effectible in response to the longitudinal displacement of the second end effector, relative to the base.

152. The robot of any one of claims 147 to 151, wherein the extendible arm is a telescoping arm.

153. The robot of any one of claims 146 to 152, wherein:
the longitudinal displacement of the second end effector, relative to the base, is independent of the lateral displacement of the first end effector, relative to the base.

154. The robot of any one of claims 146 to 153, wherein the object manipulator further comprises:
a robot-defined object supporter, wherein the robot-defined object supporter is laterally displaceable, relative to the base;
the second end effector is coupled to the robot-defined object supporter such that the second end effector is laterally displaceable, with the robot-defined object supporter, relative to the base.

155. The robot of any one of claims 146 to 154, wherein the object manipulator is displaceable vertically relative to the base.

156. The robot of claim 155, further comprising:
a lift mechanism;
wherein the vertical displaceability of the object manipulator, relative to the base, is effected by the lift mechanism

157. The robot as claimed in any one of claims 146 to 156;
wherein:
the base is a mobile base including a mobility platform configured for becoming co-operatively disposed in contact engagement with a reaction surface for facilitating movement of the robot across the reaction surface.

158. The robot as claimed in any one of claims 146 to 157, being configured for: (i) displacing a first object relative to a first object supporter, the first object supporter being configured to support the first object, and (ii) displacing a second object relative to a second object supporter, the second object supporter is configured to support the second object, wherein the first object supporter is disposed opposite the second object supporter in a spaced-apart relationship such that an aisle is defined, wherein a minimum spacing distance, between the first and second object supporters, of less than 12 feet is defined within the aisle, and the grasping of an object, for which the first end effector is configured, includes the grasping of the first object and the grasping of the second object.

159. The robot as claimed in claim 158, wherein:
the minimum spacing distance is greater than 25 inches.

160. The robot as claimed in claim 158 or claim 159;
wherein:
the base is a mobile base including a mobility platform configured for becoming co-operatively disposed in contact engagement with a reaction surface for facilitating movement of the robot across the reaction surface within the aisle.

161. A robot, comprising:
a base;
an object manipulator configured for:
grasping an object, such that a grasped object is established; and
moving the grasped object;
a lift mechanism, for vertically displacing the object manipulator relative to the base, and including a frame mounted to the base, wherein the frame includes:
a first frame section;
a second frame section; and
an intermediate frame section disposed between the first frame section and the second frame section;
wherein:
the first frame section and the second frame section are disposed in opposing relationship;
the first frame section, the second frame section, and the intermediate frame section co-operatively configured such that a torque-receiving frame portion is defined;
the object manipulator is coupled to the frame, such that the object manipulator is moveable relative to the frame for effectuating the vertical displacement, and such that, while the object manipulator is moving the grasped object, a force is transmitted from the object manipulator to the frame, with effect that a torque is applied to the torque-receiving frame portion;
the torque-receiving frame portion is configured to resist the torque applied to the frame.

162. The robot of claim 161, wherein:
the torque-receiving frame portion has a C-shaped cross-section taken along a vertical axis.

163. The robot as claimed in claim 161 or 162;
wherein:
the lift mechanism includes a primer mover for generating a force for urging the vertical displacement of the object manipulator relative to the base.

164. The robot of claim 163, wherein:
the lift mechanism includes a carrier coupled to the prime mover for vertical displacement by the prime mover;
the object manipulator and the carrier are co-operatively configured such that the object manipulator is displaceable with the carrier, such that the vertical displacement of the object manipulator is based on the vertical displacement of the carrier;
the torque-receiving frame portion defines a cavity;
the vertical displaceability of the carrier is such that the lift mechanism is displaceable between a retracted configuration and an extended configuration;
while the carrier is disposed in the retracted configuration, the lift mechanism is disposed within the cavity;
while the carrier is disposed in the extended position, the carrier is disposed above the cavity.

165. The robot as claimed in any one of claims 161 to 164;
wherein:
the base is a mobile base including a mobility platform configured for becoming co-operatively disposed in contact engagement with a reaction surface for facilitating movement of the robot across the reaction surface.

166. The robot as claimed in any one of claims 161 to 165, being configured for: (i) displacing a first object relative to a first object supporter, the first object supporter being configured to support the first object, and (ii) displacing a second object relative to a second object supporter, the second object supporter is configured to support the second object, wherein the first object supporter is disposed opposite the second object supporter in a spaced-apart relationship such that an aisle is defined, wherein a minimum spacing distance, between the first and second object supporters, of less than 12 feet is defined within the aisle, and the grasping of an object, for which the object manipulator is configured, includes the grasping of the first object and the grasping of the second object.

167. The robot as claimed in claim 166, wherein:
the minimum spacing distance is greater than 25 inches.

168. The robot as claimed in claim 166 or claim 167;
wherein:
the base is a mobile base including a mobility platform configured for becoming co-operatively disposed in contact engagement with a reaction surface for facilitating movement of the robot across the reaction surface within the aisle.

169. A robot, comprising:
a base;
an object manipulator, comprising:
a telescoping arm;
an end effector coupled to the telescoping arm;
wherein:
the end effector is configured for grasping an object, such that a grasped object is established; and
the telescoping arm is extendible and retractable for moving the grasped object;
the telescoping arm includes a plurality of arm segments;
at least one of the plurality of arm segments has a C-shaped cross-section, such that the telescoping arm includes at least one C-shaped cross-section defined arm segment.

170. The robot of claim 169, wherein:
the plurality of arm segments is defined by a base arm segment, a terminal arm segment, and at least one intermediate arm segment, the at least one intermediate arm segment being disposed between the base arm segment and the terminal arm segment; and
at least one of the at least one intermediate arm segment has a C-shaped cross-section, such that the at least one C-shaped cross-section defined arm segment includes at least one of the at least one intermediate arm segment.

171. The robot of claim 170, wherein:
each one of the at least one intermediate arm segment, independently, has a C-shaped cross-section, such that the at least one C-shaped cross-section defined arm segment includes the at least one intermediate arm segment.

172. The robot of claim 170 or claim 171, wherein:
the terminal arm segment has a C-shaped cross-section taken along a lateral axis, such that the at least one C-shaped cross-section defined arm segment includes the terminal arm segment.

173. The robot of claim 172, wherein:
the telescoping arm is configurable in a retracted configuration;
while the telescoping arm is disposed in the retracted configuration, the at least one intermediate arm segment is nested within the terminal arm segment;

174. The robot of claim 173, wherein:
the telescoping arm is configurable in an extended configuration;
while the telescoping arm is disposed in the extended position, at least a portion of the at least one intermediate arm segment is de-nested from the terminal arm segment.

175. The robot of any one of claims 170 to 174, wherein:
the terminal arm segment includes:
a first end portion defined by an upwardly extending fold, extending laterally, relative to the base; and
a second end portion defined by a downwardly extending fold, extend laterally, relative to the base.

176. The robot arm of any one of claims 169 to 175, wherein the telescoping arm is actuatable for extension and retraction, for moving the grasped object.

177. The robot arm of any one of claims 169 to 176, wherein the object manipulator is vertically displaceable, relative to the base.

178. The robot of claim 177, further comprising:
a lift mechanism;
wherein the vertical displaceability of the object manipulator, relative to the base, is effected by the lift mechanism

179. The robot as claimed in any one of claims 169 to 178;
wherein:
the base is a mobile base including a mobility platform configured for becoming co-operatively disposed in contact engagement with a reaction surface for facilitating movement of the robot across the reaction surface.

180. The robot as claimed in any one of claims 169 to 179, being configured for: (i) displacing a first object relative to a first object supporter, the first object supporter being configured to support the first object, and (ii) displacing a second object relative to a second object supporter, the second object supporter is configured to support the second object, wherein the first object supporter is disposed opposite the second object supporter in a spaced-apart relationship such that an aisle is defined, wherein a minimum spacing distance, between the first and second object supporters, of less than 12 feet is defined within the aisle, and the grasping of an object, for which the end effector is configured, includes the grasping of the first object and the grasping of the second object.

181. The robot as claimed in claim 180, wherein:
the minimum spacing distance is greater than 25 inches.

182. The robot as claimed in claim 180 or claim 181;
wherein:
the base is a mobile base including a mobility platform configured for becoming co-operatively disposed in contact engagement with a reaction surface for facilitating movement of the robot across the reaction surface within the aisle.

183. A robot, comprising:
a base;
an object manipulator including:
an end effector for grasping an object;
wherein:
the end effector is displaceable relative to the base; and
a temperature sensor, displaceable with the end effector;
wherein:
the end effector and the temperature sensor are co-operatively configured such that, while the end effector is being displaced relative to the base, the temperature sensor is effective for collecting a plurality of temperature data, wherein each one of the temperature data, independently, is representative of a temperature.

184. The robot as claimed in claim 183;
wherein:
the end effector is co-operable with an object and an object supporter for executing an object displacement operation, wherein the object displacement operation includes:
while the end effector is spaced-apart from the object supporter, and there is an absence of grasping of an object by the end effector such that the end effector is disposed in an object grasping-absent state:
displacing the end effector, relative to the base, towards the object supporter, such that the end effector becomes disposed, relative to the object, in a grasping-effective relationship;
while the end effector is disposed in the grasping-effective relationship, grasping the object, such that a grasped object is established;
and
while the end effector is grasping the object, displacing the end effector, relative to the base, away from the object supporter, such that the grasped object is displaced away from the object supporter;
the end effector is co-operable with an object and an object supporter for executing an object emplacement operation, wherein the object emplacement operation includes:
while the end effector is grasping an object and spaced-apart from the object supporter:
displacing the end effector, relative to the base, towards the object supporter, such that the grasped object becomes disposed in a releasing-effective relationship with the object supporter; and
while the grasped object is disposed in a releasing-effective relationship with the object supporter, releasing the object, such that the object becomes supported on the object supporter and the end effector becomes disposed in the object grasping-absent state;
and
after the releasing of the grasped object, and while the end effector is disposed in the grasping-absent state, displacing the end effector, relative to the base, away from the object supporter;
and
the end effector and the temperature sensor are co-operatively configured such that, during at least one of the object displacement operation and the object emplacement operation:
for each one of the at least one of the object displacement operation and the object emplacement operation, independently, the temperature sensor is effective for collecting a plurality of temperature data, wherein each one of the collected data, independently, is representative of a temperature.

185. The robot as claimed in claim 184;
wherein:
the at least one of the object displacement operation and the object emplacement operation is both of the object displacement operation and the object emplacement operation, such that the temperature sensor is effective for collecting the plurality of temperature data for, independently, each one of the object displacement operation and the object emplacement operation.

186. The robot as claimed in any one of claims 183 to 185;
wherein:
for each one of the collected data, independently, the collected datum is representative of a temperature at a discrete location in space.

187. The robot as claimed in any one of claims 183 to 186, further comprising:
a controller is configured to execute instructions stored in a memory that, when executed, causes the controller to:
process the data from the temperature sensor to generate a temperature map.

188. The robot as claimed in any one of claims 183 to 187;
wherein:
the base is a mobile base including a mobility platform configured for becoming co-operatively disposed in contact engagement with a reaction surface for facilitating movement of the robot across the reaction surface.

189. The robot as claimed in any one of claims 183 to 188, being configured for: (i) displacing a first object relative to a first object supporter, the first object supporter being configured to support the first object, and (ii) displacing a second object relative to a second object supporter, the second object supporter is configured to support the second object, wherein the first object supporter is disposed opposite the second object supporter in a spaced-apart relationship such that an aisle is defined, wherein a minimum spacing distance, between the first and second object supporters, of less than 12 feet is defined within the aisle, and the grasping of an object, for which the end effector is configured, includes the grasping of the first object and the grasping of the second object.

190. The robot as claimed in claim 189, wherein:
the minimum spacing distance is greater than 25 inches.

191. The robot as claimed in claim 189 or claim 190;
wherein:
the base is a mobile base including a mobility platform configured for becoming co-operatively disposed in contact engagement with a reaction surface for facilitating movement of the robot across the reaction surface within the aisle.
